(19) United States
(12) Patent Application Publication
(10) Pub. No.: US 2022/0417909 A1
(43) Pub. Date: Dec. 29, 2022

(54) BEAM INDICATION FOR INTER-CELL OPERATION

(71) Applicant: Samsung Electronics Co., Ltd., Suwon-si (KR)

(72) Inventors: Dalin Zhu, Richardson, TX (US); Emad N. Farag, Flanders, NJ (US); Eko Onggosanusi, Coppell, TX (US)

(21) Appl. No.: 17/807,108

(22) Filed: Jun. 15, 2022

Related U.S. Application Data
(60) Provisional application No. 63/214,993, filed on Jun. 25, 2021.
(60) Provisional application No. 63/218,132, filed on Jul. 2, 2021.

(51) Int. Cl. H04W 72/02; H04W 72/04; H04W 16/28; H04L 5/00

(52) U.S. Cl. CPC H04W 72/02; H04W 72/046; H04W 72/042; H04W 16/28; H04L 5/0051; H04W 80/02

(57) ABSTRACT

Methods and apparatuses for a beam indication and a beam update for an inter-cell operation in a wireless communication system. A method for operating user equipment (UE) includes receiving a first downlink control information (DCI) including a first transmission configuration indicator (TCI) codepoint indicating a first TCI states and a second DCI indicating a second TCI codepoint indicating second TCI states. The method further includes determining, based on the first TCI states, first quasi co-location (QCL) information for receipt of a first physical downlink control channel (PDCCH), physical downlink shared channel (PDSCH), or channel state information reference signal (CSI-RS) and determining, based on the second TCI states DCI, second QCL information for receipt of a second PDCCH, PDSCH, or CSI-RS. The method further includes receiving the first PDCCH, PDSCH, or CSI-RS based on the first QCL information and the second PDCCH, PDSCH, or CSI-RS based on the second QCL information.

### CROSS-REFERENCE TO RELATED APPLICATIONS AND CLAIM OF PRIORITY

The present application claims priority to U.S. Provisional Patent Application No. 63/214,993, filed on Jun. 25, 2021, and U.S. Provisional Patent Application No. 63/218,132, filed on Jul. 2, 2021. The content of the above-identified patent documents are incorporated herein by reference.

### TECHNICAL FIELD

The present disclosure relates generally to wireless communication systems and, more specifically, the present disclosure relates to a beam indication and a beam update for an inter-cell operation in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a beam indication and a beam update for an inter-cell operation in a wireless communication system.

In one embodiment, a user equipment (UE) is provided. The UE includes a transceiver configured to receive a first downlink control information (DCI) including at least one first transmission configuration indicator (TCI) codepoint indicating one or more first TCI states, receive a second DCI indicating at least one second TCI codepoint indicating one or more second TCI states; and receive configuration information indicating a first physical cell identity (PCI) and a second PCI. The UE further includes a processor operably coupled to the transceiver. The first DCI is received in a control resource set (CORESET) associated with a first CORESET pool index. The second DCI is received in a CORESET associated with a second CORESET pool index. The processor is configured to determine, based on the one or more first TCI states indicated by the first DCI, first quasi co-location (QCL) information for receipt of a first physical downlink control channel (PDCCH), physical downlink shared channel (PDSCH), or channel state information reference signal (CSI-RS); and determine, based on the one or more second TCI states indicated by the second DCI, second QCL information for receipt of a second PDCCH, PDSCH, or CSI-RS. The transceiver is further configured to receive the first PDCCH, PDSCH, or CSI-RS based on the first QCL information; and receive the second PDCCH, PDSCH, or CSI-RS based on the second QCL information.

In another embodiment, a base station (BS) is provided. The BS includes a transceiver configured to transmit a first DCI including at least one first TCI codepoint indicating one or more first TCI states, transmit a second DCI indicating at least one second TCI codepoint indicating one or more second TCI states, transmit configuration information indicating a first PCI and a second PCI, transmit the first PDCCH, PDSCH, or CSI-RS, and transmit the second PDCCH, PDSCH, or CSI-RS. The first DCI is transmitted in a CORESET associated with a first CORESET pool index. The one or more first TCI states indicate first QCL information for a first PDCCH, PDSCH, or CSI-RS. The second DCI is transmitted in a CORESET associated with a second CORESET pool index. The one or more second TCI states indicate second QCL information for a second PDCCH, PDSCH, or CSI-RS.

In yet another embodiment, a method for operating user equipment (UE) is provided. The method includes receiving a first DCI including at least one first TCI codepoint indicating one or more first TCI states, receiving a second DCI indicating at least one second TCI codepoint indicating one or more second TCI states, and receiving configuration information indicating a first PCI and a second PCI. The second DCI is received in a CORESET associated with a second CORESET pool index. The first DCI is received in a CORESET associated with a first CORESET pool index. The method further includes determining, based on the one or more first TCI states indicated by the first DCI, first QCL information for receipt of a first PDCCH, PDSCH, or CSI-RS and determining, based on the one or more second TCI states indicated by the second DCI, second QCL information for receipt of a second PDCCH, PDSCH, or CSI-RS. The method further includes receiving the first PDCCH, PDSCH, or CSI-RS based on the first QCL information and receiving the second PDCCH, PDSCH, or CSI-RS based on the second QCL information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure;

FIG. 8 illustrates an example of a multiple-TRP (multi-TRP) system according to embodiments of the present disclosure;

FIG. 9A illustrates an example of TCI state indication according to embodiments of the present disclosure;

FIG. 9B illustrates an example of MAC CE based beam indication according to embodiments of the present disclosure;

FIG. 9C illustrates another example of MAC CE based beam indication according to embodiments of the present disclosure;

FIG. 9D illustrates yet another example of MAC CE based beam indication according to embodiments of the present disclosure;

FIG. 9E illustrates an example of higher layer configured two lists of TCI states according to embodiments of the present disclosure;

FIG. 9F illustrates yet another example of MAC CE based beam indication according to embodiments of the present disclosure;

FIG. 9G illustrates another example of higher layer configured two lists of TCI states according to embodiments of the present disclosure;

FIG. 10A illustrates another example of TCI state indication according to embodiments of the present disclosure;

FIG. 10B illustrates an example of MAC CE activation command for activating/deactivating one or more TCI states according to embodiments of the present disclosure;

FIG. 10C illustrates another example of MAC CE activation command for activating/deactivating one or more TCI states according to embodiments of the present disclosure;

FIG. 10D illustrates yet another example of MAC CE activation command for activating/deactivating one or more TCI states according to embodiments of the present disclosure;

FIG. 10E illustrates yet another example of MAC CE activation command for activating/deactivating one or more TCI states according to embodiments of the present disclosure;

FIG. 11 illustrates an example of inter-cell system according to embodiments of the present disclosure;

FIG. 12A illustrates an example of MAC CE based TCI state/beam indication according to embodiments of the present disclosure;

FIG. 12B illustrates an example of higher layer configured two lists of TCI states according to embodiments of the present disclosure;

FIG. 12C illustrates another example of higher layer configured two lists of TCI states according to embodiments of the present disclosure;

FIG. 13 illustrates an example of DCI based TCI state/beam indication according to embodiments of the present disclosure;

FIG. 14A illustrates another example of DCI based TCI state/beam indication according to embodiments of the present disclosure;

FIG. 14B illustrates an example of MAC CE activation command for activating/deactivating one or more TCI states according to embodiments of the present disclosure;

FIG. 14C illustrates another example of MAC CE activation command for activating/deactivating one or more TCI states according to embodiments of the present disclosure;

FIG. 14D illustrates yet another example of MAC CE activation command for activating/deactivating one or more TCI states according to embodiments of the present disclosure; and

FIG. 15 illustrates an example method for beam indication for an inter-cell operation in a wireless communication system according to embodiments of the present disclosure.

### DETAILED DESCRIPTION

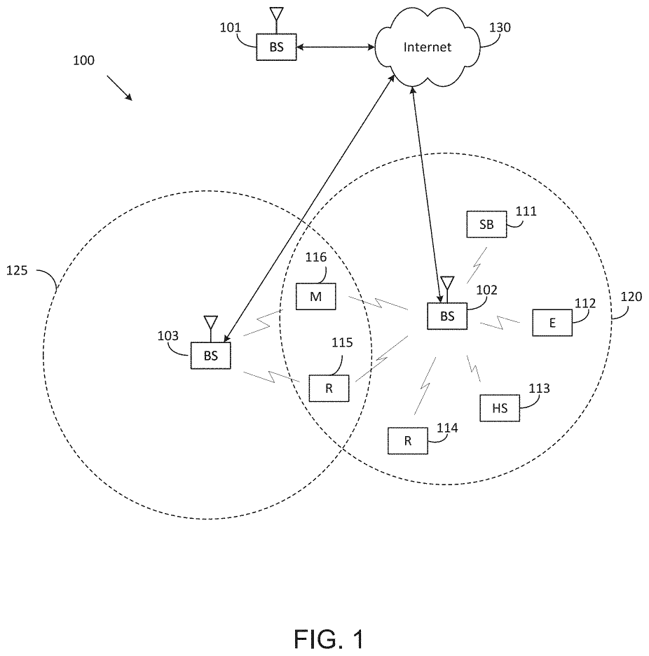

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as one or more of a transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a beam indication for an inter-cell operation in a wireless communication system. In certain embodiments, and one or more of the gNBs 101-103 includes circuitry, programing, or a combination thereof, for a beam indication for an inter-cell operation in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

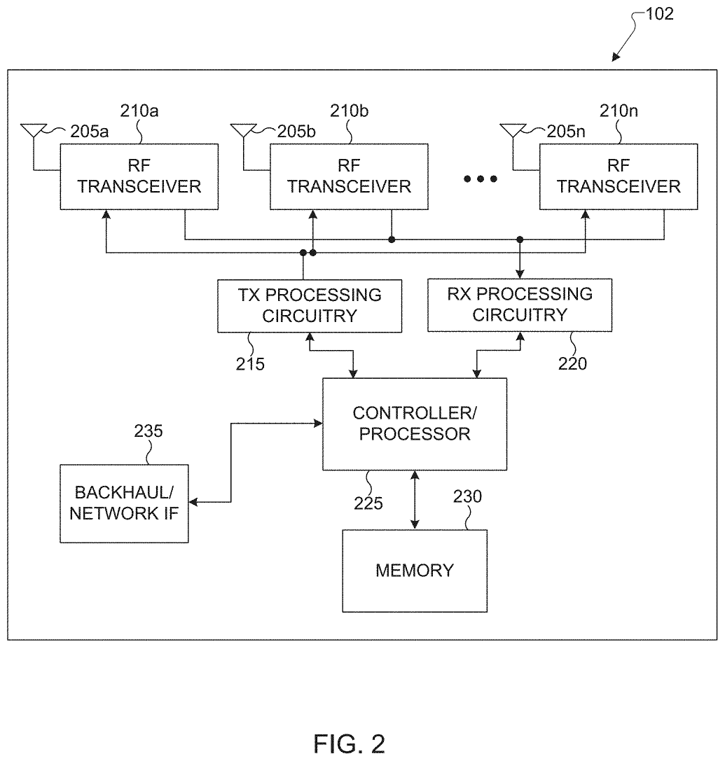

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, a base station could include multiple TRPs for beam indication for an inter-cell operation in a wireless communication system. Each of the TRPs may be co-located or may be physically separate from each other. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

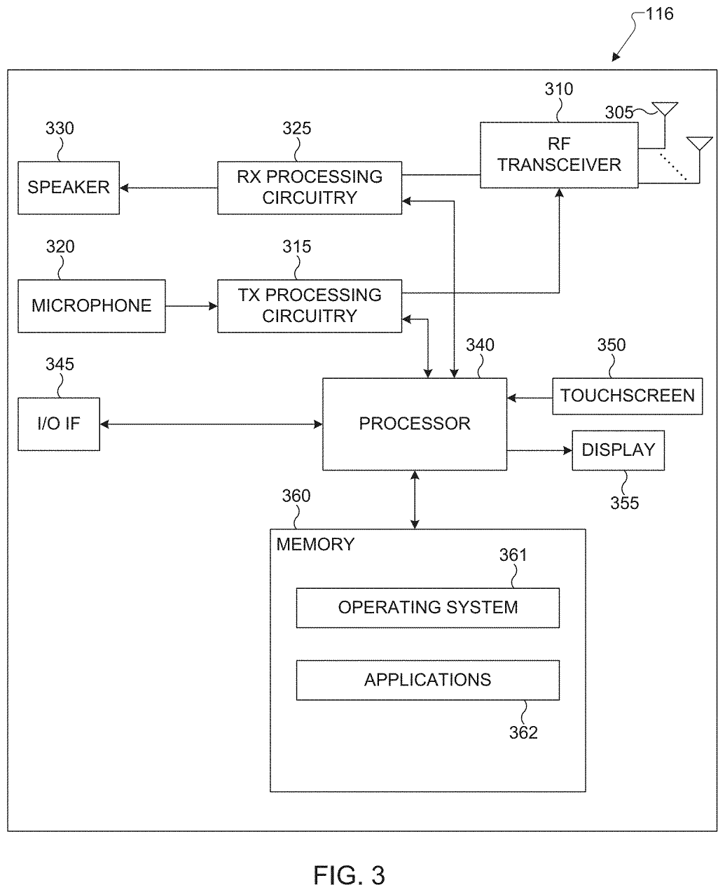

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and RX processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for a beam indication for an inter-cell operation in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

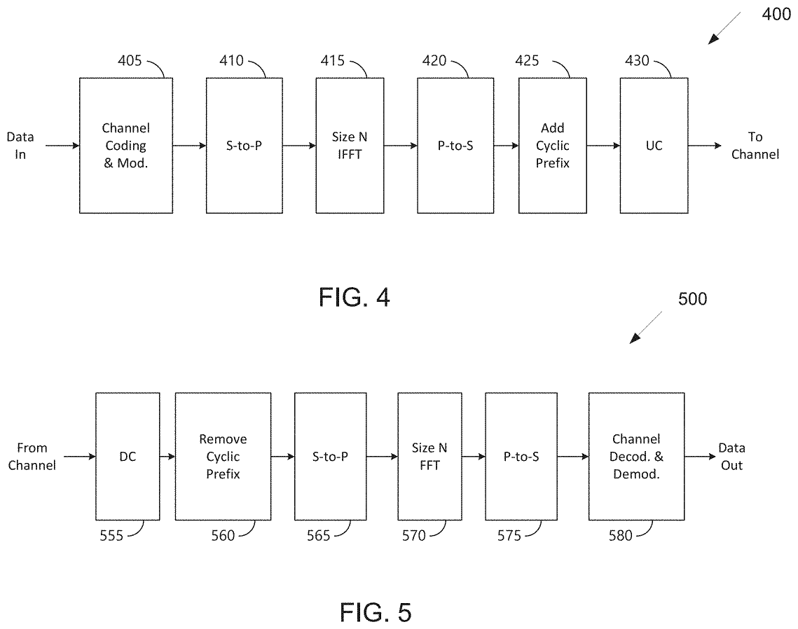

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmitpath 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

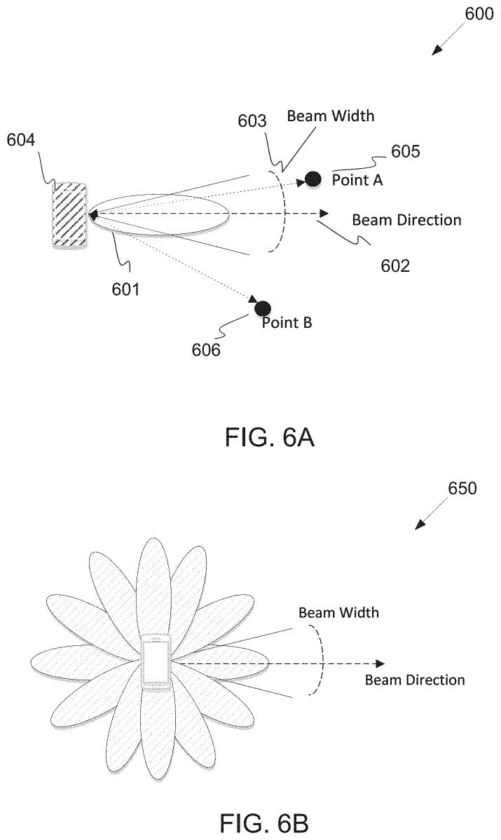

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

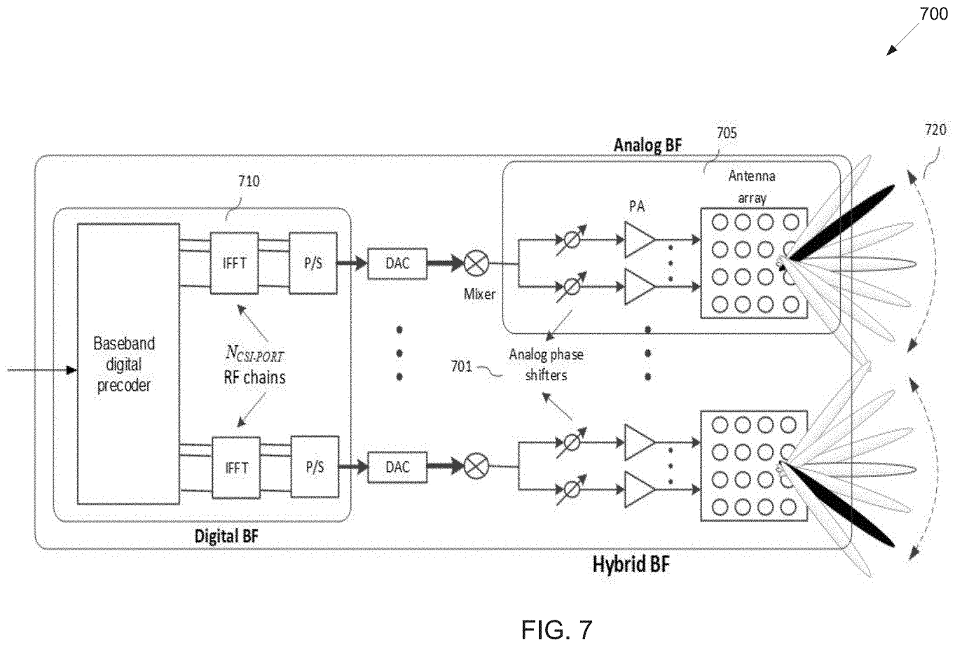

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @ 100 m distance), larger number of and sharper analog beams (hence larger number of radiators in the array) may be needed to compensate for the additional path loss.

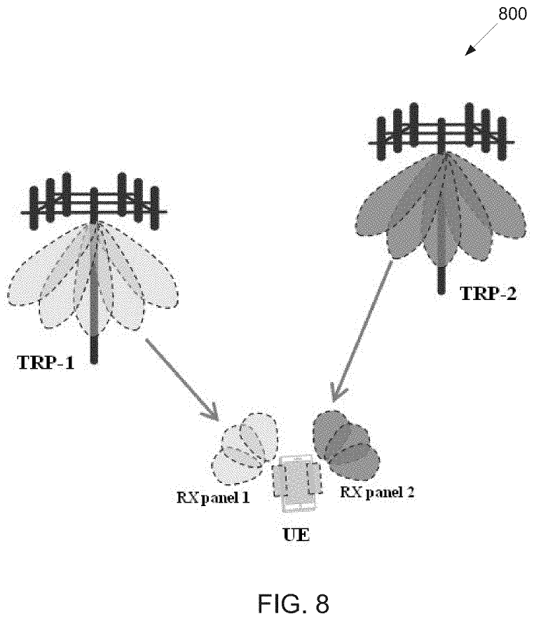

FIG. 8 illustrates an example of a multiple-TRP (multi-TRP) system 800 according to embodiments of the present disclosure. An embodiment of the multiple-TRP (multi-TRP) system 800 shown in FIG. 8 is for illustration only.

In a multiple transmission and reception point (TRP) system depicted in FIG. 8, the UE could simultaneously receive from multiple physically non-co-located TRPs various channels/RSs such as PDCCHs and/or PDSCHs using either a single receive (RX) panel or multiple RX panels. In this disclosure, a RX panel could correspond to a set of RX antenna elements/ports at the UE, a set of measurement RS resources such as SRS resources, a spatial domain RX filter or etc. Further, a TRP in the multi-TRP system can represent a collection of measurement antenna ports, measurement RS resources and/or control resource sets (CORESETs).

For example, a TRP could be associated with one or more of: (1) a plurality of CSI-RS resources; (2) a plurality of CRIs (CSI-RS resource indices/indicators); (3) a measurement RS resource set, for example, a CSI-RS resource set along with its indicator; (4) a plurality of CORESETs associated with a CORESETPoolIndex; and/or (5) a plurality of CORESETs associated with a TRP-specific index/indicator/identity.

In this disclosure, the non-serving cell(s) or the non-serving cell TRP(s) could have/broadcast or be associated/configured with different physical cell IDs (PCIs) and/or other higher layer signaling index values from that of the serving cell or the serving cell TRP (i.e., the serving cell PCI). In one example, the serving cell or the serving cell TRP could be associated with the serving cell ID (SCI) and/or the serving cell PCI. That is, for the inter-cell operation considered in the present disclosure, different cells/TRPs could broadcast/have or be associated/configured with different PCIs and/or one or more cells/TRPs (referred to/defined as non-serving cells/TRPs in the present disclosure) could broadcast/have or be associated/configured with different PCIs from that of the serving cell/TRP (i.e., the serving cell PCI) and/or one or more cells/TRPs are not associated with valid SCI (e.g., provided by the higher layer parameter ServCellIndex). In the present disclosure, a non-serving cell PCI can also be referred to as an additional PCI, another PCI or a different PCI (with respect to the serving cell PCI). The serving cell PCI or the PCI of/for the serving cell could be provided to the UE via higher layer parameter ServingCellCommonConfig.

The UE could be configured by the network one or more transmission configuration information (TCI) states, which indicate the QCL information/assumptions for one or more RSs/channels such as PDCCHs and/or PDSCHs. The TCI state update/indication for PDCCH and/or PDSCH can also be referred to as beam indication. For instance, for data transmissions on the shared channel (such as the physical downlink shared channel in NR, i.e., PDSCH), the corresponding beam indication procedure under the 3GPP Rel. 15/16 TCI framework can be summarized as follows: a UE can be first higher layer configured by the network (e.g., via high layer RRC signaling) a set/pool of TCI states; the UE could then receive from the network a MAC CE command activating one or more TCI states from the set/pool of RRC configured TCI states; the UE could be indicated by the network via dynamic DCI signaling that one or more of the MAC CE activated TCI states are active for the reception of the PDSCH(s).

The 3GPP Rel. 15/16 TCI framework supports intra-cell multi-TRP operation such that different TRPs in the multi-TRP system could share the same physical cell ID (PCI). The 3GPP Rel. 15/16 TCI framework, however, cannot support the simultaneous transmission/reception of PDCCH(s)/PDSCH(s) in an inter-cell multi-TRP system, wherein different cells/TRPs could have different PCIs. In the inter-cell multi-TRP system, the simultaneously transmitted/received PDCCH(s)/PDSCH(s) could include at least one PDCCH/PDSCH associated with at least one non-serving cell/TRP (or neighboring cell/TRP) having a different PCI from that of the serving cell/TRP.

This disclosure considers various design aspects/enhancements for the TCI state/beam indication in an inter-cell multi-TRP system, wherein different cells/TRPs could have different PCIs from that of the serving cell/TRP. The solutions developed in this disclosure could be used to support the simultaneous transmission/reception of PDCCH(s)/PDSCH(s) in the inter-cell multi-TRP system, wherein at least one PDCCH/PDSCH is transmitted from/associated with at least one non-serving cell/TRP or neighboring cell/TRP having a different PCI from that of the serving cell/TRP.

For multi-DCI based multi-TRP operation, each CORESET is associated with/linked to a CORESETPoolIndex value, e.g., by configuring the CORESETPoolIndex value (either “0” or “1”) in the higher layer parameter ControlResourceSet. For inter-cell multi-TRP operation, wherein different cells/TRPs could have different PCIs, the UE could be indicated by the network the association between the CORESETPoolIndex values and the serving/non-serving (or neighboring) cells/TRPs. For example, the UE could be indicated by the network that CORESETPoolIndex value “0” is associated with/linked to the serving cell/TRP, while CORESETPoolIndex value “1” is associated with/linked to a non-serving cell/TRP (or neighboring cell/TRP); for another example, the UE could be indicated by the network that CORESETPoolIndex value “0” is associated with/linked to a non-serving cell/TRP (or neighboring cell/TRP), while CORESETPoolIndex value “1” is associated with/linked to the serving cell/TRP; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

The UE could also be indicated by the network the association between the CORESETPoolIndex values and the PCI values for the serving/non-serving (or neighboring) cells/TRPs.

In one example, the UE could be explicitly indicated by the network, e.g., via higher layer RRC signaling and/or MAC CE command and/or dynamic DCI signaling, the exact association/mapping between the CORESETPoolIndex values and the PCI values for the serving/non-serving (or neighboring) cells/TRPs in the inter-cell multi-TRP system. For example, the UE could be first higher layer configured by the network a list/set of two PCIs for the serving/non-serving (or neighboring) cells/TRPs; the CORESETPoolIndex value “0” could be mapped to/associated with the first entry in the list/set of two PCIs for the serving/non-serving (or neighboring) cells/TRPs, while the CORESETPoolIndex value “1” could be mapped to/associated with the second entry in the list/set of two PCIs for the serving/non-serving (or neighboring) cells/TRPs.

For another example, the UE could be first higher layer configured by the network a list/set of two PCIs for the serving/non-serving (or neighboring) cells/TRPs; the CORESETPoolIndex value “1” could be mapped to/associated with the first entry in the list/set of two PCIs for the serving/non-serving (or neighboring) cells/TRPs, while the CORESETPoolIndex value “0” could be mapped to/associated with the second entry in the list/set of two PCIs for the serving/non-serving (or neighboring) cells/TRPs. For more than two configured CORESETPoolIndex values (e.g., 0, 1, . . . , M_idx−1 with M_idx>2), the UE could be first higher layer configured by the network a list/set of at least M_idx PCIs for the serving/non-serving (or neighboring) cells/TRPs in the inter-cell multi-TRP system. The UE could then be indicated by the network the association/mapping between the M_idx CORESETPoolIndex values and the PCIs in the higher layer configured list/set of PCIs. Other indication methods, e.g., via higher layer RRC signaling and/or MAC CE command and/or dynamic DCI signaling, of the exact association/mapping between the CORESETPoolIndex values and the PCI values for the serving/non-serving (or neighboring) cells/TRPs in the inter-cell multi-TRP system are also possible.

In another example, the UE could be implicitly indicated by the network the association/mapping between the CORESETPoolIndex values and the PCI values for the serving/non-serving (or neighboring) cells/TRPs in the inter-cell multi-TRP system. For example, the UE could be indicated by the network that the CORESETPoolIndex value “0” could be mapped to/associated with the lowest PCI value configured to the UE, while the CORESETPoolIndex value “1” could be mapped to/associated with the highest PCI value configured to the UE. For another example, the UE could be indicated by the network that the CORESETPoolIndex value “1” could be mapped to/associated with the lowest PCI value configured to the UE, while the CORESETPoolIndex value “0” could be mapped to/associated with the highest PCI value configured to the UE.

For more than two configured CORESETPoolIndex values (e.g., 0, 1, . . . , M_idx−1 with M_idx>2), the UE could be indicated by the network that the lowest CORESETPoolIndex value could be mapped to/associated with the lowest PCI value configured for the UE, the second lowest CORESETPoolIndex value could be mapped to/associated with the second lowest PCI value configured for the UE, and so on, and the M_idx-th highest CORESETPoolIndex value could be mapped to/associated with the M_idx-th highest PCI value configured for the UE. Other implicit indication methods of the association/mapping between the CORESETPoolIndex values and the PCI values for the serving/non-serving (or neighboring) cells/TRPs in the inter-cell multi-TRP system are also possible.

In yet another example, the UE could be first higher layer configured by the network a first set of PCIs corresponding to/associated with the CORESETPoolIndex value “0,” and a second set of PCIs corresponding to/associated with the CORESETPoolIndex value “1.” The UE could then receive from the network a first MAC CE command activating at least one PCI from the first set of PCIs corresponding to/associated with the CORESETPoolIndex value “0.” The UE could also receive from the network a second MAC CE command activating at least one PCI from the second set of PCIs corresponding to/associated with the CORESETPoolIndex value “1.”

Alternatively, the UE could receive from the network a single MAC CE command activating at least one PCI from the first set of PCIs corresponding to/associated with the CORESETPoolIndex value “0” and at least one PCI from the second set of PCIs corresponding to/associated with the CORESETPoolIndex value “1.” For more than two configured CORESETPoolIndex values (e.g., 0, 1, . . . , M_idx−1 with M_idx>2), the UE could be first higher layer configured by the network a first set of PCIs corresponding to/associated with the CORESETPoolIndex value “0,” a second set of PCIs corresponding to/associated with the CORESETPoolIndex value “1,” and so on, and a M_idx-th set of PCIs corresponding to/associated with the CORESETPoolIndex value “M_idx−1.” The UE could then receive from the network a first MAC CE command activating at least one PCI from the first set of PCIs corresponding to/associated with the CORESETPoolIndex value “0,” a second MAC CE command activating at least one PCI from the second set of PCIs corresponding to/associated with the CORESETPoolIndex value “1,” and so on, and a M_idx-th MAC CE command activating at least one PCI from the M_idx-th set of PCIs corresponding to/associated with the CORESETPoolIndex value “M_idx−1.”

Alternatively, the UE could receive from the network a single MAC CE command activating at least one PCI from the first set of PCIs corresponding to/associated with the CORESETPoolIndex value “0,” at least one PCI from the second set of PCIs corresponding to/associated with the CORESETPoolIndex value “1,” and so on, and at least one PCI from the M_idx-th set of PCIs corresponding to/associated with the CORESETPoolIndex value “M_idx−1.”

In yet another example, the UE could be first higher layer configured by the network a first set of PCIs corresponding to/associated with the CORESETPoolIndex value “0,” and a second set of PCIs corresponding to/associated with the CORESETPoolIndex value “1.” The UE could then receive from the network a first bitmap with each entry/bit in the first bitmap corresponding to/associated with a distinct entry in the first set of PCIs corresponding to/associated with the CORESETPoolIndex value “0”; if an entry/bit in the first bitmap is set to “1,” the corresponding/associated entry in the first set of PCIs corresponding to/associated with the CORESETPoolIndex value “0” is activated as the PCI corresponding to/associated with the CORESETPoolIndex value “0” for the inter-cell multi-TRP operation. The UE could also receive from the network a second bitmap with each entry/bit in the second bitmap corresponding to/associated with a distinct entry in the second set of PCIs corresponding to/associated with the CORESETPoolIndex value “1”; if an entry/bit in the second bitmap is set to “1,” the corresponding/associated entry in the second set of PCIs corresponding to/associated with the CORESETPoolIndex value “1” is activated as the PCI corresponding to/associated with the CORESETPoolIndex value “1” for the inter-cell multi-TRP operation.

Alternatively, the UE could receive from the network a single bitmap activating at least one PCI from the first set of PCIs corresponding to/associated with the CORESETPoolIndex value “0” and at least one PCI from the second set of PCIs corresponding to/associated with the CORESETPoolIndex value “1.” For more than two configured CORESETPoolIndex values (e.g., 0, 1, . . . , M_idx−1 with M_idx>2), the UE could be first higher layer configured by the network a first set of PCIs corresponding to/associated with the CORESETPoolIndex value “0,” a second set of PCIs corresponding to/associated with the CORESETPoolIndex value “1,” and so on, and a M_idx-th set of PCIs corresponding to/associated with the CORESETPoolIndex value “M_idx−1.” The UE could then receive from the network a first bitmap activating at least one PCI from the first set of PCIs corresponding to/associated with the CORESETPoolIndex value “0,” a second bitmap activating at least one PCI from the second set of PCIs corresponding to/associated with the CORESETPoolIndex value “1,” and so on, and a M_idx-th bitmap activating at least one PCI from the M_idx-th set of PCIs corresponding to/associated with the CORESETPoolIndex value “M_idx−1.”

Alternatively, the UE could receive from the network a single bitmap activating at least one PCI from the first set of PCIs corresponding to/associated with the CORESETPoolIndex value “0,” at least one PCI from the second set of PCIs corresponding to/associated with the CORESETPoolIndex value “1,” and so on, and at least one PCI from the M_idx-th set of PCIs corresponding to/associated with the CORESETPoolIndex value “M_idx−1.”

In yet another example, the UE could be indicated by the network that the CORESETPoolIndex value “0” is associated with the serving cell/TRP (and/or its corresponding PCI). For a CORESETPoolIndex value other than value “0,” e.g., value “1”: for example, the UE could be indicated by the network, e.g., via higher layer RRC signaling and/or MAC CE command and/or dynamic DCI signaling, the exact non-serving (or neighboring) cell/TRP PCI value associated with the CORESETPoolIndex value; for another example, the UE could be indicated by the network that the CORESETPoolIndex value could be associated with the lowest (or the highest) non-serving (or neighboring) cell/TRP PCI value configured for the UE; yet for another example, (i) the UE could be higher layer configured by the network a list/set of PCIs corresponding to/associated with the CORESETPoolIndex value, and (ii) the UE could receive from the network a MAC CE command activating at least one PCI from the higher layer configured list/set of PCIs corresponding to/associated with the CORESETPoolIndex value; yet for another example, (i) the UE could be higher layer configured by the network a list/set of PCIs corresponding to/associated with the CORESETPoolIndex value, and (ii) the UE could receive from the network a bitmap activating at least one PCI from the higher layer configured list/set of PCIs corresponding to/associated with the CORESETPoolIndex value.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the CORESETPoolIndex value mod(i−1, N_idx), where mod(x, y) calculates the remainder of the Euclidean division of x by y, and N_idx represents the total number of configured CORESETPoolIndex values. In this design example, if a beam associated with the i-th PCI is activated, the (i+1)-th, the (i+2)-th, . . . , and the (i+N_idx−1)-th entries in the set/list/pool of PCIs (or equivalently, the (i+1)-th PCI, the (i+2)-th PCI, . . . , and the (i+N_idx−1)-th PCI) along with the corresponding CORESETPoolIndex values could be activated, and/or, the (i−N_idx+1)-th, the (i−N_idx+2)-th, . . . , and the (i−1)-th entries in the set/list/pool of PCIs (or equivalently, the (i−N_idx+1)-th PCI, the (i−N_idx+2)-th PCI, . . . , and the (i−1)-th PCI) along with the corresponding CORESETPoolIndex values could be deactivated.

For instance, for N_idx=3 CORESETPoolIndex values 0, 1 and 2, the 1-st entry, the 2-nd entry and the 3-rd entry in the set/list/pool of PCIs (or equivalently, the 1-st PCI, the 2-nd PCI and the 3-rd PCI) are associated with CORESETPoolIndex values 0, 1 and 2, the 4-th entry, the 5-th entry and the 6-th entry in the set/list/pool of PCIs (or equivalently, the 4-th PCI, the 5-th PCI and the 6-th PCI) are associated with CORESETPoolIndex values 0, 1 and 2, and the 7-th entry, the 8-th entry and the 9-th entry in the set/list/pool of PCIs (or equivalently, the 7-th PCI, the 8-th PCI and the 9-th PCI) are associated with CORESETPoolIndex values 0, 1 and 2. In this example, if a beam associated with the 3-rd PCI (associated with the CORESETPoolIndex value “2”) is activated, the 4-th PCI (associated with the CORESETPoolIndex value “0”) and the 5-th PCI (associated with the CORESETPoolIndex value “1”) are activated. At the same time, the 1-st PCI (associated with the CORESETPoolIndex value “0”) and the 2-nd PCI (associated with the CORESETPoolIndex value “1”) are deactivated.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the CORESETPoolIndex value mod(i−1, N_idx), where mod(x, y) calculates the remainder of the Euclidean division of x by y, and N_idx represents the total number of configured CORESETPoolIndex values. In this design example, if a beam associated with the i-th PCI is activated, the (i-floor((N_idx−1)/2))-th, the (i-floor((N_idx−1)/2)+1)-th, . . . , and the (i+ceil((N_idx−1)/2))-th entries in the set/list/pool of PCIs (or equivalently, the (i-floor((N_idx−1)/2))-th PCI, the (i-floor((N_idx−1)/2)+1)-th PCI, . . . , and the (i+ceil((N_idx−1)/2))-th PCI) along with the corresponding CORESETPoolIndex values could be activated, or, the (i-ceil((N_idx−1)/2))-th, the (i-floor((N_idx−1)/2)+1)-th, . . . , and the (i+floor((N_idx−1)/2))-th entries in the set/list/pool of PCIs (or equivalently, the (i-ceil((N_idx−1)/2))-th PCI, the (i-floor((N_idx−1)/2)+1)-th PCI, . . . , and the (i+floor((N_idx−1)/2))-th PCI) along with the corresponding CORESETPoolIndex values could be activated, where floor(x) returns the largest integer that is smaller than or equal to x and ceil(x) returns the smallest integer that is greater than or equal to x.

The starting/initial activated cells could be the (i-D)-th, the (i−D+1)-th, . . . , the i-th, . . . , the (i−D+N_idx−1)-th entries in the set/list/pool of PCIs (or equivalently, the (i−D)-th PCI, the (i-D+1)-th PCI, . . . , the i-th PCI, . . . , the (i−D+N_idx−1)-th PCI); their corresponding/associated CORESETPoolIndex values are also activated. Here, the value of D could be higher layer configured to the UE by the network and/or fixed per RRC configuration. For instance, for N_idx=3 CORESETPoolIndex values 0, 1 and 2, the 1-st entry, the 2-nd entry and the 3-rd entry in the set/list/pool of PCIs (or equivalently, the 1-st PCI, the 2-nd PCI and the 3-rd PCI) are associated with CORESETPoolIndex values 0, 1 and 2, the 4-th entry, the 5-th entry and the 6-th entry in the set/list/pool of PCIs (or equivalently, the 4-th PCI, the 5-th PCI and the 6-th PCI) are associated with CORESETPoolIndex values 0, 1 and 2, and the 7-th entry, the 8-th entry and the 9-th entry in the set/list/pool of PCIs (or equivalently, the 7-th PCI, the 8-th PCI and the 9-th PCI) are associated with CORESETPoolIndex values 0, 1 and 2. In this example, if a beam associated with the 3-rd PCI (associated with the CORESETPoolIndex value “2”) is activated, the 2-nd PCI (associated with the CORESETPoolIndex value “1”) and the 4-th PCI (associated with the CORESETPoolIndex value “0”) are activated.

The non-serving cell/TRP (or neighboring cell/TRP) for inter-cell operation could have a different PCI from that of the serving cell/TRP: (1) in one example, the UE could be explicitly indicated by the network, e.g., via higher layer RRC signaling and/or MAC CE command and/or dynamic DCI signaling, the exact PCI value(s) for the non-serving cell(s)/TRP(s) (or neighboring cell(s)/TRP(s)); (2) in another example, the UE could be first higher layer configured by the network a list/pool/set of neighboring cells' PCIs. The UE could then receive from the network a MAC CE command activating one or more entries in the list/pool/set of neighboring cells' PCIs as the PCI value(s) for the non-serving cell(s)/TRP(s) (or neighboring cell(s)/TRP(s)); (3) in yet another example, the UE could be first higher layer configured by the network a list/pool/set of neighboring cells' PCIs. The UE could then receive from the network a bitmap with each entry/bit in the bitmap corresponding to/associated with a distinct entry in the list/pool/set of neighboring cells' PCIs. If an entry/bit in the bitmap is set to “1,” the corresponding/associated entry in the list/pool/set of neighboring cells' PCIs is activated as the PCI value for a non-serving cell/TRP (or neighboring cell/TRP). The bitmap could contain at least one “1”; and (4) in yet another example, the UE could be first higher layer configured by the network a list/pool/set of neighboring cells' PCIs. One or more entries in the list/pool/set of neighboring cells' PCIs could be configured as the PCI value(s) for the non-serving cell(s)/TRP(s) (or neighboring cell(s)/TRP(s)) if they are associated with one or more active TCI states for PDSCH/PDCCH.

A unified TCI framework could indicate/include N≥1 DL TCI states and/or M≥1 UL TCI states, wherein the indicated TCI state could be at least one of: a DL TCI state and/or its corresponding/associated TCI state ID, an UL TCI state and/or its corresponding/associated TCI state ID, a joint DL and UL TCI state and/or its corresponding/associated TCI state ID, and separate DL TCI state and UL TCI state and/or their corresponding/associated TCI state ID(s).

There could be various design options/channels to indicate to the UE a beam (i.e., a TCI state) for the transmission/reception of a PDCCH or a PDSCH.

In one example, a MAC CE could be used to indicate to the UE a beam (i.e., a TCI state and/or a TCI state ID) for the transmission/reception of a PDCCH or a PDSCH.

In another example, a DCI could be used to indicate to the UE a beam (i.e., a TCI state and/or a TCI state ID) for the transmission/reception of a PDCCH or a PDSCH. For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment. For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant. Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of: in case of joint TCI state indication, wherein a same beam is used for DL and UL channels, a joint TCI state that can be used at least for UE-dedicated DL channels and UE-dedicated UL channels; in case of separate TCI state indication, wherein different beams are used for DL and UL channels, a DL TCI state can be used at least for UE-dedicated DL channels; in case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and all of dedicated PUCCH resources.

As discussed above, a UE could be provided by the network, e.g., via MAC CE or DCI (e.g., DCI format 1_1 or 1_2 with or without DL assignment) based signaling via higher layer parameters DLorJointTCIState or UL-TCIState, M>1 joint DL and UL TCI states or M>1 separate UL TCI states or a first combination of M>1 joint DL and UL TCI states and separate UL TCI states or N>1 separate DL TCI states or a second combination of N>1 joint DL and UL TCI states and separate DL TCI states or a third combination of N>1 joint DL and UL TCI states, separate DL TCI states and separate UL Rel. 17 unified TCI for UE-dedicated reception on PDSCH/PDCCH or dynamic-grant/configured-grant based PUSCH and all of dedicated PUCCH resources. In the present disclosure, the term “TCI state” or “TCI state ID” could refer to a single Rel-17 unified TCI state as discussed above (e.g., a joint DL and UL TCI state, a separate DL TCI state or a separate UL TCI state) or a pair of Rel-17 unified TCI states as discussed above (e.g., a pair of separate DL and UL TCI states).

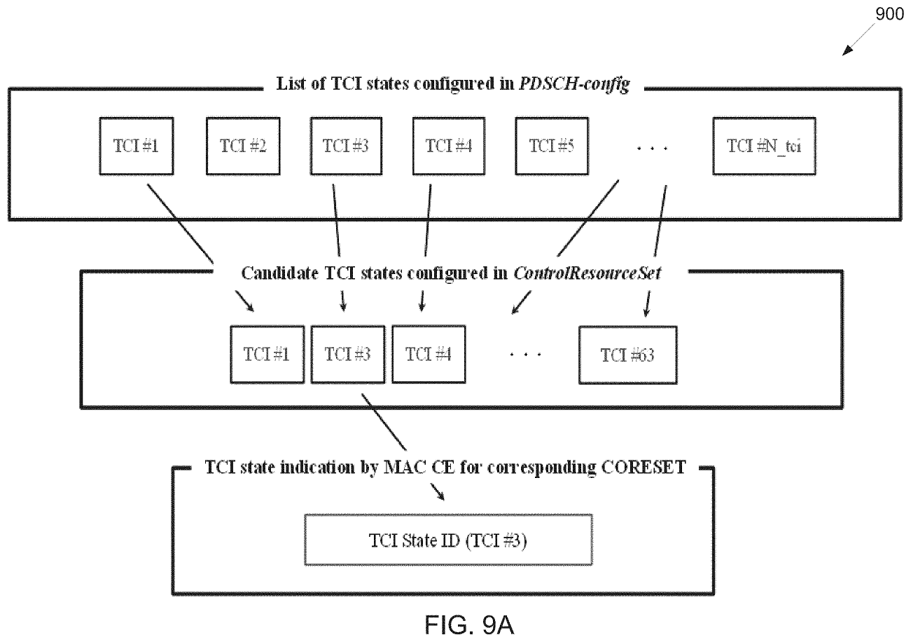

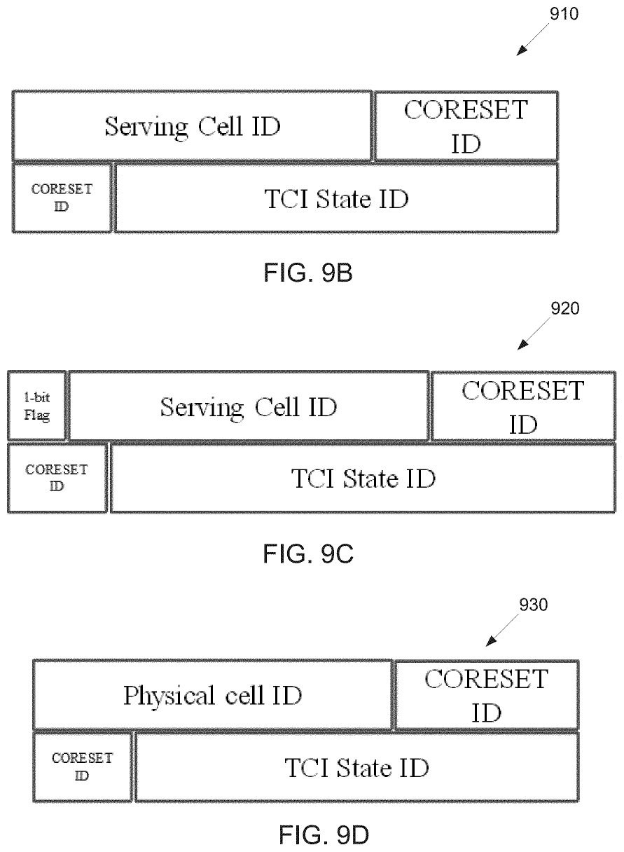

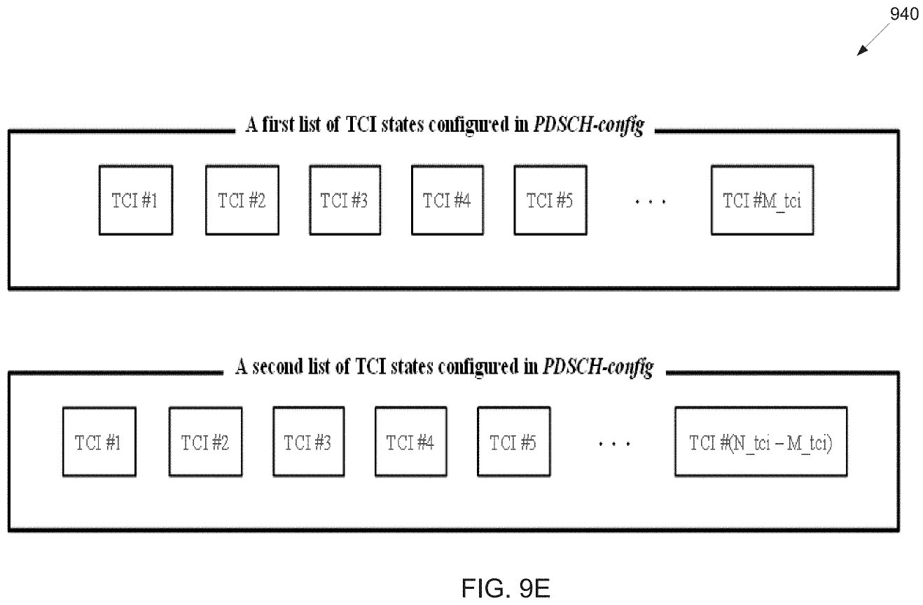

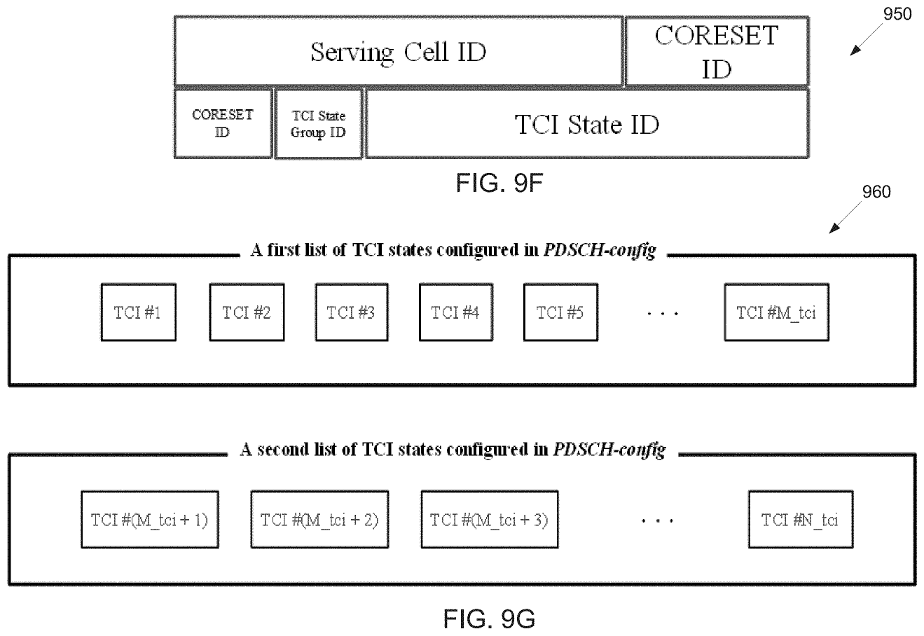

FIG. 9A illustrates an example of TCI state indication 900 according to embodiments of the present disclosure. An embodiment of the TCI state indication 900 shown in FIG. 9A is for illustration only.

In one of design example 1.A.0, in FIG. 9A, an example of TCI state indication for a DL channel/signal transmitted from/associated with either the serving cell/TRP or a non-serving cell/TRP (or neighboring cell/TRP) in an inter-cell multi-TRP system is described. As illustrated in FIG. 9A, the UE could be first higher layer configured by the network, e.g., via the higher layer RRC parameter PDSCH-Config/PDCCH-Config, a list/pool of N_tci TCI states. Each TCI state contains a QCL source RS associated with either the serving cell/TRP or a non-serving cell/TRP (or neighboring cell/TRP). Furthermore, the higher layer parameter, e.g., PDSCH-Config/PDCCH-Config, that configures the list/pool of N_tci TCI states could also indicate/include/contain/configure one or more entity IDs.

In the present disclosure, an entity ID could correspond to a CORESETPoolIndex—e.g., values 0 and/or 1 provided in PDCCH-Config, a CORESETGroupIndex—e.g., values 0 and/or 1 provided in PDCCH-Config, a PCI value, a PCI index pointing to an entry/PCI in a list of PCIs (or PCI values) higher layer configured to the UE, a resource set index/ID, a CORESET ID, a resource index/ID, a TRP-specific ID/index, a TRP-specific higher layer signaling index/ID, a one-bit/multi-bit indicator or etc. Note that in the present disclosure, the PCI index for the serving cell could be 0.

The UE could be configured by the network, e.g., via the higher layer parameter ControlResourceSet or a higher layer parameter that configures a group of TCI states (e.g., TCIState-Group), up to N_cand≥1 (N_cand=64 in FIG. 9A) (candidate) TCI states (or their corresponding TCI state IDs) for each control resource set (CORESET) or each TCI state group, where the QCL source RSs in one or more of the (candidate) TCI states configured in the higher layer parameter ControlResourceSet or in a TCI state group, e.g., provided by TCIState-Group could be associated with either the serving cell/TRP having the serving cell PCI/PCI index or a non-serving cell/TRP (or neighboring cell/TRP) having a PCI/PCI index other than the serving cell PCI/PCI index.

For example, one or more of the (candidate) TCI states (or their corresponding TCI state IDs) configured for a CORESET or a TCI state group (e.g., provided by TCIState-Group) could be selected from the higher layer configured list/pool of N_tci TCI states. For another example, the UE could be higher layer configured by the network, e.g., via the higher layer RRC parameter PDSCH-Config/PDCCH-Config, the one or more (candidate) TCI states/TCI state IDs for a CORESET or for a TCI state group (e.g., provided by TCIState-Group).

A TCI state group could be associated/configured with a unique TCI state group ID (e.g., the higher layer parameter TCIState-Group that configures a TCI state group could comprise/include/indicate/contain/configure a TCI state group ID—e.g., denoted by TCIState-GroupId). Note that the UE could be indicated/configured by the network more than one (e.g., 2) TCI state groups (e.g., in form of TCI state IDs comprised/included/contained/configured in each TCI state group), wherein each TCI state group could comprise/contain/include one or more TCI states/TCI state IDs; as discussed above, (1) in one example, the one or more TCI states/TCI state IDs comprised/contained/included/configured/indicated in a TCI state group could be selected/determined from the higher layer RRC configured list/pool of N_tci TCI states/TCI state IDs, and/or (2) in another example, the UE could be higher layer configured by the network, e.g., via the higher layer RRC parameter PDSCH-Config/PDCCH-Config, the one or more TCI states/TCI state IDs for a TCI state group (e.g., provided by TCIState-Group).

Furthermore, the UE could also be indicated/configured by the network the number of TCI states/TCI state IDs in one or more of the configured TCI state groups. In addition, a TCI state group could be associated/configured with a unique TCI state group ID (e.g., the higher layer parameter TCIState-Group that configures a TCI state group could comprise/include/indicate/contain/configure a TCI state group ID—e.g., denoted by TCIState-GroupId); that is, if two TCI state groups—denoted as a first TCI state group and a second TCI state group—are configured according to the above discussions, the first TCI state group could be associated/configured with a first TCI state group ID (e.g., the higher layer parameter TCIState-Group1 that configures the first TCI state group could comprise/include/indicate/contain/configure the first TCI state group ID—e.g., denoted by TCIState-GroupId1), and the second TCI state group could be associated/configured with a second TCI state group ID (e.g., the higher layer parameter TCIState-Group2 that configures the second TCI state group could comprise/include/indicate/contain/configure the second TCI state group ID—e.g., denoted by TCIState-GroupId2).

Alternatively, one or more TCI state groups—e.g., the first and second TCI state groups as discussed above—could be associated/configured with a same/single TCI state group ID; for instance, the higher layer parameter (e.g., TCIState-Group, TCIState-Group 1 or TCIState-Group 2) that configures the one or more TCI state groups (e.g., the first and second TCI state groups) could contain/configure/include/indicate/comprise a same/single TCI state group ID, e.g., denoted as TCIState-GroupId, TCIState-GroupId1 or TCIState-GroupId2; the above configuration/indication could be via higher layer RRC signaling and/or MAC CE command and/or dynamic DCI based signaling.

The UE could then receive from the network a MAC CE command indicating/selecting one or more of the TCI states (e.g., TCI state #3 in FIG. 9A)—from the higher layer RRC configured list/pool of N_tci TCI states or the N_cand (candidate) TCI states configured in the higher layer parameter ControlResourceSet or a TCI state group provided by, e.g., TCIState-Group—for the corresponding DL channel(s)/signal(s) such as PDCCH(s) transmitted from/associated with either the serving cell/TRP or the non-serving cell/TRP (or neighboring cell/TRP). For the multi-TRP operation, the UE could receive from the network more than one such MAC CE commands indicating TCI state(s)/beam(s) for DL channel(s)/signal(s) transmitted from/associated with the serving cell PCI or PCI(s) other than the serving cell PCI.

For an inter-cell multi-TRP system comprising two coordinating TRPs (or equivalently, the serving cell PCI and a PCI other than the serving cell PCI), the UE could receive from the network two separate MAC CE commands indicating the TCI states for the DL channels/signals such as PDCCHs transmitted from the serving cell/TRP and the non-serving cell/TRP (or neighboring cell/TRP), respectively. In addition, each entity ID—if configured —provided in the higher layer parameter, e.g., PDSCH-Config/PDCCH-Config, that configures the list/pool of N_tci TCI state IDs could be associated with a TCI state group—if configured.

For instance, the first (or last) entity ID or the lowest (or highest) entity ID could be associated with the first TCI state group or the TCI state group with the lowest TCI state group ID, the second (or second last) entity ID or the second lowest (or second highest) entity ID could be associated with the second TCI state group or the TCI state group with the second lowest TCI state group ID, and so on, and the last (or first) entity ID or the highest (or lowest) entity ID could be associated with the last TCI state group or the TCI state group with the highest TCI state group ID; here, a TCI state group ID could correspond to a CORESETPoolIndex—e.g., values 0 and/or 1 provided in PDCCH-Config, a CORESETGroupIndex—e.g., values 0 and/or 1 provided in PDCCH-Config, a PCI value, a PCI index pointing to an entry/PCI in a list of PCIs (or PCI values) higher layer configured to the UE, a resource set index/ID, a CORESET ID, a resource index/ID, a TRP-specific ID/index, a TRP-specific higher layer signaling index/ID, a one-bit/multi-bit indicator or etc.

In the present disclosure, various design options of associating serving/non-serving (or neighboring) cells/TRPs information or serving cell PCI/PCI(s) other than the serving cell PCI to one or more (candidate) TCI states/TCI state IDs configured in the higher layer parameter ControlResourceSet or a TCI state group, e.g., provided by the higher layer parameter TCIState-Group, are presented below.

In one example of Option-0, one or more of the (candidate) TCI states (and therefore, the QCL source RSs indicated therein) configured in the higher layer parameter ControlResourceSet or a TCI state group, e.g., provided by TCIState-Group, could be transmitted from/associated with either the serving cell/TRP (or equivalently, the serving cell PCI/PCI index) or one or more non-serving cells/TRPs (or neighboring cells/TRPs, or equivalently, PCIs other than the serving cell PCI). For the example shown in FIG. 9A, TCI #1 configured in the higher layer parameter ControlResourceSet could be associated with the serving cell/TRP, while TCI #3 configured in the same higher layer parameter ControlResourceSet could be associated with a non-serving cell/TRP (or neighboring cell/TRP).

In one example of Option-1, a value of CORESETPoolIndex could be indicated/configured in the higher layer parameter ControlResourceSet. Hence, from the higher layer parameter ControlResourceSet, the UE could identify the CORESETPoolIndex value (if configured/indicated) associated with the corresponding CORESET ID.

If the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could further identify whether the corresponding PDCCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH is transmitted. That is, a PDCCH or a DM-RS of a PDCCH is said to be transmitted from/associated with a PCI (e.g., the serving cell PCI or a PCI other than the serving cell PCI) if the PDCCH or the DM-RS of the PDCCH is received in a CORESET associated with a value of CORESETPoolIndex associated with the PCI.

In addition, if the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could identify whether the QCL source RSs in all the candidate TCI states configured in the higher layer parameter ControlResourceSet are transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RSs in all the candidate TCI states configured in the higher layer parameter ControlResourceSet are transmitted. That is, all the (candidate) TCI states/TCI state IDs (and therefore, the QCL source RSs indicated therein) configured in the higher layer parameter ControlResourceSet could be associated with the CORESETPoolIndex value indicated/configured in the ControlResourceSet, and therefore the PCI/PCI index (e.g., the serving cell PCI/PCI index or a PCI/PCI index other than the serving cell PCI/PCI index) associated to the CORESETPoolIndex value.

In one example of Option-1a, a value of CORESETPoolIndex could be indicated/configured in a TCI state group, e.g., indicated/configured in the higher layer parameter TCIState-Group that configures a TCI state group. If the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could identify whether the QCL source RSs in all the TCI states configured in a TCI state group or the higher layer parameter TCIState-Group that configures a TCI state group are transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RSs in all the TCI states configured in a TCI state group or the higher layer parameter TCIState-Group that configures a TCI state group are transmitted.

That is, all the TCI states/TCI state IDs (and therefore, the QCL source RSs indicated therein) configured in a TCI state group or the higher layer parameter TCIState-Group that configures a TCI state group could be associated with the CORESETPoolIndex value indicated/configured in the TCI state group or the higher layer parameter TCIState-Group that configures the TCI state group, and therefore the PCI/PCI index (e.g., the serving cell PCI/PCI index or a PCI/PCI index other than the serving cell PCI/PCI index) associated to the CORESETPoolIndex value.

In one example of Option-2, a one-bit flag indicator could be included/configured/indicated in ControlResourceSet. If the one-bit flag indicator is present and set to ‘1’ (or ‘0’), the corresponding PDCCH could be transmitted from/associated with the serving cell/TRP; in this case, the QCL source RSs in all the candidate TCI states configured in the higher layer parameter ControlResourceSet could also be associated with/transmitted from the serving cell/TRP. That is, a PDCCH or a DM-RS a PDCCH is said to be transmitted from/associated with the serving cell PCI/PCI index if the PDCCH or the DM-RS of the PDCCH is received in a CORESET with the one-bit flag indicator set to ‘1’ (or ‘0’) in the corresponding parameter ControlResourceSet that configures the CORESET, and all the (candidate) TCI states/TCI state IDs (and therefore, the QCL source RSs indicated therein) configured in the higher layer parameter ControlResourceSet could be associated with the serving cell PCI/PCI index if the one-bit flag indicator in the corresponding parameter ControlResourceSet is set to ‘1’ (or ‘0’).

If the one-bit flag indicator is not present or set to ‘0’, the corresponding PDCCH could be transmitted from/associated with a non-serving cell/TRP (or neighboring cell/TRP) in the inter-cell multi-TRP system; in this case, the QCL source RSs in all the candidate TCI states configured in the higher layer parameter ControlResourceSet could also be associated with/transmitted from the non-serving cell/TRP (or neighboring cell/TRP). That is, a PDCCH or a DM-RS a PDCCH is said to be transmitted from/associated with a PCI/PCI index other than the serving cell PCI/PCI index if the PDCCH or the DM-RS of the PDCCH is received in a CORESET with the one-bit flag indicator set to ‘0’ (or ‘1’) in the corresponding parameter ControlResourceSet that configures the CORESET, and all the (candidate) TCI states/TCI state IDs (and therefore, the QCL source RSs indicated therein) configured in the higher layer parameter ControlResourceSet could be associated with the PCI/PCI index other than the serving cell PCI/PCI index if the one-bit flag indicator in the corresponding parameter ControlResourceSet is set to ‘0’ (or ‘1’). A snippet of the higher layer parameter ControlResourceSet incorporating the one-bit flag indicator is presented in TABLE 1.

TABLE 1
An example of higher layer parameter ControlResourceSet

-- ASN1 START
-- TAG-CONTROLRESOURCESET-START

| | |
|---|---|
| ControlResourceSet ::= | SEQUENCE { |
| controlResourceSetId | ControlResourceSetId, |

| | |
|---|---|
| frequencyDomainResources | BIT STRING (SIZE (45)), |

| | |
|---|---|
| duration | INTEGER (1..maxCoReSetDuration), |

| | |
|---|---|
| cce-REG-MappingType | CHOICE { |

| | |
|---|---|
| interleaved | SEQUENCE { |

| | |
|---|---|
| reg-BundleSize | ENUMERATED {n2, n3, n6}, |
| interleaverSize | ENUMERATED {n2, n3, n6}, |

| | | |
|---|---|---|
| shiftIndex | INTEGER(0..maxNrofPhysicalResourceBlocks−1) | OPTIONAL -- Need |

S
},

| | |
|---|---|
| nonInterleaved | NULL |

},

| | |
|---|---|
| precoderGranularity | ENUMERATED {sameAsREG-bundle, allContiguousRBs}, |

| | |
|---|---|
| nsc-flag | ENUMERATED {true} OPTIONAL, -- Need R |

| | |
|---|---|
| tci-StatesPDCCH-ToAddList | SEQUENCE(SIZE (1..maxNrofTCI-StatesPDCCH)) OF |

TCI-StateId OPTIONAL, -- Cond NotSIB1-initialBWP

| | |
|---|---|
| tci-StatesPDCCH-ToReleaseList | SEQUENCE(SIZE (1..maxNrofTCI-StatesPDCCH)) OF |

TCI-StateId OPTIONAL, -- Cond NotSIB1-initialBWP

| | | |
|---|---|---|
| tci-PresentInDCI | ENUMERATED {enabled} | OPTIONAL, -- Need S |

| | | |
|---|---|---|
| pdcch-DMRS-ScramblingID | INTEGER (0..65535) | OPTIONAL, -- Need S |

```
  ...,
  [[
```

| | | |
|---|---|---|
| rb-Offset-r16 | INTEGER (0..5) | OPTIONAL, -- Need S |

| | | |
|---|---|---|
| tci-PresentDCI-1-2-r16 | INTEGER (1..3) | OPTIONAL, -- Need S |
| coresetPoolIndex-r16 | INTEGER (0..1) | OPTIONAL, -- Need S |

| | | |
|---|---|---|
| controlResourceSetId-v1610 | ControlResourceSetId-v1610 | OPTIONAL -- Need S |

]]
}
-- TAG-CONTROLRESOURCESET-STOP
-- ASN1STOP

In one example of Option-2a, a one-bit flag indicator could be included/configured/indicated in the signaling/parameter, e.g., the higher layer RRC parameter TCIState-Group, that configures a TCI state group. If the one-bit flag indicator is present and set to ‘1’ (or ‘0’), the QCL source RSs in all the TCI states configured in the TCI state group could be associated with/transmitted from the serving cell/TRP. That is, all the TCI states/TCI state IDs (and therefore, the QCL source RSs indicated therein) configured in a TCI state group or the higher layer parameter TCIState-Group that configures a TCI state group could be associated with the serving cell PCI/PCI index if the one-bit flag indicator in the signaling/parameter, e.g., the higher layer parameter TCIState-Group, that configures the TCI state group is set to ‘1’ (or ‘0’).

If the one-bit flag indicator is not present or set to ‘0’, the QCL source RSs in all the TCI states configured in the TCI state group could be associated with/transmitted from a non-serving cell/TRP (or neighboring cell/TRP) in the inter-cell multi-TRP system. That is, all the TCI states/TCI state IDs (and therefore, the QCL source RSs indicated therein) configured in a TCI state group or the higher layer parameter TCIState-Group that configures a TCI state group could be associated with the PCI/PCI index other than the serving cell PCI/PCI index if the one-bit flag indicator in the signaling/parameter, e.g., the higher layer parameter TCIState-Group, that configures the TCI state group is set to ‘0’ (or ‘1’).

In one example of Option-3, a multi-bit (more than one bit) indicator could be included in the higher layer parameter ControlResourceSet or the signaling/parameter, e.g., the higher layer RRC parameter TCIState-Group, that configures a TCI state group to indicate the serving cell/TRP and two or more non-serving cells/TRPs (or neighboring cells/TRPs) in the inter-cell multi-TRP system. The number of bits n_b required for representing the multi-bit indicator could be ceil(log 2(N_nsc+1)), where N_nsc is the total number of non-serving cells/TRPs (or neighboring cells/TRPs) and ceil(x) rounds x up to the next largest integer. In this case, the n_b-bit indicator could correspond to 2\hat{ }(n_b) states, and one of the states (e.g., the first state) could correspond to the serving cell/TRP, and the rest of the states could correspond to the non-serving cells/TRPs (or neighboring cells/TRPs).

Alternatively, the number of bits n_b required for representing the multi-bit indicator could be ceil(log 2(N_nsc)). In this case, the multi-bit indicator only indicates/identifies the non-serving cells/TRPs (or neighboring cells/TRPs); if the multi-bit indicator is not present, the UE would expect that the corresponding PDCCH is transmitted from/associated with the serving cell/TRP; if the multi-bit indicator is not present, the UE could also expect that the QCL source RSs in all the (candidate) TCI states configured in the higher layer parameter ControlResourceSet or the TCI state group or the higher layer parameter TCIState-Group that configures the TCI state group are associated with/transmitted from the serving cell/TRP.

The UE could be indicated by the network the association rule(s)/mapping relationship(s) between the states of the multi-bit indicator and the PCI values for the serving/non-serving (or neighboring) cells/TRPs in the inter-cell multi-TRP system; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

TABLE 2
Another example of higher layer parameter ControlResourceSet

-- ASN1START
-- TAG-CONTROLRESOURCESET-START

| | |
|---|---|
| ControlResourceSet ::= | SEQUENCE { |
| controlResourceSetId | ControlResourceSetId, |

| | |
|---|---|
| frequencyDomainResources | BIT STRING (SIZE (45)), |

| | |
|---|---|
| duration | INTEGER (1..maxCoReSetDuration), |

| | |
|---|---|
| cce-REG-MappingType | CHOICE { |

| | |
|---|---|
| interleaved | SEQUENCE { |

| | |
|---|---|
| reg-BundleSize | ENUMERATED {n2, n3, n6}, |
| interleaverSize | ENUMERATED {n2, n3, n6}, |

| | | |
|---|---|---|
| shiftIndex | INTEGER(0..maxNrofPhysicalResourceBlocks−1) | OPTIONAL -- Need |

```
S
    },
    nonInterleaved NULL
  },
```

| | |
|---|---|
| precoderGranularity | ENUMERATED {sameAsREG-bundle, allContiguousRBs}, |

| | | |
|---|---|---|
| physCellId | PhysCellId | OPTIONAL, -- Need S |

| | |
|---|---|
| tci-StatesPDCCH-ToAddList | SEQUENCE(SIZE (1..maxNrofTCI-StatesPDCCH)) OF |

TCI-StateId OPTIONAL, -- Cond NotSIB1-initialBWP

| | |
|---|---|
| tci-StatesPDCCH-ToReleaseList | SEQUENCE(SIZE (1..maxNrofTCI-StatesPDCCH)) OF |

TCI-StateId OPTIONAL, -- Cond NotSIB1-initialBWP

| | | |
|---|---|---|
| tci-PresentInDCI | ENUMERATED {enabled} | OPTIONAL, -- Need S |

| | | |
|---|---|---|
| pdcch-DMRS-ScramblingID | INTEGER (0..65535) | OPTIONAL, -- Need S |

```
  ...,
  [[
```

| | | |
|---|---|---|
| rb-Offset-r16 | INTEGER (0..5) | OPTIONAL, -- Need S |

| | | |
|---|---|---|
| tci-PresentDCI-1-2-r16 | INTEGER (1..3) | OPTIONAL, -- Need S |
| coresetPoolIndex-r16 | INTEGER (0..1) | OPTIONAL, -- Need S |

| | | |
|---|---|---|
| controlResourceSetId-v1610 | ControlResourceSetId-v1610 | OPTIONAL -- Need S |

]]
}
-- TAG-CONTROLRESOURCESET-STOP
-- ASN1STOP

In one example of Option-4, one or more PCIs or PCI indexes could be included/indicated/configured in the higher layer parameter ControlResourceSet. In TABLE 2, a snippet of the higher layer parameter ControlResourceSet including/indicating the PCI value(s) is presented. One or more PCI values or PCI indexes could be used/reserved for representing the serving cell/TRP. In the present disclosure, a PCI index could point to an entry/PCI in a list of PCIs higher layer configured to the UE; the higher layer configured list of PCIs could only contain PCIs other than the serving cell PCI; alternatively, the higher layer configured list of PCIs could contain both the serving cell PCI and PCI(s) other than the serving cell PCI; furthermore, the PCI index for the serving cell PCI could be 0.

The UE could be indicated by the network the association between the PCI value(s)/PCI index(es) and the serving cell/TRP and/or the association between the PCI value(s)/PCI index(es) and the non-serving (or neighboring) cell(s)/TRP(s). If the indicated PCI value/PCI index is associated with the serving cell/TRP, or equivalently, corresponds to the serving cell PCI/PCI index, the corresponding PDCCH could be transmitted from/associated with the serving cell/TRP; in this case, the QCL source RSs in all the candidate TCI states configured in the higher layer parameter ControlResourceSet could also be associated with/transmitted from the serving cell/TRP.

That is, a PDCCH or a DM-RS a PDCCH is said to be transmitted from/associated with the serving cell PCI/PCI index if the PDCCH or the DM-RS of the PDCCH is received in a CORESET with the serving cell PCI/PCI index indicated in the corresponding parameter ControlResourceSet that configures the CORESET, and all the (candidate) TCI states/TCI state IDs (and therefore, the QCL source RSs indicated therein) configured in the higher layer parameter ControlResourceSet could be associated with the serving cell PCI/PCI index if the serving cell PCI/PCI index is indicated in the corresponding parameter ControlResourceSet.

If the indicated PCI value/PCI index is associated with a non-serving cell/TRP (or neighboring cell/TRP), or equivalently, corresponds to a PCI/PCI index other than the serving cell PCI/PCI index, the corresponding PDCCH could be transmitted from/associated with the non-serving cell/TRP (or neighboring cell/TRP) in the inter-cell multi-TRP system; in this case, the QCL source RSs in all the candidate TCI states configured in the higher layer parameter ControlResourceSet could also be associated with/transmitted from the non-serving cell/TRP (or neighboring cell/TRP).

That is, a PDCCH or a DM-RS a PDCCH is said to be transmitted from/associated with a PCI/PCI index other than the serving cell PCI/PCI index if the PDCCH or the DM-RS of the PDCCH is received in a CORESET with the PCI/PCI index other than the serving cell PCI/PCI index indicated in the corresponding parameter ControlResourceSet that configures the CORESET, and all the (candidate) TCI states/TCI state IDs (and therefore, the QCL source RSs indicated therein) configured in the higher layer parameter ControlResourceSet could be associated with the PCI/PCI index other than the serving cell PCI/PCI index if the PCI/PCI index other than the serving cell PCI/PCI index is indicated in the corresponding parameter ControlResourceSet.

In one example of Option-4a, one or more PCIs or PCI indexes could be included/indicated/configured in the signaling/parameter, e.g., the higher layer RRC parameter TCIState-Group, that configures a TCI state group. One or more PCI values or PCI indexes could be used/reserved for representing the serving cell/TRP. In the present disclosure, a PCI index could point to an entry/PCI in a list of PCIs higher layer configured to the UE; the higher layer configured list of PCIs could only contain PCIs other than the serving cell PCI; alternatively, the higher layer configured list of PCIs could contain both the serving cell PCI and PCI(s) other than the serving cell PCI; furthermore, the PCI index for the serving cell PCI could be 0.

The UE could be indicated by the network the association between the PCI value(s)/PCI index(es) and the serving cell/TRP and/or the association between the PCI value(s)/PCI index(es) and the non-serving (or neighboring) cell(s)/TRP(s). If the indicated PCI value/PCI index is associated with the serving cell/TRP, or equivalently, corresponds to the serving cell PCI/PCI index, the QCL source RSs in all the TCI states configured in the corresponding TCI state group or in the signaling/parameter, e.g., the higher layer RRC parameter TCIState-Group, that configures the TCI state group could also be associated with/transmitted from the serving cell/TRP.

That is, all the TCI states/TCI state IDs (and therefore, the QCL source RSs indicated therein) configured in a TCI state group or the higher layer parameter TCIState-Group that configures a TCI state group could be associated with the serving cell PCI/PCI index if the serving cell PCI/PCI index is indicated in the signaling/parameter, e.g., the higher layer RRC parameter TCIState-Group, that configures the TCI state group. If the indicated PCI value/PCI index is associated with a non-serving cell/TRP (or neighboring cell/TRP), or equivalently, corresponds to a PCI/PCI index other than the serving cell PCI/PCI index, the QCL source RSs in all the TCI states configured in the corresponding TCI state group or in the signaling/parameter, e.g., the higher layer RRC parameter TCIState-Group, that configures the TCI state group could also be associated with/transmitted from the non-serving cell/TRP (or neighboring cell/TRP).

That is, all the TCI states/TCI state IDs (and therefore, the QCL source RSs indicated therein) configured in a TCI state group or the higher layer parameter TCIState-Group that configures a TCI state group could be associated with the PCI/PCI index other than the serving cell PCI/PCI index if the PCI/PCI index other than the serving cell PCI/PCI index is indicated in the signaling/parameter, e.g., the higher layer RRC parameter TCIState-Group, that configures the TCI state group.

In one example of Option-5, a TCI state or the higher layer parameter TCI-State, QCL-Info, DLorJointTCI-State or ULTCI-State that configures a TCI state could include/indicate information that indicates/identifies the serving/non-serving (or neighboring) cells/TRPs information. For example, a TCI state or the higher layer parameter TCI-State, QCL-Info, DLorJointTCI-State or ULTCI-State that configures a TCI state could include/indicate/configure/provide a CORESETPoolIndex value, which could be associated with the serving cell/TRP or a non-serving cell/TRP (or neighboring cell/TRP). For another example, a TCI state or the higher layer parameter TCI-State, QCL-Info, DLorJointTCI-State or ULTCI-State that configures a TCI state could include/indicate/configure/provide a one-bit flag indicator with ‘0’ (or ‘1’) indicating the serving cell/TRP and ‘1’ (or ‘0’) indicating a non-serving cell/TRP (or neighboring cell/TRP).

Yet for another example, a TCI state or the higher layer parameter TCI-State, QCL-Info, DLorJointTCI-State or ULTCI-State that configures a TCI state could include/indicate/configure/provide a multi-bit indicator to indicate the serving cell/TRP (and/or its PCI value/PCI index) and the non-serving (or neighboring) cell(s)/TRPs (and/or the corresponding PCI value(s)/PCI index(es)). Yet for another example, a TCI state or the higher layer parameter TCI-State, QCL-Info, DLorJointTCI-State or UL-TCIState that configures a TCI state could include/configure/indicate/provide one or more PCIs/PCI indexes, wherein a PCI index could point to an entry/PCI in a list of PCIs higher layer configured to the UE; the higher layer configured list of PCIs could only contain PCIs other than the serving cell PCI; alternatively, the higher layer configured list of PCIs could contain both the serving cell PCI and PCI(s) other than the serving cell PCI; furthermore, the PCI index for the serving cell PCI could be 0.

Yet for another example, one or more serving cell IDs (SCIs) in a TCI state or the higher layer parameter TCI-State, QCL-Info, DLorJointTCI-State or ULTCI-State that configures a TCI state could be reserved/used to indicate one or more non-serving (or neighboring) cells/TRPs information. The (candidate) TCI states indicating the same serving cell/TRP information or the same non-serving (or neighboring) cell(s)/TRP(s) information could be configured in the same higher layer parameter ControlResourceSet (e.g., with the same CORESET ID) or in the same TCI state group, e.g., provided by TCIState-Group. That is, the higher layer parameter ControlResourceSet that configures a CORESET/CORESET ID or a TCI state group, e.g., provided by TCIState-Group, could contain/include/configure one or more TCI states associated with the same PCI/PCI index (corresponding to the serving cell PCI/PCI index or a PCI/PCI index other than the serving cell PCI/PCI index); as discussed above, a TCI state is said to be associated with a PCI/PCI index when the higher layer parameter TCI-State, QCL-Info, DLorJointTCI-State or UL-TCIState that configures the TCI state includes/indicates/configures/provides the PCI/PCI index.

If the serving cell/TRP information such as the serving cell PCI/PCI index is indicated in all the (candidate) TCI states or their corresponding higher layer parameters such as TCI-State, QCL-Info, DLorJointTCI-State or UL-TCIState, the corresponding PDCCH could be transmitted from/associated with the serving cell/TRP; in this case, the QCL source RSs in all the (candidate) TCI states configured in the higher layer parameter ControlResourceSet or in the TCI state group, e.g., provided by TCIState-Group, could also be associated with/transmitted from the serving cell/TRP.

If the non-serving (or neighboring) cell/TRP information such as PCI(s)/PCI index(es) other than the serving cell PCI/PCI index is indicated in all the (candidate) TCI states or their corresponding higher layer parameters such as TCI-State, QCL-Info, DLorJointTCI-State or UL-TCIState, the corresponding PDCCH could be transmitted from/associated with the non-serving cell/TRP (or neighboring cell/TRP) in the inter-cell multi-TRP system; in this case, the QCL source RSs in all the (candidate) TCI states configured in the higher layer parameter ControlResourceSet or in the TCI state group, e.g., provided by TCIState-Group, could also be associated with/transmitted from the non-serving cell/TRP (or neighboring cell/TRP).

In one example of Option-6, one or more entity IDs could be included/indicated/configured in the higher layer parameter ControlResourceSet. In the present disclosure, an entity ID could correspond to a CORESETPoolIndex—e.g., values 0 and/or 1 provided in PDCCH-Config, a CORESETGroupIndex—e.g., values 0 and/or 1 provided in PDCCH-Config, a PCI value, a PCI index pointing to an entry/PCI in a list of PCIs (or PCI values) higher layer configured to the UE, a resource set index/ID, a CORESET ID, a resource index/ID, a TRP-specific ID/index, a TRP-specific higher layer signaling index/ID, a one-bit/multi-bit indicator or etc. One or more entity IDs could be used/reserved for representing the serving cell PCI/PCI index. In the present disclosure, a PCI index could point to an entry/PCI in a list of PCIs higher layer configured to the UE; the higher layer configured list of PCIs could only contain PCIs other than the serving cell PCI; alternatively, the higher layer configured list of PCIs could contain both the serving cell PCI and PCI(s) other than the serving cell PCI; furthermore, the PCI index for the serving cell PCI could be 0.

The UE could be indicated by the network the association between the entity IDs and PCIs/PCI indexes (corresponding to the serving cell PCI/PCI index and PCI(s)/PCI index(es) other than the serving cell PCI/PCI index). If the indicated entity ID is associated with the serving cell PCI/PCI index, the corresponding PDCCH could be transmitted from/associated with the serving cell/TRP; in this case, the QCL source RSs in all the candidate TCI states configured in the higher layer parameter ControlResourceSet could also be associated with/transmitted from the serving cell/TRP.

That is, a PDCCH or a DM-RS a PDCCH is said to be transmitted from/associated with the serving cell PCI/PCI index if the PDCCH or the DM-RS of the PDCCH is received in a CORESET with the entity ID associated with the serving cell PCI/PCI index indicated in the corresponding parameter ControlResourceSet that configures the CORESET, and all the (candidate) TCI states/TCI state IDs (and therefore, the QCL source RSs indicated therein) configured in the higher layer parameter ControlResourceSet could be associated with the serving cell PCI/PCI index if the entity ID associated with the serving cell PCI/PCI index is indicated in the corresponding parameter ControlResourceSet.

If the indicated entity ID is associated with a PCI/PCI index other than the serving cell PCI/PCI index, the corresponding PDCCH could be transmitted from/associated with the non-serving cell/TRP (or neighboring cell/TRP) in the inter-cell multi-TRP system; in this case, the QCL source RSs in all the candidate TCI states configured in the higher layer parameter ControlResourceSet could also be associated with/transmitted from the non-serving cell/TRP (or neighboring cell/TRP).

That is, a PDCCH or a DM-RS a PDCCH is said to be transmitted from/associated with a PCI/PCI index other than the serving cell PCI/PCI index if the PDCCH or the DM-RS of the PDCCH is received in a CORESET with the entity ID associated with the PCI/PCI index other than the serving cell PCI/PCI index indicated in the corresponding parameter ControlResourceSet that configures the CORESET, and all the (candidate) TCI states/TCI state IDs (and therefore, the QCL source RSs indicated therein) configured in the higher layer parameter ControlResourceSet could be associated with the PCI/PCI index other than the serving cell PCI/PCI index if the entity ID associated with the PCI/PCI index other than the serving cell PCI/PCI index is indicated in the corresponding parameter ControlResourceSet.

In one example of Option-6a, one or more entity IDs could be included/indicated/configured in the signaling/parameter, e.g., the higher layer RRC parameter TCIState-Group, that configures a TCI state group. In the present disclosure, an entity ID could correspond to a CORESETPoolIndex—e.g., values 0 and/or 1 provided in PDCCH-Config, a CORESETGroupIndex—e.g., values 0 and/or 1 provided in PDCCH-Config, a PCI value, a PCI index pointing to an entry/PCI in a list of PCIs (or PCI values) higher layer configured to the UE, a resource set index/ID, a CORESET ID, a resource index/ID, a TRP-specific ID/index, a TRP-specific higher layer signaling index/ID, a one-bit/multi-bit indicator or etc.

One or more entity IDs could be used/reserved for representing the serving cell PCI/PCI index. In the present disclosure, a PCI index could point to an entry/PCI in a list of PCIs higher layer configured to the UE; the higher layer configured list of PCIs could only contain PCIs other than the serving cell PCI; alternatively, the higher layer configured list of PCIs could contain both the serving cell PCI and PCI(s) other than the serving cell PCI; furthermore, the PCI index for the serving cell PCI could be 0. The UE could be indicated by the network the association between the entity IDs and PCIs/PCI indexes (corresponding to the serving cell PCI/PCI index and PCI(s)/PCI index(es) other than the serving cell PCI/PCI index).

If the indicated entity ID is associated with the serving cell PCI/PCI index, the QCL source RSs in all the TCI states configured in the corresponding TCI state group or in the signaling/parameter, e.g., the higher layer RRC parameter TCIState-Group, that configures the TCI state group could also be associated with/transmitted from the serving cell/TRP. That is, all the TCI states/TCI state IDs (and therefore, the QCL source RSs indicated therein) configured in a TCI state group or the higher layer parameter TCIState-Group that configures a TCI state group could be associated with the serving cell PCI/PCI index if the entity ID associated with the serving cell PCI/PCI index is indicated in the signaling/parameter, e.g., the higher layer RRC parameter TCIState-Group, that configures the TCI state group.

If the indicated entity ID is associated with a PCI/PCI index other than the serving cell PCI/PCI index, the QCL source RSs in all the TCI states configured in the corresponding TCI state group or in the signaling/parameter, e.g., the higher layer RRC parameter TCIState-Group, that configures the TCI state group could also be associated with/transmitted from the non-serving cell/TRP (or neighboring cell/TRP). That is, all the TCI states/TCI state IDs (and therefore, the QCL source RSs indicated therein) configured in a TCI state group or the higher layer parameter TCIState-Group that configures a TCI state group could be associated with the PCI/PCI index other than the serving cell PCI/PCI index if the entity ID associated with the PCI/PCI index other than the serving cell PCI/PCI index is indicated in the signaling/parameter, e.g., the higher layer RRC parameter TCIState-Group, that configures the TCI state group.

FIG. 9B illustrates an example of MAC CE based beam indication 910 according to embodiments of the present disclosure. An embodiment of the MAC CE based beam indication 910 shown in FIG. 9B is for illustration only.

An example of MAC CE command for beam indication is given in FIG. 9B. As can be seen from FIG. 9B, the MAC CE command could include a CORESET ID and a TCI state ID. Various design options of using one or more MAC CE commands to indicate one or more TCI states/TCI state IDs for receiving DL channel(s)/signal(s) or transmitting UL channel(s)/signals associated with the serving cell PCI/PCI index or PCI(s)/PCI index(es) other than the serving cell PCI/PCI index are presented below.

In one example of Option-I, when the MAC CE command indicating one or more TCI state IDs also indicates a CORESET ID, upon receiving the MAC CE command, the UE could identify the CORESETPoolIndex value (if configured) associated with the CORESET ID, and therefore, the corresponding MAC CE command for beam indication. If the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could further identify whether the corresponding PDCCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH is transmitted.

In addition, if the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could identify whether the QCL source RS(s) in the TCI state(s) indicated in the MAC CE command is transmitted from/associated with the serving cell/TRP or a non-serving cell/TRP (or neighboring cell/TRP), and/or, the exact PCI value or PCI index for either the serving cell/TRP or the non-serving cell/TRP (or neighboring cell/TRP), from which the QCL source RS(s) in the TCI state(s) indicated in the MAC CE command is transmitted.

In one example of Option-I.1, if a MAC CE command indicating one or more TCI states/TCI state IDs is associated with a CORESETPoolIndex value—the CORESET ID indicated in the MAC CE command for beam indication is associated with the CORESETPoolIndex value, the TCI state(s) (and therefore, the QCL source RS(s) indicated therein) indicated in the MAC CE command is associated with the PCI/PCI index (e.g., corresponding to the serving cell PCI/PCI index or a PCI/PCI index other than the serving cell PCI/PCI index) associated with the CORESETPoolIndex.

In one example of Option-I.2, if a MAC CE command indicating one or more TCI states/TCI state IDs is associated with a first CORESETPoolIndex value—the CORESET ID indicated in the MAC CE command for beam indication is associated with the first CORESETPoolIndex value, the TCI state(s) (and therefore, the QCL source RS(s) indicated therein) indicated in the MAC CE command is associated with the PCI/PCI index (e.g., corresponding to the serving cell PCI/PCI index or a PCI/PCI index other than the serving cell PCI/PCI index) associated with a second CORESETPoolIndex other than the first CORESETPoolIndex.

The UE could be indicated/configured by the network whether Option-I.1 and/or Option-I.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Option-I.1 is enabled and ‘1’ (or ‘0’) indicating the Option-I.2 is enabled. The one-bit indicator could be indicated via a higher layer RRC signaling/parameter and/or in the MAC CE command for beam indication and/or via dynamic DCI based signaling (e.g., DCI format 1_1 or 1_2 with or without DL assignment).

In another example, the UE could be indicated/configured by the network a bitmap with each entry/bit position in the bitmap corresponding to either Option-I.1 or Option-I.2. For this example, if the first (or second) entry/bit position in the bitmap is set to ‘1’, Option-I.1 is enabled; if the second (or first) entry/bit position in the bitmap is set to ‘1’, Option-I.2 is enabled. The bitmap could be indicated via a higher layer RRC signaling/parameter and/or in the MAC CE command for beam indication and/or via dynamic DCI based signaling (e.g., DCI format 1_1 or 1_2 with or without DL assignment).

In yet another example, if the CORESET ID indicated in the MAC CE command for beam indication is associated with value 0 (or 1) of CORESETPoolIndex, Option-I.1 is enabled; otherwise, if the CORESET ID indicated in the MAC CE command for beam indication is associated with value 1 (or 0) of CORESETPoolIndex, Option-I.2 is enabled.

In yet another example, when a radio link failure or a beam failure has been declared for the second CORESETPoolIndex value or the PCI/PCI index associated with the second CORESETPoolIndex value, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Option-I.2 is enabled.

In the present disclosure, the first or second CORESETPoolIndex value could correspond to value 0 (or 1) of CORESETPoolIndex.

In one example of Option-Ia, when the MAC CE command indicating one or more TCI state IDs also indicates a CORESET ID, upon receiving the MAC CE command, the UE could identify the CORESETPoolIndex value (if configured) associated with the CORESET ID, and therefore, the corresponding MAC CE command for beam indication. For this design option, the MAC CE command could indicate two TCI states, denoted as a first TCI state and a second TCI state.

If the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could identify whether the QCL source RS(s) in the first or second TCI state indicated in the MAC CE command is transmitted from/associated with the serving cell/TRP or a non-serving cell/TRP (or neighboring cell/TRP), and/or, the exact PCI value or PCI index for either the serving cell/TRP or the non-serving cell/TRP (or neighboring cell/TRP), from which the QCL source RS(s) in the first or second TCI state indicated in the MAC CE command is transmitted.

In one example of Option-Ia.1, if a MAC CE command indicating the first and second TCI states/TCI state IDs is associated with a first CORESETPoolIndex value—the CORESET ID indicated in the MAC CE command for beam indication is associated with the first CORESETPoolIndex value, the first TCI state (and therefore, the QCL source RS(s) indicated therein) indicated in the MAC CE command is associated with the PCI/PCI index (e.g., corresponding to the serving cell PCI/PCI index or a PCI/PCI index other than the serving cell PCI/PCI index) associated with the first CORESETPoolIndex value, and the second TCI state (and therefore, the QCL source RS(s) indicated therein) indicated in the MAC CE command is associated with the PCI/PCI index (e.g., corresponding to the serving cell PCI/PCI index or a PCI/PCI index other than the serving cell PCI/PCI index) associated with a second CORESETPoolIndex value other than the first CORESETPoolIndex value.

In one example of Option-Ia.2, if a MAC CE command indicating the first and second TCI states/TCI state IDs is associated with a first CORESETPoolIndex value—the CORESET ID indicated in the MAC CE command for beam indication is associated with the first CORESETPoolIndex value, the first TCI state (and therefore, the QCL source RS(s) indicated therein) indicated in the MAC CE command is associated with the PCI/PCI index (e.g., corresponding to the serving cell PCI/PCI index or a PCI/PCI index other than the serving cell PCI/PCI index) associated with a second CORESETPoolIndex value other than the first CORESETPoolIndex value, and the second TCI state (and therefore, the QCL source RS(s) indicated therein) indicated in the MAC CE command is associated with the PCI/PCI index (e.g., corresponding to the serving cell PCI/PCI index or a PCI/PCI index other than the serving cell PCI/PCI index) associated with the first CORESETPoolIndex value.

The UE could be indicated/configured by the network whether Option-Ia.1 and/or Option-Ia.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Option-Ia.1 is enabled and ‘1’ (or ‘0’) indicating the Option-Ia.2 is enabled. The one-bit indicator could be indicated via a higher layer RRC signaling/parameter and/or in the MAC CE command for beam indication and/or via dynamic DCI based signaling (e.g., DCI format 1_1 or 1_2 with or without DL assignment).

In another example, the UE could be indicated/configured by the network a bitmap with each entry/bit position in the bitmap corresponding to either Option-Ia.1 or Option-Ia.2. For this example, if the first (or second) entry/bit position in the bitmap is set to ‘1’, Option-Ia.1 is enabled; if the second (or first) entry/bit position in the bitmap is set to ‘1’, Option-Ia.2 is enabled. The bitmap could be indicated via a higher layer RRC signaling/parameter and/or in the MAC CE command for beam indication and/or via dynamic DCI based signaling (e.g., DCI format 1_1 or 1_2 with or without DL assignment).

In yet another example, if the CORESET ID indicated in the MAC CE command for beam indication is associated with value 0 (or 1) of CORESETPoolIndex, Option-Ia.1 is enabled; otherwise, if the CORESET ID indicated in the MAC CE command for beam indication is associated with value 1 (or 0) of CORESETPoolIndex, Option-Ia.2 is enabled.

In the present disclosure, the first or second CORESETPoolIndex value could correspond to value 0 (or 1) of CORESETPoolIndex.

FIG. 9C illustrates another example of MAC CE based beam indication 920 according to embodiments of the present disclosure. An embodiment of the MAC CE based beam indication 920 shown in FIG. 9C is for illustration only.

In one example of Option-II, a one-bit flag indicator could be included/indicated/configured/provided in the MAC CE command for beam indication, wherein one or more TCI states/TCI state IDs are indicated. If the one-bit flag indicator is present and set to ‘1’ (or ‘0’), the MAC CE command for beam indication could be associated with the serving cell PCI/PCI index; in this case, the TCI state(s) (and therefore, the QCL source RS(s) indicated therein) indicated in the MAC CE command could also be associated with/transmitted from the serving cell/TRP having the serving cell PCI/PCI index. If the one-bit flag indicator is not present or set to ‘0’ (or ‘1’), the MAC CE command for beam indication could be associated with a PCI/PCI index other than the serving cell PCI/PCI index; in this case, the TCI state(s) (and therefore, the QCL source RS(s) indicated therein) indicated in the MAC CE command could also be associated with/transmitted from the non-serving cell/TRP (or neighboring cell/TRP) having the PCI/PCI index other than the serving cell PCI/PCI index. One conceptual example of including/indicating/configuring/providing the one-bit flag indicator in the MAC CE command for beam indication, wherein one or more TCI states/TCI state IDs are indicated, is depicted in FIG. 9C.

In one example of Option-IIa, a one-bit flag indicator could be included/indicated/configured/provided in the MAC CE command for beam indication, wherein two TCI states/TCI state IDs, denoted as a first TCI state and a second TCI state, are indicated. If the one-bit flag indicator is present and set to ‘1’ (or ‘0’), the first TCI state (and therefore, the QCL source RS(s) indicated therein) indicated in the MAC CE command is associated with the serving cell/TRP having the serving cell PCI/PCI index, and the second TCI state (and therefore, the QCL source RS(s) indicated therein) indicated in the MAC CE command is associated with a PCI/PCI index other than the serving cell PCI/PCI index. If the one-bit flag indicator is present and set to ‘0’ (or ‘1’), the first TCI state (and therefore, the QCL source RS(s) indicated therein) indicated in the MAC CE command is associated with a PCI/PCI index other than the serving cell PCI/PCI index, and the second TCI state (and therefore, the QCL source RS(s) indicated therein) indicated in the MAC CE command is associated with the serving cell/TRP having the serving cell PCI/PCI index.

In one example of Option-III, a multi-bit (more than one bit) indicator could be included/indicated/configured/provided in the MAC CE command for beam indication to indicate the serving cell/TRP having the serving cell PCI/PCI index and two or more non-serving cells/TRPs (or neighboring cells/TRPs) having PCIs/PCI indexes other than the serving cell PCI/PCI index in the inter-cell multi-TRP system. The number of bits n_b required for representing the multi-bit indicator could be ceil(log 2(N_nsc+1)), where N_nsc is the total number of non-serving cells/TRPs (or neighboring cells/TRPs) and ceil(x) rounds x up to the next largest integer. In this case, the n_b-bit indicator could correspond to 2\hat{ }(n_b) states, and one of the states (e.g., the first state) could correspond to the serving cell/TRP, and the rest of the states could correspond to the non-serving cells/TRPs (or neighboring cells/TRPs).

Alternatively, the number of bits n_b required for representing the multi-bit indicator could be ceil(log 2(N_nsc)). In this case, the multi-bit indicator only indicates/identifies the non-serving cells/TRPs (or neighboring cells/TRPs); if the multi-bit indicator is not present, the one or more TCI states (and therefore, the QCL source RS(s) indicated therein) indicated in the MAC CE command for beam indication could be associated with the serving cell PCI/PCI index. The UE could be indicated by the network the association rule(s)/mapping relationship(s) between the states of the multi-bit indicator and the PCIs/PCI indexes (e.g., corresponding to the serving cell PCI/PCI index and/or PCI(s)/PCI index(es) other than the serving cell PCI/PCI index); this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

FIG. 9D illustrates yet another example of MAC CE based beam indication 930 according to embodiments of the present disclosure. An embodiment of the MAC CE based beam indication 930 shown in FIG. 9D is for illustration only.

In one example of Option-IV, one or more PCIs/PCI indexes could be included/indicated/configured/provided in the MAC CE command for beam indication. The inclusion/indication of the PCI value(s)/PCI index(es) in the MAC CE command could be in addition to the SCI value/field. Alternatively, the MAC CE command could contain/include/indicate/configure/provide the PCI value(s)/PCI index(es) without the SCI value/field. In FIG. 9D, an example of the MAC CE command including/indicating/providing the PCI value(s) is presented. In this case, one or more PCI values could be used/reserved for representing the serving cell/TRP—e.g., PCI index 0 could correspond to the serving cell/TRP. The UE could be indicated by the network the association between the PCI value(s) and the serving cell/TRP and/or the association between the PCI value(s) and the non-serving (or neighboring) cell(s)/TRP(s).

If the indicated PCI value is associated with the serving cell/TRP, the MAC CE command could indicate the beam used for transmitting the PDCCH from the serving cell/TRP; in this case, the QCL source RS in the TCI state indicated by the MAC CE command could also be associated with/transmitted from the serving cell/TRP.

If the indicated PCI value is associated with a non-serving cell/TRP (or neighboring cell/TRP), the MAC CE command could indicate the beam used for transmitting the PDCCH from the non-serving cell/TRP (or neighboring cell/TRP) in the inter-cell multi-TRP system; in this case, the QCL source RS in the TCI state indicated by the MAC CE command could also be associated with/transmitted from the non-serving cell/TRP (or neighboring cell/TRP).

That is, a PCI or PCI index pointing to an entry/PCI in a list of PCIs that are higher layer configured to the UE could be indicated/included/configured/provided in the MAC CE command for beam indication. For this case, the TCI state(s) (and therefore, the QCL source RS(s) indicated therein) indicated in the MAC CE command could be associated with the PCI or PCI index indicated in the same MAC CE command for beam indication. The serving cell PCI index could be value 0.

In one example of Option-IV.1, if a MAC CE command for beam indication indicates/configures/includes/provides the serving cell PCI/PCI index, the TCI state(s) (and therefore, the QCL source RS(s) indicated therein) indicated in the MAC CE command is associated with the serving cell PCI/PCI index. If a MAC CE command for beam indication indicates/configures/includes/provides a PCI/PCI index other than the serving cell PCI/PCI index, the TCI state(s) (and therefore, the QCL source RS(s) indicated therein) indicated in the MAC CE command is associated with the PCI/PCI index other than the serving cell PCI/PCI index.

In one example of Option-IV.2, if a MAC CE command for beam indication indicates/configures/includes/provides a PCI/PCI index other than the serving cell PCI/PCI index, the TCI state(s) (and therefore, the QCL source RS(s) indicated therein) indicated in the MAC CE command is associated with the serving cell PCI/PCI index. If a MAC CE command for beam indication indicates/configures/includes/provides the serving cell PCI/PCI index, the TCI state(s) (and therefore, the QCL source RS(s) indicated therein) indicated in the MAC CE command is associated with the PCI/PCI index other than the serving cell PCI/PCI index.

The UE could be indicated/configured by the network whether Option-IV.1 and/or Option-IV.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Option-IV.1 is enabled and ‘1’ (or ‘0’) indicating the Option-IV.2 is enabled. The one-bit indicator could be indicated via a higher layer RRC signaling/parameter and/or in the MAC CE command for beam indication and/or via dynamic DCI based signaling (e.g., DCI format 1_1 or 1_2 with or without DL assignment).

In another example, the UE could be indicated/configured by the network a bitmap with each entry/bit position in the bitmap corresponding to either Option-IV.1 or Option-IV.2. For this example, if the first (or second) entry/bit position in the bitmap is set to ‘1’, Option-IV.1 is enabled; if the second (or first) entry/bit position in the bitmap is set to ‘1’, Option-IV.2 is enabled. The bitmap could be indicated via a higher layer RRC signaling/parameter and/or in the MAC CE command for beam indication and/or via dynamic DCI based signaling (e.g., DCI format 1_1 or 1_2 with or without DL assignment).

In yet another example, if the CORESET ID indicated in the MAC CE command for beam indication is associated with value 0 (or 1) of CORESETPoolIndex, Option-IV.1 is enabled; otherwise, if the CORESET ID indicated in the MAC CE command for beam indication is associated with value 1 (or 0) of CORESETPoolIndex, Option-IV.2 is enabled.

In yet another example, when a radio link failure or a beam failure has been declared for the PCI/PCI index (e.g., the serving cell PCI/PCI index or the PCI/PCI index other than the serving cell PCI/PCI index) indicated/included in the MAC CE command for beam indication, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Option-IV.2 is enabled.

In one example of Option-IVa, (a set of) two PCIs/PCI indexes, denoted as a first PCI/PCI index and a second PCI/PCI index, could be included/indicated/configured/provided in the MAC CE command for beam indication. The inclusion/indication of the two PCI values/PCI indexes in the MAC CE command could be in addition to the SCI value/field. Alternatively, the MAC CE command could contain/include/indicate/configure/provide the set of two PCI values/PCI indexes without the SCI value/field. One or more PCI values/PCI indexes could be used/reserved for representing the serving cell/TRP—e.g., in the present disclosure, PCI index 0 could correspond to the serving cell/TRP. The UE could be indicated by the network the association between the PCI value(s)/PCI index(es) and the serving cell/TRP and/or the association between the PCI value(s)/PCI index(es) and the non-serving (or neighboring) cell(s)/TRP(s). Furthermore, in this design option, the MAC CE command for beam indication could indicate two TCI states, denoted as a first TCI state and a second TCI state.

In one example of Option-IVa.1, the first TCI state (and therefore, the QCL source RS(s) indicated therein) indicated in the MAC CE command is associated with the first PCI/PCI index indicated in the MAC CE command. The second TCI state (and therefore, the QCL source RS(s) indicated therein) indicated in the MAC CE command is associated with the second PCI/PCI index indicated in the MAC CE command.

In one example of Option-IVa.2, the first TCI state (and therefore, the QCL source RS(s) indicated therein) indicated in the MAC CE command is associated with the second PCI/PCI index indicated in the MAC CE command. The second TCI state (and therefore, the QCL source RS(s) indicated therein) indicated in the MAC CE command is associated with the first PCI/PCI index indicated in the MAC CE command.

The UE could be indicated/configured by the network whether Option-IVa.1 and/or Option-IVa.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Option-IVa.1 is enabled and ‘1’ (or ‘0’) indicating the Option-IVa.2 is enabled. The one-bit indicator could be indicated via a higher layer RRC signaling/parameter and/or in the MAC CE command for beam indication and/or via dynamic DCI based signaling (e.g., DCI format 1_1 or 1_2 with or without DL assignment).

In another example, the UE could be indicated/configured by the network a bitmap with each entry/bit position in the bitmap corresponding to either Option-IVa.1 or Option-IVa.2. For this example, if the first (or second) entry/bit position in the bitmap is set to ‘1’, Option-IVa.1 is enabled; if the second (or first) entry/bit position in the bitmap is set to ‘1’, Option-IVa.2 is enabled. The bitmap could be indicated via a higher layer RRC signaling/parameter and/or in the MAC CE command for beam indication and/or via dynamic DCI based signaling (e.g., DCI format 1_1 or 1_2 with or without DL assignment).

In yet another example, if the CORESET ID indicated in the MAC CE command for beam indication is associated with value 0 (or 1) of CORESETPoolIndex, Option-IVa.1 is enabled; otherwise, if the CORESET ID indicated in the MAC CE command for beam indication is associated with value 1 (or 0) of CORESETPoolIndex, Option-IVa.2 is enabled.

The first PCI/PCI index or the second PCI/PCI index could correspond to the serving cell PCI/PCI index or a PCI/PCI index other than the serving cell PCI/PCI index. In the present disclosure, a PCI index could point to an entry/PCI in a list of PCIs that are higher layer configured to the UE; the list of PCIs could comprise only the PCIs other than the serving cell PCI, or both the serving cell PCI and PCI(s) other than the serving cell PCIs. Furthermore, as aforementioned, the PCI index for the serving cell/TRP could correspond to value 0.

In one example of Option-V, one or more SCI values in the MAC CE command could be used for representing one or more non-serving cells/TRPs (or neighboring cells/TRPs), and/or, correspond to one or more PCI values for the non-serving cells/TRPs (or neighboring cells/TRPs), in the inter-cell multi-TRP system. The UE could be indicated by the network the exact SCI value(s) used/reserved for representing the non-serving cell(s)/TRP(s) (or neighboring cell(s)/TRP(s)), and/or, the association between the reserved SCI value(s) and the PCI value(s) for the non-serving cell(s)/TRP(s) (or neighboring cell(s)/TRP(s)). If the indicated SCI value is reserved/used for representing a non-serving cell/TRP (or neighboring cell/TRP) and/or corresponds to a non-serving cell/TRP (or neighboring cell/TRP) PCI value, the MAC CE command could indicate the beam used for transmitting the PDCCH from the non-serving cell/TRP (or neighboring cell/TRP) in the inter-cell multi-TRP system; in this case, the QCL source RS in the TCI state indicated by the MAC CE command could also be associated with/transmitted from the non-serving cell/TRP (or neighboring cell/TRP).

In one example of Option-VI, upon receiving the MAC CE command, the UE could identify the serving/non-serving (or neighboring) cell/TRP information/identification, e.g., via the one-bit flag indicator and/or the multi-bit indicator and/or the PCI value(s) indicated in the higher layer parameter ControlResourceSet associated with the CORESET ID indicated in the MAC CE command. The UE could further identify whether the corresponding PDCCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH is transmitted. In addition, the UE could also identify whether the QCL source RS in the indicated TCI state is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS in the indicated TCI state is transmitted.

In one example of Option-VII, a TCI state could be associated with the serving cell/TRP having the serving cell PCI/PCI index or a non-serving cell/TRP having a PCI/PCI index other than the serving cell PCI/PCI index—e.g., the higher layer parameter TCI-State, QCL-Info, DLorJointTCI-State or UL-TCIState could include/contain/provide/indicate information related to indicating/identifying the serving cell/TRP and/or non-serving cell(s)/TRP(s).

For example, a TCI state or the higher layer parameter TCI-State, QCL-Info, DLorJointTCI-State or UL-TCIState that configures a TCI state could include/indicate/configure/provide a CORESETPoolIndex value, which could be associated with the serving cell/TRP or a non-serving cell/TRP (or neighboring cell/TRP)—e.g., with value 0 (or 1) of CORESETPoolIndex associated with the serving cell PCI/PCI index and value 1 (or 0) associated with a PCI/PCI index other than the serving cell PCI/PCI index.

For another example, a TCI state or the higher layer parameter TCI-State, QCL-Info, DLorJointTCI-State or UL-TCIState that configures a TCI state could include/indicate/configure/provide a one-bit flag indicator to indicate the serving cell/TRP or a non-serving cell/TRP (or neighboring cell/TRP)—e.g., with the one-bit flag indicator set to ‘0’ (or ‘1’) indicating the serving cell PCI/PCI index and ‘1’ (or ‘0’) indicating a PCI/PCI index other than the serving cell PCI/PCI index.

Yet for another example, a TCI state or the higher layer parameter TCI-State, QCL-Info, DLorJointTCI-State or UL-TCIState that configures a TCI state could include/indicate/configure/provide a multi-bit indicator to indicate the serving cell/TRP (and/or its PCI value/PCI index) and the non-serving (or neighboring) cell(s)/TRPs (and/or the corresponding PCI value(s)/PCI index(es)).

Yet for another example, a TCI state or the higher layer parameter TCI-State, QCL-Info, DLorJointTCI-State or UL-TCIState that configures a TCI state could include/indicate/configure/provide a PCI value/PCI index (e.g., corresponding to the serving cell PCI/PCI index or a PCI/PCI index other than the serving cell PCI/PCI index). Yet for another example, one or more serving cell IDs (SCIs) in a TCI state could be reserved/used to indicate one or more non-serving (or neighboring) cells/TRPs information. Other details about the indication/identification of the serving/non-serving (or neighboring) cells/TRPs information in a TCI state could be according to the US provisional patent application 63/067,122 filed on Aug. 18, 2020.

Based on the above, a TCI state (and therefore, the corresponding QCL source RS(s) indicated therein) indicated in the MAC CE command (e.g., via the TCI state ID shown in FIG. 9B) could be associated with the serving cell/TRP having the serving cell PCI/PCI index or a non-serving (or neighboring) cell/TRP having a PCI/PCI index other than the serving cell PCI/PCI index. If the serving cell/TRP information is indicated in a TCI state or the higher layer parameter TCI-State, QCL-Info, DLorJointTCI-State or UL-TCIState that configures a TCI state indicated in the MAC CE command, the corresponding PDCCH could be transmitted from/associated with the serving cell/TRP; in this case, the QCL source RS(s) in the TCI state indicated in the MAC CE command could also be associated with/transmitted from the serving cell/TRP.

If the non-serving (or neighboring) cell/TRP information is indicated in a TCI state or the higher layer parameter TCI-State, QCL-Info, DLorJointTCI-State or UL-TCIState that configures a TCI state indicated in the MAC CE command, the corresponding PDCCH could be transmitted from/associated with the non-serving cell/TRP (or neighboring cell/TRP) in the inter-cell multi-TRP system; in this case, the QCL source RS(s) in the TCI state indicated in the MAC CE command could also be associated with/transmitted from the non-serving cell/TRP (or neighboring cell/TRP).

In one example of Option-VII.1, if a TCI state indicated in the MAC CE command for beam indication is associated with the serving cell/TRP having the serving cell PCI/PCI index—e.g., the higher layer parameter TCI-State, QCL-Info, DLorJointTCI-State or UL-TCIState that configures the TCI state indicates/includes/configures/provides information related to the serving cell/TRP having the serving cell PCI/PCI index, the corresponding QCL source RS(s) indicated in the TCI state could be associated with the serving cell/TRP having the serving cell PCI/PCI index. If a TCI state indicated in the MAC CE command for beam indication is associated with a non-serving cell/TRP having a PCI/PCI index other than the serving cell PCI/PCI index—e.g., the higher layer parameter TCI-State, QCL-Info, DLorJointTCI-State or UL-TCIState that configures the TCI state indicates/includes/configures/provides information related to the non-serving cell/TRP having the PCI/PCI index other than the serving cell PCI/PCI index, the corresponding QCL source RS(s) indicated in the TCI state could be associated with the non-serving cell/TRP having the PCI/PCI index other than the serving cell PCI/PCI index.

In one example of Option-VII.2, if a TCI state indicated in the MAC CE command for beam indication is associated with a non-serving cell/TRP having a PCI/PCI index other than the serving cell PCI/PCI index—e.g., the higher layer parameter TCI-State, QCL-Info, DLorJointTCI-State or UL-TCIState that configures the TCI state indicates/includes/configures/provides information related to the non-serving cell/TRP having the PCI/PCI index other than the serving cell PCI/PCI index, the corresponding QCL source RS(s) indicated in the TCI state could be associated with the serving cell/TRP having the serving cell PCI/PCI index. If a TCI state indicated in the MAC CE command for beam indication is associated with the serving cell/TRP having the serving cell PCI/PCI index—e.g., the higher layer parameter TCI-State, QCL-Info, DLorJointTCI-State or UL-TCIState that configures the TCI state indicates/includes/configures/provides information related to the serving cell/TRP having the serving cell PCI/PCI index, the corresponding QCL source RS(s) indicated in the TCI state could be associated with the non-serving cell/TRP having the PCI/PCI index other than the serving cell PCI/PCI index.

The UE could be indicated/configured by the network whether Option-VII.1 and/or Option-VII.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Option-VII.1 is enabled for at least one TCI state indicated in the MAC CE command for beam indication and ‘1’ (or ‘0’) indicating the Option-VII.2 is enabled for at least one TCI state indicated in the MAC CE command for beam indication. The one-bit indicator could be indicated via a higher layer RRC signaling/parameter and/or in the MAC CE command for beam indication and/or via dynamic DCI based signaling (e.g., DCI format 1_1 or 1_2 with or without DL assignment).

In another example, the UE could be indicated/configured by the network a bitmap with each entry/bit position in the bitmap corresponding to either Option-VII.1 or Option-VII.2. For this example, if the first (or second) entry/bit position in the bitmap is set to ‘1’, Option-VII.1 is enabled for at least one TCI state indicated in the MAC CE command for beam indication; if the second (or first) entry/bit position in the bitmap is set to ‘1’, Option-VII.2 is enabled for at least one TCI state indicated in the MAC CE command for beam indication. The bitmap could be indicated via a higher layer RRC signaling/parameter and/or in the MAC CE command for beam indication and/or via dynamic DCI based signaling (e.g., DCI format 1_1 or 1_2 with or without DL assignment).

In yet another example, if the CORESET ID indicated in the MAC CE command for beam indication is associated with value 0 (or 1) of CORESETPoolIndex, Option-VII.1 is enabled for at least one TCI state indicated in the MAC CE command for beam indication; otherwise, if the CORESET ID indicated in the MAC CE command for beam indication is associated with value 1 (or 0) of CORESETPoolIndex, Option-VII.2 is enabled for at least one TCI state indicated in the MAC CE command for beam indication.

In yet another example, when a radio link failure or a beam failure has been declared for the PCI/PCI index (e.g., the serving cell PCI/PCI index or the PCI/PCI index other than the serving cell PCI/PCI index) associated to a TCI state—e.g., the higher layer parameter TCI-State, QCL-Info, DLorJointTCI-State or UL-TCIState that configures the TCI state indicates/includes/configures/provides information related to the PCI/PCI index—indicated in the MAC CE command for beam indication, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Option-VII.2 is enabled for at least the TCI state.

The above design options and examples apply to when more than one (e.g., 2) TCI states/TCI state IDs are indicated in a MAC CE command for beam indication.

In one example of Option-VIII, one or more entity IDs could be included/indicated/configured/provided in the MAC CE command for beam indication. In the present disclosure, an entity ID could correspond to a PCI, a PCI index pointing to an entry/PCI in a list of PCIs that are higher layer configured to the UE, a one-bit indicator with ‘0’ (or ‘1’) indicating the serving cell PCI/PCI index and ‘1’ (or ‘0’) indicating a PCI/PCI index other than the serving cell PCI/PCI index, a multi-bit indicator with each bit index corresponding to a PCI/PCI index, PCI index 0 for the serving cell/TRP, a CORESETPoolIndex, a CORESETGroupIndex, a CORESET ID, a resource set ID/index, a resource ID/index, a TRP-specific ID/index or a TRP-specific higher layer signaling index/ID.

The inclusion/indication of the entity ID(s) in the MAC CE command could be in addition to the SCI value/field. Alternatively, the MAC CE command could contain/include/indicate/configure/provide the entity ID(s) without the SCI value/field. In this case, one or more entity IDs could be used/reserved for representing the serving cell/TRP—e.g., PCI index 0 could correspond to the serving cell/TRP. The UE could be indicated by the network the association between the entity ID(s) and the serving cell/TRP having the serving cell PCI/PCI index, and/or the association between the entity ID(s) and the non-serving (or neighboring) cell(s)/TRP(s) having PCI(s)/PCI index(es) other than the serving cell PCI/PCI index.

If the indicated entity ID is associated with the serving cell/TRP, the MAC CE command could indicate the beam used for transmitting the PDCCH from the serving cell/TRP; in this case, the QCL source RS in the TCI state indicated by the MAC CE command could also be associated with/transmitted from the serving cell/TRP. If the indicated entity ID is associated with a non-serving cell/TRP (or neighboring cell/TRP), the MAC CE command could indicate the beam used for transmitting the PDCCH from the non-serving cell/TRP (or neighboring cell/TRP) in the inter-cell multi-TRP system; in this case, the QCL source RS in the TCI state indicated by the MAC CE command could also be associated with/transmitted from the non-serving cell/TRP (or neighboring cell/TRP).

That is, an entity ID could be indicated/included/configured/provided in the MAC CE command for beam indication. For this case, the TCI state(s) (and therefore, the QCL source RS(s) indicated therein) indicated in the MAC CE command could be associated with the entity ID (and therefore, the associated/corresponding serving cell or non-serving cell) indicated in the same MAC CE command for beam indication.

In one example of Option-VIII.1, if a MAC CE command for beam indication indicates/configures/includes/provides an entity ID associated with/corresponding to the serving cell—e.g., the serving cell PCI/PCI index, the TCI state(s) (and therefore, the QCL source RS(s) indicated therein) indicated in the MAC CE command is associated with the serving cell—e.g., the serving cell PCI/PCI index. If a MAC CE command for beam indication indicates/configures/includes/provides an entity ID associated with/corresponding to a non-serving cell—e.g., a PCI/PCI index other than the serving cell PCI/PCI index, the TCI state(s) (and therefore, the QCL source RS(s) indicated therein) indicated in the MAC CE command is associated with the non-serving cell—e.g., the PCI/PCI index other than the serving cell PCI/PCI index.

In one example of Option-VIII.2, if a MAC CE command for beam indication indicates/configures/includes/provides an entity ID associated with/corresponding to a non-serving cell—e.g., a PCI/PCI index other than the serving cell PCI/PCI index, the TCI state(s) (and therefore, the QCL source RS(s) indicated therein) indicated in the MAC CE command is associated with the serving cell—e.g., the serving cell PCI/PCI index. If a MAC CE command for beam indication indicates/configures/includes/provides an entity ID associated with/corresponding to the serving cell—e.g., the serving cell PCI/PCI index, the TCI state(s) (and therefore, the QCL source RS(s) indicated therein) indicated in the MAC CE command is associated with the non-serving cell—e.g., the PCI/PCI index other than the serving cell PCI/PCI index.

The UE could be indicated/configured by the network whether Option-VIII.1 and/or Option-VIII.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Option-VIII.1 is enabled and ‘1’ (or ‘0’) indicating the Option-VIII.2 is enabled. The one-bit indicator could be indicated via a higher layer RRC signaling/parameter and/or in the MAC CE command for beam indication and/or via dynamic DCI based signaling (e.g., DCI format 1_1 or 1_2 with or without DL assignment).

In another example, the UE could be indicated/configured by the network a bitmap with each entry/bit position in the bitmap corresponding to either Option-VII.1 or Option-VIII.2. For this example, if the first (or second) entry/bit position in the bitmap is set to ‘1’, Option-VIII.1 is enabled; if the second (or first) entry/bit position in the bitmap is set to ‘1’, Option-VIII.2 is enabled. The bitmap could be indicated via a higher layer RRC signaling/parameter and/or in the MAC CE command for beam indication and/or via dynamic DCI based signaling (e.g., DCI format 1_1 or 1_2 with or without DL assignment).

In yet another example, if the CORESET ID indicated in the MAC CE command for beam indication is associated with value 0 (or 1) of CORESETPoolIndex, Option-VIII.1 is enabled; otherwise, if the CORESET ID indicated in the MAC CE command for beam indication is associated with value 1 (or 0) of CORESETPoolIndex, Option-VIII.2 is enabled.

In yet another example, when a radio link failure or a beam failure has been declared for the cell (e.g., the serving cell having the serving cell PCI/PCI index or a non-serving cell having a PCI/PCI index other than the serving cell PCI/PCI index) associated to the entity ID indicated/included in the MAC CE command for beam indication, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Option-VIII.2 is enabled.

In one example of Option-VIIIa, (a set of) two entity IDs, denoted as a first entity ID and a second entity ID, could be included/indicated/configured/provided in the MAC CE command for beam indication. In the present disclosure, an entity ID could correspond to a PCI, a PCI index pointing to an entry/PCI in a list of PCIs that are higher layer configured to the UE, a one-bit indicator with ‘0’ (or ‘1’) indicating the serving cell PCI/PCI index and ‘1’ (or ‘0’) indicating a PCI/PCI index other than the serving cell PCI/PCI index, a multi-bit indicator with each bit index corresponding to a PCI/PCI index, PCI index 0 for the serving cell/TRP, a CORESETPoolIndex, a CORESETGroupIndex, a CORESET ID, a resource set ID/index, a resource ID/index, a TRP-specific ID/index or a TRP-specific higher layer signaling index/ID.

The inclusion/indication of the two entity IDs in the MAC CE command could be in addition to the SCI value/field. Alternatively, the MAC CE command could contain/include/indicate/configure/provide the set of two entity IDs without the SCI value/field. One or more entity IDs could be used/reserved for representing the serving cell/TRP—e.g., in the present disclosure, PCI index 0 could correspond to the serving cell/TRP. The UE could be indicated by the network the association between the entity ID(s) and the serving cell/TRP having the serving cell PCI/PCI index, and/or the association between the entity ID(s) and the non-serving (or neighboring) cell(s)/TRP(s) having PCI(s)/PCI index(es) other than the serving cell PCI/PCI index. Furthermore, in this design option, the MAC CE command for beam indication could indicate two TCI states, denoted as a first TCI state and a second TCI state.

In one example of Option-VIIIa.1, the first TCI state (and therefore, the QCL source RS(s) indicated therein) indicated in the MAC CE command is associated with the first entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the MAC CE command. The second TCI state (and therefore, the QCL source RS(s) indicated therein) indicated in the MAC CE command is associated with the second entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the MAC CE command.

In one example of Option-VIIIa.2, the first TCI state (and therefore, the QCL source RS(s) indicated therein) indicated in the MAC CE command is associated with the second entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the MAC CE command. The second TCI state (and therefore, the QCL source RS(s) indicated therein) indicated in the MAC CE command is associated with the first entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the MAC CE command.

The UE could be indicated/configured by the network whether Option-VIIIa.1 and/or Option-VIIIa.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Option-VIIIa.1 is enabled and ‘1’ (or ‘0’) indicating the Option-VIIIa.2 is enabled. The one-bit indicator could be indicated via a higher layer RRC signaling/parameter and/or in the MAC CE command for beam indication and/or via dynamic DCI based signaling (e.g., DCI format 1_1 or 1_2 with or without DL assignment).

In another example, the UE could be indicated/configured by the network a bitmap with each entry/bit position in the bitmap corresponding to either Option-VIIIa.1 or Option-VIIIa.2. For this example, if the first (or second) entry/bit position in the bitmap is set to ‘1’, Option-VIIIa.1 is enabled; if the second (or first) entry/bit position in the bitmap is set to ‘1’, Option-VIIIa.2 is enabled. The bitmap could be indicated via a higher layer RRC signaling/parameter and/or in the MAC CE command for beam indication and/or via dynamic DCI based signaling (e.g., DCI format 1_1 or 1_2 with or without DL assignment).

In yet another example, if the CORESET ID indicated in the MAC CE command for beam indication is associated with value 0 (or 1) of CORESETPoolIndex, Option-VIIIa.1 is enabled; otherwise, if the CORESET ID indicated in the MAC CE command for beam indication is associated with value 1 (or 0) of CORESETPoolIndex, Option-VIIIa.2 is enabled.

For Option-0 based (candidate) TCI states configuration, wherein one or more of the (candidate) TCI states (and therefore, the QCL source RSs indicated therein) configured in the higher layer parameter ControlResourceSet or a TCI state group, e.g., provided by TCIState-Group could be transmitted from/associated with either the serving cell/TRP having the serving cell PCI/PCI index or the non-serving cell(s)/TRP(s) (or neighboring cell(s)/TRP(s)) having PCI(s)/PCI index(es) other than the serving cell PCI/PCI index, Option-1 based candidate TCI states configuration, wherein the UE could identify whether one or more of the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the CORESETPoolIndex value (if configured) in the higher layer parameter ControlResourceSet, Option-1a based TCI states configuration, wherein a CORESETPoolIndex value is indicated/configured in a TCI state group, e.g., provided by TCIState-Group, and used to indicate/identify whether one or more of the TCI states (and therefore, the QCL source RSs indicated therein) configured in the TCI state group, e.g., provided by TCIState-Group, are associated with the serving cell/TRP having the serving cell PCI/PCI index or the non-serving cell(s)/TRP(s) (or neighboring cell(s)/TRP(s)) having PCI(s)/PCI index(es) other than the serving cell PCI/PCI index, Option-2 based candidate TCI states configuration, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the one-bit flag indicator in the higher layer parameter ControlResourceSet, Option-2a based TCI states configuration, wherein a one-bit flag indicator is indicated/configured in a TCI state group, e.g., provided by TCIState-Group, and used to indicate/identify whether one or more of the TCI states (and therefore, the QCL source RSs indicated therein) configured in the TCI state group, e.g., provided by TCIState-Group, are associated with the serving cell/TRP having the serving cell PCI/PCI index or the non-serving cell(s)/TRP(s) (or neighboring cell(s)/TRP(s)) having PCI(s)/PCI index(es) other than the serving cell PCI/PCI index, Option-3 based (candidate) TCI states configuration, wherein the UE could identify whether one or more of the (candidate) TCI states (and therefore, the QCL source RSs indicated therein) and/or the corresponding PDCCH(s) are transmitted from/associated with either the serving cell/TRP having the serving cell PCI/PCI index or a non-serving cell/TRP (or neighboring cell/TRP) having a PCI/PCI index other than the serving cell PCI/PCI index via the multi-bit indicator indicated in the higher layer parameter ControlResourceSet or a TCI state group, e.g., provided by the higher layer parameter TCIState-Group, Option-4 based candidate TCI states configuration, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the PCI value/PCI index indicated in the higher layer parameter ControlResourceSet, Option-4a based TCI states configuration, wherein a PCI/PCI index is indicated/configured in a TCI state group, e.g., provided by TCIState-Group, and used to indicate/identify whether one or more of the TCI states (and therefore, the QCL source RSs indicated therein) configured in the TCI state group, e.g., provided by TCIState-Group, are associated with the serving cell/TRP having the serving cell PCI/PCI index or the non-serving cell(s)/TRP(s) (or neighboring cell(s)/TRP(s)) having PCI(s)/PCI index(es) other than the serving cell PCI/PCI index, Option-5 based (candidate) TCI states configuration, wherein the UE could identify whether one or more of the (candidate) TCI states (and therefore, the QCL source RSs indicated therein) and/or the corresponding PDCCH(s) are transmitted from/associated with either the serving cell/TRP having the serving cell PCI/PCI index or a non-serving cell/TRP (or neighboring cell/TRP) having a PCI/PCI index other than the serving cell PCI/PCI index via the serving/non-serving (or neighboring) cells/TRPs information indicated in the (candidate) TCI state(s) or the higher layer parameter TCI-State, QCL-Info, DLorJointTCI-State or UL-TCIState that configures the (candidate) TCI state(s) configured/indicated in the higher layer parameter ControlResourceSet, or a TCI state group, e.g., provided by TCIState-Group, Option-6 based candidate TCI states configuration, wherein the UE could identify whether one or more of the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the entity ID in the higher layer parameter ControlResourceSet, Option-6a based TCI states configuration, wherein an entity ID is indicated/configured in a TCI state group, e.g., provided by TCIState-Group, and used to indicate/identify whether one or more of the TCI states (and therefore, the QCL source RSs indicated therein) configured in the TCI state group, e.g., provided by TCIState-Group, are associated with the serving cell/TRP having the serving cell PCI/PCI index or the non-serving cell(s)/TRP(s) (or neighboring cell(s)/TRP(s)) having PCI(s)/PCI index(es) other than the serving cell PCI/PCI index (based on the association between PCIs/PCI indexes and entity IDs),

In one example, the Option-I based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the CORESETPoolIndex value (if configured) associated with the MAC CE command.

That is, DMRS antenna ports for PDCCH receptions, DMRS antenna ports for PDSCH receptions or CSI-RS associated with a first (or second) CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in the TCI state indicated in the MAC CE command for beam indication, wherein the MAC CE command is also associated with the (same) first (or second) CORESETPoolIndex value—the CORESET ID indicated in the MAC CE command for beam indication is associated with the first (or second) CORESETPoolIndex. Alternatively, DMRS antenna ports for PDCCH receptions, DMRS antenna ports for PDSCH receptions or CSI-RS associated with a first (or second) CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in the TCI state indicated in the MAC CE command for beam indication, wherein the MAC CE command is associated with the second (or first) CORESETPoolIndex value—the CORESET ID indicated in the MAC CE command for beam indication is associated with the second (or first) CORESETPoolIndex.

In another example, the Option-Ia based TCI state indication could be applied for one or more DL channels/signals. That is, DMRS antenna ports for PDCCH receptions, DMRS antenna ports for PDSCH receptions or CSI-RS associated with a first CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in a first (or second) TCI state indicated in the MAC CE command for beam indication, wherein the first (or second) TCI state is associated with the first (or second) CORESETPoolIndex value, and DMRS antenna ports for PDSCH receptions or CSI-RS associated with a second CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in a second (or first) TCI state indicated in the MAC CE command for beam indication, wherein the second (or first) TCI state is associated with the second (or first) CORESETPoolIndex value.

Alternatively, DMRS antenna ports for PDCCH receptions, DMRS antenna ports for PDSCH receptions or CSI-RS associated with a first CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in the second (or first) TCI state indicated in the MAC CE command for beam indication, wherein the second (or first) TCI state is associated with the first (or second) CORESETPoolIndex value, and DMRS antenna ports for PDSCH receptions or CSI-RS associated with a second CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in the first (or second) TCI state indicated in the MAC CE command for beam indication, wherein the first (or second) TCI state could be associated with the second (or first) CORESETPoolIndex value.

For this case, the MAC CE command for beam indication could be associated with the first (or second) CORESETPoolIndex—and therefore, the corresponding/associated PCI/PCI index corresponding to the serving cell PCI/PCI index or a PCI/PCI index other than the serving cell PCI/PCI index—i.e., the CORESET ID indicated in the MAC CE command for beam indication is associated with the first (or second) CORESETPoolIndex value. Furthermore, the first (or second) CORESETPoolIndex value could correspond value 0 or 1, e.g., provided in the higher layer parameter PDCCH-Config.

In yet another example, the Option-II based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the one-bit flag indicator in the MAC CE command.

That is, DMRS antenna ports for PDCCH receptions, DMRS antenna ports for PDSCH receptions or CSI-RS associated with the serving cell PCI/PCI index could be QCL'ed with the set of RSs in the TCI state indicated in the MAC CE command for beam indication, wherein the MAC CE command for beam indication indicates/configures/includes/provides a one-bit flag indicator set to ‘0’ (or ‘1’). Furthermore, DMRS antenna ports for PDCCH receptions, DMRS antenna ports for PDSCH receptions or CSI-RS associated with a PCI/PCI index other than the serving cell PCI/PCI index could be QCL'ed with the set of RSs in the TCI state indicated in the MAC CE command for beam indication, wherein the MAC CE command for beam indication indicates/configures/includes/provides a one-bit flag indicator set to ‘1’ (or ‘0’).

In yet another example, the Option-IIa based TCI state indication could be applied for one or more DL channels/signals. That is, DMRS antenna ports for PDCCH receptions, DMRS antenna ports for PDSCH receptions or CSI-RS associated with the serving cell PCI/PCI index could be QCL'ed with the set of RSs in the first (or second) TCI state indicated in the MAC CE command for beam indication, and DMRS antenna ports for PDCCH receptions, DMRS antenna ports for PDSCH receptions or CSI-RS associated with a PCI/PCI index other than the serving cell PCI/PCI index could be QCL'ed with the set of RSs in the second (or first) TCI state indicated in the MAC CE command for beam indication, wherein the MAC CE command for beam indication indicates/configures/includes/provides a one-bit flag indicator set to ‘1’ (or ‘0’).

Alternatively, DMRS antenna ports for PDCCH receptions, DMRS antenna ports for PDSCH receptions or CSI-RS associated with the PCI/PCI index other than the serving cell PCI/PCI index could be QCL'ed with the set of RSs in the first (or second) TCI state indicated in the MAC CE command for beam indication, and DMRS antenna ports for PDCCH receptions, DMRS antenna ports for PDSCH receptions or CSI-RS associated with the serving cell PCI/PCI index could be QCL'ed with the set of RSs in the second (or first) TCI state indicated in the MAC CE command for beam indication, wherein the MAC CE command for beam indication indicates/configures/includes/provides a one-bit flag indicator set to ‘0’ (or ‘1’).

In yet another example, the Option-III based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the multi-bit indicator in the MAC CE command.

In yet another example, the Option-IV based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the PCI value/PCI index indicated in the MAC CE command. That is, DMRS antenna ports for PDCCH receptions, DMRS antenna ports for PDSCH receptions or CSI-RS associated with the serving cell PCI/PCI index could be QCL'ed with the set of RSs in the TCI state indicated in the MAC CE command for beam indication, wherein the MAC CE command for beam indication indicates/configures/includes/provides the serving cell PCI/PCI index, and DMRS antenna ports for PDCCH receptions, DMRS antenna ports for PDSCH receptions or CSI-RS associated with a PCI/PCI index other than the serving cell PCI/PCI index could be QCL'ed with the set of RSs in the TCI state indicated in the MAC CE command for beam indication, wherein the MAC CE command for beam indication indicates/configures/includes/provides the PCI/PCI index other than the serving cell PCI/PCI index.

Alternatively, DMRS antenna ports for PDCCH receptions, DMRS antenna ports for PDSCH receptions or CSI-RS associated with the serving cell PCI/PCI index could be QCL'ed with the set of RSs in the TCI state indicated in the MAC CE command for beam indication, wherein the MAC CE command for beam indication indicates/configures/includes/provides the PCI/PCI index other than the serving cell PCI/PCI index, and DMRS antenna ports for PDCCH receptions, DMRS antenna ports for PDSCH receptions or CSI-RS associated with the PCI/PCI index other than the serving cell PCI/PCI index could be QCL'ed with the set of RSs in the TCI state indicated in the MAC CE command for beam indication, wherein the MAC CE command for beam indication indicates/configures/includes/provides the serving cell PCI/PCI index.

In yet another example, the Option-IVa based TCI state indication could be applied for one or more DL channels/signals. That is, DMRS antenna ports for PDCCH receptions, DMRS antenna ports for PDSCH receptions or CSI-RS associated with the first PCI/PCI index could be QCL'ed with the set of RSs in the first (or second) TCI state indicated in the MAC CE command for beam indication, wherein the first (or second) TCI state is associated with the first (or second) PCI/PCI index, and DMRS antenna ports for PDCCH receptions, DMRS antenna ports for PDSCH receptions or CSI-RS associated with the second PCI/PCI index could be QCL'ed with the set of RSs in the second (or first) TCI state indicated in the MAC CE command for beam indication, wherein the second (or first) TCI state is associated with the second (or first) PCI/PCI index.

Alternatively, DMRS antenna ports for PDCCH receptions, DMRS antenna ports for PDSCH receptions or CSI-RS associated with the first PCI/PCI index could be QCL'ed with the set of RSs in the first (or second) TCI state indicated in the MAC CE command for beam indication, wherein the first (or second) TCI state is associated with the second (or first) PCI/PCI index, and DMRS antenna ports for PDCCH receptions, DMRS antenna ports for PDSCH receptions or CSI-RS associated with the second PCI/PCI index could be QCL'ed with the set of RSs in the second (or first) TCI state indicated in the MAC CE command for beam indication, wherein the second (or first) TCI state is also associated with the first (or second) PCI/PCI index. As aforementioned, the first (or second) PCI/PCI index could correspond to the serving cell PCI/PCI index or a PCI/PCI index other than the serving cell PCI/PCI index.

In yet another example, the Option-V based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the SCI value in the MAC CE command.

In yet another example, the Option-VI based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the association between the one-bit flag indicator and/or the multi-bit indicator and/or the PCI value(s) indicated in the higher layer parameter ControlResourceSet and the CORESET ID in the MAC CE command.

In yet another example, the Option-VII based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the serving/non-serving (or neighboring) cells/TRPs information indicated in the TCI state or the higher layer parameter TCI-State, QCL-Info, DLorJointTCI-State or UL-TCIState that configures the TCI state indicated in the MAC CE command.

That is, DMRS antenna ports for PDCCH receptions, DMRS antenna ports for PDSCH receptions or CSI-RS associated with the serving cell PCI/PCI index could be QCL'ed with the set of RSs in the TCI state indicated in the MAC CE command for beam indication, wherein the TCI state is associated with the serving cell/TRP having the serving cell PCI/PCI index—e.g., the higher layer parameter TCI-State, QCL-Info, DLorJointTCI-State or UL-TCIState that configures the TCI state indicates/includes/configures/provides information related to the serving cell/TRP having the serving cell PCI/PCI index, and DMRS antenna ports for PDCCH receptions, DMRS antenna ports for PDSCH receptions or CSI-RS associated with a PCI/PCI index other than the serving cell PCI/PCI index could be QCL'ed with the set of RSs in the TCI state indicated in the MAC CE command for beam indication, wherein the TCI state is associated with the PCI/PCI index other than the serving cell PCI/PCI index—e.g., the higher layer parameter TCI-State, QCL-Info, DLorJointTCI-State or UL-TCIState that configures the TCI state indicates/includes/configures/provides information related to the non-serving cell/TRP having the PCI/PCI index other than the serving cell PCI/PCI index.

Alternatively, DMRS antenna ports for PDCCH receptions, DMRS antenna ports for PDSCH receptions or CSI-RS associated with the serving cell PCI/PCI index could be QCL'ed with the set of RSs in the TCI state indicated in the MAC CE command for beam indication, wherein the TCI state is associated with the non-serving cell/TRP having the PCI/PCI index other than the serving cell PCI/PCI index—e.g., the higher layer parameter TCI-State, QCL-Info, DLorJointTCI-State or UL-TCIState that configures the TCI state indicates/includes/configures/provides information related to the non-serving cell/TRP having the PCI/PCI index other than the serving cell PCI/PCI index, and DMRS antenna ports for PDCCH receptions, DMRS antenna ports for PDSCH receptions or CSI-RS associated with the PCI/PCI index other than the serving cell PCI/PCI index could be QCL'ed with the set of RSs in the TCI state indicated in the MAC CE command for beam indication, wherein the TCI state is associated with the serving cell PCI/PCI index—e.g., the higher layer parameter TCI-State, QCL-Info, DLorJointTCI-State or UL-TCIState that configures the TCI state indicates/includes/configures/provides information related to the serving cell/TRP having the serving cell PCI/PCI index.

In yet another example, the Option-VIII based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the entity ID indicated in the MAC CE command.

That is, DMRS antenna ports for PDCCH receptions, DMRS antenna ports for PDSCH receptions or CSI-RS associated with the serving cell PCI/PCI index could be QCL'ed with the set of RSs in the TCI state indicated in the MAC CE command for beam indication, wherein the MAC CE command for beam indication indicates/configures/includes/provides an entity ID associated with/corresponding to the serving cell—e.g., the serving cell PCI/PCI index, and DMRS antenna ports for PDCCH receptions, DMRS antenna ports for PDSCH receptions or CSI-RS associated with a PCI/PCI index other than the serving cell PCI/PCI index could be QCL'ed with the set of RSs in the TCI state indicated in the MAC CE command for beam indication, wherein the MAC CE command for beam indication indicates/configures/includes/provides an entity ID associated with/corresponding to the non-serving cell—e.g., the PCI/PCI index other than the serving cell PCI/PCI index.

Alternatively, DMRS antenna ports for PDCCH receptions, DMRS antenna ports for PDSCH receptions or CSI-RS associated with the serving cell PCI/PCI index could be QCL'ed with the set of RSs in the TCI state indicated in the MAC CE command for beam indication, wherein the MAC CE command for beam indication indicates/configures/includes/provides an entity ID associated with/corresponding to the non-serving cell—e.g., the PCI/PCI index other than the serving cell PCI/PCI index, and DMRS antenna ports for PDCCH receptions, DMRS antenna ports for PDSCH receptions or CSI-RS associated with the PCI/PCI index other than the serving cell PCI/PCI index could be QCL'ed with the set of RSs in the TCI state indicated in the MAC CE command for beam indication, wherein the MAC CE command for beam indication indicates/configures/includes/provides an entity ID associated with/corresponding the serving cell—e.g., the serving cell PCI/PCI index.

In yet another example, the Option-VIIIa based TCI state indication could be applied for one or more DL channels/signals. That is, DMRS antenna ports for PDCCH receptions, DMRS antenna ports for PDSCH receptions or CSI-RS associated with the first entity ID—and therefore, the associated/corresponding cell (e.g., the serving cell/TRP having the serving cell PCI/PCI index or a non-serving cell/TRP having a PCI/PCI index other than the serving cell PCI/PCI index) —could be QCL'ed with the set of RSs in the first (or second) TCI state indicated in the MAC CE command for beam indication, wherein the first (or second) TCI state is associated with the first (or second) entity ID, DMRS antenna ports for PDSCH receptions or CSI-RS associated with the second entity ID—and therefore, the associated/corresponding cell (e.g., the serving cell/TRP having the serving cell PCI/PCI index or a non-serving cell/TRP having a PCI/PCI index other than the serving cell PCI/PCI index)—could be QCL'ed with the set of RSs in the second (or first) TCI state indicated in the MAC CE command for beam indication, wherein the second (or first) TCI state is associated with the second (or first) entity ID.

Alternatively, DMRS antenna ports for PDCCH receptions, DMRS antenna ports for PDSCH receptions or CSI-RS associated with the first entity ID—and therefore, the associated/corresponding cell (e.g., the serving cell/TRP having the serving cell PCI/PCI index or a non-serving cell/TRP having a PCI/PCI index other than the serving cell PCI/PCI index)—could be QCL'ed with the set of RSs in the first (or second) TCI state indicated in the MAC CE command for beam indication, wherein the first (or second) TCI state is associated with the second (or first) entity ID, and DMRS antenna ports for PDCCH receptions, DMRS antenna ports for PDSCH receptions or CSI-RS associated with the second entity ID—and therefore, the associated/corresponding cell (e.g., the serving cell/TRP having the serving cell PCI/PCI index or a non-serving cell/TRP having a PCI/PCI index other than the serving cell PCI/PCI index)—could be QCL'ed with the set of RSs in the second (or first) TCI state indicated in the MAC CE command for beam indication, wherein the second (or first) TCI state is also associated with the first (or second) entity ID.

As aforementioned, an entity ID could correspond to a PCI, a PCI index pointing to an entry/PCI in a list of PCIs that are higher layer configured to the UE, a one-bit indicator with ‘0’ (or ‘1’) indicating the serving cell PCI/PCI index and ‘1’ (or ‘0’) indicating a PCI/PCI index other than the serving cell PCI/PCI index, a multi-bit indicator with each bit index corresponding to a PCI/PCI index, PCI index 0 for the serving cell/TRP, a CORESETPoolIndex, a CORESETGroupIndex, a CORESET ID, a resource set ID/index, a resource ID/index, a TRP-specific ID/index or a TRP-specific higher layer signaling index/ID.

In one example of design example 1.A.1, the UE could be first higher layer configured by the network, e.g., via the higher layer RRC parameter PDSCH-Config/PDCCH-Config, N_s>1 lists/pools of TCI states with each list/pool of TCI state(s) containing at least one TCI state. Each TCI state contains a QCL source RS associated with either the serving cell/TRP or a non-serving cell/TRP (or neighboring cell/TRP). The TCI state indices/IDs and/or the bit-width used for representing the TCI state indices/IDs could be separately determined within each list/pool of TCI states.

In this design example, a list/pool of TCI states could correspond to or configured as a TCI state group discussed in the design example 1.A.2. Furthermore, a list/pool of TCI states could be associated/configured with a unique list/pool ID—e.g., a higher layer parameter TCIState-List that configures the list/pool of TCI states could indicate/include/contain/configure/comprise the corresponding TCI state list/pool ID denoted by TCIState-ListId. For instance, if two lists/pools of TCI states/TCI state IDs—denoted as a first list/pool of TCI states and a second list/pool of TCI states—are configured according to the above discussions, the first TCI state list/pool could be associated/configured with a first TCI state list/pool ID (e.g., the higher layer parameter TCIState-List1 that configures the first list/pool of TCI states could comprise/include/indicate/contain/configure the first TCI state list/pool ID—e.g., denoted by TCIState-ListId1), and the second TCI state list/pool could be associated/configured with a second TCI state list/pool ID (e.g., the higher layer parameter TCIState-List2 that configures the second list/pool of TCI states could comprise/include/indicate/contain/configure the second TCI state list/pool ID—e.g., denoted by TCIState-ListId2).

Alternatively, one or more of the configured N_s lists/pools of TCI states/TCI state IDs—e.g., the first and second lists/pools of TCI states/TCI state IDs—could be associated/configured with a same/single TCI state list/pool ID. For instance, the higher layer parameter (e.g., TCIState-List, TCIState-List1 or TCIState-List2) that configures the one or more TCI state lists/pools (e.g., the first and second lists/pools of TCI states/TCI state IDs) could contain/configure/include/indicate/comprise a same/single TCI state list/pool ID, e.g., denoted as TCIState-ListId, TCIState-ListId1 or TCIState-ListId2. The UE could be configured by the network, e.g., via the higher layer parameter ControlResourceSet, up to N_cand; ≥1 candidate TCI states—selected from a list/pool of TCI states—for each control resource set (CORESET), where the QCL source RSs in one or more of the candidate TCI states configured in the higher layer parameter ControlResourceSet could be associated with either the serving cell/TRP or a non-serving cell/TRP (or neighboring cell/TRP).

The UE could then receive from the network a MAC CE command to indicate one of the candidate TCI states for the corresponding CORESET/PDCCH transmitted from/associated with either the serving cell/TRP or the non-serving cell/TRP (or neighboring cell/TRP). For the multi-TRP operation, the UE could receive from the network more than one MAC CE commands for the PDCCH beam indication. For an inter-cell multi-TRP system comprising of two coordinating TRPs, the UE could receive from the network two separate MAC CE commands to indicate the TCI states for the PDCCHs transmitted from the serving cell/TRP and the non-serving cell/TRP (or neighboring cell/TRP).

FIG. 9E illustrates an example of higher layer configured two lists of TCI states 940 according to embodiments of the present disclosure. An embodiment of the higher layer configured two lists of TCI states 940 shown in FIG. 9E is for illustration only.

In FIG. 9E, an example of configuring N_s=2 lists/pools of TCI states in the higher layer parameter PDSCH-Config/PDCCH-Config is presented. A first list/pool of TCI states contains a total of M_tci TCI states, and a second list of TCI states contains a total of (N_tci−M_tci) TCI states. In this example, the TCI state indices/IDs and/or the bit-width used for representing the TCI state indices/IDs are separately determined within each list/pool of TCI states. As shown in FIG. 9E, the TCI states in the first list/pool of TCI states are indexed as #1, #2, . . . , #M_tci or the TCI state IDs in the first list/pool of TCI states are #1, #2, . . . , #M_tci; the TCI states in the second list/pool of TCI states are indexed as #1, #2, . . . , #(N_tci−M_tci) or the TCI state IDs in the second list/pool of TCI states are #1, #2, . . . , #(N_tci−M_tci).

A distinct TCI state group ID could be associated with/configured for a list/pool of TCI states configured in the higher layer parameter PDSCH-Config. For the example shown in FIG. 9E, two TCI state group IDs ‘0’ and ‘1’ could be defined with TCI state group ID ‘0’ associated with the first list/pool of TCI states and TCI state group ID ‘1’ associated with the second list/pool of TCI states. In the present disclosure, a TCI state group ID could correspond to a CORESETPoolIndex—e.g., values 0 and/or 1 provided in PDCCH-Config, a CORESETGroupIndex—e.g., values 0 and/or 1 provided in PDCCH-Config, a PCI value, a PCI index pointing to an entry/PCI in a list of PCIs (or PCI values) higher layer configured to the UE, a resource set index/ID, a CORESET ID, a resource index/ID, a TRP-specific ID/index, a TRP-specific higher layer signaling index/ID, a one-bit/multi-bit indicator or etc.

Each TCI state group ID, and therefore, the TCI states in the corresponding list/pool of TCI states configured in the higher layer parameter PDSCH-config could be associated with/mapped to a PCI for either the serving cell/TRP or a non-serving cell/TRP (or neighboring cell/TRP). The UE could be indicated by the network the association between the TCI state group ID values and the PCI values for the serving/non-serving (or neighboring) cells/TRPs.

In one example, the UE could be explicitly indicated by the network, e.g., via higher layer RRC signaling and/or MAC CE command and/or dynamic DCI signaling, the exact association/mapping between the TCI state group ID values and the PCI values for the serving/non-serving (or neighboring) cells/TRPs in the inter-cell multi-TRP system. For example, the UE could be first higher layer configured by the network a list/set of two PCIs for the serving/non-serving (or neighboring) cells/TRPs; the TCI state group ID value “0” could be mapped to/associated with the first entry in the list/set of two PCIs for the serving/non-serving (or neighboring) cells/TRPs, while the TCI state group ID value “1” could be mapped to/associated with the second entry in the list/set of two PCIs for the serving/non-serving (or neighboring) cells/TRPs. For more than two configured TCI state group ID values (e.g., 0, 1, . . . , L_idx−1 with L_idx>2), the UE could be first higher layer configured by the network a list/set of at least L_idx PCIs for the serving/non-serving (or neighboring) cells/TRPs in the inter-cell multi-TRP system. The UE could then be indicated by the network the association/mapping between the L_idx TCI state group ID values and the PCIs in the higher layer configured list/set of PCIs. Other indication methods, e.g., via higher layer RRC signaling and/or MAC CE command and/or dynamic DCI signaling, of the exact association/mapping between the TCI state group ID values and the PCI values for the serving/non-serving (or neighboring) cells/TRPs in the inter-cell multi-TRP system are also possible.

In another example, the UE could be implicitly indicated by the network the association/mapping between the TCI state group ID values and the PCI values for the serving/non-serving (or neighboring) cells/TRPs in the inter-cell multi-TRP system. For example, the UE could be indicated by the network that the TCI state group ID value “0” could be mapped to/associated with the lowest PCI value configured to the UE, while the TCI state group ID value “1” could be mapped to/associated with the highest PCI value configured to the UE. For more than two configured TCI state group ID values (e.g., 0, 1, . . . , L_idx−1 with L_idx>2), the UE could be indicated by the network that the lowest TCI state group ID value could be mapped to/associated with the lowest PCI value configured for the UE, the second lowest TCI state group ID value could be mapped to/associated with the second lowest PCI value configured for the UE, and so on, and the L_idx-th highest TCI state group ID value could be mapped to/associated with the L_idx-th highest PCI value configured for the UE. Other implicit indication methods of the association/mapping between the TCI state group ID values and the PCI values for the serving/non-serving (or neighboring) cells/TRPs in the inter-cell multi-TRP system are also possible.

In yet another example, the UE could be first higher layer configured by the network the mapping/association between one or more PCI values and the TCI state group ID values; the UE could then receive from the network one or more MAC CE commands to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first MAC CE command activating at least one PCI from the first set of PCIs corresponding to/associated with the TCI state group ID value “0.” The UE could also receive from the network a second MAC CE command activating at least one PCI from the second set of PCIs corresponding to/associated with the TCI state group ID value “1.”

Alternatively, the UE could receive from the network a single MAC CE command activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first MAC CE command activating at least one PCI from the first set of PCIs corresponding to/associated with the TCI state group ID value “0,” a second MAC CE command activating at least one PCI from the second set of PCIs corresponding to/associated with the TCI state group ID value “1,” and so on, and a L_idx-th MAC CE command activating at least one PCI from the L_idx-th set of PCIs corresponding to/associated with the TCI state group ID value “L_idx−1.”

Alternatively, the UE could receive from the network a single MAC CE command activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be first higher layer configured by the network the mapping/association between one or more PCI values and the TCI state group ID values; the UE could then receive from the network one or more bitmaps to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first bitmap with each entry/bit in the first bitmap corresponding to/associated with a distinct entry in the first set of PCIs corresponding to/associated with the TCI state group ID value “0”; if an entry/bit in the first bitmap is set to “1,” the corresponding/associated entry in the first set of PCIs corresponding to/associated with the TCI state group ID value “0” is activated as the PCI corresponding to/associated with the TCI state group ID value “0” for the inter-cell multi-TRP operation. The UE could also receive from the network a second bitmap with each entry/bit in the second bitmap corresponding to/associated with a distinct entry in the second set of PCIs corresponding to/associated with the TCI state group ID value “1”; if an entry/bit in the second bitmap is set to “1,” the corresponding/associated entry in the second set of PCIs corresponding to/associated with the TCI state group ID value “1” is activated as the PCI corresponding to/associated with the TCI state group ID value “1” for the inter-cell multi-TRP operation.

Alternatively, the UE could receive from the network a single bitmap activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first bitmap activating at least one PCI from the first set of PCIs corresponding to/associated with the TCI state group ID value “0,” a second bitmap activating at least one PCI from the second set of PCIs corresponding to/associated with the TCI state group ID value “1,” and so on, and a L_idx-th bitmap activating at least one PCI from the L_idx-th set of PCIs corresponding to/associated with the TCI state group ID value “L_idx−1.”

Alternatively, the UE could receive from the network a single bitmap activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be indicated by the network that the TCI state group ID value “0” is associated with the serving cell/TRP (and/or its corresponding PCI). For a TCI state group ID value other than value “0,” e.g., value “1”: for example, the UE could be indicated by the network, e.g., via higher layer RRC signaling and/or MAC CE command and/or dynamic DCI signaling, the exact non-serving (or neighboring) cell/TRP PCI value associated with the TCI state group ID value; for another example, the UE could be indicated by the network that the TCI state group ID value could be associated with the lowest (or the highest) non-serving (or neighboring) cell/TRP PCI value configured for the UE; yet for another example, (i) the UE could be higher layer configured by the network a list/set of PCIs corresponding to/associated with the TCI state group ID value, and (ii) the UE could receive from the network a MAC CE command activating at least one PCI from the higher layer configured list/set of PCIs corresponding to/associated with the TCI state group ID value; yet for another example, (i) the UE could be higher layer configured by the network a list/set of PCIs corresponding to/associated with the TCI state group ID value, and (ii) the UE could receive from the network a bitmap activating at least one PCI from the higher layer configured list/set of PCIs corresponding to/associated with the TCI state group ID value.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values. In this design example, if a beam associated with the i-th PCI is activated, the (i+1)-th, the (i+2)-th, . . . , and the (i+K_idx−1)-th entries in the set/list/pool of PCIs (or equivalently, the (i+1)-th PCI, the (i+2)-th PCI, . . . , and the (i+K_idx−1)-th PCI) along with the corresponding TCI state group ID values could be activated, and/or, the (i−K_idx+1)-th, the (i−K_idx+2)-th, . . . , and the (i−1)-th entries in the set/list/pool of PCIs (or equivalently, the (i−K_idx+1)-th PCI, the (i−K_idx+2)-th PCI, . . . , and the (i−1)-th PCI) along with the corresponding TCI state group ID values could be deactivated.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 4-th PCI (associated with the TCI state group ID value “0”) and the 5-th PCI (associated with the TCI state group ID value “1”) are activated. At the same time, the 1-st PCI (associated with the TCI state group ID value “0”) and the 2-nd PCI (associated with the TCI state group ID value “1”) are deactivated.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values. In this design example, if a beam associated with the i-th PCI is activated, the (i-floor((K_idx−1)/2))-th, the (i-floor((K_idx−1)/2)+1)-th, . . . , and the (i+ceil((K_idx−1)/2))-th entries in the set/list/pool of PCIs (or equivalently, the (i-floor((K_idx−1)/2))-th PCI, the (i-floor((K_idx−1)/2)+1)-th PCI, . . . , and the (i+ceil((K_idx−1)/2))-th PCI) along with the corresponding TCI state group ID values could be activated, or, the (i-ceil((K_idx−1)/2))-th, the (i-floor((K_idx−1)/2)+1)-th, . . . , and the (i+floor((K_idx−1)/2))-th entries in the set/list/pool of PCIs (or equivalently, the (i-ceil((K_idx−1)/2))-th PCI, the (i-floor((K_idx−1)/2)+1)-th PCI, . . . , and the (i+floor((K_idx−1)/2))-th PCI) along with the corresponding TCI state group ID values could be activated, where floor(x) returns the largest integer that is smaller than or equal to x and ceil(x) returns the smallest integer that is greater than or equal to x. The starting/initial activated cells could be the (i−G)-th, the (i−G+1)-th, . . . , the i-th, . . . , the (i−G+K_idx−1)-th entries in the set/list/pool of PCIs (or equivalently, the (i−G)-th PCI, the (i−G+1)-th PCI, . . . , the i-th PCI, . . . , the (i−G+K_idx−1)-th PCI); their corresponding/associated TCI state group ID values are also activated. Here, the value of G could be higher layer configured to the UE by the network and/or fixed per RRC configuration.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 2-nd PCI (associated with the TCI state group ID value “1”) and the 4-th PCI (associated with the TCI state group ID value “0”) are activated.

In addition to Option-0, Option-1, Option-1a, Option-2, Option-2a, Option-3, Option-4, Option-4a, Option-5, Option-6 and Option-6a based (candidate) TCI states configuration, in one example of Option-7, the higher layer parameter ControlResourceSet could include the TCI state group ID value(s). If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDCCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH is transmitted. In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RSs in all the candidate TCI states configured in the higher layer parameter ControlResourceSet are transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RSs in all the candidate TCI states configured in the higher layer parameter ControlResourceSet are transmitted.

FIG. 9F illustrates yet another example of MAC CE based beam indication 950 according to embodiments of the present disclosure. An embodiment of the MAC CE based beam indication 950 shown in FIG. 9F is for illustration only.

In addition to Option-I, Option-Ia, Option-II, Option-IIa, Option-III, Option-IV, Option-IVa, Option-V, Option-VI, Option-VII, Option-VIII and Option-VIIIa based TCI state indication, in one example of Option-IX, the MAC CE command for beam indication could also include the TCI state group ID value(s). A conceptual example of the MAC CE command comprising of the TCI state group ID value is given in FIG. 9F. Under this setting, upon receiving the MAC CE command, the UE could identify the serving/non-serving (or neighboring) cell/TRP information/identification via the TCI state group ID value(s) indicated/configured in the MAC CE command.

If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the corresponding PDCCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH is transmitted. In addition, the UE could also identify whether the QCL source RS in the indicated TCI state is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS in the indicated TCI state is transmitted.

Option-IX could correspond to or be equivalent to Option-VIII if the TCI state group ID here is the same as the entity ID in the design Option-VIII. Furthermore, the MAC CE command for beam indication could include/indicate/contain/comprise more than one TCI state group IDs, which could correspond to or be equivalent to Option-VIIIa in the present disclosure if the TCI state group IDs here are the same as the entity IDs in the design Option-VIIIa.

In this design example, the Option-0 based candidate TCI states configuration for the PDCCH, wherein one or more candidate TCI states (and therefore, the QCL source RSs indicated therein) and/or the corresponding PDCCH(s) could be transmitted from/associated with either the serving cell/TRP (and/or its PCI value) or the non-serving cell(s)/TRP(s) (or neighboring cell(s)/TRP(s)) (and/or the corresponding PCI value(s)), and/or the Option-1 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the CORESETPoolIndex value (if configured) in the higher layer parameter ControlResourceSet, and/or the Option-2 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the one-bit flag indicator in the higher layer parameter ControlResourceSet, and/or the Option-3 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the multi-bit indicator in the higher layer parameter ControlResourceSet, and/or the Option-4 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the PCI value in the higher layer parameter ControlResourceSet, and/or the Option-5 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the serving/non-serving (or neighboring) cells/TRPs information indicated in the candidate TCI state(s) in the higher layer parameter ControlResourceSet, and/or the Option-6 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the TCI state group ID value in the higher layer parameter ControlResourceSet, could be applied.

In one example, the Option-I based TCI state indication for the PDCCH could be applied, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the CORESETPoolIndex value (if configured) in the MAC CE command.

In another example, the Option-II based TCI state indication for the PDCCH could be applied, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the one-bit flag indicator in the MAC CE command.

In yet another example, the Option-III based TCI state indication for the PDCCH is used, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the multi-bit indicator in the MAC CE command.

In yet another example, the Option-IV based TCI state indication for the PDCCH is used, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the PCI value in the MAC CE command.

In yet another example, the Option-V based TCI state indication for the PDCCH is used, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the SCI value in the MAC CE command.

In yet another example, the Option-VI based TCI state indication for the PDCCH is used, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the association between the one-bit flag indicator and/or the multi-bit indicator and/or the PCI value(s) indicated in the higher layer parameter ControlResourceSet and the CORESET ID in the MAC CE command.

In yet another example, the Option-VII based TCI state indication for the PDCCH could be applied, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the serving/non-serving (or neighboring) cells/TRPs information indicated in the TCI state indicated in the MAC CE command.

In yet another example, the Option-VIII based TCI state indication for the PDCCH is used, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the TCI state group ID value in the MAC CE command.

In one example of design example 1.A.2, the UE could be first higher layer configured by the network, e.g., via the higher layer RRC parameter PDSCH-Config, N_s>1 lists/pools of TCI states with each list/pool of TCI state(s) containing at least one TCI state. Each TCI state contains a QCL source RS associated with either the serving cell/TRP or a non-serving cell/TRP (or neighboring cell/TRP). The TCI state indices/IDs and/or the bit-width used for representing the TCI state indices/IDs could be determined across all N_s lists/pools of TCI states and/or one or more of all N_s lists/pools of TCI states.

In this design example, a list/pool of TCI states could correspond to or configured as a TCI state group discussed in the design example 1.A.2. Furthermore, a list/pool of TCI states could be associated/configured with a unique list/pool ID—e.g., a higher layer parameter TCIState-List that configures the list/pool of TCI states could indicate/include/contain/configure/comprise the corresponding TCI state list/pool ID denoted by TCIState-ListId. For instance, if two lists/pools of TCI states/TCI state IDs—denoted as a first list/pool of TCI states and a second list/pool of TCI states—are configured according to the above discussions, the first TCI state list/pool could be associated/configured with a first TCI state list/pool ID (e.g., the higher layer parameter TCIState-List1 that configures the first list/pool of TCI states could comprise/include/indicate/contain/configure the first TCI state list/pool ID—e.g., denoted by TCIState-ListId1), and the second TCI state list/pool could be associated/configured with a second TCI state list/pool ID (e.g., the higher layer parameter TCIState-List2 that configures the second list/pool of TCI states could comprise/include/indicate/contain/configure the second TCI state list/pool ID—e.g., denoted by TCIState-ListId2).

Alternatively, one or more of the configured N_s lists/pools of TCI states/TCI state IDs—e.g., the first and second lists/pools of TCI states/TCI state IDs—could be associated/configured with a same/single TCI state list/pool ID. For instance, the higher layer parameter (e.g., TCIState-List, TCIState-List1 or TCIState-List2) that configures the one or more TCI state lists/pools (e.g., the first and second lists/pools of TCI states/TCI state IDs) could contain/configure/include/indicate/comprise a same/single TCI state list/pool ID, e.g., denoted as TCIState-ListId, TCIState-ListId1 or TCIState-ListId2.

The UE could be configured by the network, e.g., via the higher layer parameter ControlResourceSet, up to N_cand≥1 candidate TCI states—selected from a list/pool of TCI states—for each control resource set (CORESET), where the QCL source RSs in all the candidate TCI states configured in the higher layer parameter ControlResourceSet could be associated with either the serving cell/TRP or a non-serving cell/TRP (or neighboring cell/TRP). The UE could then receive from the network a MAC CE command to indicate one of the candidate TCI states for the corresponding CORESET/PDCCH transmitted from/associated with either the serving cell/TRP or the non-serving cell/TRP (or neighboring cell/TRP).

For the multi-TRP operation, the UE could receive from the network more than one MAC CE commands for the PDCCH beam indication. For an inter-cell multi-TRP system comprising of two coordinating TRPs, the UE could receive from the network two separate MAC CE commands to indicate the TCI states for the PDCCHs transmitted from the serving cell/TRP and the non-serving cell/TRP (or neighboring cell/TRP).

FIG. 9G illustrates another example of higher layer configured two lists of TCI states 960 according to embodiments of the present disclosure. An embodiment of the higher layer configured two lists of TCI states 960 shown in FIG. 9G is for illustration only.

In FIG. 9G, an example of configuring N_s=2 lists/pools of TCI states in the higher layer parameter PDSCH-config is presented. A first list/pool of TCI states contains a total of M_tci TCI states, and a second list of TCI states contains a total of (N_tci−M_tci) TCI states. In this example, the TCI state indices/IDs and/or the bit-width used for representing the TCI state indices/IDs are determined across all N_s=2 lists/pools of TCI states. As shown in FIG. 9G, the TCI states in the first list/pool of TCI states are indexed as #1, #2, . . . , #M_tci or the TCI state IDs in the first list/pool of TCI states are #1, #2, . . . , #M_tci; the TCI states in the second list/pool of TCI states are indexed as #(M_tci+1), #(M_tci+2), . . . , #N_tci or the TCI state IDs in the second list/pool of TCI states are #(M_tci+1), #(M_tci+2), . . . , #N_tci.

A distinct TCI state group ID could be associated with a list/pool of TCI states configured in the higher layer parameter PDSCH-config. For the example shown in FIG. 9G, two TCI state IDs ‘0’ and ‘1’ could be defined with TCI state group ID ‘0’ associated with the first list/pool of TCI states and TCI state group ID ‘1’ associated with the second list/pool of TCI states. In the present disclosure, a TCI state group ID could correspond to a CORESETPoolIndex—e.g., values 0 and/or 1 provided in PDCCH-Config, a CORESETGroupIndex—e.g., values 0 and/or 1 provided in PDCCH-Config, a PCI value, a PCI index pointing to an entry/PCI in a list of PCIs (or PCI values) higher layer configured to the UE, a resource set index/ID, a CORESET ID, a resource index/ID, a TRP-specific ID/index, a TRP-specific higher layer signaling index/ID, a one-bit/multi-bit indicator or etc.

Each TCI state group ID, and therefore, the TCI states in the corresponding list/pool of TCI states configured in the higher layer parameter PDSCH-config could be associated with/mapped to a PCI for either the serving cell/TRP or a non-serving cell/TRP (or neighboring cell/TRP). The UE could be indicated by the network the association between the TCI state group ID values and the PCI values for the serving/non-serving (or neighboring) cells/TRPs.

In one example, the UE could be explicitly indicated by the network, e.g., via higher layer RRC signaling and/or MAC CE command and/or dynamic DCI signaling, the exact association/mapping between the TCI state group ID values and the PCI values for the serving/non-serving (or neighboring) cells/TRPs in the inter-cell multi-TRP system. For example, the UE could be first higher layer configured by the network a list/set of two PCIs for the serving/non-serving (or neighboring) cells/TRPs; the TCI state group ID value “0” could be mapped to/associated with the first entry in the list/set of two PCIs for the serving/non-serving (or neighboring) cells/TRPs, while the TCI state group ID value “1” could be mapped to/associated with the second entry in the list/set of two PCIs for the serving/non-serving (or neighboring) cells/TRPs. For more than two configured TCI state group ID values (e.g., 0, 1, . . . , L_idx−1 with L_idx>2), the UE could be first higher layer configured by the network a list/set of at least L_idx PCIs for the serving/non-serving (or neighboring) cells/TRPs in the inter-cell multi-TRP system.

The UE could then be indicated by the network the association/mapping between the L_idx TCI state group ID values and the PCIs in the higher layer configured list/set of PCIs. Other indication methods, e.g., via higher layer RRC signaling and/or MAC CE command and/or dynamic DCI signaling, of the exact association/mapping between the TCI state group ID values and the PCI values for the serving/non-serving (or neighboring) cells/TRPs in the inter-cell multi-TRP system are also possible.

In another example, the UE could be implicitly indicated by the network the association/mapping between the TCI state group ID values and the PCI values for the serving/non-serving (or neighboring) cells/TRPs in the inter-cell multi-TRP system. For example, the UE could be indicated by the network that the TCI state group ID value “0” could be mapped to/associated with the lowest PCI value configured to the UE, while the TCI state group ID value “1” could be mapped to/associated with the highest PCI value configured to the UE. For more than two configured TCI state group ID values (e.g., 0, 1, . . . , L_idx−1 with L_idx>2), the UE could be indicated by the network that the lowest TCI state group ID value could be mapped to/associated with the lowest PCI value configured for the UE, the second lowest TCI state group ID value could be mapped to/associated with the second lowest PCI value configured for the UE, and so on, and the L_idx-th highest TCI state group ID value could be mapped to/associated with the L_idx-th highest PCI value configured for the UE. Other implicit indication methods of the association/mapping between the TCI state group ID values and the PCI values for the serving/non-serving (or neighboring) cells/TRPs in the inter-cell multi-TRP system are also possible.

In yet another example, the UE could be first higher layer configured by the network the mapping/association between one or more PCI values and the TCI state group ID values; the UE could then receive from the network one or more MAC CE commands to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first MAC CE command activating at least one PCI from the first set of PCIs corresponding to/associated with the TCI state group ID value “0.” The UE could also receive from the network a second MAC CE command activating at least one PCI from the second set of PCIs corresponding to/associated with the TCI state group ID value “1.”

Alternatively, the UE could receive from the network a single MAC CE command activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first MAC CE command activating at least one PCI from the first set of PCIs corresponding to/associated with the TCI state group ID value “0,” a second MAC CE command activating at least one PCI from the second set of PCIs corresponding to/associated with the TCI state group ID value “1,” and so on, and a L_idx-th MAC CE command activating at least one PCI from the L_idx-th set of PCIs corresponding to/associated with the TCI state group ID value “L_idx−1.”

Alternatively, the UE could receive from the network a single MAC CE command activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be first higher layer configured by the network the mapping/association between one or more PCI values and the TCI state group ID values; the UE could then receive from the network one or more bitmaps to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first bitmap with each entry/bit in the first bitmap corresponding to/associated with a distinct entry in the first set of PCIs corresponding to/associated with the TCI state group ID value “0”; if an entry/bit in the first bitmap is set to “1,” the corresponding/associated entry in the first set of PCIs corresponding to/associated with the TCI state group ID value “0” is activated as the PCI corresponding to/associated with the TCI state group ID value “0” for the inter-cell multi-TRP operation. The UE could also receive from the network a second bitmap with each entry/bit in the second bitmap corresponding to/associated with a distinct entry in the second set of PCIs corresponding to/associated with the TCI state group ID value “1”; if an entry/bit in the second bitmap is set to “1,” the corresponding/associated entry in the second set of PCIs corresponding to/associated with the TCI state group ID value “1” is activated as the PCI corresponding to/associated with the TCI state group ID value “1” for the inter-cell multi-TRP operation.

Alternatively, the UE could receive from the network a single bitmap activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first bitmap activating at least one PCI from the first set of PCIs corresponding to/associated with the TCI state group ID value “0,” a second bitmap activating at least one PCI from the second set of PCIs corresponding to/associated with the TCI state group ID value “1,” and so on, and a L_idx-th bitmap activating at least one PCI from the L_idx-th set of PCIs corresponding to/associated with the TCI state group ID value “L_idx−1.”

Alternatively, the UE could receive from the network a single bitmap activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be indicated by the network that the TCI state group ID value “0” is associated with the serving cell/TRP (and/or its corresponding PCI). For a TCI state group ID value other than value “0,” e.g., value “1”: for example, the UE could be indicated by the network, e.g., via higher layer RRC signaling and/or MAC CE command and/or dynamic DCI signaling, the exact non-serving (or neighboring) cell/TRP PCI value associated with the TCI state group ID value; for another example, the UE could be indicated by the network that the TCI state group ID value could be associated with the lowest (or the highest) non-serving (or neighboring) cell/TRP PCI value configured for the UE; yet for another example, (i) the UE could be higher layer configured by the network a list/set of PCIs corresponding to/associated with the TCI state group ID value, and (ii) the UE could receive from the network a MAC CE command activating at least one PCI from the higher layer configured list/set of PCIs corresponding to/associated with the TCI state group ID value; yet for another example, (i) the UE could be higher layer configured by the network a list/set of PCIs corresponding to/associated with the TCI state group ID value, and (ii) the UE could receive from the network a bitmap activating at least one PCI from the higher layer configured list/set of PCIs corresponding to/associated with the TCI state group ID value.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values. In this design example, if a beam associated with the i-th PCI is activated, the (i+1)-th, the (i+2)-th, . . . , and the (i+K_idx−1)-th entries in the set/list/pool of PCIs (or equivalently, the (i+1)-th PCI, the (i+2)-th PCI, . . . , and the (i+K_idx−1)-th PCI) along with the corresponding TCI state group ID values could be activated, and/or, the (i−K_idx+1)-th, the (i−K_idx+2)-th, . . . , and the (i−1)-th entries in the set/list/pool of PCIs (or equivalently, the (i−K_idx+1)-th PCI, the (i−K_idx+2)-th PCI, . . . , and the (i−1)-th PCI) along with the corresponding TCI state group ID values could be deactivated.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 4-th PCI (associated with the TCI state group ID value “0”) and the 5-th PCI (associated with the TCI state group ID value “1”) are activated. At the same time, the 1-st PCI (associated with the TCI state group ID value “0”) and the 2-nd PCI (associated with the TCI state group ID value “1”) are deactivated.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values. In this design example, if a beam associated with the i-th PCI is activated, the (i−floor((K_idx−1)/2))-th, the (i−floor((K_idx−1)/2)+1)-th, . . . , and the (i+ceil((K_idx−1)/2))-th entries in the set/list/pool of PCIs (or equivalently, the (i-floor((K_idx−1)/2))-th PCI, the (i−floor((K_idx−1)/2)+1)-th PCI, . . . , and the (i+ceil((K_idx−1)/2))-th PCI) along with the corresponding TCI state group ID values could be activated, or, the (i-ceil((K_idx−1)/2))-th, the (i−floor((K_idx−1)/2)+1)-th, . . . , and the (i+floor((K_idx−1)/2))-th entries in the set/list/pool of PCIs (or equivalently, the (i-ceil((K_idx−1)/2))-th PCI, the (i−floor((K_idx−1)/2)+1)-th PCI, . . . , and the (i+floor((K_idx−1)/2))-th PCI) along with the corresponding TCI state group ID values could be activated, where floor(x) returns the largest integer that is smaller than or equal to x and ceil(x) returns the smallest integer that is greater than or equal to x. The starting/initial activated cells could be the (i−G)-th, the (i−G+1)-th, . . . , the i-th, . . . , the (i−G+K_idx−1)-th entries in the set/list/pool of PCIs (or equivalently, the (i−G)-th PCI, the (i−G+1)-th PCI, . . . , the i-th PCI, . . . , the (i−G+K_idx−1)-th PCI); their corresponding/associated TCI state group ID values are also activated. Here, the value of G could be higher layer configured to the UE by the network and/or fixed per RRC configuration.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 2-nd PCI (associated with the TCI state group ID value “1”) and the 4-th PCI (associated with the TCI state group ID value “0”) are activated.

In addition to Option-0, Option-1, Option-1a, Option-2, Option-2a, Option-3, Option-4, Option-4a, Option-5, Option-6, Option-6a and Option-7 based (candidate) TCI states configuration, in one example of Option-8, the higher layer parameter ControlResourceSet may not include the TCI state group ID value(s)—different from the design example 1.A.1. The UE could identify the TCI state group ID value(s) from the candidate TCI states/TCI state IDs configured in the higher layer parameter ControlResourceSet because the TCI state IDs are determined across all N_s>1 lists/pools of TCI states. If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDCCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH is transmitted.

In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RSs in the candidate TCI states configured in the higher layer parameter ControlResourceSet are transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RSs in the candidate TCI states configured in the higher layer parameter ControlResourceSet are transmitted.

In addition to Option-I, Option-Ia, Option-II, Option-IIa, Option-III, Option-IV, Option-Iva, Option-V, Option-VI, Option-VII, Option-VIII, Option-VIIIa and Option-IX based TCI state indication, in one example of Option-X, upon receiving the MAC CE command, the UE could first identify the TCI state group ID value from the TCI state/TCI state ID indicated in the MAC CE command because the TCI state IDs are determined across all N_s>1 lists/pools of TCI states. If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDCCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH is transmitted.

In addition, the UE could also identify whether the QCL source RS in the indicated TCI state is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS in the indicated TCI state is transmitted.

In this design example, the Option-0 based candidate TCI states configuration for the PDCCH, wherein one or more candidate TCI states (and therefore, the QCL source RSs indicated therein) and/or the corresponding PDCCH(s) could be transmitted from/associated with either the serving cell/TRP (and/or its PCI value) or the non-serving cell(s)/TRP(s) (or neighboring cell(s)/TRP(s)) (and/or the corresponding PCI value(s)), and/or the Option-1 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the CORESETPoolIndex value (if configured) in the higher layer parameter ControlResourceSet, and/or the Option-2 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the one-bit flag indicator in the higher layer parameter ControlResourceSet, and/or the Option-3 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the multi-bit indicator in the higher layer parameter ControlResourceSet, and/or the Option-4 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the PCI value in the higher layer parameter ControlResourceSet, and/or the Option-5 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the serving/non-serving (or neighboring) cells/TRPs information indicated in the candidate TCI state(s) in the higher layer parameter ControlResourceSet, and/or the Option-6 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the TCI state group ID value in the higher layer parameter ControlResourceSet, and/or the Option-7 based candidate TCI states configuration for the PDCCH, wherein the UE could identify whether all the candidate TCI states (and therefore, the QCL source RSs indicated therein) and/or the corresponding PDCCH(s) are transmitted from/associated with either the serving cell/TRP (and/or its PCI value) or a non-serving cell/TRP (or neighboring cell/TRP) (and/or its PCI value) via the association between the TCI state ID value(s) in the higher layer parameter ControlResourceSet and the TCI state group ID value(s), could be applied.

In one example, the Option-I based TCI state indication for the PDCCH could be applied, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the CORESETPoolIndex value (if configured) in the MAC CE command.

In another example, the Option-II based TCI state indication for the PDCCH could be applied, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the one-bit flag indicator in the MAC CE command.

In yet another example, the Option-III based TCI state indication for the PDCCH is used, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the multi-bit indicator in the MAC CE command.

In yet another example, the Option-IV based TCI state indication for the PDCCH is used, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the PCI value in the MAC CE command.

In yet another example, the Option-V based TCI state indication for the PDCCH is used, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the SCI value in the MAC CE command.

In yet another example, the Option-VI based TCI state indication for the PDCCH is used, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the association between the one-bit flag indicator and/or the multi-bit indicator and/or the PCI value(s) indicated in the higher layer parameter ControlResourceSet and the CORESET ID in the MAC CE command.

In yet another example, the Option-VII based TCI state indication for the PDCCH could be applied, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the serving/non-serving (or neighboring) cells/TRPs information indicated in the TCI state indicated in the MAC CE command.

In yet another example, the Option-VIII based TCI state indication for the PDCCH is used, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the TCI state group ID value in the MAC CE command.

In yet another example, the Option-IX based TCI state indication for the PDCCH is used, wherein the UE could identify whether the indicated TCI state (and therefore, the QCL source RS indicated therein) and/or the corresponding PDCCH are transmitted from/associated with either the serving cell/TRP (and/or its PCI value) or a non-serving cell/TRP (or neighboring cell/TRP) (and/or its PCI value) via the association between the TCI state ID value(s) in the MAC CE command and the TCI state group ID value(s).

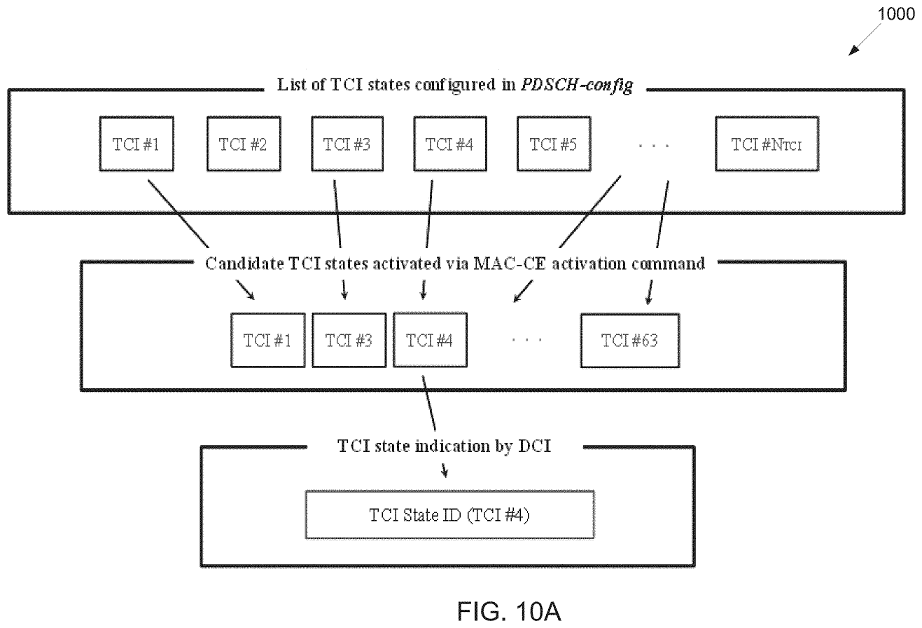

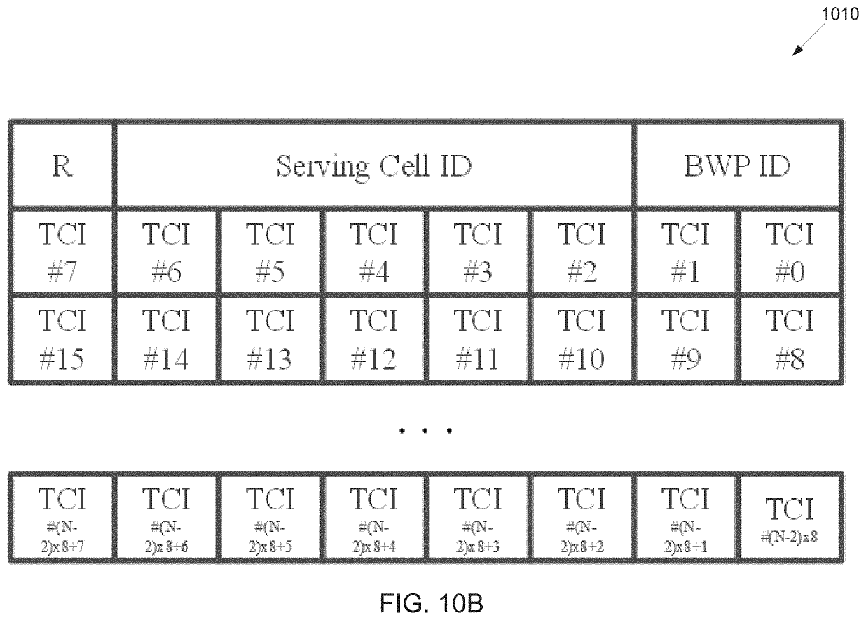

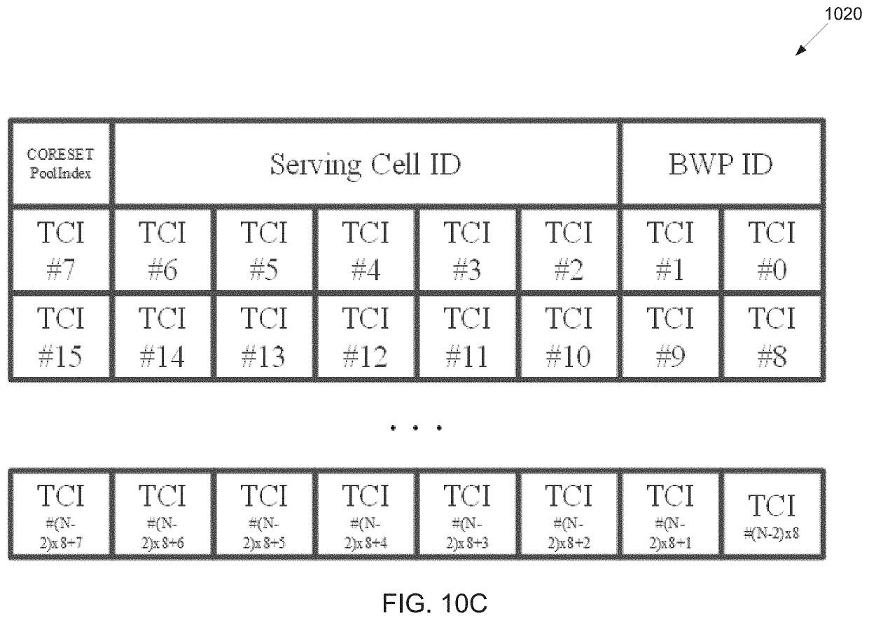

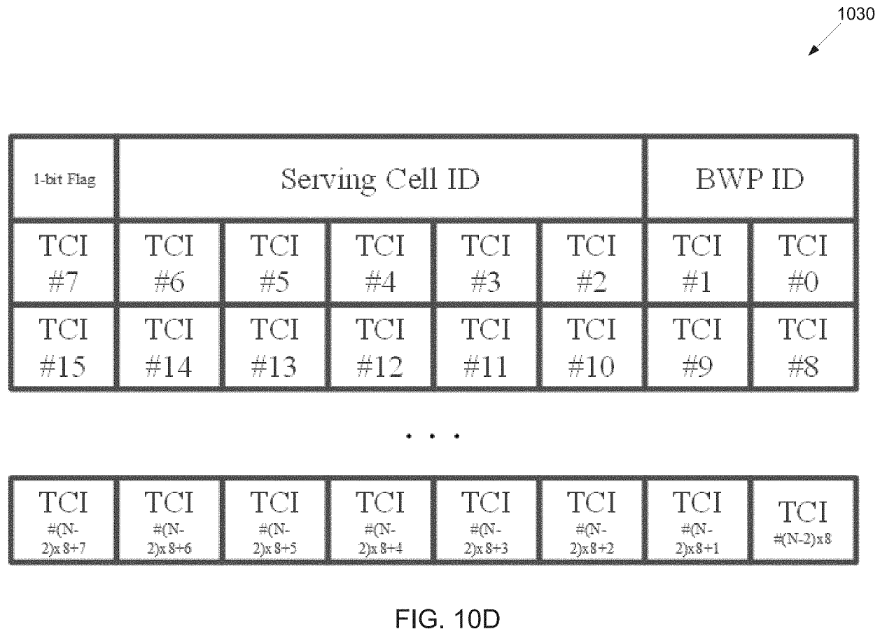

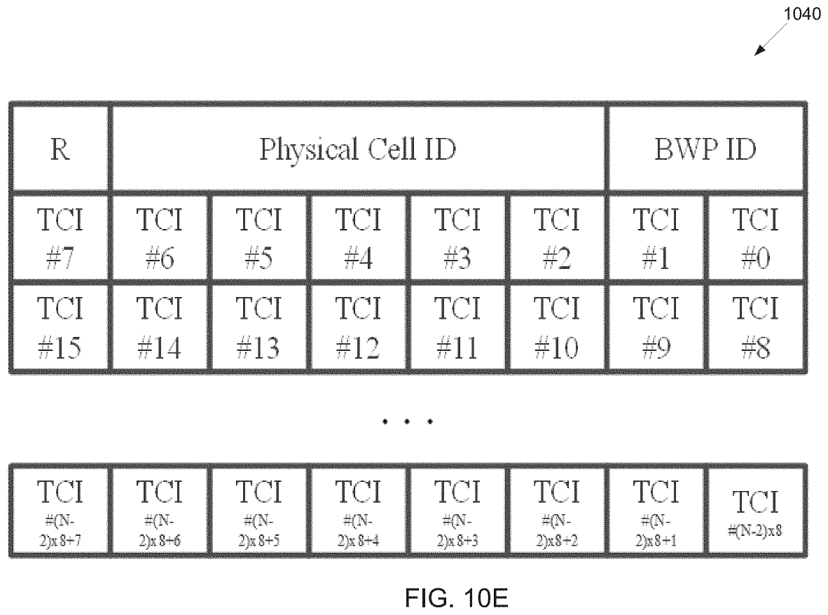

FIG. 10A illustrates another example of TCI state indication 1000 according to embodiments of the present disclosure. An embodiment of the TCI state indication 1000 shown in FIG. 10A is for illustration only.

In one example of design example 1.B.0, in FIG. 10A, an example of TCI state indication for a DL channel/signal transmitted from/associated with either the serving cell/TRP or a non-serving cell/TRP (or neighboring cell/TRP) is presented. As shown in FIG. 10A, the UE could be first higher layer configured by the network, e.g., via the higher layer parameter PDSCH-Config/PDCCH-Config, a list/pool of N_tci TCI states, e.g., provided by higher layer parameter TCIState-List. Each TCI state contains one or more QCL source RSs transmitted from/associated with either the serving cell/TRP having the serving cell PCI/PCI index or a non-serving cell/TRP (or neighboring cell/TRP) having a PCI/PCI index other than the serving cell PCI/PCI index.

Furthermore, the higher layer parameter, e.g., PDSCH-Config/PDCCH-Config, that configures the list/pool of N_tci TCI states could also indicate/include/contain/configure one or more entity IDs. In the present disclosure, an entity ID could correspond to a CORESETPoolIndex—e.g., values 0 and/or 1 provided in PDCCH-Config, a CORESETGroupIndex—e.g., values 0 and/or 1 provided in PDCCH-Config, a PCI value, a PCI index pointing to an entry/PCI in a list of PCIs (or PCI values) higher layer configured to the UE, a resource set index/ID, a CORESET ID, a resource index/ID, a TRP-specific ID/index, a TRP-specific higher layer signaling index/ID, a one-bit/multi-bit indicator or etc. Note that in the present disclosure, the PCI index for the serving cell could be 0.

The UE could be configured by the network, e.g., via the higher layer parameter ControlResourceSet or a higher layer parameter that configures a group of TCI states (e.g., TCIState-Group), up to N_cand≥1 (N_cand=64 in FIG. 10A) (candidate) TCI states (or their corresponding TCI state IDs) for each control resource set (CORESET) or each TCI state group, where the QCL source RSs in one or more of the (candidate) TCI states configured in the higher layer parameter ControlResourceSet or in a TCI state group, e.g., provided by TCIState-Group could be associated with either the serving cell/TRP having the serving cell PCI/PCI index or a non-serving cell/TRP (or neighboring cell/TRP) having a PCI/PCI index other than the serving cell PCI/PCI index.

For example, one or more of the (candidate) TCI states (or their corresponding TCI state IDs) configured for a CORESET or a TCI state group (e.g., provided by TCIState-Group) could be selected from the higher layer configured list/pool of N_tci TCI states. For another example, the UE could be higher layer configured by the network, e.g., via the higher layer RRC parameter PDSCH-Config/PDCCH-Config, the one or more (candidate) TCI states/TCI state IDs for a CORESET or for a TCI state group (e.g., provided by TCIState-Group). A TCI state group could be associated/configured with a unique TCI state group ID (e.g., the higher layer parameter TCIState-Group that configures a TCI state group could comprise/include/indicate/contain/configure a TCI state group ID—e.g., denoted by TCIState-GroupId).

Note that the UE could be indicated/configured by the network more than one (e.g., 2) TCI state groups (e.g., in form of TCI state IDs comprised/included/contained/configured in each TCI state group), wherein each TCI state group could comprise/contain/include one or more TCI states/TCI state IDs; as discussed above, (1) in one example, the one or more TCI states/TCI state IDs comprised/contained/included/configured/indicated in a TCI state group could be selected/determined from the higher layer RRC configured list/pool of N_tci TCI states/TCI state IDs, and/or (2) in another example, the UE could be higher layer configured by the network, e.g., via the higher layer RRC parameter PDSCH-Config/PDCCH-Config, the one or more TCI states/TCI state IDs for a TCI state group (e.g., provided by TCIState-Group).

Furthermore, the UE could also be indicated/configured by the network the number of TCI states/TCI state IDs in one or more of the configured TCI state groups; in addition, a TCI state group could be associated/configured with a unique TCI state group ID (e.g., the higher layer parameter TCIState-Group that configures a TCI state group could comprise/include/indicate/contain/configure a TCI state group ID—e.g., denoted by TCIState-GroupId); that is, if two TCI state groups—denoted as a first TCI state group and a second TCI state group—are configured according to the above discussions, the first TCI state group could be associated/configured with a first TCI state group ID (e.g., the higher layer parameter TCIState-Group1 that configures the first TCI state group could comprise/include/indicate/contain/configure the first TCI state group ID—e.g., denoted by TCIState-GroupId1), and the second TCI state group could be associated/configured with a second TCI state group ID (e.g., the higher layer parameter TCIState-Group2 that configures the second TCI state group could comprise/include/indicate/contain/configure the second TCI state group ID—e.g., denoted by TCIState-GroupId2).

Alternatively, one or more TCI state groups—e.g., the first and second TCI state groups as discussed above—could be associated/configured with a same/single TCI state group ID; for instance, the higher layer parameter (e.g., TCIState-Group, TCIState-Group 1 or TCIState-Group 2) that configures the one or more TCI state groups (e.g., the first and second TCI state groups) could contain/configure/include/indicate/comprise a same/single TCI state group ID, e.g., denoted as TCIState-GroupId, TCIState-GroupId1 or TCIState-GroupId2; the above configuration/indication could be via higher layer RRC signaling and/or MAC CE command and/or dynamic DCI based signaling.

The UE could then receive from the network one or more MAC CE activation commands each activating one or more TCI states/TCI state IDs from the higher layer configured list/pool of N_tci TCI states (e.g., provided by TCIState-List) or one or more TCI state groups (e.g., each provided by TCIState-Group). The one or more activated TCI states/TCI state IDs are mapped to one or more TCI codepoints, e.g., up to eight TCI codepoints as depicted in FIG. 8A, of a DCI format (e.g., DCI format 1_1 or 1_1 with or without DL assignment), where the QCL source RSs in all the candidate TCI states activated by the MAC CE activation command(s) could be transmitted from/associated with either the serving cell/TRP having the serving cell PCI/PCI index or a non-serving cell/TRP (or neighboring cell/TRP) having a PCI/PCI index other than the serving cell PCI/PCI index.

If the higher layer parameter tci-PresentInDCI configured for the UE is set as “enabled” for the CORESET/PDCCH that schedules the PDSCH (i.e., the TCI field is present in the corresponding DCI) and the time offset between the CORESET/PDCCH and the scheduled PDSCH is larger than a threshold (e.g., the threshold timeDuration-ForQCL is determined based on UE's capability indication), the TCI state/beam for the PDSCH could be indicated via the DCI (e.g., DCI format 1_1 or 1_2 with or without DL assignment). Otherwise, the TCI state/beam for the PDSCH could follow the TCI state/beam indicated for the corresponding PDCCH. For an inter-cell multi-TRP system comprising of at least two coordinating TRPs, the UE could receive from the network one or more (e.g., 2) MAC CE activation commands each activating one or more TCI states/TCI state IDs—from the higher layer configured list/pool of N_tci TCI states (e.g., provided by TCIState-List) or one or more TCI state groups (e.g., each provided by TCIState-Group)—for the DL channel(s)/signal(s) such as PDSCHs transmitted from the serving cell/TRP and the non-serving cell/TRP (or neighboring cell/TRP), and the UE could be indicated by the network one or more DCIs (e.g., DCI format 1_1 or 1_2 with or without DL assignment) each indicating one or more TCI states/TCI state IDs—e.g., selected from the one or more MAC CE activated TCI states/TCI state IDs—for the DL channel(s)/signal(s) such as PDSCHs transmitted from the serving cell/TRP and the non-serving cell/TRP (or neighboring cell/TRP).

In addition, each entity ID—if configured—provided in the higher layer parameter, e.g., PDSCH-Config/PDCCH-Config, that configures the list/pool of N_tci TCI state IDs could be associated with a TCI state group—if configured. For instance, the first (or last) entity ID or the lowest (or highest) entity ID could be associated with the first TCI state group or the TCI state group with the lowest TCI state group ID, the second (or second last) entity ID or the second lowest (or second highest) entity ID could be associated with the second TCI state group or the TCI state group with the second lowest TCI state group ID, and so on, and the last (or first) entity ID or the highest (or lowest) entity ID could be associated with the last TCI state group or the TCI state group with the highest TCI state group ID; here, a TCI state group ID could correspond to a CORESETPoolIndex—e.g., values 0 and/or 1 provided in PDCCH-Config, a CORESETGroupIndex—e.g., values 0 and/or 1 provided in PDCCH-Config, a PCI value, a PCI index pointing to an entry/PCI in a list of PCIs (or PCI values) higher layer configured to the UE, a resource set index/ID, a CORESET ID, a resource index/ID, a TRP-specific ID/index, a TRP-specific higher layer signaling index/ID, a one-bit/multi-bit indicator or etc.

FIG. 10B illustrates an example of MAC CE activation command for activating/deactivating one or more TCI states 1010 according to embodiments of the present disclosure. An embodiment of the MAC CE activation command for activating/deactivating one or more TCI states 1010 shown in FIG. 10B is for illustration only.

An example of the MAC CE activation command for activating/deactivating one or more specific TCI states is given in FIG. 10B. As indicated in FIG. 10B, the MAC CE activation command could comprise of a SCI, a BWP ID and a bitmap. Each entry/bit in the bitmap could correspond to a distinct TCI state or TCI state ID in the higher layer configured list/pool of TCI states or in a TCI state group (e.g., provided by TCIState-Group) discussed above. If an entry/bit in the bitmap is set to ‘1’, the corresponding/associated TCI state is activated. If an entry/bit in the bitmap is set to ‘0’, the corresponding/associated TCI state is deactivated. The list of bit positions in the bitmap that are set to ‘1’s are assigned/mapped to a set of codepoints in an increasing order. One or more DCI fields (e.g., a TCI field) of a DCI (e.g., DCI format 1_1 or 1_2 with or without DL scheduling) could indicate the codepoint index, and therefore, the corresponding TCI state/TCI state ID indicated for the corresponding DL channels/signals such as PDCCHs, PDSCHs or CSI-RSs.

A MAC CE activation command in this design example could correspond to or be equivalent to a MAC CE command for beam indication in the design example 1.A.0 in the present disclosure, when the number of TCI states/TCI state IDs activated by the MAC CE activation command is the same as the number of TCI states/TCI state IDs indicated in the MAC CE command for beam indication. That is, the number of TCI states/TCI state IDs activated by the MAC CE activation command in this design example 1.B.0 could be greater than or equal to the number of TCI states/TCI state IDs indicated in the MAC CE command for beam indication in the design example 1.A.0.

In the present disclosure, various design options of associating serving/non-serving (or neighboring) cells/TRPs information or serving cell PCI/PCI(s) other than the serving cell PCI to one or more TCI states/TCI state IDs activated by the MAC CE activation command(s) are presented below.

In one example of Alternative-0, one or more of the (candidate) TCI states (and therefore, the QCL source RSs indicated therein) activated by a MAC CE activation command could be transmitted from/associated with the serving cell/TRP having the serving cell PCI/PCI index and/or one or more non-serving cells/TRPs (or neighboring cells/TRPs) having PCIs/PCI indexes other than the serving cell PCI/PCI index. That is, a MAC CE activation command could activate one or more TCI states/TCI state IDs associated with the serving cell/TRP having the serving cell PCI/PCI index (a first set of TCI states/TCI state IDs), e.g., from the TCI state group (provided by TCIState-Group) that is associated with the serving cell/TRP following those described in Option-0, Option-1, Option-1a, Option-2, Option-2a, Option-3, Option-4, Option-4a, Option-5, Option-6 or Option-6a in the present disclosure, and/or one or more TCI states/TCI state IDs associated with a non-serving cell/TRP having a PCI/PCI index other than the serving cell PCI/PCI index (a second set of TCI states/TCI state IDs), e.g., from the TCI state group (provided by TCIState-Group) that is associated with the non-serving cell/TRP following those described in Option-0, Option-1, Option-1a, Option-2, Option-2a, Option-3, Option-4, Option-4a, Option-5, Option-6 or Option-6a in the present disclosure.

For the example shown in FIG. 10A, TCI #1 and TCI #3 could be activated by the MAC CE activation command, and they could be associated with the serving cell/TRP and a non-serving cell/TRP (or neighboring cell/TRP), respectively. In this case, for an inter-cell multi-TRP system comprising of at least two coordinating TRPs, the UE could receive from the network a single MAC CE activation command activating one or more TCI states for the DL channels/signals transmitted from/associated with the serving cell/TRP and/or the non-serving cell/TRP (or neighboring cell/TRP), and the UE could receive from network separate DCIs each indicating one or more TCI states from the one or more TCI states activated by the MAC CE activation command for the DL channels/signals such as PDCCHs, PDSCHs or CSI-RSs transmitted from/associated with the serving cell/TRP having the serving cell PCI/PCI index and the non-serving cell/TRP (or neighboring cell/TRP) having the PCI/PCI index other than the serving cell PCI/PCI index.

In one example of Alternative-1, a MAC CE activation command could include/indicate/configure/comprise/contain a value of CORESETPoolIndex or a value of CORESETGroupIndex. In the present disclosure, a UE could be provided in PDCCH-Config/PDSCH-Config, different values of CORESETPoolIndex or CORESETGroupIndex (e.g., values 0 and 1). One or more CORESETs could be associated/configured with a same value of CORESETPoolIndex/CORESETGroupIndex, and CORESETs associated with different values of CORESETPoolIndex/CORESETGroupIndex could be different. In the present disclosure, any configuration, association, indication methods described/discussed for CORESETPoolIndex value(s) could be equally applied to CORESETGroupIndex value(s).

FIG. 10C illustrates another example of MAC CE activation command for activating/deactivating one or more TCI states 1020 according to embodiments of the present disclosure. An embodiment of the MAC CE activation command for activating/deactivating one or more TCI states 1020 shown in FIG. 10C is for illustration only.

In FIG. 10C, an example of a MAC CE activation command including/indicating/configuring/comprising/containing a CORESETPoolIndex is depicted. As the MAC CE activation command activates the TCI states for one or more DL channels/signals, if the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could further identify whether the corresponding PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDSCH is transmitted.

In addition, if the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could identify whether the QCL source RS(s) in the activated TCI state(s) is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS(s) in the activated TCI state(s) is transmitted.

For instance, if the CORESETPoolIndex value in the MAC CE activation command is set to/configured as ‘0’ (or ‘1’) and it is associated with the serving cell/TRP, the UE could identify that the QCL source RS(s) in the TCI state(s) activated by the MAC CE activation command and/or the corresponding PDSCH are transmitted from/associated with the serving cell/TRP. If the CORESETPoolIndex value in the MAC CE command is set to/configured as ‘1’ and it is associated with a non-serving cell/TRP (or neighboring cell/TRP), the UE could identify that the QCL source RS(s) in the TCI state(s) activated by the MAC CE activation command and/or the corresponding PDSCH are transmitted from/associated with the non-serving cell/TRP (or neighboring cell/TRP).

In one example of Alternative-1.1, if a MAC CE activation command activating one or more TCI states/TCI state IDs is associated with a CORESETPoolIndex value—the CORESETPoolIndex value is indicated/configured/included/comprised in the MAC CE activation command, the TCI state(s) (and therefore, the QCL source RS(s) indicated therein) activated by the MAC CE activation command is associated with the PCI/PCI index (e.g., corresponding to the serving cell PCI/PCI index or a PCI/PCI index other than the serving cell PCI/PCI index) associated with the CORESETPoolIndex.

In one example of Alternative-1.2, if a MAC CE activation command activating one or more TCI states/TCI state IDs is associated with a first CORESETPoolIndex value—the first CORESETPoolIndex value is indicated/configured/included/comprised in the MAC CE activation command, the TCI state(s) (and therefore, the QCL source RS(s) indicated therein) activated by the MAC CE activation command is associated with the PCI/PCI index (e.g., corresponding to the serving cell PCI/PCI index or a PCI/PCI index other than the serving cell PCI/PCI index) associated with a second CORESETPoolIndex other than the first CORESETPoolIndex.

The UE could be indicated/configured by the network whether Alternative-1.1 and/or Alternative-1.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-1.1 is enabled and ‘1’ (or ‘0’) indicating the Alternative-1.2 is enabled. The one-bit indicator could be indicated via a higher layer RRC signaling/parameter and/or in the MAC CE activation command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-1.1 or Alternative-1.2. For this example, if the first (or second) entry/bit position in the bitmap is set to ‘1’, Alternative-1.1 is enabled; if the second (or first) entry/bit position in the bitmap is set to ‘1’, Alternative-1.2 is enabled. The bitmap could be indicated via a higher layer RRC signaling/parameter and/or in the MAC CE activation command and/or via dynamic DCI based signaling (e.g., DCI format 1_1 or 1_2 with or without DL assignment).

In yet another example, if value 0 (or 1) of CORESETPoolIndex is indicated in the MAC CE activation command, Alternative-1.1 is enabled; otherwise, if value 1 (or 0) of CORESETPoolIndex is indicated in the MAC CE activation command, Alternative-1.2 is enabled.

In yet another example, when a radio link failure or a beam failure has been declared for the second CORESETPoolIndex value or the PCI/PCI index associated with the second CORESETPoolIndex value, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Alternative-1.2 is enabled.

In the present disclosure, the first or second CORESETPoolIndex value could correspond to value 0 (or 1) of CORESETPoolIndex.

In one example of Alternative-1a, a MAC CE activation command could include/indicate/configure/comprise/contain a value of CORESETPoolIndex or a value of CORESETGroupIndex. For this design alternative, the MAC CE activation command could activate two sets of TCI states, denoted as a first set of TCI states and a second set of TCI states, from the higher layer configured list/pool of N_tci TCI states/TCI state IDs or one or more TCI state groups (e.g., each provided by TCIState-Group) discussed above.

If the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could identify whether the QCL source RSs in the first or second sets of TCI states activated by the MAC CE activation command are transmitted from/associated with the serving cell/TRP or a non-serving cell/TRP (or neighboring cell/TRP), and/or, the exact PCI value or PCI index for either the serving cell/TRP or the non-serving cell/TRP (or neighboring cell/TRP), from which the QCL source RSs in the first or second sets of TCI states activated by the MAC CE activation command are transmitted.

In one example of Alternative-1a.1, if a MAC CE activation command activating the first and second sets of TCI states/TCI state IDs is associated with a first CORESETPoolIndex value—the first CORESETPoolIndex value is indicated in the MAC CE activation command, the first set of TCI states (and therefore, the QCL source RSs indicated therein) activated by the MAC CE activation command is associated with the PCI/PCI index (e.g., corresponding to the serving cell PCI/PCI index or a PCI/PCI index other than the serving cell PCI/PCI index) associated with the first CORESETPoolIndex value, and the second set TCI states (and therefore, the QCL source RSs indicated therein) activated by the MAC CE activation command is associated with the PCI/PCI index (e.g., corresponding to the serving cell PCI/PCI index or a PCI/PCI index other than the serving cell PCI/PCI index) associated with a second CORESETPoolIndex value other than the first CORESETPoolIndex value.

In one example of Alternative-1a.2, if a MAC CE activation command activating the first and second sets of TCI states/TCI state IDs is associated with a first CORESETPoolIndex value—the first CORESETPoolIndex value is indicated in the MAC CE activation command, the first set of TCI states (and therefore, the QCL source RSs indicated therein) activated by the MAC CE activation command is associated with the PCI/PCI index (e.g., corresponding to the serving cell PCI/PCI index or a PCI/PCI index other than the serving cell PCI/PCI index) associated with a second CORESETPoolIndex value other than the first CORESETPoolIndex value, and the second set of TCI states (and therefore, the QCL source RSs indicated therein) activated by the MAC CE activation command is associated with the PCI/PCI index (e.g., corresponding to the serving cell PCI/PCI index or a PCI/PCI index other than the serving cell PCI/PCI index) associated with the first CORESETPoolIndex value.

The UE could be indicated/configured by the network whether Alternative-1a.1 and/or Alternative-1a.2 is enabled; the corresponding indication/configuration could be via higher layer RRC signaling and/or MAC CE activation command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-1a.1 is enabled and ‘1’ (or ‘0’) indicating the Alternative-1a.2 is enabled. The one-bit indicator could be indicated via a higher layer RRC signaling/parameter and/or in the MAC CE activation command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-1a.1 or Alternative-1a.2. For this example, if the first (or second) entry/bit position in the bitmap is set to ‘1’, Alternative-Ia.1 is enabled; if the second (or first) entry/bit position in the bitmap is set to ‘1’, Alternative-Ia.2 is enabled. The bitmap could be indicated via a higher layer RRC signaling/parameter and/or in the MAC CE activation command and/or via dynamic DCI based signaling (e.g., DCI format 1_1 or 1_2 with or without DL assignment).

In yet another example, if value 0 (or 1) of CORESETPoolIndex is indicated in the MAC CE activation command, Alternative-1a.1 is enabled; otherwise, if value 1 (or 0) of CORESETPoolIndex is indicated in the MAC CE activation command, Alternative-1a.2 is enabled.

In the present disclosure, the first or second CORESETPoolIndex value could correspond to value 0 (or 1) of CORESETPoolIndex.

In one example of Alternative-1b, a MAC CE activation command could include/indicate/configure/comprise/contain a CORESET ID. The MAC CE activation command is therefore associated with the CORESETPoolIndex/CORESETGroupIndex (if configured) associated/configured for the CORESET ID indicated therein. As the MAC CE activation command activates the TCI states for one or more DL channels/signals, if the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could further identify whether the corresponding PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDSCH is transmitted.

In addition, if the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could identify whether the QCL source RS(s) in the activated TCI state(s) is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS(s) in the activated TCI state(s) is transmitted.

For instance, if the CORESETPoolIndex value associated with the MAC CE activation command is set to/configured as ‘0’ (or ‘1’) and it is associated with the serving cell/TRP, the UE could identify that the QCL source RS(s) in the TCI state(s) activated by the MAC CE activation command and/or the corresponding PDSCH are transmitted from/associated with the serving cell/TRP. If the CORESETPoolIndex value associated with the MAC CE command is set to/configured as ‘1’ and it is associated with a non-serving cell/TRP (or neighboring cell/TRP), the UE could identify that the QCL source RS(s) in the TCI state(s) activated by the MAC CE activation command and/or the corresponding PDSCH are transmitted from/associated with the non-serving cell/TRP (or neighboring cell/TRP).

In one example of Alternative-1b.1, if a MAC CE activation command activating one or more TCI states/TCI state IDs is associated with a CORESETPoolIndex value—the CORESET ID indicated/configured/included/comprised in the MAC CE activation command is associated/configured with the CORESETPoolIndex value, the TCI state(s) (and therefore, the QCL source RS(s) indicated therein) activated by the MAC CE activation command is associated with the PCI/PCI index (e.g., corresponding to the serving cell PCI/PCI index or a PCI/PCI index other than the serving cell PCI/PCI index) associated with the CORESETPoolIndex.

In one example of Alternative-1b.2, if a MAC CE activation command activating one or more TCI states/TCI state IDs is associated with a first CORESETPoolIndex value—the CORESET ID indicated/configured/included/comprised in the MAC CE activation command is associated/configured with the first CORESETPoolIndex value, the TCI state(s) (and therefore, the QCL source RS(s) indicated therein) activated by the MAC CE activation command is associated with the PCI/PCI index (e.g., corresponding to the serving cell PCI/PCI index or a PCI/PCI index other than the serving cell PCI/PCI index) associated with a second CORESETPoolIndex other than the first CORESETPoolIndex.

The UE could be indicated/configured by the network whether Alternative-1b.1 and/or Alternative-1b.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-1b.1 is enabled and ‘1’ (or ‘0’) indicating the Alternative-1b.2 is enabled. The one-bit indicator could be indicated via a higher layer RRC signaling/parameter and/or in the MAC CE activation command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-1b.1 or Alternative-1b.2. For this example, if the first (or second) entry/bit position in the bitmap is set to ‘1’, Alternative-1b.1 is enabled; if the second (or first) entry/bit position in the bitmap is set to ‘1’, Alternative-1b.2 is enabled. The bitmap could be indicated via a higher layer RRC signaling/parameter and/or in the MAC CE activation command and/or via dynamic DCI based signaling (e.g., DCI format 1_1 or 1_2 with or without DL assignment).

In yet another example, if value 0 (or 1) of CORESETPoolIndex is associated with the MAC CE activation command—the CORESET ID indicated/included/configured/contained/comprised in the MAC CE activation command is associated/configured with value 0 (or 1) of CORESETPoolIndex, Alternative-1b.1 is enabled; otherwise, if value 1 (or 0) of CORESETPoolIndex is associated with the MAC CE activation command—the CORESET ID indicated/included/configured/contained/comprised in the MAC CE activation command is associated/configured with value 1 (or 0) of CORESETPoolIndex, Alternative-1b.2 is enabled.

In yet another example, when a radio link failure or a beam failure has been declared for the second CORESETPoolIndex value or the PCI/PCI index associated with the second CORESETPoolIndex value, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Alternative-1b.2 is enabled.

In the present disclosure, the first or second CORESETPoolIndex value could correspond to value 0 (or 1) of CORESETPoolIndex.

In one example of Alternative-1c, a MAC CE activation command could include/indicate/configure/comprise/contain a CORESET ID. The MAC CE activation command is therefore associated with the CORESETPoolIndex/CORESETGroupIndex (if configured) associated/configured for the CORESET ID indicated therein. If the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could identify whether the QCL source RSs in the first or second sets of TCI states activated by the MAC CE activation command are transmitted from/associated with the serving cell/TRP or a non-serving cell/TRP (or neighboring cell/TRP), and/or, the exact PCI value or PCI index for either the serving cell/TRP or the non-serving cell/TRP (or neighboring cell/TRP), from which the QCL source RSs in the first or second sets of TCI states activated by the MAC CE activation command are transmitted.

In one example of Alternative-1c.1, if a MAC CE activation command activating the first and second sets of TCI states/TCI state IDs is associated with a first CORESETPoolIndex value—the CORESET ID indicated in the MAC CE activation command is associated/configured with the first CORESETPoolIndex value, the first set of TCI states (and therefore, the QCL source RSs indicated therein) activated by the MAC CE activation command is associated with the PCI/PCI index (e.g., corresponding to the serving cell PCI/PCI index or a PCI/PCI index other than the serving cell PCI/PCI index) associated with the first CORESETPoolIndex value, and the second set TCI states (and therefore, the QCL source RSs indicated therein) activated by the MAC CE activation command is associated with the PCI/PCI index (e.g., corresponding to the serving cell PCI/PCI index or a PCI/PCI index other than the serving cell PCI/PCI index) associated with a second CORESETPoolIndex value other than the first CORESETPoolIndex value.

In one example of Alternative-1c.2, if a MAC CE activation command activating the first and second sets of TCI states/TCI state IDs is associated with a first CORESETPoolIndex value—the CORESET ID indicated in the MAC CE activation command is associated/configured with the first CORESETPoolIndex value, the first set of TCI states (and therefore, the QCL source RSs indicated therein) activated by the MAC CE activation command is associated with the PCI/PCI index (e.g., corresponding to the serving cell PCI/PCI index or a PCI/PCI index other than the serving cell PCI/PCI index) associated with a second CORESETPoolIndex value other than the first CORESETPoolIndex value, and the second set of TCI states (and therefore, the QCL source RSs indicated therein) activated by the MAC CE activation command is associated with the PCI/PCI index (e.g., corresponding to the serving cell PCI/PCI index or a PCI/PCI index other than the serving cell PCI/PCI index) associated with the first CORESETPoolIndex value.

The UE could be indicated/configured by the network whether Alternative-1c.1 and/or Alternative-1c.2 is enabled; the corresponding indication/configuration could be via higher layer RRC signaling and/or MAC CE activation command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-1c.1 is enabled and ‘1’ (or ‘0’) indicating the Alternative-1c.2 is enabled. The one-bit indicator could be indicated via a higher layer RRC signaling/parameter and/or in the MAC CE activation command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-1c.1 or Alternative-1c.2. For this example, if the first (or second) entry/bit position in the bitmap is set to ‘1’, Alternative-1c.1 is enabled; if the second (or first) entry/bit position in the bitmap is set to ‘1’, Alternative-1c.2 is enabled. The bitmap could be indicated via a higher layer RRC signaling/parameter and/or in the MAC CE activation command and/or via dynamic DCI based signaling (e.g., DCI format 1_1 or 1_2 with or without DL assignment).

In yet another example, if value 0 (or 1) of CORESETPoolIndex is associated with the MAC CE activation command—the CORESET ID indicated/included/configured/contained/comprised in the MAC CE activation command is associated/configured with value 0 (or 1) of CORESETPoolIndex, Alternative-1c.1 is enabled; otherwise, if value 1 (or 0) of CORESETPoolIndex is associated with the MAC CE activation command—the CORESET ID indicated/included/configured/contained/comprised in the MAC CE activation command is associated/configured with value 1 (or 0) of CORESETPoolIndex, Alternative-1c.2 is enabled.

In the present disclosure, the first or second CORESETPoolIndex value could correspond to value 0 (or 1) of CORESETPoolIndex.

FIG. 10D illustrates yet another example of MAC CE activation command for activating/deactivating one or more TCI states 1030 according to embodiments of the present disclosure. An embodiment of the MAC CE activation command for activating/deactivating one or more TCI states 1030 shown in FIG. 10D is for illustration only.

In one example of Alternative-2, a one-bit flag indicator could be included/indicated/contained/configured/comprised in the MAC CE activation command, wherein one or more TCI states/TCI state IDs are activated from the higher layer configured list/pool of N_tci TCI states/TCI state IDs and/or one or more TCI state groups (e.g., each provided by TCIState-Group). If the one-bit flag indicator is present and set to ‘1’ (or ‘0’), the MAC CE activation command could be associated with the serving cell/TRP having the serving cell PCI/PCI index; in this case, the QCL source RS(s) in the TCI state(s) activated by the MAC CE activation command could also be associated with/transmitted from the serving cell/TRP having the serving cell PCI/PCI index. If the one-bit flag indicator is not present or set to ‘0’ (or ‘1’), the MAC CE activation command could be associated the non-serving cell/TRP (or neighboring cell/TRP) having the PCI/PCI index other than the serving cell PCI/PCI index; in this case, the QCL source RS(s) in the TCI state(s) activated by the MAC CE activation command could also be associated with/transmitted from the non-serving cell/TRP (or neighboring cell/TRP) having the PCI/PCI index other than the serving cell PCI/PCI index. One conceptual example of including/indicating/configuring/containing/comprising the one-bit flag indicator in the MAC CE activation command is depicted in FIG. 10D.

In one example of Alternative-2a, a one-bit flag indicator could be included/indicated/contained/configured/comprised in the MAC CE activation command, wherein two sets of TCI states/TCI state IDs—denoted as a first set of TCI states/TCI state IDs and a second set of TCI states/TCI state IDs—are activated from the higher layer configured list/pool of N_tci TCI states/TCI state IDs and/or one or more TCI state groups (e.g., each provided by TCIState-Group). If the one-bit flag indicator is present and set to ‘1’ (or ‘0’), the first set of TCI states (and therefore, the QCL source RS(s) indicated therein) activated by the MAC CE activation command is associated with the serving cell/TRP having the serving cell PCI/PCI index, and the second set TCI states (and therefore, the QCL source RS(s) indicated therein) activated by the MAC CE activation command is associated with a PCI/PCI index other than the serving cell PCI/PCI index. If the one-bit flag indicator is present and set to ‘0’ (or ‘1’), the first set of TCI states (and therefore, the QCL source RS(s) indicated therein) activated by the MAC CE activation command is associated with a PCI/PCI index other than the serving cell PCI/PCI index, and the second set of TCI states (and therefore, the QCL source RS(s) indicated therein) activated by the MAC CE activation command is associated with the serving cell/TRP having the serving cell PCI/PCI index.

In one example of Alternative-3, a multi-bit (more than one bit) indicator could be included/indicated/configured/comprised/contained in the MAC CE activation command to indicate the serving cell/TRP having the serving cell PCI/PCI index and two or more non-serving cells/TRPs (or neighboring cells/TRPs) having PCIs/PCI indexes other than the serving cell PCI/PCI index in the inter-cell multi-TRP system. The number of bits n_b required for representing the multi-bit indicator could be ceil(log 2(N_nsc+1)), where N_nsc is the total number of non-serving cells/TRPs (or neighboring cells/TRPs) and ceil(x) rounds x up to the next largest integer. In this case, the n_b-bit indicator could correspond to 2\hat{ }(n_b) states, and one of the states (e.g., the first state) could correspond to the serving cell/TRP, and the rest of the states could correspond to the non-serving cells/TRPs (or neighboring cells/TRPs).

Alternatively, the number of bits n_b required for representing the multi-bit indicator could be ceil(log 2(N_nsc)). In this case, the multi-bit indicator only indicates/identifies the non-serving cells/TRPs (or neighboring cells/TRPs); if the multi-bit indicator is not present, the UE would expect that the MAC CE activation command activates one or more TCI states from the higher layer configured list/pool of TCI states, from which at least one TCI state indicated by the DCI could be used for transmitting the PDSCH from the serving cell/TRP; that is, the one or more TCI states (and therefore, the QCL source RS(s) indicated therein) activated by the MAC CE activation command could be associated with the serving cell PCI/PCI index; if the multi-bit indicator is not present, the UE could also expect that the QCL source RS(s) in the TCI state(s) activated by the MAC CE activation command is associated with/transmitted from the serving cell/TRP.

The UE could be indicated by the network the association rule(s)/mapping relationship(s) between the states/bit indexes of the multi-bit indicator and the PCIs/PCI indexes (e.g., corresponding to the serving cell PCI/PCI index and/or PCI(s)/PCI index(es) other than the serving cell PCI/PCI index); this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

FIG. 10E illustrates yet another example of MAC CE activation command for activating/deactivating one or more TCI states 1040 according to embodiments of the present disclosure. An embodiment of the MAC CE activation command for activating/deactivating one or more TCI states 1040 shown in FIG. 10E is for illustration only.

In one example of Alternative-4, one or more PCIs/PCI indexes could be included/indicated/configured/provided in the MAC CE activation command. The inclusion/indication of the PCI value(s)/PCI index(es) in the MAC CE activation command could be in addition to the SCI value/field. Alternatively, the MAC CE activation command could contain/indicate/configure/include/comprise the PCI value(s)/PCI index(es) without the SCI value/field. In FIG. 10E, an example of the MAC CE activation command including/indicating/providing the PCI value(s) is presented. In this case, one or more PCI values could be used/reserved for representing the serving cell/TRP—e.g., PCI index 0 could correspond to the serving cell/TRP.

The UE could be indicated by the network the association between the PCI value(s) and the serving cell/TRP and/or the association between the PCI value(s) and the non-serving (or neighboring) cell(s)/TRP(s). If the indicated PCI value is associated with the serving cell/TRP, the MAC CE activation command could activate one or more TCI states from the higher layer configured list/pool of TCI states, from which at least one TCI state indicated by the DCI could be used for transmitting the PDSCH from the serving cell/TRP; in this case, the QCL source RS(s) in the TCI state(s) activated by the MAC CE activation command could also be associated with/transmitted from the serving cell/TRP.

If the indicated PCI value is associated with a non-serving cell/TRP (or neighboring cell/TRP), the MAC CE command could activate one or more TCI states from the higher layer configured list/pool of TCI states, from which at least one TCI state indicated by the DCI could be used for transmitting the PDSCH from the non-serving cell/TRP (or neighboring cell/TRP) in the inter-cell multi-TRP system; in this case, the QCL source RS(s) in the TCI state(s) activated by the MAC CE activation command could also be associated with/transmitted from the non-serving cell/TRP (or neighboring cell/TRP).

That is, a PCI or PCI index pointing to an entry/PCI in a list of PCIs that are higher layer configured to the UE could be indicated/included/configured/provided in the MAC CE activation command. For this case, the TCI state(s) (and therefore, the QCL source RS(s) indicated therein) activated by the MAC CE activation command could be associated with the PCI or PCI index indicated in the same MAC CE activation command described above. The serving cell PCI index could be value 0.

In one example of Alternative-4.1, if a MAC CE activation command indicates/configures/includes/provides the serving cell PCI/PCI index, the TCI state(s) (and therefore, the QCL source RS(s) indicated therein) activated by the MAC CE activation command could be associated with the serving cell PCI/PCI index. If a MAC CE activation command indicates/configures/includes/provides a PCI/PCI index other than the serving cell PCI/PCI index, the TCI state(s) (and therefore, the QCL source RS(s) indicated therein) activated by the MAC CE activation command is associated with the PCI/PCI index other than the serving cell PCI/PCI index.

In one example of Alternative-4.2, if a MAC CE activation command indicates/configures/includes/provides a PCI/PCI index other than the serving cell PCI/PCI index, the TCI state(s) (and therefore, the QCL source RS(s) indicated therein) activated by the MAC CE activation command is associated with the serving cell PCI/PCI index. If a MAC CE activation command indicates/configures/includes/provides the serving cell PCI/PCI index, the TCI state(s) (and therefore, the QCL source RS(s) indicated therein) activated by the MAC CE activation command is associated with the PCI/PCI index other than the serving cell PCI/PCI index.

The UE could be indicated/configured by the network whether Alternative-4.1 and/or Alternative-4.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-4.1 is enabled and ‘1’ (or ‘0’) indicating the Alternative-4.2 is enabled. The one-bit indicator could be indicated via a higher layer RRC signaling/parameter and/or in the MAC CE activation command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-4.1 or Alternative-4.2. For this example, if the first (or second) entry/bit position in the bitmap is set to ‘1’, Alternative-4.1 is enabled; if the second (or first) entry/bit position in the bitmap is set to ‘1’, Alternative-4.2 is enabled. The bitmap could be indicated via a higher layer RRC signaling/parameter and/or in the MAC CE activation command and/or via dynamic DCI based signaling (e.g., DCI format 1_1 or 1_2 with or without DL assignment).

In yet another example, if the MAC CE activation command is associated with value 0 (or 1) of CORESETPoolIndex, Alternative-4.1 is enabled; otherwise, if the MAC CE activation command is associated with value 1 (or 0) of CORESETPoolIndex, Alternative-4.2 is enabled.

In yet another example, when a radio link failure or a beam failure has been declared for the PCI/PCI index (e.g., the serving cell PCI/PCI index or the PCI/PCI index other than the serving cell PCI/PCI index) indicated/included in the MAC CE activation command, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Alternative-4.2 is enabled.

In one example of Alternative-4a, (a set of) two PCIs/PCI indexes, denoted as a first PCI/PCI index and a second PCI/PCI index, could be included/indicated/configured/provided in the MAC CE activation command as described above. The inclusion/indication of the two PCI values/PCI indexes in the MAC CE activation command could be in addition to the SCI value/field. Alternatively, the MAC CE activation command could contain/include/indicate/configure/provide the set of two PCI values/PCI indexes without the SCI value/field. One or more PCI values/PCI indexes could be used/reserved for representing the serving cell/TRP—e.g., in the present disclosure, PCI index 0 could correspond to the serving cell/TRP.

The UE could be indicated by the network the association between the PCI value(s)/PCI index(es) and the serving cell/TRP and/or the association between the PCI value(s)/PCI index(es) and the non-serving (or neighboring) cell(s)/TRP(s). Furthermore, in this design option, the MAC CE activation command could activate two sets of TCI states, denoted as a first set TCI states and a second set of TCI states from the higher layer configured list/pool of TCI states/TCI state IDs and/or one or more TCI state groups (e.g., each provided by TCIState-Group).

In one example of Alternative-4a.1, the first set of TCI states (and therefore, the QCL source RS(s) indicated therein) activated by the MAC CE activation command is associated with the first PCI/PCI index indicated in the MAC CE activation command. The second set of TCI states (and therefore, the QCL source RS(s) indicated therein) activated by the MAC CE activation command is associated with the second PCI/PCI index indicated in the MAC CE activation command.

In one example of Alternative-4a.2, the first set of TCI states (and therefore, the QCL source RS(s) indicated therein) activated by the MAC CE activation command is associated with the second PCI/PCI index indicated in the MAC CE activation command. The second set of TCI states (and therefore, the QCL source RS(s) indicated therein) activated by the MAC CE activation command is associated with the first PCI/PCI index indicated in the MAC CE activation command.

The UE could be indicated/configured by the network whether Alternative-4a.1 and/or Alternative-4a.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-4a.1 is enabled and ‘1’ (or ‘0’) indicating the Alternative-4a.2 is enabled. The one-bit indicator could be indicated via a higher layer RRC signaling/parameter and/or in the MAC CE activation command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-4a.1 or Alternative-4a.2. For this example, if the first (or second) entry/bit position in the bitmap is set to ‘1’, Alternative-4a.1 is enabled; if the second (or first) entry/bit position in the bitmap is set to ‘1’, Alternative-4a.2 is enabled. The bitmap could be indicated via a higher layer RRC signaling/parameter and/or in the MAC CE activation command and/or via dynamic DCI based signaling (e.g., DCI format 1_1 or 1_2 with or without DL assignment).

In yet another example, if the MAC CE activation command is associated with value 0 (or 1) of CORESETPoolIndex, Alternative-4a.1 is enabled; otherwise, if the MAC CE activation command is associated with value 1 (or 0) of CORESETPoolIndex, Alternative-4a.2 is enabled.

The first PCI/PCI index or the second PCI/PCI index could correspond to the serving cell PCI/PCI index or a PCI/PCI index other than the serving cell PCI/PCI index. In the present disclosure, a PCI index could point to an entry/PCI in a list of PCIs that are higher layer configured to the UE; the list of PCIs could comprise only the PCIs other than the serving cell PCI, or both the serving cell PCI and PCI(s) other than the serving cell PCIs. Furthermore, as aforementioned, the PCI index for the serving cell/TRP could correspond to value 0.

In one example of Alternative-5, one or more SCI values in the MAC CE activation command could be used for representing one or more non-serving cells/TRPs (or neighboring cells/TRPs), and/or, correspond to one or more PCI values for the non-serving cells/TRPs (or neighboring cells/TRPs), in the inter-cell multi-TRP system. The UE could be indicated by the network the exact SCI value(s) used/reserved for representing the non-serving cell(s)/TRP(s) (or neighboring cell(s)/TRP(s)), and/or, the association between the reserved SCI value(s) and the PCI value(s) for the non-serving cell(s)/TRP(s) (or neighboring cell(s)/TRP(s)). If the indicated SCI value is reserved/used for representing a non-serving cell/TRP (or neighboring cell/TRP) and/or corresponds to a non-serving cell/TRP (or neighboring cell/TRP) PCI value, the MAC CE activation command could activate one or more TCI states from the higher layer configured list/pool of TCI states, from which at least one TCI state indicated by the DCI could be used for transmitting the PDSCH from the non-serving cell/TRP (or neighboring cell/TRP) in the inter-cell multi-TRP system; in this case, the QCL source RS(s) in the TCI state(s) activated by the MAC CE activation command could also be associated with/transmitted from the non-serving cell/TRP (or neighboring cell/TRP).

In one example of Alternative-6, a TCI state could be associated with the serving cell/TRP having the serving cell PCI/PCI index or a non-serving cell/TRP having a PCI/PCI index other than the serving cell PCI/PCI index—e.g., the higher layer parameter TCI-State, QCL-Info, DLorJointTCI-State or UL-TCIState could include/contain/provide/indicate information related to indicating/identifying the serving cell/TRP and/or non-serving cell(s)/TRP(s). For example, a TCI state or the higher layer parameter TCI-State, QCL-Info, DLorJointTCI-State or UL-TCIState that configures a TCI state could include/indicate/configure/provide a CORESETPoolIndex value, which could be associated with the serving cell/TRP or a non-serving cell/TRP (or neighboring cell/TRP)—e.g., with value 0 (or 1) of CORESETPoolIndex associated with the serving cell PCI/PCI index and value 1 (or 0) associated with a PCI/PCI index other than the serving cell PCI/PCI index. For another example, a TCI state or the higher layer parameter TCI-State, QCL-Info, DLorJointTCI-State or UL-TCIState that configures a TCI state could include/indicate/configure/provide a one-bit flag indicator to indicate the serving cell/TRP or a non-serving cell/TRP (or neighboring cell/TRP)—e.g., with the one-bit flag indicator set to ‘0’ (or ‘1’) indicating the serving cell PCI/PCI index and ‘1’ (or ‘0’) indicating a PCI/PCI index other than the serving cell PCI/PCI index.

Yet for another example, a TCI state or the higher layer parameter TCI-State, QCL-Info, DLorJointTCI-State or UL-TCIState that configures a TCI state could include/indicate/configure/provide a multi-bit indicator to indicate the serving cell/TRP (and/or its PCI value/PCI index) and the non-serving (or neighboring) cell(s)/TRPs (and/or the corresponding PCI value(s)/PCI index(es)). Yet for another example, a TCI state or the higher layer parameter TCI-State, QCL-Info, DLorJointTCI-State or UL-TCIState that configures a TCI state could include/indicate/configure/provide a PCI value/PCI index (e.g., corresponding to the serving cell PCI/PCI index or a PCI/PCI index other than the serving cell PCI/PCI index). Yet for another example, one or more serving cell IDs (SCIs) in a TCI state could be reserved/used to indicate one or more non-serving (or neighboring) cells/TRPs information. Other details about the indication/identification of the serving/non-serving (or neighboring) cells/TRPs information in a TCI state could be according to the US provisional patent application 63/067,122 filed on Aug. 18, 2020.

Based on the above discussions, the TCI state(s)—and therefore, the QCL source RS(s) indicated therein—activated by a MAC CE activation command could be associated with the serving cell/TRP having the serving cell PCI/PCI index or a non-serving cell/TRP (or neighboring cell/TRP) having a PCI/PCI index other than the serving cell PCI/PCI index. That is, the higher layer parameter TCI-State, QCL-Info, DLorJointTCI-State or ULTCI-State that configures the TCI state(s) activated by the MAC CE activation command could indicate the same serving cell/TRP information or the same non-serving cell(s)/TRP(s) information as discussed above.

If the serving cell/TRP information is indicated in the TCI state(s) or the higher layer parameter TCI-State, QCL-Info, DLorJointTCI-State or UL-TCIState that configures the TCI state(s) activated by a MAC CE activation command, the corresponding PDSCH(s) could be transmitted from/associated with the serving cell/TRP; in this case, the QCL source RS(s) in the TCI state(s) activated by the MAC CE activation command could also be associated with/transmitted from the serving cell/TRP. If the non-serving (or neighboring) cell/TRP information is indicated in the TCI state(s) or the higher layer parameter TCI-State, QCL-Info, DLorJointTCI-State or UL-TCIState that configures the TCI state(s) activated by the MAC CE activation command, the corresponding PDSCH(s) could be transmitted from/associated with the non-serving cell/TRP (or neighboring cell/TRP) in the inter-cell multi-TRP system; in this case, the QCL source RS(s) in the TCI state(s) activated by the MAC CE activation command could also be associated with/transmitted from the non-serving cell/TRP (or neighboring cell/TRP).

In one example of Alternative-6.1, if a TCI state activated by the MAC CE activation command is associated with the serving cell/TRP having the serving cell PCI/PCI index—e.g., the higher layer parameter TCI-State, QCL-Info, DLorJointTCI-State or UL-TCIState that configures the TCI state indicates/includes/configures/provides information related to the serving cell/TRP having the serving cell PCI/PCI index, the corresponding QCL source RS(s) indicated in the TCI state could be associated with the serving cell/TRP having the serving cell PCI/PCI index. If a TCI state activated by the MAC CE activation command is associated with a non-serving cell/TRP having a PCI/PCI index other than the serving cell PCI/PCI index—e.g., the higher layer parameter TCI-State, QCL-Info, DLorJointTCI-State or UL-TCIState that configures the TCI state indicates/includes/configures/provides information related to the non-serving cell/TRP having the PCI/PCI index other than the serving cell PCI/PCI index, the corresponding QCL source RS(s) indicated in the TCI state could be associated with the non-serving cell/TRP having the PCI/PCI index other than the serving cell PCI/PCI index.

In one example of Alternative-6.2, if a TCI state activated by the MAC CE activation command is associated with a non-serving cell/TRP having a PCI/PCI index other than the serving cell PCI/PCI index—e.g., the higher layer parameter TCI-State, QCL-Info, DLorJointTCI-State or UL-TCIState that configures the TCI state indicates/includes/configures/provides information related to the non-serving cell/TRP having the PCI/PCI index other than the serving cell PCI/PCI index, the corresponding QCL source RS(s) indicated in the TCI state could be associated with the serving cell/TRP having the serving cell PCI/PCI index. If a TCI state activated by the MAC CE activation command is associated with the serving cell/TRP having the serving cell PCI/PCI index—e.g., the higher layer parameter TCI-State, QCL-Info, DLorJointTCI-State or UL-TCIState that configures the TCI state indicates/includes/configures/provides information related to the serving cell/TRP having the serving cell PCI/PCI index, the corresponding QCL source RS(s) indicated in the TCI state could be associated with the non-serving cell/TRP having the PCI/PCI index other than the serving cell PCI/PCI index.

The UE could be indicated/configured by the network whether Alternative-6.1 and/or Alternative-6.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-6.1 is enabled for at least one TCI state activated by the MAC CE activation command and ‘1’ (or ‘0’) indicating that Alternative-6.2 is enabled for at least one TCI state activated by the MAC CE activation command. The one-bit indicator could be indicated via a higher layer RRC signaling/parameter and/or in the MAC CE activation command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-6.1 or Alternative-6.2. For this example, if the first (or second) entry/bit position in the bitmap is set to ‘1’, Alternative-6.1 is enabled for at least one TCI state activated by the MAC CE activation command; if the second (or first) entry/bit position in the bitmap is set to ‘1’, Alternative-6.2 is enabled for at least one TCI state activated by the MAC CE activation command. The bitmap could be indicated via a higher layer RRC signaling/parameter and/or in the MAC CE activation command and/or via dynamic DCI based signaling (e.g., DCI format 1_1 or 1_2 with or without DL assignment).

In yet another example, if the MAC CE activation command is associated with value 0 (or 1) of CORESETPoolIndex, Alternative-6.1 is enabled for at least one TCI state activated by the MAC CE activation command; otherwise, if the MAC CE activation command is associated with value 1 (or 0) of CORESETPoolIndex, Alternative-6.2 is enabled for at least one TCI state activated by the MAC CE activation command.

In yet another example, when a radio link failure or a beam failure has been declared for the PCI/PCI index (e.g., the serving cell PCI/PCI index or the PCI/PCI index other than the serving cell PCI/PCI index) associated to a TCI state—e.g., the higher layer parameter TCI-State, QCL-Info, DLorJointTCI-State or UL-TCIState that configures the TCI state indicates/includes/configures/provides information related to the PCI/PCI index—activated by the MAC CE activation command, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Alternative-6.2 is enabled for at least the TCI state.

The above design options and examples apply to when more than one (e.g., 2) sets of TCI states/TCI state IDs are activated by a MAC CE activation command.

In one example of Alternative-7, one or more entity IDs could be included/indicated/configured/provided in the MAC CE activation command as described above. In the present disclosure, an entity ID could correspond to a PCI, a PCI index pointing to an entry/PCI in a list of PCIs that are higher layer configured to the UE, a one-bit indicator with ‘0’ (or ‘1’) indicating the serving cell PCI/PCI index and ‘1’ (or ‘0’) indicating a PCI/PCI index other than the serving cell PCI/PCI index, a multi-bit indicator with each bit index corresponding to a PCI/PCI index, PCI index 0 for the serving cell/TRP, a CORESETPoolIndex, a CORESETGroupIndex, a CORESET ID, a resource set ID/index, a resource ID/index, a TRP-specific ID/index or a TRP-specific higher layer signaling index/ID.

The inclusion/indication of the entity ID(s) in the MAC CE activation command could be in addition to the SCI value/field. Alternatively, the MAC CE activation command could contain/include/indicate/configure/provide the entity ID(s) without the SCI value/field. In this case, one or more entity IDs could be used/reserved for representing the serving cell/TRP—e.g., PCI index 0 could correspond to the serving cell/TRP. The UE could be indicated by the network the association between the entity ID(s) and the serving cell/TRP having the serving cell PCI/PCI index, and/or the association between the entity ID(s) and the non-serving (or neighboring) cell(s)/TRP(s) having PCI(s)/PCI index(es) other than the serving cell PCI/PCI index.

If the indicated entity ID is associated with the serving cell/TRP, the MAC CE activation command could activate one or more beams used for transmitting the DL channels/signals from the serving cell/TRP; in this case, the QCL source RS in the TCI state activated by the MAC CE activation command could also be associated with/transmitted from the serving cell/TRP. If the indicated entity ID is associated with a non-serving cell/TRP (or neighboring cell/TRP), the MAC CE activation command could activate one or more beams used for transmitting the DL channels/signals from the non-serving cell/TRP (or neighboring cell/TRP) in the inter-cell multi-TRP system; in this case, the QCL source RS in the TCI state activated by the MAC CE activation command could also be associated with/transmitted from the non-serving cell/TRP (or neighboring cell/TRP).

That is, an entity ID could be indicated/included/configured/provided in the MAC CE activation command. For this case, the TCI state(s) (and therefore, the QCL source RS(s) indicated therein) activated by the MAC CE activation command could be associated with the entity ID (and therefore, the associated/corresponding serving cell or non-serving cell) indicated in the same MAC CE activation command.

In one example of Alternative-7.1, if a MAC CE activation command indicates/configures/includes/provides an entity ID associated with/corresponding to the serving cell—e.g., the serving cell PCI/PCI index, the TCI state(s) (and therefore, the QCL source RS(s) indicated therein) activated by the MAC CE activation command is associated with the serving cell—e.g., the serving cell PCI/PCI index. If a MAC CE activation command indicates/configures/includes/provides an entity ID associated with/corresponding to a non-serving cell—e.g., a PCI/PCI index other than the serving cell PCI/PCI index, the TCI state(s) (and therefore, the QCL source RS(s) indicated therein) activated by the MAC CE activation command is associated with the non-serving cell—e.g., the PCI/PCI index other than the serving cell PCI/PCI index.

In one example of Alternative-7.2, if a MAC CE activation command indicates/configures/includes/provides an entity ID associated with/corresponding to a non-serving cell—e.g., a PCI/PCI index other than the serving cell PCI/PCI index, the TCI state(s) (and therefore, the QCL source RS(s) indicated therein) activated by the MAC CE activation command is associated with the serving cell—e.g., the serving cell PCI/PCI index. If a MAC CE activation command indicates/configures/includes/provides an entity ID associated with/corresponding to the serving cell—e.g., the serving cell PCI/PCI index, the TCI state(s) (and therefore, the QCL source RS(s) indicated therein) activated by the MAC CE activation command is associated with the non-serving cell—e.g., the PCI/PCI index other than the serving cell PCI/PCI index.

The UE could be indicated/configured by the network whether Alternative-7.1 and/or Alternative-7.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-7.1 is enabled and ‘1’ (or ‘0’) indicating the Alternative-7.2 is enabled. The one-bit indicator could be indicated via a higher layer RRC signaling/parameter and/or in the MAC CE activation command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-7.1 or Alternative-7.2. For this example, if the first (or second) entry/bit position in the bitmap is set to ‘1’, Alternative-7.1 is enabled; if the second (or first) entry/bit position in the bitmap is set to ‘1’, Alternative-7.2 is enabled. The bitmap could be indicated via a higher layer RRC signaling/parameter and/or in the MAC CE activation command and/or via dynamic DCI based signaling (e.g., DCI format 1_1 or 1_2 with or without DL assignment).

In yet another example, if the MAC CE activation command is associated with value 0 (or 1) of CORESETPoolIndex, Alternative-7.1 is enabled; otherwise, if the MAC CE activation command is associated with value 1 (or 0) of CORESETPoolIndex, Alternative-7.2 is enabled.

In yet another example, when a radio link failure or a beam failure has been declared for the cell (e.g., the serving cell having the serving cell PCI/PCI index or a non-serving cell having a PCI/PCI index other than the serving cell PCI/PCI index) associated to the entity ID indicated/included in the MAC CE activation command, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Alternative-7.2 is enabled.

In one example of Alternative-7a, (a set of) two entity IDs, denoted as a first entity ID and a second entity ID, could be included/indicated/configured/provided in the MAC CE activation command. In the present disclosure, an entity ID could correspond to a PCI, a PCI index pointing to an entry/PCI in a list of PCIs that are higher layer configured to the UE, a one-bit indicator with ‘0’ (or ‘1’) indicating the serving cell PCI/PCI index and ‘1’ (or ‘0’) indicating a PCI/PCI index other than the serving cell PCI/PCI index, a multi-bit indicator with each bit index corresponding to a PCI/PCI index, PCI index 0 for the serving cell/TRP, a CORESETPoolIndex, a CORESETGroupIndex, a CORESET ID, a resource set ID/index, a resource ID/index, a TRP-specific ID/index or a TRP-specific higher layer signaling index/ID.

The inclusion/indication of the two entity IDs in the MAC CE activation command could be in addition to the SCI value/field. Alternatively, the MAC CE activation command could contain/include/indicate/configure/provide the set of two entity IDs without the SCI value/field. One or more entity IDs could be used/reserved for representing the serving cell/TRP—e.g., in the present disclosure, PCI index 0 could correspond to the serving cell/TRP. The UE could be indicated by the network the association between the entity ID(s) and the serving cell/TRP having the serving cell PCI/PCI index, and/or the association between the entity ID(s) and the non-serving (or neighboring) cell(s)/TRP(s) having PCI(s)/PCI index(es) other than the serving cell PCI/PCI index. Furthermore, in this design option, the MAC CE activation command could activate two sets of TCI states/TCI state IDs, denoted as a first set of TCI states/TCI state IDs and a second set of TCI states/TCI state IDs, from the higher layer configured list/pool of TCI states and/or one or more TCI state groups as discussed above (e.g., each provided by TCIState-Group).

In one example of Alternative-7a.1, the first set of TCI states (and therefore, the QCL source RS(s) indicated therein) activated by the MAC CE activation command is associated with the first entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the MAC CE activation command. The second set of TCI states (and therefore, the QCL source RS(s) indicated therein) activated by the MAC CE activation command is associated with the second entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the MAC CE activation command.

In one example of Alternative-7a.2, the first set of TCI states (and therefore, the QCL source RS(s) indicated therein) activated by the MAC CE activation command is associated with the second entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the MAC CE activation command. The second set of TCI states (and therefore, the QCL source RS(s) indicated therein) activated by the MAC CE activation command is associated with the first entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the MAC CE activation command.

The UE could be indicated/configured by the network whether Alternative-7a.1 and/or Alternative-7a.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-7a.1 is enabled and ‘1’ (or ‘0’) indicating the Alternative-7a.2 is enabled. The one-bit indicator could be indicated via a higher layer RRC signaling/parameter and/or in the MAC CE activation command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-7a.1 or Alternative-7a.2. For this example, if the first (or second) entry/bit position in the bitmap is set to ‘1’, Alternative-7a.1 is enabled; if the second (or first) entry/bit position in the bitmap is set to ‘1’, Alternative-7a.2 is enabled. The bitmap could be indicated via a higher layer RRC signaling/parameter and/or in the MAC CE activation command and/or via dynamic DCI based signaling (e.g., DCI format 1_1 or 1_2 with or without DL assignment).

In yet another example, if the MAC CE activation command is associated with value 0 (or 1) of CORESETPoolIndex, Alternative-7a.1 is enabled; otherwise, if the MAC CE activation command is associated with value 1 (or 0) of CORESETPoolIndex, Alternative-7a.2 is enabled.

Various design options of using one or more DCIs (e.g., DCI format 1_1 or 1_2 with or without DL assignment) to indicate one or more TCI states/TCI state IDs for receiving DL channel(s)/signal(s) or transmitting UL channel(s)/signal(s) associated with the serving cell PCI/PCI index or PCI(s)/PCI index(es) other than the serving cell PCI/PCI index are presented below.

The one or more TCI states/TCI state IDs indicated in a DCI format for beam indication (e.g., DCI format 1_1 or 1_2 with or without DL assignment) could be determined/selected from the one or more TCI states/TCI state IDs activated by one or more MAC CE activation commands as described/discussed above—e.g., the one or more TCI states/TCI state IDs in the first or second sets of TCI states/TCI state IDs activated by one or more MAC CE activation commands as described/discussed in the above design alternatives/options. In an inter-cell (multi-TRP) system, a DCI for beam indication (e.g., DCI format 1_1 or 1_2 with or without DL assignment) could be received in a CORESET associated/configured with a value of CORESETPoolIndex/CORESETGroup (e.g., 0 or 1) when the UE receives in PDCCH-Config different values (e.g., 0 and 1) of CORESETPoolIndex/CORESETGroupIndex.

In one example of Alternative-I, upon receiving a DCI for beam indication, the UE could identify the corresponding/associated CORESETPoolIndex/CORESETGroupIndex value (if configured). That is, the UE could receive a DCI for beam indication in a CORESET associated/configured with a value of CORESETPoolIndex/CORESETGroupIndex. If the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could further identify whether the corresponding DL channel(s)/signal(s) such as PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDSCH is transmitted.

In addition, if the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could identify whether the QCL source RS(s) in the TCI state(s) indicated in the DCI for beam indication (e.g., DCI format 1_1 or 1_2 with or without DL assignment) is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS(s) in the TCI state(s) indicated in the DCI for beam indication (e.g., DCI format 1_1 or 1_2 with or without DL assignment) is transmitted.

For instance, if a DCI for beam indication is received in a CORESET associated/configured with value 0 (or 1) of CORESETPoolIndex and it is associated with the serving cell/TRP having the serving cell PCI/PCI index, the UE could identify that the QCL source RS(s) in the TCI state(s) indicated in the DCI and/or the corresponding PDSCH are transmitted from/associated with the serving cell/TRP having the serving cell PCI/PCI index. If a DCI for beam indication is received in a CORESET associated/configured with value 1 (or 0) of CORESETPoolIndex, and it is associated with a non-serving cell/TRP (or neighboring cell/TRP) having a PCI/PCI index other than the serving cell PCI/PCI index, the UE could identify that the QCL source RS(s) in the TCI state(s) indicated in the DCI and/or the corresponding PDSCH are transmitted from/associated with the non-serving cell/TRP (or neighboring cell/TRP) having the PCI/PCI index other than the serving cell PCI/PCI index.

In one example of Alternative-I.1, if a DCI for beam indication (e.g., DCI format 1_1 or 1_2 with or without DL assignment) indicating one or more TCI states/TCI state IDs is associated with a CORESETPoolIndex value—the DCI for beam indication is received in a CORESET associated/configured with the CORESETPoolIndex value, the TCI state(s) (and therefore, the QCL source RS(s) indicated therein) indicated in the DCI for beam indication is associated with the PCI/PCI index (e.g., corresponding to the serving cell PCI/PCI index or a PCI/PCI index other than the serving cell PCI/PCI index) associated with the CORESETPoolIndex.

In one example of Alternative-I.2, if a DCI for beam indication (e.g., DCI format 1_1 or 1_2 with or without DL assignment) indicating one or more TCI states/TCI state IDs is associated with a first CORESETPoolIndex value—the DCI for beam indication is received in a CORESET associated/configured with the first CORESETPoolIndex value, the TCI state(s) (and therefore, the QCL source RS(s) indicated therein) indicated in the DCI for beam indication is associated with the PCI/PCI index (e.g., corresponding to the serving cell PCI/PCI index or a PCI/PCI index other than the serving cell PCI/PCI index) associated with a second CORESETPoolIndex other than the first CORESETPoolIndex.

The UE could be indicated/configured by the network whether Alternative-I.1 and/or Alternative-I.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-I.1 is enabled and ‘1’ (or ‘0’) indicating that Alternative-I.2 is enabled. The one-bit indicator could be indicated via a higher layer RRC signaling/parameter and/or in the MAC CE command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-I.1 or Alternative-I.2. For this example, if the first (or second) entry/bit position in the bitmap is set to ‘1’, Alternative-I.1 is enabled; if the second (or first) entry/bit position in the bitmap is set to ‘1’, Alternative-I.2 is enabled. The bitmap could be indicated via a higher layer RRC signaling/parameter and/or in the MAC CE command and/or via dynamic DCI based signaling (e.g., DCI format 1_1 or 1_2 with or without DL assignment).

In yet another example, if the DCI for beam indication (e.g., DCI format 1_1 or 1_2 with or without DL assignment) indicating one or more TCI states/TCI state IDs is received in a CORESET associated/configured with value 0 (or 1) of CORESETPoolIndex, Alternative-I.1 is enabled; otherwise, if the DCI for beam indication (e.g., DCI format 1_1 or 1_2 with or without DL assignment) indicating one or more TCI states/TCI state IDs is received in a CORESET associated/configured with value 1 (or 0) of CORESETPoolIndex, Alternative-I.2 is enabled.

In yet another example, when a radio link failure or a beam failure has been declared for the second CORESETPoolIndex value or the PCI/PCI index associated with the second CORESETPoolIndex value, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Alternative-I.2 is enabled.

In the present disclosure, the first or second CORESETPoolIndex value could correspond to value 0 (or 1) of CORESETPoolIndex. Furthermore, the one or more TCI states (and therefore, the corresponding QCL source RSs indicated therein) indicated in a DCI for beam indication (e.g., DCI format 1_1 or 1_2 with or without DL assignment) associated with a PCI/PCI index (and therefore, the corresponding/associated CORESETPoolIndex/CORESETGroupIndex) could be determined/selected from the one or more TCI states (and therefore, the corresponding QCL source RSs indicated therein) activated by one or more MAC CE activation commands associated with the same PCI/PCI index (and therefore, the corresponding/associated CORESETPoolIndex/CORESETGroupIndex).

Alternatively, the one or more TCI states (and therefore, the corresponding QCL source RSs indicated therein) indicated in a DCI for beam indication (e.g., DCI format 1_1 or 1_2 with or without DL assignment) could be determined/selected from the first set or the second set of one or more TCI states (and therefore, the corresponding QCL source RSs indicated therein) activated by one or more MAC CE activation commands as discussed above, wherein the first or second set of TCI states/TCI state IDs could be associated with a PCI/PCI index—e.g., the serving cell PCI/PCI index or a PCI/PCI index other than the serving cell PCI/PCI index—and, therefore, the corresponding/associated CORESETPoolIndex/CORESETGroupIndex.

In one example of Alternative-Ia, upon receiving a DCI for beam indication (e.g., DCI format 1_1 or 1_2 with or without DL assignment), the UE could identify the corresponding/associated CORESETPoolIndex/CORESETGroupIndex value (if configured). That is, the UE could receive a DCI for beam indication in a CORESET associated/configured with a value of CORESETPoolIndex/CORESETGroupIndex. For this design option, a DCI for beam indication could indicate two TCI states, denoted as a first TCI state and a second TCI state, by one or more TCI codepoints of one or more TCI/DCI fields. If the UE has been configured/indicated by the network the association between the CORESETPoolIndex values and the serving/non-serving (or neighboring) cells/TRPs, and/or, the association between the CORESETPoolIndex values and the PCIs/PCI indexes (e.g., the serving cell PCI/PCI index and PCI(s)/PCI index(es) other than the serving cell PCI/PCI index), the UE could identify whether the QCL source RS(s) in the first or second TCI state indicated in the DCI format (e.g., DCI format 1_1 or 1_2 with or without DL assignment) is transmitted from/associated with the serving cell/TRP or a non-serving cell/TRP (or neighboring cell/TRP), and/or, the exact PCI value or PCI index for either the serving cell/TRP or the non-serving cell/TRP (or neighboring cell/TRP), from which the QCL source RS(s) in the first or second TCI state indicated in the DCI format (e.g., DCI format 1_1 or 1_2 with or without DL assignment) is transmitted.

In one example of Alternative-Ia.1, if a DCI format (e.g., DCI format 1_1 or 1_2 with or without DL assignment) indicating the first and second TCI states/TCI state IDs is associated with a first CORESETPoolIndex value—the DCI format for beam indication is received in a CORESET associated/configured with the first CORESETPoolIndex value, the first TCI state (and therefore, the QCL source RS(s) indicated therein) indicated in the DCI for beam indication is associated with the PCI/PCI index (e.g., corresponding to the serving cell PCI/PCI index or a PCI/PCI index other than the serving cell PCI/PCI index) associated with the first CORESETPoolIndex value, and the second TCI state (and therefore, the QCL source RS(s) indicated therein) indicated in the DCI for beam indication is associated with the PCI/PCI index (e.g., corresponding to the serving cell PCI/PCI index or a PCI/PCI index other than the serving cell PCI/PCI index) associated with a second CORESETPoolIndex value other than the first CORESETPoolIndex value.

In one example of Alternative-Ia.2, if a DCI format (e.g., DCI format 1_1 or 1_2 with or without DL assignment) indicating the first and second TCI states/TCI state IDs is associated with a first CORESETPoolIndex value—the DCI format for beam indication is received in a CORESET associated/configured with the first CORESETPoolIndex value, the first TCI state (and therefore, the QCL source RS(s) indicated therein) indicated in the DCI for beam indication is associated with the PCI/PCI index (e.g., corresponding to the serving cell PCI/PCI index or a PCI/PCI index other than the serving cell PCI/PCI index) associated with a second CORESETPoolIndex value other than the first CORESETPoolIndex value, and the second TCI state (and therefore, the QCL source RS(s) indicated therein) indicated in the DCI for beam indication is associated with the PCI/PCI index (e.g., corresponding to the serving cell PCI/PCI index or a PCI/PCI index other than the serving cell PCI/PCI index) associated with the first CORESETPoolIndex value.

The UE could be indicated/configured by the network whether Alternative-Ia.1 and/or Alternative-Ia.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-Ia.1 is enabled and ‘1’ (or ‘0’) indicating the Alternative-Ia.2 is enabled. The one-bit indicator could be indicated via a higher layer RRC signaling/parameter and/or in the MAC CE command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-Ia.1 or Alternative-Ia.2. For this example, if the first (or second) entry/bit position in the bitmap is set to ‘1’, Alternative-Ia.1 is enabled; if the second (or first) entry/bit position in the bitmap is set to ‘1’, Alternative-Ia.2 is enabled. The bitmap could be indicated via a higher layer RRC signaling/parameter and/or in the MAC CE command and/or via dynamic DCI based signaling (e.g., DCI format 1_1 or 1_2 with or without DL assignment).

In yet another example, if the DCI for beam indication (e.g., DCI format 1_1 or 1_2 with or without DL assignment) indicating one or more TCI states/TCI state IDs is received in a CORESET associated/configured with value 0 (or 1) of CORESETPoolIndex, Alternative-Ia.1 is enabled; otherwise, if the DCI for beam indication (e.g., DCI format 1_1 or 1_2 with or without DL assignment) indicating one or more TCI states/TCI state IDs is received in a CORESET associated/configured with value 1 (or 0) of CORESETPoolIndex, Alternative-Ia.2 is enabled.

In the present disclosure, the first or second CORESETPoolIndex value could correspond to value 0 (or 1) of CORESETPoolIndex. Furthermore, the one or more TCI states—e.g., the first and/or second TCI states/TCI state IDs (and therefore, the corresponding QCL source RSs indicated therein) indicated in a DCI for beam indication (e.g., DCI format 1_1 or 1_2 with or without DL assignment) associated with a PCI/PCI index (and therefore, the corresponding/associated CORESETPoolIndex/CORESETGroupIndex) could be determined/selected from the one or more TCI states (and therefore, the corresponding QCL source RSs indicated therein) activated by one or more MAC CE activation commands associated with the same PCI/PCI index (and therefore, the corresponding/associated CORESETPoolIndex/CORESETGroupIndex).

Alternatively, the one or more TCI states—e.g., the first and/or second TCI states/TCI state IDs (and therefore, the corresponding QCL source RSs indicated therein) indicated in a DCI for beam indication (e.g., DCI format 1_1 or 1_2 with or without DL assignment) could be determined/selected from the first set or the second set of one or more TCI states (and therefore, the corresponding QCL source RSs indicated therein) activated by one or more MAC CE activation commands as discussed above, wherein the first or second set of TCI states/TCI state IDs could be associated with a PCI/PCI index—e.g., the serving cell PCI/PCI index or a PCI/PCI index other than the serving cell PCI/PCI index—and, therefore, the corresponding/associated CORESETPoolIndex/CORESETGroupIndex.

In one example of Alternative-II, a one-bit flag indicator could be included/indicated/configured/provided in a DCI format for beam indication (e.g., DCI format 1_1 or 1_2 with or without DL assignment), via one or more bits/codepoints of one or more new DCI fields or by repurposing one or more bits/codepoints of one or more existing DCI fields in the corresponding DCI format. If the one-bit flag indicator is present and set to ‘1’ (or ‘0’), the DCI for beam indication could be associated with the serving cell PCI/PCI index; in this case, the TCI state(s) (and therefore, the QCL source RS(s) indicated therein) indicated in the DCI for beam indication (e.g., DCI format 1_1 or 1_2 with or without DL assignment) could also be associated with/transmitted from the serving cell/TRP having the serving cell PCI/PCI index.

If the one-bit flag indicator is not present or set to ‘0’ (or ‘1’), the DCI for beam indication could be associated with a PCI/PCI index other than the serving cell PCI/PCI index; in this case, the TCI state(s) (and therefore, the QCL source RS(s) indicated therein) indicated in the DCI for beam indication (e.g., DCI format 1_1 or 1_2 with or without DL assignment) could also be associated with/transmitted from the non-serving cell/TRP (or neighboring cell/TRP) having the PCI/PCI index other than the serving cell PCI/PCI index.

Furthermore, the one or more TCI states (and therefore, the corresponding QCL source RSs indicated therein) indicated in a DCI for beam indication (e.g., DCI format 1_1 or 1_2 with or without DL assignment) associated with a PCI/PCI index (and therefore, the corresponding/associated CORESETPoolIndex/CORESETGroupIndex) could be determined/selected from the one or more TCI states (and therefore, the corresponding QCL source RSs indicated therein) activated by one or more MAC CE activation commands associated with the same PCI/PCI index (and therefore, the corresponding/associated CORESETPoolIndex/CORESETGroupIndex).

Alternatively, the one or more TCI states (and therefore, the corresponding QCL source RSs indicated therein) indicated in a DCI for beam indication (e.g., DCI format 1_1 or 1_2 with or without DL assignment) could be determined/selected from the first set or the second set of one or more TCI states (and therefore, the corresponding QCL source RSs indicated therein) activated by one or more MAC CE activation commands as discussed above, wherein the first or second set of TCI states/TCI state IDs could be associated with a PCI/PCI index—e.g., the serving cell PCI/PCI index or a PCI/PCI index other than the serving cell PCI/PCI index—and, therefore, the corresponding/associated CORESETPoolIndex/CORESETGroupIndex.

In one example of Alternative-IIa, a one-bit flag indicator could be included/indicated/configured/provided in a DCI for beam indication (e.g., DCI format 1_1 or 1_2 with or without DL assignment), wherein two TCI states/TCI state IDs, denoted as a first TCI state and a second TCI state, are indicated. If the one-bit flag indicator is present and set to ‘1’ (or ‘0’), the first TCI state (and therefore, the QCL source RS(s) indicated therein) indicated in the DCI for beam indication is associated with the serving cell/TRP having the serving cell PCI/PCI index, and the second TCI state (and therefore, the QCL source RS(s) indicated therein) indicated in the DCI for beam indication is associated with a PCI/PCI index other than the serving cell PCI/PCI index. If the one-bit flag indicator is present and set to ‘0’ (or ‘1’), the first TCI state (and therefore, the QCL source RS(s) indicated therein) indicated in the DCI for beam indication is associated with a PCI/PCI index other than the serving cell PCI/PCI index, and the second TCI state (and therefore, the QCL source RS(s) indicated therein) indicated in the DCI for beam indication is associated with the serving cell/TRP having the serving cell PCI/PCI index.

Furthermore, the one or more TCI states—e.g., the first and/or second TCI states/TCI state IDs (and therefore, the corresponding QCL source RSs indicated therein) indicated in a DCI for beam indication (e.g., DCI format 1_1 or 1_2 with or without DL assignment) associated with a PCI/PCI index (and therefore, the corresponding/associated CORESETPoolIndex/CORESETGroupIndex) could be determined/selected from the one or more TCI states (and therefore, the corresponding QCL source RSs indicated therein) activated by one or more MAC CE activation commands associated with the same PCI/PCI index (and therefore, the corresponding/associated CORESETPoolIndex/CORESETGroupIndex).

Alternatively, the one or more TCI states—e.g., the first and/or second TCI states/TCI state IDs (and therefore, the corresponding QCL source RSs indicated therein) indicated in a DCI for beam indication (e.g., DCI format 1_1 or 1_2 with or without DL assignment) could be determined/selected from the first set or the second set of one or more TCI states (and therefore, the corresponding QCL source RSs indicated therein) activated by one or more MAC CE activation commands as discussed above, wherein the first or second set of TCI states/TCI state IDs could be associated with a PCI/PCI index—e.g., the serving cell PCI/PCI index or a PCI/PCI index other than the serving cell PCI/PCI index—and, therefore, the corresponding/associated CORESETPoolIndex/CORESETGroupIndex.

In one example of Alternative-III, a multi-bit (more than one bit) indicator could be included/indicated/configured/contained/comprised in a DCI for beam indication to indicate the serving cell/TRP having the serving cell PCI/PCI Index and two or more non-serving cells/TRPs (or neighboring cells/TRPs) having PCIs/PCI indexes other than the serving cell PCI/PCI index in the inter-cell multi-TRP system. The number of bits n_b required for representing the multi-bit indicator could be ceil(log 2(N_nsc+1)), where N_nsc is the total number of non-serving cells/TRPs (or neighboring cells/TRPs) and ceil(x) rounds x up to the next largest integer. In this case, the n_b-bit indicator could correspond to 2\hat{ }(n_b) states, and one of the states (e.g., the first state) could correspond to the serving cell/TRP, and the rest of the states could correspond to the non-serving cells/TRPs (or neighboring cells/TRPs).

Alternatively, the number of bits n_b required for representing the multi-bit indicator could be ceil(log 2(N_nsc)). In this case, the multi-bit indicator only indicates/identifies the non-serving cells/TRPs (or neighboring cells/TRPs); if the multi-bit indicator is not present, the UE would expect that the DCI for beam indication is associated with the serving cell/TRP having the serving cell PCI/PCI index; if the multi-bit indicator is not present, the UE could also expect that the QCL source RS(s) in the TCI state(s) indicated by the DCI for beam indication is associated with/transmitted from the serving cell/TRP. The UE could be indicated by the network the association rule(s)/mapping relationship(s) between the states of the multi-bit indicator and PCIs/PCI indexes (e.g., corresponding to the serving cell PCI/PCI index and/or one or more PCIs/PCI indexes other than the serving cell PCI/PCI index) in the inter-cell multi-TRP system; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

In one example of Alternative-IV, one or more PCIs/PCI indexes could be included/indicated/configured/provided in a DCI format for beam indication (e.g., DCI format 1_1 or 1_2 with or without DL assignment), via one or more bits/codepoints of one or more new DCI fields or by repurposing one or more bits/codepoints of one or more existing DCI fields in the corresponding DCI format. The inclusion/indication of the PCI value(s)/PCI index(es) in the DCI format for beam indication could be in addition to the SCI value/field. Alternatively, the DCI format for beam indication could contain/include/indicate/configure/provide the PCI value(s)/PCI index(es) without the SCI value/field. In this case, one or more PCI values could be used/reserved for representing the serving cell/TRP—e.g., PCI index 0 could correspond to the serving cell/TRP.

The UE could be indicated by the network the association between the PCI value(s) and the serving cell/TRP and/or the association between the PCI value(s) and the non-serving (or neighboring) cell(s)/TRP(s). If the indicated PCI value is associated with the serving cell/TRP, the DCI format could indicate the beam used for transmitting the DL channel(s)/signal(s) such as PDCCH/PDSCH/CSI-RS from the serving cell/TRP; in this case, the QCL source RS in the TCI state indicated by the DCI for beam indication could also be associated with/transmitted from the serving cell/TRP having the serving cell PCI/PCI index. If the indicated PCI value is associated with a non-serving cell/TRP (or neighboring cell/TRP), the DCI format could indicate the beam used for transmitting the DL channel(s)/signal(s) such as PDCCH/PDSCH/CSI-RS from the non-serving cell/TRP (or neighboring cell/TRP) having the PCI/PCI index other than the serving cell PCI/PCI index in the inter-cell multi-TRP system; in this case, the QCL source RS in the TCI state indicated by the DCI format could also be associated with/transmitted from the non-serving cell/TRP (or neighboring cell/TRP).

That is, a PCI or PCI index pointing to an entry/PCI in a list of PCIs that are higher layer configured to the UE could be indicated/included/configured/provided in the DCI format for beam indication (e.g., DCI format 1_1 or 1_2 with or without DL assignment), via one or more bits/codepoints of one or more new DCI fields or by repurposing one or more bits/codepoints of one or more existing DCI fields in the corresponding DCI format. For this case, the TCI state(s) (and therefore, the QCL source RS(s) indicated therein) indicated in the DCI for beam indication could be associated with the PCI or PCI index indicated in the same DCI format for beam indication. The serving cell PCI index could be value 0.

In one example of Alternative-IV.1, if a DCI for beam indication (e.g., DCI format 1_1 or 1_2 with or without DL assignment) indicates/configures/includes/provides the serving cell PCI/PCI index, the TCI state(s) (and therefore, the QCL source RS(s) indicated therein) indicated in the DCI format is associated with the serving cell PCI/PCI index. If a DCI for beam indication indicates/configures/includes/provides a PCI/PCI index other than the serving cell PCI/PCI index, the TCI state(s) (and therefore, the QCL source RS(s) indicated therein) indicated in the DCI format is associated with the PCI/PCI index other than the serving cell PCI/PCI index.

In one example of Alternative-IV.2, if a DCI for beam indication (e.g., DCI format 1_1 or 1_2 with or without DL assignment) indicates/configures/includes/provides a PCI/PCI index other than the serving cell PCI/PCI index, the TCI state(s) (and therefore, the QCL source RS(s) indicated therein) indicated in the DCI format is associated with the serving cell PCI/PCI index. If a DCI for beam indication indicates/configures/includes/provides the serving cell PCI/PCI index, the TCI state(s) (and therefore, the QCL source RS(s) indicated therein) indicated in the DCI format is associated with the PCI/PCI index other than the serving cell PCI/PCI index.

The UE could be indicated/configured by the network whether Alternative-IV.1 and/or Alternative-IV.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-IV.1 is enabled and ‘1’ (or ‘0’) indicating the Alternative-IV.2 is enabled. The one-bit indicator could be indicated via a higher layer RRC signaling/parameter and/or in the MAC CE command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-IV.1 or Alternative-IV.2. For this example, if the first (or second) entry/bit position in the bitmap is set to ‘1’, Alternative-IV.1 is enabled; if the second (or first) entry/bit position in the bitmap is set to ‘1’, Alternative-IV.2 is enabled. The bitmap could be indicated via a higher layer RRC signaling/parameter and/or in the MAC CE command and/or via dynamic DCI based signaling (e.g., DCI format 1_1 or 1_2 with or without DL assignment).

In yet another example, if the DCI for beam indication (e.g., DCI format 1_1 or 1_2 with or without DL assignment) indicating one or more TCI states/TCI state IDs is received in a CORESET associated/configured with value 0 (or 1) of CORESETPoolIndex, Alternative-IV.1 is enabled; otherwise, if the DCI for beam indication (e.g., DCI format 1_1 or 1_2 with or without DL assignment) indicating one or more TCI states/TCI state IDs is received in a CORESET associated/configured with value 1 (or 0) of CORESETPoolIndex, Alternative-IV.2 is enabled.

In yet another example, when a radio link failure or a beam failure has been declared for the PCI/PCI index (e.g., the serving cell PCI/PCI index or the PCI/PCI index other than the serving cell PCI/PCI index) indicated/included in the DCI for beam indication, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Alternative-IV.2 is enabled.

Furthermore, the one or more TCI states (and therefore, the corresponding QCL source RSs indicated therein) indicated in a DCI for beam indication (e.g., DCI format 1_1 or 1_2 with or without DL assignment) associated with a PCI/PCI index (and therefore, the corresponding/associated CORESETPoolIndex/CORESETGroupIndex) could be determined/selected from the one or more TCI states (and therefore, the corresponding QCL source RSs indicated therein) activated by one or more MAC CE activation commands associated with the same PCI/PCI index (and therefore, the corresponding/associated CORESETPoolIndex/CORESETGroupIndex). Alternatively, the one or more TCI states (and therefore, the corresponding QCL source RSs indicated therein) indicated in a DCI for beam indication (e.g., DCI format 1_1 or 1_2 with or without DL assignment) could be determined/selected from the first set or the second set of one or more TCI states (and therefore, the corresponding QCL source RSs indicated therein) activated by one or more MAC CE activation commands as discussed above, wherein the first or second set of TCI states/TCI state IDs could be associated with a PCI/PCI index—e.g., the serving cell PCI/PCI index or a PCI/PCI index other than the serving cell PCI/PCI index—and, therefore, the corresponding/associated CORESETPoolIndex/CORESETGroupIndex.

In one example of Alternative-IVa, (a set of) two PCIs/PCI indexes, denoted as a first PCI/PCI index and a second PCI/PCI index, could be included/indicated/configured/provided in a DCI for beam indication, via one or more bits/codepoints of one or more new DCI fields or by repurposing one or more bits/codepoints of one or more existing DCI fields in the corresponding DCI format. The inclusion/indication of the two PCI values/PCI indexes in the DCI format for beam indication could be in addition to the SCI value/field. Alternatively, the DCI format for beam indication could contain/include/indicate/configure/provide the set of two PCI values/PCI indexes without the SCI value/field. One or more PCI values/PCI indexes could be used/reserved for representing the serving cell/TRP—e.g., in the present disclosure, PCI index 0 could correspond to the serving cell/TRP.

The UE could be indicated by the network the association between the PCI value(s)/PCI index(es) and the serving cell/TRP and/or the association between the PCI value(s)/PCI index(es) and the non-serving (or neighboring) cell(s)/TRP(s). Furthermore, in this design option, the DCI format for beam indication could indicate two TCI states, denoted as a first TCI state and a second TCI state, by one or more TCI codepoints of one or more TCI/DCI fields.

In one example of Alternative-IVa.1, the first TCI state (and therefore, the QCL source RS(s) indicated therein) indicated in the DCI for beam indication is associated with the first PCI/PCI index indicated in the same DCI format for beam indication. The second TCI state (and therefore, the QCL source RS(s) indicated therein) indicated in the DCI for beam indication is associated with the second PCI/PCI index indicated in the same DCI format for beam indication.

In one example of Alternative-IVa.2, the first TCI state (and therefore, the QCL source RS(s) indicated therein) indicated in the DCI for beam indication is associated with the second PCI/PCI index indicated in the same DCI format for beam indication. The second TCI state (and therefore, the QCL source RS(s) indicated therein) indicated in the DCI for beam indication is associated with the first PCI/PCI index indicated in the same DCI format for beam indication.

The UE could be indicated/configured by the network whether Alternative-IVa.1 and/or Alternative-IVa.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-IVa.1 is enabled and ‘1’ (or ‘0’) indicating the Alternative-IVa.2 is enabled. The one-bit indicator could be indicated via a higher layer RRC signaling/parameter and/or in the MAC CE command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-IVa.1 or Alternative-IVa.2. For this example, if the first (or second) entry/bit position in the bitmap is set to ‘1’, Alternative-IVa.1 is enabled; if the second (or first) entry/bit position in the bitmap is set to ‘1’, Alternative-IVa.2 is enabled. The bitmap could be indicated via a higher layer RRC signaling/parameter and/or in the MAC CE command and/or via dynamic DCI based signaling (e.g., DCI format 1_1 or 1_2 with or without DL assignment).

In yet another example, if the DCI for beam indication (e.g., DCI format 1_1 or 1_2 with or without DL assignment) indicating one or more TCI states/TCI state IDs is received in a CORESET associated/configured with value 0 (or 1) of CORESETPoolIndex, Alternative-IVa.1 is enabled; otherwise, if the DCI for beam indication (e.g., DCI format 1_1 or 1_2 with or without DL assignment) indicating one or more TCI states/TCI state IDs is received in a CORESET associated/configured with value 1 (or 0) of CORESETPoolIndex, Alternative-IVa.2 is enabled.

The first PCI/PCI index or the second PCI/PCI index could correspond to the serving cell PCI/PCI index or a PCI/PCI index other than the serving cell PCI/PCI index. In the present disclosure, a PCI index could point to an entry/PCI in a list of PCIs that are higher layer configured to the UE; the list of PCIs could comprise only the PCIs other than the serving cell PCI, or both the serving cell PCI and PCI(s) other than the serving cell PCIs. Furthermore, as aforementioned, the PCI index for the serving cell/TRP could correspond to value 0.

Furthermore, the one or more TCI states—e.g., the first and/or second TCI states/TCI state IDs (and therefore, the corresponding QCL source RSs indicated therein) indicated in a DCI for beam indication (e.g., DCI format 1_1 or 1_2 with or without DL assignment) associated with a PCI/PCI index (and therefore, the corresponding/associated CORESETPoolIndex/CORESETGroupIndex) could be determined/selected from the one or more TCI states (and therefore, the corresponding QCL source RSs indicated therein) activated by one or more MAC CE activation commands associated with the same PCI/PCI index (and therefore, the corresponding/associated CORESETPoolIndex/CORESETGroupIndex).

Alternatively, the one or more TCI states—e.g., the first and/or second TCI states/TCI state IDs (and therefore, the corresponding QCL source RSs indicated therein) indicated in a DCI for beam indication (e.g., DCI format 1_1 or 1_2 with or without DL assignment) could be determined/selected from the first set or the second set of one or more TCI states (and therefore, the corresponding QCL source RSs indicated therein) activated by one or more MAC CE activation commands as discussed above, wherein the first or second set of TCI states/TCI state IDs could be associated with a PCI/PCI index—e.g., the serving cell PCI/PCI index or a PCI/PCI index other than the serving cell PCI/PCI index—and, therefore, the corresponding/associated CORESETPoolIndex/CORESETGroupIndex.

In one example of Alternative-V, the codepoint indices and/or the bit-width of the codepoint indices in the DCI(s) to indicate the TCI state(s) for the PDSCH(s) could be determined across one or more TCI state(s) activated by one or more MAC CE activation commands. For instance, the UE could receive from the network a first MAC CE command activating 8 TCI states; the QCL source RS in each activated TCI state is transmitted from/associated with the serving cell/TRP and/or each activated TCI state is for a PDSCH transmitted from/associated with the serving cell/TRP. The UE could receive from the network a second MAC CE activation command activating 8 TCI states; the QCL source RS in each activated TCI state is transmitted from/associated with a non-serving cell/TRP (or neighboring cell/TRP) and/or each activated TCI state is for a PDSCH transmitted from/associated with a non-serving cell/TRP (or neighboring cell/TRP).

The UE could then receive from the network a first DCI indicating a TCI state for the PDSCH transmitted from/associated with the serving cell/TRP, where the QCL source RS in the indicated TCI state could also be transmitted from/associated with the serving cell/TRP. The UE could receive from the network a second DCI indicating a TCI state for the PDSCH transmitted from/associated with a non-serving cell/TRP (or neighboring cell/TRP), where the QCL source RS in the indicated TCI state could also be transmitted from/associated with the non-serving cell/TRP (or neighboring cell/TRP). In this example, the codepoint indices in the first and the second DCIs to indicate the TCI states for the PDSCHs could be determined across all 16 TCI states activated by the first and the second MAC CE activation commands.

The corresponding bit-width of the codepoint indices can then be determined as 4. For instance, the codepoints in the first DCI to indicate the TCI state for the PDSCH transmitted from/associated with the serving cell/TRP could be indexed from 0 to 7, while the codepoints in the second DCI to indicate the TCI state for the PDSCH transmitted from/associated with the non-serving cell/TRP (or neighboring cell/TRP) could be indexed from 8 to 15. The UE could be indicated by the network the mapping between the codepoint indices and the TCI states activated by the MAC CE activation commands. For the example discussed above, if the TCI codepoint index indicated in a DCI is 3, the UE would expect that the corresponding TCI state is for a PDSCH transmitted from/associated with the serving cell/TRP and/or the QCL source RS in the indicated TCI state is transmitted from/associated with the serving cell/TRP.

In one example of Alternative-VI, a TCI state could be associated with the serving cell/TRP having the serving cell PCI/PCI index or a non-serving cell/TRP having a PCI/PCI index other than the serving cell PCI/PCI index—e.g., the higher layer parameter TCI-State, QCL-Info, DLorJointTCI-State or UL-TCIState could include/contain/provide/indicate information related to indicating/identifying the serving cell/TRP and/or non-serving cell(s)/TRP(s). For example, a TCI state or the higher layer parameter TCI-State, QCL-Info, DLorJointTCI-State or UL-TCIState that configures a TCI state could include/indicate/configure/provide a CORESETPoolIndex value, which could be associated with the serving cell/TRP or a non-serving cell/TRP (or neighboring cell/TRP)—e.g., with value 0 (or 1) of CORESETPoolIndex associated with the serving cell PCI/PCI index and value 1 (or 0) associated with a PCI/PCI index other than the serving cell PCI/PCI index. For another example, a TCI state or the higher layer parameter TCI-State, QCL-Info, DLorJointTCI-State or UL-TCIState that configures a TCI state could include/indicate/configure/provide a one-bit flag indicator to indicate the serving cell/TRP or a non-serving cell/TRP (or neighboring cell/TRP)—e.g., with the one-bit flag indicator set to ‘0’ (or ‘1’) indicating the serving cell PCI/PCI index and ‘1’ (or ‘0’) indicating a PCI/PCI index other than the serving cell PCI/PCI index.

Yet for another example, a TCI state or the higher layer parameter TCI-State, QCL-Info, DLorJointTCI-State or UL-TCIState that configures a TCI state could include/indicate/configure/provide a multi-bit indicator to indicate the serving cell/TRP (and/or its PCI value/PCI index) and the non-serving (or neighboring) cell(s)/TRPs (and/or the corresponding PCI value(s)/PCI index(es)). Yet for another example, a TCI state or the higher layer parameter TCI-State, QCL-Info, DLorJointTCI-State or UL-TCIState that configures a TCI state could include/indicate/configure/provide a PCI value/PCI index (e.g., corresponding to the serving cell PCI/PCI index or a PCI/PCI index other than the serving cell PCI/PCI index). Yet for another example, one or more serving cell IDs (SCIs) in a TCI state could be reserved/used to indicate one or more non-serving (or neighboring) cells/TRPs information. Other details about the indication/identification of the serving/non-serving (or neighboring) cells/TRPs information in a TCI state could be according to the US provisional patent application 63/067,122 filed on Aug. 18, 2020.

Based on the above, a TCI state (and therefore, the corresponding QCL source RS(s) indicated therein) indicated in the DCI for beam indication could be associated with the serving cell/TRP having the serving cell PCI/PCI index or a non-serving (or neighboring) cell/TRP having a PCI/PCI index other than the serving cell PCI/PCI index. If the serving cell/TRP information is indicated in a TCI state or the higher layer parameter TCI-State, QCL-Info, DLorJointTCI-State or UL-TCIState that configures a TCI state indicated in the DCI format for beam indication, the corresponding DL channel(s)/signal(s) such as PDSCH could be transmitted from/associated with the serving cell/TRP; in this case, the QCL source RS(s) in the TCI state indicated in the DCI format for beam indication could also be associated with/transmitted from the serving cell/TRP.

If the non-serving (or neighboring) cell/TRP information is indicated in a TCI state or the higher layer parameter TCI-State, QCL-Info, DLorJointTCI-State or UL-TCIState that configures a TCI state indicated in the DCI format for beam indication, the corresponding DL channel(s)/signal(s) such as PDSCH could be transmitted from/associated with the non-serving cell/TRP (or neighboring cell/TRP) in the inter-cell multi-TRP system; in this case, the QCL source RS(s) in the TCI state indicated in the DCI format for beam indication could also be associated with/transmitted from the non-serving cell/TRP (or neighboring cell/TRP).

In one example of Alternative-VI.1, if a TCI state indicated in the DCI for beam indication (e.g., DCI format 1_1 or 1_2 with or without DL assignment) is associated with the serving cell/TRP having the serving cell PCI/PCI index—e.g., the higher layer parameter TCI-State, QCL-Info, DLorJointTCI-State or UL-TCIState that configures the TCI state indicates/includes/configures/provides information related to the serving cell/TRP having the serving cell PCI/PCI index, the corresponding QCL source RS(s) indicated in the TCI state could be associated with the serving cell/TRP having the serving cell PCI/PCI index. If a TCI state indicated in the DCI for beam indication (e.g., DCI format 1_1 or 1_2 with or without DL assignment) is associated with a non-serving cell/TRP having a PCI/PCI index other than the serving cell PCI/PCI index—e.g., the higher layer parameter TCI-State, QCL-Info, DLorJointTCI-State or UL-TCIState that configures the TCI state indicates/includes/configures/provides information related to the non-serving cell/TRP having the PCI/PCI index other than the serving cell PCI/PCI index, the corresponding QCL source RS(s) indicated in the TCI state could be associated with the non-serving cell/TRP having the PCI/PCI index other than the serving cell PCI/PCI index.

In one example of Alternative-VI.2, if a TCI state indicated in the DCI for beam indication (e.g., DCI format 1_1 or 1_2 with or without DL assignment) is associated with a non-serving cell/TRP having a PCI/PCI index other than the serving cell PCI/PCI index—e.g., the higher layer parameter TCI-State, QCL-Info, DLorJointTCI-State or UL-TCIState that configures the TCI state indicates/includes/configures/provides information related to the non-serving cell/TRP having the PCI/PCI index other than the serving cell PCI/PCI index, the corresponding QCL source RS(s) indicated in the TCI state could be associated with the serving cell/TRP having the serving cell PCI/PCI index. If a TCI state indicated in the DCI for beam indication (e.g., DCI format 1_1 or 1_2 with or without DL assignment) is associated with the serving cell/TRP having the serving cell PCI/PCI index—e.g., the higher layer parameter TCI-State, QCL-Info, DLorJointTCI-State or UL-TCIState that configures the TCI state indicates/includes/configures/provides information related to the serving cell/TRP having the serving cell PCI/PCI index, the corresponding QCL source RS(s) indicated in the TCI state could be associated with the non-serving cell/TRP having the PCI/PCI index other than the serving cell PCI/PCI index.

The UE could be indicated/configured by the network whether Alternative-VI.1 and/or Alternative-VI.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-VI.1 is enabled for at least one TCI state indicated in the DCI for beam indication and ‘1’ (or ‘0’) indicating that Alternative-VI.2 is enabled for at least one TCI state indicated in the DCI for beam indication. The one-bit indicator could be indicated via a higher layer RRC signaling/parameter and/or in the MAC CE command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-VI.1 or Alternative-VI.2. For this example, if the first (or second) entry/bit position in the bitmap is set to ‘1’, Alternative-VI.1 is enabled for at least one TCI state indicated in the DCI for beam indication; if the second (or first) entry/bit position in the bitmap is set to ‘1’, Alternative-VI.2 is enabled for at least one TCI state indicated in the DCI for beam indication. The bitmap could be indicated via a higher layer RRC signaling/parameter and/or in the MAC CE command and/or via dynamic DCI based signaling (e.g., DCI format 1_1 or 1_2 with or without DL assignment).

In yet another example, if the DCI for beam indication (e.g., DCI format 1_1 or 1_2 with or without DL assignment) indicating one or more TCI states/TCI state IDs is received in a CORESET associated/configured with value 0 (or 1) of CORESETPoolIndex, Alternative-VI.1 is enabled for at least one TCI state indicated in the DCI for beam indication; otherwise, if the DCI for beam indication (e.g., DCI format 1_1 or 1_2 with or without DL assignment) indicating one or more TCI states/TCI state IDs is received in a CORESET associated/configured with value 1 (or 0) of CORESETPoolIndex, Alternative-VI.2 is enabled for at least one TCI state indicated in the DCI for beam indication.

In yet another, when a radio link failure or a beam failure has been declared for the PCI/PCI index (e.g., the serving cell PCI/PCI index or the PCI/PCI index other than the serving cell PCI/PCI index) associated to a TCI state—e.g., the higher layer parameter TCI-State, QCL-Info, DLorJointTCI-State or UL-TCIState that configures the TCI state indicates/includes/configures/provides information related to the PCI/PCI index—indicated in the DCI for beam indication, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Alternative-VI.2 is enabled for at least the TCI state.

The above design options and examples apply to when more than one (e.g., 2) TCI states/TCI state IDs are indicated in a DCI for beam indication (e.g., DCI format 1_1 or 1_2 with or without DL assignment). Furthermore, the one or more TCI states—e.g., the first and/or second TCI states/TCI state IDs (and therefore, the corresponding QCL source RSs indicated therein) indicated in a DCI for beam indication (e.g., DCI format 1_1 or 1_2 with or without DL assignment) associated with a PCI/PCI index (and therefore, the corresponding/associated CORESETPoolIndex/CORESETGroupIndex) could be determined/selected from the one or more TCI states (and therefore, the corresponding QCL source RSs indicated therein) activated by one or more MAC CE activation commands associated with the same PCI/PCI index (and therefore, the corresponding/associated CORESETPoolIndex/CORESETGroupIndex).

Alternatively, the one or more TCI states—e.g., the first and/or second TCI states/TCI state IDs (and therefore, the corresponding QCL source RSs indicated therein) indicated in a DCI for beam indication (e.g., DCI format 1_1 or 1_2 with or without DL assignment) could be determined/selected from the first set or the second set of one or more TCI states (and therefore, the corresponding QCL source RSs indicated therein) activated by one or more MAC CE activation commands as discussed above, wherein the first or second set of TCI states/TCI state IDs could be associated with a PCI/PCI index—e.g., the serving cell PCI/PCI index or a PCI/PCI index other than the serving cell PCI/PCI index—and, therefore, the corresponding/associated CORESETPoolIndex/CORESETGroupIndex.

In one example of Alternative-VII, one or more entity IDs could be included/indicated/configured/provided in a DCI for beam indication (e.g., DCI format 1_1 or 1_2 with or without DL assignment), via one or more bits/codepoints of one or more new DCI fields or by repurposing one or more bits/codepoints of one or more existing DCI fields in the corresponding DCI format. In the present disclosure, an entity ID could correspond to a PCI, a PCI index pointing to an entry/PCI in a list of PCIs that are higher layer configured to the UE, a one-bit indicator with ‘0’ (or ‘1’) indicating the serving cell PCI/PCI index and ‘1’ (or ‘0’) indicating a PCI/PCI index other than the serving cell PCI/PCI index, a multi-bit indicator with each bit index corresponding to a PCI/PCI index, PCI index 0 for the serving cell/TRP, a CORESETPoolIndex, a CORESETGroupIndex, a CORESET ID, a resource set ID/index, a resource ID/index, a TRP-specific ID/index or a TRP-specific higher layer signaling index/ID.

The inclusion/indication of the entity ID(s) in the DCI format for beam indication could be in addition to the SCI value/field. Alternatively, the DCI format for beam indication could contain/include/indicate/configure/provide the entity ID(s) without the SCI value/field. In this case, one or more entity IDs could be used/reserved for representing the serving cell/TRP—e.g., PCI index 0 could correspond to the serving cell/TRP. The UE could be indicated by the network the association between the entity ID(s) and the serving cell/TRP having the serving cell PCI/PCI index, and/or the association between the entity ID(s) and the non-serving (or neighboring) cell(s)/TRP(s) having PCI(s)/PCI index(es) other than the serving cell PCI/PCI index.

If the indicated entity ID is associated with the serving cell/TRP, the DCI for beam indication could indicate the beam(s) used for transmitting the DL channel(s)/signal(s) such as PDCCH/PDSCH/CSI-RS from the serving cell/TRP; in this case, the QCL source RS in the TCI state indicated in the DCI format could also be associated with/transmitted from the serving cell/TRP. If the indicated entity ID is associated with a non-serving cell/TRP (or neighboring cell/TRP), the DCI for beam indication could indicate the beam(s) used for transmitting the DL channel(s)/signal(s) from the non-serving cell/TRP (or neighboring cell/TRP) in the inter-cell multi-TRP system; in this case, the QCL source RS in the TCI state indicated in the DCI format could also be associated with/transmitted from the non-serving cell/TRP (or neighboring cell/TRP).

That is, an entity ID could be indicated/included/configured/provided in the DCI format for beam indication, via one or more bits/codepoints of one or more new DCI fields or by repurposing one or more bits/codepoints of one or more existing DCI fields in the corresponding DCI format. For this case, the TCI state(s) (and therefore, the QCL source RS(s) indicated therein) indicated in the DCI format for beam indication could be associated with the entity ID (and therefore, the associated/corresponding serving cell or non-serving cell) indicated in the same DCI for beam indication.

In one example of Alternative-VII.1, if a DCI for beam indication (e.g., DCI format 1_1 or 1_2 with or without DL assignment) indicates/configures/includes/provides an entity ID associated with/corresponding to the serving cell—e.g., the serving cell PCI/PCI index, the TCI state(s) (and therefore, the QCL source RS(s) indicated therein) indicated in the DCI for beam indication is associated with the serving cell—e.g., the serving cell PCI/PCI index. If a DCI for beam indication (e.g., DCI format 1_1 or 1_2 with or without DL assignment) indicates/configures/includes/provides an entity ID associated with/corresponding to a non-serving cell—e.g., a PCI/PCI index other than the serving cell PCI/PCI index, the TCI state(s) (and therefore, the QCL source RS(s) indicated therein) indicated in the DCI for beam indication is associated with the non-serving cell—e.g., the PCI/PCI index other than the serving cell PCI/PCI index.

In one example of Alternative-VII.2, if a DCI for beam indication (e.g., DCI format 1_1 or 1_2 with or without DL assignment) indicates/configures/includes/provides an entity ID associated with/corresponding to a non-serving cell—e.g., a PCI/PCI index other than the serving cell PCI/PCI index, the TCI state(s) (and therefore, the QCL source RS(s) indicated therein) indicated in the DCI for beam indication is associated with the serving cell—e.g., the serving cell PCI/PCI index. If a DCI for beam indication (e.g., DCI format 1_1 or 1_2 with or without DL assignment) indicates/configures/includes/provides an entity ID associated with/corresponding to the serving cell—e.g., the serving cell PCI/PCI index, the TCI state(s) (and therefore, the QCL source RS(s) indicated therein) indicated in the DCI for beam indication is associated with the non-serving cell—e.g., the PCI/PCI index other than the serving cell PCI/PCI index.

The UE could be indicated/configured by the network whether Alternative-VII.1 and/or Alternative-VII.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-VII.1 is enabled and ‘1’ (or ‘0’) indicating the Alternative-VII.2 is enabled. The one-bit indicator could be indicated via a higher layer RRC signaling/parameter and/or in the MAC CE command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-VII.1 or Alternative-VII.2. For this example, if the first (or second) entry/bit position in the bitmap is set to ‘1’, Alternative-VII.1 is enabled; if the second (or first) entry/bit position in the bitmap is set to ‘1’, Alternative-VII.2 is enabled. The bitmap could be indicated via a higher layer RRC signaling/parameter and/or in the MAC CE command and/or via dynamic DCI based signaling (e.g., DCI format 1_1 or 1_2 with or without DL assignment).

In yet another example, if the DCI for beam indication (e.g., DCI format 1_1 or 1_2 with or without DL assignment) indicating one or more TCI states/TCI state IDs is received in a CORESET associated/configured with value 0 (or 1) of CORESETPoolIndex, Alternative-VII.1 is enabled; otherwise, if the DCI for beam indication (e.g., DCI format 1_1 or 1_2 with or without DL assignment) indicating one or more TCI states/TCI state IDs is received in a CORESET associated/configured with value 1 (or 0) of CORESETPoolIndex, Alternative-VII.2 is enabled.

In yet another example, when a radio link failure or a beam failure has been declared for the cell (e.g., the serving cell having the serving cell PCI/PCI index or a non-serving cell having a PCI/PCI index other than the serving cell PCI/PCI index) associated to the entity ID indicated/included in the DCI for beam indication, e.g., the UE has detected the radio link failure or the beam failure and sent to the network radio link/beam failure recovery request, and the radio link failure or the beam failure has not been recovered or is still in progress, e.g., the UE has not received from the network radio link/beam failure recover response, Alternative-VII.2 is enabled.

Furthermore, the one or more TCI states (and therefore, the corresponding QCL source RSs indicated therein) indicated in a DCI for beam indication (e.g., DCI format 1_1 or 1_2 with or without DL assignment) associated with a PCI/PCI index (and therefore, the corresponding/associated CORESETPoolIndex/CORESETGroupIndex) could be determined/selected from the one or more TCI states (and therefore, the corresponding QCL source RSs indicated therein) activated by one or more MAC CE activation commands associated with the same PCI/PCI index (and therefore, the corresponding/associated CORESETPoolIndex/CORESETGroupIndex).

Alternatively, the one or more TCI states (and therefore, the corresponding QCL source RSs indicated therein) indicated in a DCI for beam indication (e.g., DCI format 1_1 or 1_2 with or without DL assignment) could be determined/selected from the first set or the second set of one or more TCI states (and therefore, the corresponding QCL source RSs indicated therein) activated by one or more MAC CE activation commands as discussed above, wherein the first or second set of TCI states/TCI state IDs could be associated with a PCI/PCI index—e.g., the serving cell PCI/PCI index or a PCI/PCI index other than the serving cell PCI/PCI index—and, therefore, the corresponding/associated CORESETPoolIndex/CORESETGroupIndex.

In one example of Alternative-VIIa, (a set of) two entity IDs, denoted as a first entity ID and a second entity ID, could be included/indicated/configured/provided in a DCI for beam indication (e.g., DCI format 1_1 or 1_2 with or without DL assignment), via one or more bits/codepoints of one or more new DCI fields or by repurposing one or more bits/codepoints of one or more existing DCI fields in the corresponding DCI format. In the present disclosure, an entity ID could correspond to a PCI, a PCI index pointing to an entry/PCI in a list of PCIs that are higher layer configured to the UE, a one-bit indicator with ‘0’ (or ‘1’) indicating the serving cell PCI/PCI index and ‘1’ (or ‘0’) indicating a PCI/PCI index other than the serving cell PCI/PCI index, a multi-bit indicator with each bit index corresponding to a PCI/PCI index, PCI index 0 for the serving cell/TRP, a CORESETPoolIndex, a CORESETGroupIndex, a CORESET ID, a resource set ID/index, a resource ID/index, a TRP-specific ID/index or a TRP-specific higher layer signaling index/ID.

The inclusion/indication of the two entity IDs in the DCI format for beam indication could be in addition to the SCI value/field. Alternatively, the DCI format for beam indication could contain/include/indicate/configure/provide the set of two entity IDs without the SCI value/field. One or more entity IDs could be used/reserved for representing the serving cell/TRP—e.g., in the present disclosure, PCI index 0 could correspond to the serving cell/TRP.

The UE could be indicated by the network the association between the entity ID(s) and the serving cell/TRP having the serving cell PCI/PCI index, and/or the association between the entity ID(s) and the non-serving (or neighboring) cell(s)/TRP(s) having PCI(s)/PCI index(es) other than the serving cell PCI/PCI index. Furthermore, in this design option, the DCI format for beam indication could indicate two TCI states, denoted as a first TCI state and a second TCI state, by one or more TCI codepoints of one or more TCI/DCI fields.

In one example of Alternative-VIIa.1, the first TCI state (and therefore, the QCL source RS(s) indicated therein) indicated in the DCI for beam indication is associated with the first entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the same DCI format. The second TCI state (and therefore, the QCL source RS(s) indicated therein) indicated in the DCI for beam indication is associated with the second entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the same DCI format.

In one example of Alternative-VIIa.2, the first TCI state (and therefore, the QCL source RS(s) indicated therein) indicated in the DCI for beam indication is associated with the second entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the same DCI format. The second TCI state (and therefore, the QCL source RS(s) indicated therein) indicated in the DCI for beam indication is associated with the first entity ID—and therefore, the associated/corresponding cell (e.g., the serving cell/TRP having the serving cell PCI/PCI index or a non-serving cell/TRP having a PCI/PCI index other than the serving cell PCI/PCI index)—indicated in the same DCI format.

The UE could be indicated/configured by the network whether Alternative-VIIa.1 and/or Alternative-VIIa.2 is enabled; the corresponding indication/configuration could be via higher layer RRC signaling and/or MAC CE command and/or dynamic DCI based signaling.

In one example, the UE could be indicated/configured by the network a one-bit indicator (the one-bit indicator could be set to either ‘0’ or ‘1’) with ‘0’ (or ‘1’) indicating that Alternative-VIIa.1 is enabled and ‘1’ (or ‘0’) indicating the Alternative-VIIa.2 is enabled. The one-bit indicator could be indicated via a higher layer RRC signaling/parameter and/or in the MAC CE command and/or via dynamic DCI based signaling (e.g., DCI format 1_1 or 1_2 with or without DL assignment).

In another example, the UE could be indicated/configured by the network a bitmap with each entry/bit position in the bitmap corresponding to either Alternative-VIIa.1 or Alternative-VIIa.2. For this example, if the first (or second) entry/bit position in the bitmap is set to ‘1’, Alternative-VIIa.1 is enabled; if the second (or first) entry/bit position in the bitmap is set to ‘1’, Alternative-VIIa.2 is enabled. The bitmap could be indicated via a higher layer RRC signaling/parameter and/or in the MAC CE command and/or via dynamic DCI based signaling (e.g., DCI format 1_1 or 1_2 with or without DL assignment).

In yet another example, if the DCI for beam indication (e.g., DCI format 1_1 or 1_2 with or without DL assignment) indicating one or more TCI states/TCI state IDs is received in a CORESET associated/configured with value 0 (or 1) of CORESETPoolIndex, Alternative-VIIa.1 is enabled; otherwise, if the DCI for beam indication (e.g., DCI format 1_1 or 1_2 with or without DL assignment) indicating one or more TCI states/TCI state IDs is received in a CORESET associated/configured with value 1 (or 0) of CORESETPoolIndex, Alternative-VIIa.2 is enabled.

Furthermore, the one or more TCI states—e.g., the first and/or second TCI states/TCI state IDs (and therefore, the corresponding QCL source RSs indicated therein) indicated in a DCI for beam indication (e.g., DCI format 1_1 or 1_2 with or without DL assignment) associated with a PCI/PCI index (and therefore, the corresponding/associated CORESETPoolIndex/CORESETGroupIndex) could be determined/selected from the one or more TCI states (and therefore, the corresponding QCL source RSs indicated therein) activated by one or more MAC CE activation commands associated with the same PCI/PCI index (and therefore, the corresponding/associated CORESETPoolIndex/CORESETGroupIndex).

Alternatively, the one or more TCI states—e.g., the first and/or second TCI states/TCI state IDs (and therefore, the corresponding QCL source RSs indicated therein) indicated in a DCI for beam indication (e.g., DCI format 1_1 or 1_2 with or without DL assignment) could be determined/selected from the first set or the second set of one or more TCI states (and therefore, the corresponding QCL source RSs indicated therein) activated by one or more MAC CE activation commands as discussed above, wherein the first or second set of TCI states/TCI state IDs could be associated with a PCI/PCI index—e.g., the serving cell PCI/PCI index or a PCI/PCI index other than the serving cell PCI/PCI index—and, therefore, the corresponding/associated CORESETPoolIndex/CORESETGroupIndex.

For Alternative-0 based (candidate) TCI states activation, wherein one or more of the (candidate) TCI states (and therefore, the QCL source RSs indicated therein) activated by a MAC CE activation command could be transmitted from/associated with either the serving cell/TRP having the serving cell PCI/PCI index or the non-serving cell(s)/TRP(s) (or neighboring cell(s)/TRP(s)) having PCI(s)/PCI index(es) other than the serving cell PCI/PCI index, Alternative-1 based (candidate) TCI states activation, wherein the UE could identify whether one or more of the (candidate) TCI states (and therefore, the QCL source RSs indicated therein) activated by the MAC CE activation command are transmitted from/associated with either the serving cell/TRP (and/or its PCI value) or a non-serving cell/TRP (or neighboring cell/TRP) (and/or its PCI value) via the CORESETPoolIndex value (if configured) indicated in the MAC CE activation command, Alternative-1a based TCI states activation, Alternative-1b based TCI states activation, Alternative-1c based TCI states activation, Alternative-2 based (candidate) TCI states activation, wherein the UE could identify whether one or more of the candidate TCI states (and therefore, the QCL source RSs indicated therein) activated by the MAC CE activation command are transmitted from/associated with either the serving cell/TRP (and/or its PCI value) or a non-serving cell/TRP (or neighboring cell/TRP) (and/or its PCI value) via the one-bit flag indicator indicated/configured/included/contained/comprised in the MAC CE activation command, Alternative-2a based TCI states activation, Alternative-3 based candidate TCI states activation, wherein the UE could identify whether one or more of the candidate TCI states (and therefore, the QCL source RSs indicated therein) activated by the MAC CE activation command are transmitted from/associated with either the serving cell/TRP (and/or its PCI value) or a non-serving cell/TRP (or neighboring cell/TRP) (and/or its PCI value) via the multi-bit indicator indicated/configured/provided/included/comprised in the MAC CE activation command, Alternative-4 based candidate TCI states activation, wherein the UE could identify whether one or more of the candidate TCI states (and therefore, the QCL source RSs indicated therein) activated by the MAC CE activation command are transmitted from/associated with either the serving cell/TRP (and/or its PCI value) or a non-serving cell/TRP (or neighboring cell/TRP) (and/or its PCI value) via the PCI value/PCI index indicated in the MAC CE activation command, Alternative-4a based (candidate) TCI states activation, Alternative-5 based candidate TCI states activation, wherein the UE could identify whether one or more of the candidate TCI states (and therefore, the QCL source RSs indicated therein) activated by the MAC CE activation command are transmitted from/associated with either the serving cell/TRP (and/or its PCI value) or a non-serving cell/TRP (or neighboring cell/TRP) (and/or its PCI value) via the SCI value indicated/configured/included/contained/comprised in the MAC CE activation command, Alternative-6 based candidate TCI states activation, Alternative-7 based candidate TCI states activation, and Alternative-7a based (candidate) TCI states activation,

In one example, the Alternative-I based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the CORESETPoolIndex value (if configured) associated with the DCI for beam indication.

That is, DMRS antenna ports for PDCCH receptions, DMRS antenna ports for PDSCH receptions or CSI-RS associated with a first (or second) CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in the TCI state indicated in the DCI for beam indication, wherein the DCI for beam indication is also associated with the (same) first (or second) CORESETPoolIndex value—the DCI for beam indication is received in a CORESET associated/configured with the first (or second) CORESETPoolIndex. Alternatively, DMRS antenna ports for PDCCH receptions, DMRS antenna ports for PDSCH receptions or CSI-RS associated with a first (or second) CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in the TCI state indicated in the DCI for beam indication, wherein the DCI for beam indication is associated with the second (or first) CORESETPoolIndex value—the DCI for beam indication is received in a CORESET associated/configured with the second (or first) CORESETPoolIndex value.

In another example, the Alternative-Ia based TCI state indication could be applied for one or more DL channels/signals. That is, DMRS antenna ports for PDCCH receptions, DMRS antenna ports for PDSCH receptions or CSI-RS associated with a first CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in a first (or second) TCI state indicated in the DCI for beam indication, wherein the first (or second) TCI state is associated with the first (or second) CORESETPoolIndex value, and DMRS antenna ports for PDSCH receptions or CSI-RS associated with a second CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in a second (or first) TCI state indicated in the DCI for beam indication, wherein the second (or first) TCI state is associated with the second (or first) CORESETPoolIndex value.

Alternatively, DMRS antenna ports for PDCCH receptions, DMRS antenna ports for PDSCH receptions or CSI-RS associated with a first CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in the second (or first) TCI state indicated in the DCI for beam indication, wherein the second (or first) TCI state is associated with the first (or second) CORESETPoolIndex value, and DMRS antenna ports for PDSCH receptions or CSI-RS associated with a second CORESETPoolIndex value—and therefore, the associated/corresponding PCI/PCI index corresponding to the serving cell PCI/PCI index or a PCI/PCI index other than the serving cell PCI/PCI index—could be quasi co-located (QCL'ed) with the set of RSs in the first (or second) TCI state indicated in the DCI for beam indication, wherein the first (or second) TCI state could be associated with the second (or first) CORESETPoolIndex value.

For this case, the DCI for beam indication could be associated with the first (or second) CORESETPoolIndex—and therefore, the corresponding/associated PCI/PCI index corresponding to the serving cell PCI/PCI index or a PCI/PCI index other than the serving cell PCI/PCI index—i.e., the DCI for beam indication is received in a CORESET associated/configured with the first (or second) CORESETPoolIndex value. Furthermore, the first (or second) CORESETPoolIndex value could correspond value 0 or 1, e.g., provided in the higher layer parameter PDCCH-Config.

In yet another example, the Alternative-II based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the one-bit flag indicator in the DCI format for beam indication. That is, DMRS antenna ports for PDCCH receptions, DMRS antenna ports for PDSCH receptions or CSI-RS associated with the serving cell PCI/PCI index could be QCL'ed with the set of RSs in the TCI state indicated in the DCI for beam indication, wherein the DCI format for beam indication indicates/configures/includes/provides a one-bit flag indicator set to ‘0’ (or ‘1’). Furthermore, DMRS antenna ports for PDCCH receptions, DMRS antenna ports for PDSCH receptions or CSI-RS associated with a PCI/PCI index other than the serving cell PCI/PCI index could be QCL'ed with the set of RSs in the TCI state indicated in the DCI for beam indication, wherein the DCI format for beam indication indicates/configures/includes/provides a one-bit flag indicator set to ‘1’ (or ‘0’).

In yet another example, the Alternative-IIa based TCI state indication could be applied for one or more DL channels/signals. That is, DMRS antenna ports for PDCCH receptions, DMRS antenna ports for PDSCH receptions or CSI-RS associated with the serving cell PCI/PCI index could be QCL'ed with the set of RSs in the first (or second) TCI state indicated in the DCI for beam indication, and DMRS antenna ports for PDCCH receptions, DMRS antenna ports for PDSCH receptions or CSI-RS associated with a PCI/PCI index other than the serving cell PCI/PCI index could be QCL'ed with the set of RSs in the second (or first) TCI state indicated in the DCI for beam indication, wherein the DCI format for beam indication indicates/configures/includes/provides a one-bit flag indicator set to ‘1’ (or ‘0’).

Alternatively, DMRS antenna ports for PDCCH receptions, DMRS antenna ports for PDSCH receptions or CSI-RS associated with the PCI/PCI index other than the serving cell PCI/PCI index could be QCL'ed with the set of RSs in the first (or second) TCI state indicated in the DCI for beam indication, and DMRS antenna ports for PDCCH receptions, DMRS antenna ports for PDSCH receptions or CSI-RS associated with the serving cell PCI/PCI index could be QCL'ed with the set of RSs in the second (or first) TCI state indicated in the DCI for beam indication, wherein the DCI format for beam indication indicates/configures/includes/provides a one-bit flag indicator set to ‘0’ (or ‘1’).

In yet another example, the Alternative-III based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the multi-bit indicator in the DCI format for beam indication.

In yet another example, the Alternative-IV based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the PCI value/PCI index indicated in the DCI format for beam indication.

That is, DMRS antenna ports for PDCCH receptions, DMRS antenna ports for PDSCH receptions or CSI-RS associated with the serving cell PCI/PCI index could be QCL'ed with the set of RSs in the TCI state indicated in the DCI for beam indication, wherein the DCI format for beam indication indicates/configures/includes/provides the serving cell PCI/PCI index, and DMRS antenna ports for PDCCH receptions, DMRS antenna ports for PDSCH receptions or CSI-RS associated with a PCI/PCI index other than the serving cell PCI/PCI index could be QCL'ed with the set of RSs in the TCI state indicated in the DCI for beam indication, wherein the DCI format for beam indication indicates/configures/includes/provides the PCI/PCI index other than the serving cell PCI/PCI index.

Alternatively, DMRS antenna ports for PDCCH receptions, DMRS antenna ports for PDSCH receptions or CSI-RS associated with the serving cell PCI/PCI index could be QCL'ed with the set of RSs in the TCI state indicated in the DCI for beam indication, wherein the DCI format for beam indication indicates/configures/includes/provides the PCI/PCI index other than the serving cell PCI/PCI index, and DMRS antenna ports for PDCCH receptions, DMRS antenna ports for PDSCH receptions or CSI-RS associated with the PCI/PCI index other than the serving cell PCI/PCI index could be QCL'ed with the set of RSs in the TCI state indicated in the DCI for beam indication, wherein the DCI format for beam indication indicates/configures/includes/provides the serving cell PCI/PCI index.

In yet another example, the Alternative-IVa based TCI state indication could be applied for one or more DL channels/signals. That is, DMRS antenna ports for PDCCH receptions, DMRS antenna ports for PDSCH receptions or CSI-RS associated with the first PCI/PCI index could be QCL'ed with the set of RSs in the first (or second) TCI state indicated in the DCI for beam indication, wherein the first (or second) TCI state is associated with the first (or second) PCI/PCI index, and DMRS antenna ports for PDCCH receptions, DMRS antenna ports for PDSCH receptions or CSI-RS associated with the second PCI/PCI index could be QCL'ed with the set of RSs in the second (or first) TCI state indicated in the DCI for beam indication, wherein the second (or first) TCI state is associated with the second (or first) PCI/PCI index.

Alternatively, DMRS antenna ports for PDCCH receptions, DMRS antenna ports for PDSCH receptions or CSI-RS associated with the first PCI/PCI index could be QCL'ed with the set of RSs in the first (or second) TCI state indicated in the DCI format for beam indication, wherein the first (or second) TCI state is associated with the second (or first) PCI/PCI index, and DMRS antenna ports for PDCCH receptions, DMRS antenna ports for PDSCH receptions or CSI-RS associated with the second PCI/PCI index could be QCL'ed with the set of RSs in the second (or first) TCI state indicated in the DCI for beam indication, wherein the second (or first) TCI state is also associated with the first (or second) PCI/PCI index. As aforementioned, the first (or second) PCI/PCI index could correspond to the serving cell PCI/PCI index or a PCI/PCI index other than the serving cell PCI/PCI index.

In yet another example, the Alternative-V based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the association/mapping between the codepoint indices in the DCI(s) for the PDSCH beam indication and the candidate TCI states activated by the MAC CE activation command.

In yet another example, the Alternative-VI based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the serving/non-serving (or neighboring) cells/TRPs information indicated in the TCI state or the higher layer parameter TCI-State, QCL-Info, DLorJointTCI-State or UL-TCIState that configures the TCI state indicated in the DCI format for beam indication.

That is, DMRS antenna ports for PDCCH receptions, DMRS antenna ports for PDSCH receptions or CSI-RS associated with the serving cell PCI/PCI index could be QCL'ed with the set of RSs in the TCI state indicated in the DCI for beam indication, wherein the TCI state is associated with the serving cell/TRP having the serving cell PCI/PCI index—e.g., the higher layer parameter TCI-State, QCL-Info, DLorJointTCI-State or UL-TCIState that configures the TCI state indicates/includes/configures/provides information related to the serving cell/TRP having the serving cell PCI/PCI index, and DMRS antenna ports for PDCCH receptions, DMRS antenna ports for PDSCH receptions or CSI-RS associated with a PCI/PCI index other than the serving cell PCI/PCI index could be QCL'ed with the set of RSs in the TCI state indicated in the DCI for beam indication, wherein the TCI state is associated with the PCI/PCI index other than the serving cell PCI/PCI index—e.g., the higher layer parameter TCI-State, QCL-Info, DLorJointTCI-State or UL-TCIState that configures the TCI state indicates/includes/configures/provides information related to the non-serving cell/TRP having the PCI/PCI index other than the serving cell PCI/PCI index.

Alternatively, DMRS antenna ports for PDCCH receptions, DMRS antenna ports for PDSCH receptions or CSI-RS associated with the serving cell PCI/PCI index could be QCL'ed with the set of RSs in the TCI state indicated in the DCI for beam indication, wherein the TCI state is associated with the non-serving cell/TRP having the PCI/PCI index other than the serving cell PCI/PCI index—e.g., the higher layer parameter TCI-State, QCL-Info, DLorJointTCI-State or UL-TCIState that configures the TCI state indicates/includes/configures/provides information related to the non-serving cell/TRP having the PCI/PCI index other than the serving cell PCI/PCI index, and DMRS antenna ports for PDCCH receptions, DMRS antenna ports for PDSCH receptions or CSI-RS associated with the PCI/PCI index other than the serving cell PCI/PCI index could be QCL'ed with the set of RSs in the TCI state indicated in the DCI for beam indication, wherein the TCI state is associated with the serving cell PCI/PCI index—e.g., the higher layer parameter TCI-State, QCL-Info, DLorJointTCI-State or UL-TCIState that configures the TCI state indicates/includes/configures/provides information related to the serving cell/TRP having the serving cell PCI/PCI index.

In yet another example, the Alternative-VII based TCI state indication could be applied for one or more DL channels/signals, wherein the UE could identify whether the indicated TCI state (and therefore, the QCL source RS indicated therein) and/or the corresponding DL channels/signals are transmitted from/associated with either the serving cell/TRP (and/or its PCI value) or a non-serving cell/TRP (or neighboring cell/TRP) (and/or its PCI value) via the entity ID indicated in the DCI format for beam indication. That is, DMRS antenna ports for PDCCH receptions, DMRS antenna ports for PDSCH receptions or CSI-RS associated with the serving cell PCI/PCI index could be QCL'ed with the set of RSs in the TCI state indicated in the DCI for beam indication, wherein the DCI for beam indication indicates/configures/includes/provides an entity ID associated with/corresponding to the serving cell—e.g., the serving cell PCI/PCI index, and DMRS antenna ports for PDCCH receptions, DMRS antenna ports for PDSCH receptions or CSI-RS associated with a PCI/PCI index other than the serving cell PCI/PCI index could be QCL'ed with the set of RSs in the TCI state indicated in the DCI for beam indication, wherein the DCI for beam indication indicates/configures/includes/provides an entity ID associated with/corresponding to the non-serving cell—e.g., the PCI/PCI index other than the serving cell PCI/PCI index.

Alternatively, DMRS antenna ports for PDCCH receptions, DMRS antenna ports for PDSCH receptions or CSI-RS associated with the serving cell PCI/PCI index could be QCL'ed with the set of RSs in the TCI state indicated in the DCI for beam indication, wherein the DCI for beam indication indicates/configures/includes/provides an entity ID associated with/corresponding to the non-serving cell—e.g., the PCI/PCI index other than the serving cell PCI/PCI index, and DMRS antenna ports for PDCCH receptions, DMRS antenna ports for PDSCH receptions or CSI-RS associated with the PCI/PCI index other than the serving cell PCI/PCI index could be QCL'ed with the set of RSs in the TCI state indicated in the DCI for beam indication, wherein the DCI for beam indication indicates/configures/includes/provides an entity ID associated with/corresponding the serving cell—e.g., the serving cell PCI/PCI index.

In yet another example, the Alternative-VIIa based TCI state indication could be applied for one or more DL channels/signals. That is, DMRS antenna ports for PDCCH receptions, DMRS antenna ports for PDSCH receptions or CSI-RS associated with the first entity ID—and therefore, the associated/corresponding cell (e.g., the serving cell/TRP having the serving cell PCI/PCI index or a non-serving cell/TRP having a PCI/PCI index other than the serving cell PCI/PCI index)—could be QCL'ed with the set of RSs in the first (or second) TCI state indicated in the DCI for beam indication, wherein the first (or second) TCI state is associated with the first (or second) entity ID, DMRS antenna ports for PDSCH receptions or CSI-RS associated with the second entity ID—and therefore, the associated/corresponding cell (e.g., the serving cell/TRP having the serving cell PCI/PCI index or a non-serving cell/TRP having a PCI/PCI index other than the serving cell PCI/PCI index)—could be QCL'ed with the set of RSs in the second (or first) TCI state indicated in the DCI for beam indication, wherein the second (or first) TCI state is associated with the second (or first) entity ID.

Alternatively, DMRS antenna ports for PDCCH receptions, DMRS antenna ports for PDSCH receptions or CSI-RS associated with the first entity ID—and therefore, the associated/corresponding cell (e.g., the serving cell/TRP having the serving cell PCI/PCI index or a non-serving cell/TRP having a PCI/PCI index other than the serving cell PCI/PCI index)—could be QCL'ed with the set of RSs in the first (or second) TCI state indicated in the DCI for beam indication, wherein the first (or second) TCI state is associated with the second (or first) entity ID, and DMRS antenna ports for PDCCH receptions, DMRS antenna ports for PDSCH receptions or CSI-RS associated with the second entity ID—and therefore, the associated/corresponding cell (e.g., the serving cell/TRP having the serving cell PCI/PCI index or a non-serving cell/TRP having a PCI/PCI index other than the serving cell PCI/PCI index)—could be QCL'ed with the set of RSs in the second (or first) TCI state indicated in the DCI for beam indication, wherein the second (or first) TCI state is also associated with the first (or second) entity ID.

As aforementioned, an entity ID could correspond to a PCI, a PCI index pointing to an entry/PCI in a list of PCIs that are higher layer configured to the UE, a one-bit indicator with ‘0’ (or ‘1’) indicating the serving cell PCI/PCI index and ‘1’ (or ‘0’) indicating a PCI/PCI index other than the serving cell PCI/PCI index, a multi-bit indicator with each bit index corresponding to a PCI/PCI index, PCI index 0 for the serving cell/TRP, a CORESETPoolIndex, a CORESETGroupIndex, a CORESET ID, a resource set ID/index, a resource ID/index, a TRP-specific ID/index or a TRP-specific higher layer signaling index/ID.

In one example of design example 1.B.1, the UE could be first higher layer configured by the network, e.g., via the higher layer RRC parameter PDSCH-Config/PDCCH-Config, N_s>1 lists/pools of TCI states with each list/pool of TCI state(s) containing at least one TCI state. Each TCI state contains a QCL source RS associated with either the serving cell/TRP or a non-serving cell/TRP (or neighboring cell/TRP). The TCI state indices/IDs and/or the bit-width used for representing the TCI state indices/IDs could be separately determined within each list/pool of TCI states. In this design example, a list/pool of TCI states could correspond to or configured as a TCI state group discussed in the design example 1.A.2 in the present disclosure.

Furthermore, a list/pool of TCI states could be associated/configured with a unique list/pool ID—e.g., a higher layer parameter TCIState-List that configures the list/pool of TCI states could indicate/include/contain/configure/comprise the corresponding TCI state list/pool ID denoted by TCIState-ListId. For instance, if two lists/pools of TCI states/TCI state IDs—denoted as a first list/pool of TCI states and a second list/pool of TCI states—are configured according to the above discussions, the first TCI state list/pool could be associated/configured with a first TCI state list/pool ID (e.g., the higher layer parameter TCIState-List1 that configures the first list/pool of TCI states could comprise/include/indicate/contain/configure the first TCI state list/pool ID—e.g., denoted by TCIState-ListId1), and the second TCI state list/pool could be associated/configured with a second TCI state list/pool ID (e.g., the higher layer parameter TCIState-List2 that configures the second list/pool of TCI states could comprise/include/indicate/contain/configure the second TCI state list/pool ID—e.g., denoted by TCIState-ListId2).

Alternatively, one or more of the configured N_s lists/pools of TCI states/TCI state IDs—e.g., the first and second lists/pools of TCI states/TCI state IDs—could be associated/configured with a same/single TCI state list/pool ID. For instance, the higher layer parameter (e.g., TCIState-List, TCIState-List1 or TCIState-List2) that configures the one or more TCI state lists/pools (e.g., the first and second lists/pools of TCI states/TCI state IDs) could contain/configure/include/indicate/comprise a same/single TCI state list/pool ID, e.g., denoted as TCIState-ListId, TCIState-ListId1 or TCIState-ListId2.

The UE could then receive from the network one or more MAC CE activation commands activating one or more TCI states from the higher layer configured list(s)/pool(s) of TCI states, e.g., up to eight TCI states could be activated by a MAC CE activation command as depicted in FIG. 10A, where the QCL source RSs in all the candidate TCI states activated by the MAC CE activation command could be transmitted from/associated with either the serving cell/TRP or a non-serving cell/TRP (or neighboring cell/TRP).

If the higher layer parameter tci-PresentInDCI configured for the UE is set as “enabled” for the CORESET/PDCCH that schedules the PDSCH (i.e., the TCI field is present in the corresponding DCI) and the time offset between the CORESET/PDCCH and the scheduled PDSCH is larger than a threshold (e.g., the threshold timeDuration-ForQCL is determined based on UE's capability indication), the TCI state/beam for the PDSCH is indicated via the DCI (e.g., DCI format 1_1). Otherwise, the TCI state/beam for the PDSCH follows that for the corresponding PDCCH. For an inter-cell multi-TRP system comprising of two coordinating TRPs, the UE could receive from the network two separate MAC CE activation commands activating one or more TCI states for transmitting/receiving one or more DL/UL channels/signals associated with the serving cell/TRP having the serving cell PCI/PCI index and the non-serving cell/TRP (or neighboring cell/TRP) having the PCI/PCI index other than the serving cell PCI/PCI index, and the UE could be indicated by the network two separate DCIs indicating one or more TCI states —determined/selected from the one or more TCI states activated by the MAC CE command(s)—for transmitting/receiving one or more DL/UL channels/signals associated with the serving cell/TRP having the serving cell PCI/PCI index and the non-serving cell/TRP (or neighboring cell/TRP) having the PCI/PCI index other than the serving cell PCI/PCI index.

In FIG. 9E, an example of configuring N_s=2 lists/pools of TCI states in the higher layer parameter PDSCH-config is presented. A first list/pool of TCI states contains a total of M_tci TCI states, and a second list of TCI states contains a total of (N_tci−M_tci) TCI states. In this example, the TCI state indices/IDs and/or the bit-width used for representing the TCI state indices/IDs are separately determined within each list/pool of TCI states. As shown in FIG. 9E, the TCI states in the first list/pool of TCI states are indexed as #1, #2, . . . , #M_tci or the TCI state IDs in the first list/pool of TCI states are #1, #2, . . . , #M_tci; the TCI states in the second list/pool of TCI states are indexed as #1, #2, . . . , #(N_tci−M_tci) or the TCI state IDs in the second list/pool of TCI states are #1, #2, . . . , #(N_tci−M_tci).

A distinct TCI state group ID could be associated with a list/pool of TCI states configured in the higher layer parameter PDSCH-config. For the example shown in FIG. 9E, two TCI state group IDs “0” and “1” could be defined with TCI state group ID “0” associated with the first list/pool of TCI states and TCI state group ID “1” associated with the second list/pool of TCI states. In the present disclosure, a TCI state group ID could correspond to a CORESETPoolIndex—e.g., values 0 and/or 1 provided in PDCCH-Config, a CORESETGroupIndex—e.g., values 0 and/or 1 provided in PDCCH-Config, a PCI value, a PCI index pointing to an entry/PCI in a list of PCIs (or PCI values) higher layer configured to the UE, a resource set index/ID, a CORESET ID, a resource index/ID, a TRP-specific ID/index, a TRP-specific higher layer signaling index/ID, a one-bit/multi-bit indicator or etc. Each TCI state group ID, and therefore, the TCI states in the corresponding list/pool of TCI states configured in the higher layer parameter PDSCH-config could be associated with/mapped to a PCI for either the serving cell/TRP or a non-serving cell/TRP (or neighboring cell/TRP). The UE could be indicated by the network the association between the TCI state group ID values and the PCI values for the serving/non-serving (or neighboring) cells/TRPs.

In one example, the UE could be explicitly indicated by the network, e.g., via higher layer RRC signaling and/or MAC CE command and/or dynamic DCI signaling, the exact association/mapping between the TCI state group ID values and the PCI values for the serving/non-serving (or neighboring) cells/TRPs in the inter-cell multi-TRP system. For example, the UE could be first higher layer configured by the network a list/set of two PCIs for the serving/non-serving (or neighboring) cells/TRPs; the TCI state group ID value “0” could be mapped to/associated with the first entry in the list/set of two PCIs for the serving/non-serving (or neighboring) cells/TRPs, while the TCI state group ID value “1” could be mapped to/associated with the second entry in the list/set of two PCIs for the serving/non-serving (or neighboring) cells/TRPs. For more than two configured TCI state group ID values (e.g., 0, 1, . . . , L_idx−1 with L_idx>2), the UE could be first higher layer configured by the network a list/set of at least L_idx PCIs for the serving/non-serving (or neighboring) cells/TRPs in the inter-cell multi-TRP system.

The UE could then be indicated by the network the association/mapping between the L_idx TCI state group ID values and the PCIs in the higher layer configured list/set of PCIs. Other indication methods, e.g., via higher layer RRC signaling and/or MAC CE command and/or dynamic DCI signaling, of the exact association/mapping between the TCI state group ID values and the PCI values for the serving/non-serving (or neighboring) cells/TRPs in the inter-cell multi-TRP system are also possible.

In another example, the UE could be implicitly indicated by the network the association/mapping between the TCI state group ID values and the PCI values for the serving/non-serving (or neighboring) cells/TRPs in the inter-cell multi-TRP system. For example, the UE could be indicated by the network that the TCI state group ID value “0” could be mapped to/associated with the lowest PCI value configured to the UE, while the TCI state group ID value “1” could be mapped to/associated with the highest PCI value configured to the UE.

For more than two configured TCI state group ID values (e.g., 0, 1, . . . , L_idx−1 with L_idx>2), the UE could be indicated by the network that the lowest TCI state group ID value could be mapped to/associated with the lowest PCI value configured for the UE, the second lowest TCI state group ID value could be mapped to/associated with the second lowest PCI value configured for the UE, and so on, and the L_idx-th highest TCI state group ID value could be mapped to/associated with the L_idx-th highest PCI value configured for the UE. Other implicit indication methods of the association/mapping between the TCI state group ID values and the PCI values for the serving/non-serving (or neighboring) cells/TRPs in the inter-cell multi-TRP system are also possible.

In yet another example, the UE could be first higher layer configured by the network the mapping/association between one or more PCI values and the TCI state group ID values; the UE could then receive from the network one or more MAC CE commands to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first MAC CE command activating at least one PCI from the first set of PCIs corresponding to/associated with the TCI state group ID value “0.” The UE could also receive from the network a second MAC CE command activating at least one PCI from the second set of PCIs corresponding to/associated with the TCI state group ID value “1.”

Alternatively, the UE could receive from the network a single MAC CE command activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first MAC CE command activating at least one PCI from the first set of PCIs corresponding to/associated with the TCI state group ID value “0,” a second MAC CE command activating at least one PCI from the second set of PCIs corresponding to/associated with the TCI state group ID value “1,” and so on, and a L_idx-th MAC CE command activating at least one PCI from the L_idx-th set of PCIs corresponding to/associated with the TCI state group ID value “L_idx−1.”

Alternatively, the UE could receive from the network a single MAC CE command activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be first higher layer configured by the network the mapping/association between one or more PCI values and the TCI state group ID values; the UE could then receive from the network one or more bitmaps to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first bitmap with each entry/bit in the first bitmap corresponding to/associated with a distinct entry in the first set of PCIs corresponding to/associated with the TCI state group ID value “0”; if an entry/bit in the first bitmap is set to “1,” the corresponding/associated entry in the first set of PCIs corresponding to/associated with the TCI state group ID value “0” is activated as the PCI corresponding to/associated with the TCI state group ID value “0” for the inter-cell multi-TRP operation.

The UE could also receive from the network a second bitmap with each entry/bit in the second bitmap corresponding to/associated with a distinct entry in the second set of PCIs corresponding to/associated with the TCI state group ID value “1”; if an entry/bit in the second bitmap is set to “1,” the corresponding/associated entry in the second set of PCIs corresponding to/associated with the TCI state group ID value “1” is activated as the PCI corresponding to/associated with the TCI state group ID value “1” for the inter-cell multi-TRP operation.

Alternatively, the UE could receive from the network a single bitmap activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.”

The UE could then receive from the network a first bitmap activating at least one PCI from the first set of PCIs corresponding to/associated with the TCI state group ID value “0,” a second bitmap activating at least one PCI from the second set of PCIs corresponding to/associated with the TCI state group ID value “1,” and so on, and a L_idx-th bitmap activating at least one PCI from the L_idx-th set of PCIs corresponding to/associated with the TCI state group ID value “L_idx−1.”

Alternatively, the UE could receive from the network a single bitmap activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be indicated by the network that the TCI state group ID value “0” is associated with the serving cell/TRP (and/or its corresponding PCI). For a TCI state group ID value other than value “0,” e.g., value “1”: for example, the UE could be indicated by the network, e.g., via higher layer RRC signaling and/or MAC CE command and/or dynamic DCI signaling, the exact non-serving (or neighboring) cell/TRP PCI value associated with the TCI state group ID value; for another example, the UE could be indicated by the network that the TCI state group ID value could be associated with the lowest (or the highest) non-serving (or neighboring) cell/TRP PCI value configured for the UE; yet for another example, (i) the UE could be higher layer configured by the network a list/set of PCIs corresponding to/associated with the TCI state group ID value, and (ii) the UE could receive from the network a MAC CE command activating at least one PCI from the higher layer configured list/set of PCIs corresponding to/associated with the TCI state group ID value; yet for another example, (i) the UE could be higher layer configured by the network a list/set of PCIs corresponding to/associated with the TCI state group ID value, and (ii) the UE could receive from the network a bitmap activating at least one PCI from the higher layer configured list/set of PCIs corresponding to/associated with the TCI state group ID value.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values.

In this design example, if a beam associated with the i-th PCI is activated, the (i+1)-th, the (i+2)-th, . . . , and the (i+K_idx−1)-th entries in the set/list/pool of PCIs (or equivalently, the (i+1)-th PCI, the (i+2)-th PCI, . . . , and the (i+K_idx−1)-th PCI) along with the corresponding TCI state group ID values could be activated, and/or, the (i−K_idx+1)-th, the (i−K_idx+2)-th, . . . , and the (i−1)-th entries in the set/list/pool of PCIs (or equivalently, the (i−K_idx+1)-th PCI, the (i-K_idx+2)-th PCI, . . . , and the (i−1)-th PCI) along with the corresponding TCI state group ID values could be deactivated. For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 4-th PCI (associated with the TCI state group ID value “0”) and the 5-th PCI (associated with the TCI state group ID value “1”) are activated. At the same time, the 1-st PCI (associated with the TCI state group ID value “0”) and the 2-nd PCI (associated with the TCI state group ID value “1”) are deactivated.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values.

In this design example, if a beam associated with the i-th PCI is activated, the (i-floor((K_idx−1)/2))-th, the (i−floor((K_idx−1)/2)+1)-th, . . . , and the (i+ceil((K_idx−1)/2))-th entries in the set/list/pool of PCIs (or equivalently, the (i−floor((K_idx−1)/2))-th PCI, the (i−floor((K_idx−1)/2)+1)-th PCI, . . . , and the (i+ceil((K_idx−1)/2))-th PCI) along with the corresponding TCI state group ID values could be activated, or, the (i-ceil((K_idx−1)/2))-th, the (i−floor((K_idx−1)/2)+1)-th, . . . , and the (i+floor((K_idx−1)/2))-th entries in the set/list/pool of PCIs (or equivalently, the (i-ceil((K_idx−1)/2))-th PCI, the (i−floor((K_idx−1)/2)+1)-th PCI, . . . , and the (i+floor((K_idx−1)/2))-th PCI) along with the corresponding TCI state group ID values could be activated, where floor(x) returns the largest integer that is smaller than or equal to x and ceil(x) returns the smallest integer that is greater than or equal to x.

The starting/initial activated cells could be the (i−G)-th, the (i−G+1)-th, . . . , the i-th, . . . , the (i−G+K_idx−1)-th entries in the set/list/pool of PCIs (or equivalently, the (i−G)-th PCI, the (i-G+1)-th PCI, . . . , the i-th PCI, . . . , the (i−G+K_idx−1)-th PCI); their corresponding/associated TCI state group ID values are also activated. Here, the value of G could be higher layer configured to the UE by the network and/or fixed per RRC configuration. For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 2-nd PCI (associated with the TCI state group ID value “1”) and the 4-th PCI (associated with the TCI state group ID value “0”) are activated.

In addition to Alternative-0, Alternative-1, Alternative-1a, Alternative-1b, Alternative-1c, Alternative-2, Alternative-2a, Alternative-3, Alternative-4, Alternative-4a, Alternative-5, Alternative-6, Alternative-7 and Alternative-7a based candidate TCI states activation, in one example of Alternative-8, the MAC CE activation command could include the TCI state group ID value(s). If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDSCH is transmitted.

In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RSs in all the candidate TCI states activated by the MAC CE activation command are transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RSs in all the candidate TCI states activated by the MAC CE activation command are transmitted.

In addition to Alternative-I, Alternative-Ia, Alternative-II, Alternative-IIa, Alternative-III, Alternative-IV, Alternative-IVa, Alternative-V, Alternative-VI, Alternative-VII and Alternative-VIIa based TCI state indication via DCI, in one example, Alternative-VIII, the DCI for beam indication could also include/indicate/configure/contain/comprise/provide the TCI state group ID value(s). Under this setting, upon receiving the DCI for beam indication, the UE could identify the serving/non-serving (or neighboring) cell/TRP information/identification via the TCI state group ID value(s) indicated/configured in the DCI format. If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the corresponding PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDSCH is transmitted.

Alternative-VIII could correspond to or be equivalent to Alternative-VII if the TCI state group ID here is the same as the entity ID in the design Alternative-VII. Furthermore, the DCI for beam indication could include/indicate/contain/comprise more than one TCI state group IDs, which could correspond to or be equivalent to Alternative-VIIa in the present disclosure if the TCI state group IDs here are the same as the entity IDs in the design Alternative-VIIa.

In addition, the UE could also identify whether the QCL source RS in the indicated TCI state is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS in the indicated TCI state is transmitted.

In this design example, the Alternative-0 based candidate TCI states activation for the PDSCH, wherein one or more candidate TCI states (and therefore, the QCL source RSs indicated therein) and/or the corresponding PDSCH(s) could be transmitted from/associated with either the serving cell/TRP (and/or its PCI value) or the non-serving cell(s)/TRP(s) (or neighboring cell(s)/TRP(s)) (and/or the corresponding PCI value(s)), and/or the Alternative-1 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the CORESETPoolIndex value (if configured) in the MAC CE activation command, and/or the Alternative-2 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the one-bit flag indicator in the MAC CE activation command, and/or the Alternative-3 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the multi-bit indicator in the MAC CE activation command, and/or the Alternative-4 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the PCI value in the MAC CE activation command, and/or the Alternative-5 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the SCI value in the MAC CE activation command, and/or the Alternative-6 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the serving/non-serving (or neighboring) cells/TRPs information indicated in the candidate TCI state(s) in the MAC CE activation command, and/or the Alternative-7 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the TCI state group ID value in the MAC CE activation command, could be applied.

In one example, the Alternative-I based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the CORESETPoolIndex value (if configured) in the DCI for the PDSCH beam indication.

In another example, the Alternative-II based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the one-bit flag indicator in the DCI for the PDSCH beam indication.

In yet another example, the Alternative-III based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the multi-bit indicator in the DCI for the PDSCH beam indication.

In yet another example, the Alternative-IV based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the PCI value in the DCI for the PDSCH beam indication.

In yet another example, the Alternative-V based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the association/mapping between the codepoint indices in the DCI(s) for the PDSCH beam indication and the candidate TCI states activated by the MAC CE activation command.

In yet another example, the Alternative-VI based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the serving/non-serving (or neighboring) cells/TRPs information indicated in the TCI state indicated in the DCI for the PDSCH beam indication.

In yet another example, the Alternative-VII based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the TCI state group ID value in the DCI for the PDSCH beam indication.

In one example of design example 1.B.2, the UE could be first higher layer configured by the network, e.g., via the higher layer RRC parameter PDSCH-config, N_s>1 lists/pools of TCI states with each list/pool of TCI state(s) containing at least one TCI state. Each TCI state contains a QCL source RS associated with either the serving cell/TRP or a non-serving cell/TRP (or neighboring cell/TRP). The TCI state indices/IDs and/or the bit-width used for representing the TCI state indices/IDs could be determined across all N_s lists/pools of TCI states and/or one or more of all N_s lists/pools of TCI states. In this design example, a list/pool of TCI states could correspond to or configured as a TCI state group discussed in the design example 1.A.2 in the present disclosure.

Furthermore, a list/pool of TCI states could be associated/configured with a unique list/pool ID—e.g., a higher layer parameter TCIState-List that configures the list/pool of TCI states could indicate/include/contain/configure/comprise the corresponding TCI state list/pool ID denoted by TCIState-ListId. For instance, if two lists/pools of TCI states/TCI state IDs—denoted as a first list/pool of TCI states and a second list/pool of TCI states—are configured according to the above discussions, the first TCI state list/pool could be associated/configured with a first TCI state list/pool ID (e.g., the higher layer parameter TCIState-List1 that configures the first list/pool of TCI states could comprise/include/indicate/contain/configure the first TCI state list/pool ID—e.g., denoted by TCIState-ListId1), and the second TCI state list/pool could be associated/configured with a second TCI state list/pool ID (e.g., the higher layer parameter TCIState-List2 that configures the second list/pool of TCI states could comprise/include/indicate/contain/configure the second TCI state list/pool ID—e.g., denoted by TCIState-ListId2). Alternatively, one or more of the configured N_s lists/pools of TCI states/TCI state IDs—e.g., the first and second lists/pools of TCI states/TCI state IDs—could be associated/configured with a same/single TCI state list/pool ID.

For instance, the higher layer parameter (e.g., TCIState-List, TCIState-List1 or TCIState-List2) that configures the one or more TCI state lists/pools (e.g., the first and second lists/pools of TCI states/TCI state IDs) could contain/configure/include/indicate/comprise a same/single TCI state list/pool ID, e.g., denoted as TCIState-ListId, TCIState-ListId1 or TCIState-ListId2. The UE could then receive from the network one or more MAC CE activation commands activating one or more TCI states from the higher layer configured list(s)/pool(s) of TCI states, e.g., up to eight TCI states could be activated by a MAC CE activation command as depicted in FIG. 10A, where the QCL source RSs in all the candidate TCI states activated by the MAC CE activation command could be transmitted from/associated with either the serving cell/TRP or a non-serving cell/TRP (or neighboring cell/TRP).

If the higher layer parameter tci-PresentInDCI configured for the UE is set as “enabled” for the CORESET/PDCCH that schedules the PDSCH (i.e., the TCI field is present in the corresponding DCI) and the time offset between the CORESET/PDCCH and the scheduled PDSCH is larger than a threshold (e.g., the threshold timeDuration-ForQCL is determined based on UE's capability indication), the TCI state/beam for the PDSCH is indicated via the DCI (e.g., DCI format 1_1).

Otherwise, i.e., (i) the higher layer parameter tci-PresentInDCI configured for the UE is set as “disabled” for the CORESET/PDCCH that schedules the PDSCH (i.e., the TCI field is not present in the corresponding DCI) or (ii) the time offset between the CORESET/PDCCH and the scheduled PDSCH is smaller than the threshold timeDuration-forQCL, the TCI state/beam for the PDSCH follows that for the corresponding PDCCH. For an inter-cell multi-TRP system comprising of two coordinating TRPs, the UE could receive from the network two separate MAC CE activation commands to activate the TCI states for the PDSCHs transmitted from the serving cell/TRP and the non-serving cell/TRP (or neighboring cell/TRP), and the UE could be indicated by the network two separate DCIs to indicate the TCI states for the PDSCHs transmitted from the serving cell/TRP and the non-serving cell/TRP (or neighboring cell/TRP).

In FIG. 9G, an example of configuring N_s=2 lists/pools of TCI states in the higher layer parameter PDSCH-config is presented. A first list/pool of TCI states contains a total of M_tci TCI states, and a second list of TCI states contains a total of (N_tci−M_tci) TCI states. In this example, the TCI state indices/IDs and/or the bit-width used for representing the TCI state indices/IDs are determined across all N_s=2 lists/pools of TCI states. As shown in FIG. 9G, the TCI states in the first list/pool of TCI states are indexed as #1, #2, . . . , #M_tci or the TCI state IDs in the first list/pool of TCI states are #1, #2, . . . , #M_tci; the TCI states in the second list/pool of TCI states are indexed as #(M_tci+1), #(M_tci+2), . . . , #N_tci or the TCI state IDs in the second list/pool of TCI states are #(M_tci+1), #(M_tci+2), . . . , #N_tci.

A distinct TCI state group ID could be associated with a list/pool of TCI states configured in the higher layer parameter PDSCH-config. For the example shown in FIG. 9G, two TCI state group IDs “0” and “1” could be defined with TCI state group ID “0” associated with the first list/pool of TCI states and TCI state group ID “1” associated with the second list/pool of TCI states. In the present disclosure, a TCI state group ID could correspond to a CORESETPoolIndex—e.g., values 0 and/or 1 provided in PDCCH-Config, a CORESETGroupIndex—e.g., values 0 and/or 1 provided in PDCCH-Config, a PCI value, a PCI index pointing to an entry/PCI in a list of PCIs (or PCI values) higher layer configured to the UE, a resource set index/ID, a CORESET ID, a resource index/ID, a TRP-specific ID/index, a TRP-specific higher layer signaling index/ID, a one-bit/multi-bit indicator or etc. Each TCI state group ID, and therefore, the TCI states in the corresponding list/pool of TCI states configured in the higher layer parameter PDSCH-config could be associated with/mapped to a PCI for either the serving cell/TRP or a non-serving cell/TRP (or neighboring cell/TRP). The UE could be indicated by the network the association between the TCI state group ID values and the PCI values for the serving/non-serving (or neighboring) cells/TRPs.

In one example, the UE could be explicitly indicated by the network, e.g., via higher layer RRC signaling and/or MAC CE command and/or dynamic DCI signaling, the exact association/mapping between the TCI state group ID values and the PCI values for the serving/non-serving (or neighboring) cells/TRPs in the inter-cell multi-TRP system. For example, the UE could be first higher layer configured by the network a list/set of two PCIs for the serving/non-serving (or neighboring) cells/TRPs; the TCI state group ID value “0” could be mapped to/associated with the first entry in the list/set of two PCIs for the serving/non-serving (or neighboring) cells/TRPs, while the TCI state group ID value “1” could be mapped to/associated with the second entry in the list/set of two PCIs for the serving/non-serving (or neighboring) cells/TRPs. For more than two configured TCI state group ID values (e.g., 0, 1, . . . , L_idx−1 with L_idx>2), the UE could be first higher layer configured by the network a list/set of at least L_idx PCIs for the serving/non-serving (or neighboring) cells/TRPs in the inter-cell multi-TRP system.

The UE could then be indicated by the network the association/mapping between the L_idx TCI state group ID values and the PCIs in the higher layer configured list/set of PCIs. Other indication methods, e.g., via higher layer RRC signaling and/or MAC CE command and/or dynamic DCI signaling, of the exact association/mapping between the TCI state group ID values and the PCI values for the serving/non-serving (or neighboring) cells/TRPs in the inter-cell multi-TRP system are also possible.

In another example, the UE could be implicitly indicated by the network the association/mapping between the TCI state group ID values and the PCI values for the serving/non-serving (or neighboring) cells/TRPs in the inter-cell multi-TRP system. For example, the UE could be indicated by the network that the TCI state group ID value “0” could be mapped to/associated with the lowest PCI value configured to the UE, while the TCI state group ID value “1” could be mapped to/associated with the highest PCI value configured to the UE. For more than two configured TCI state group ID values (e.g., 0, 1, . . . , L_idx−1 with L_idx>2), the UE could be indicated by the network that the lowest TCI state group ID value could be mapped to/associated with the lowest PCI value configured for the UE, the second lowest TCI state group ID value could be mapped to/associated with the second lowest PCI value configured for the UE, and so on, and the L_idx-th highest TCI state group ID value could be mapped to/associated with the L_idx-th highest PCI value configured for the UE. Other implicit indication methods of the association/mapping between the TCI state group ID values and the PCI values for the serving/non-serving (or neighboring) cells/TRPs in the inter-cell multi-TRP system are also possible.

In yet another example, the UE could be first higher layer configured by the network the mapping/association between one or more PCI values and the TCI state group ID values; the UE could then receive from the network one or more MAC CE commands to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first MAC CE command activating at least one PCI from the first set of PCIs corresponding to/associated with the TCI state group ID value “0.” The UE could also receive from the network a second MAC CE command activating at least one PCI from the second set of PCIs corresponding to/associated with the TCI state group ID value “1.”

Alternatively, the UE could receive from the network a single MAC CE command activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first MAC CE command activating at least one PCI from the first set of PCIs corresponding to/associated with the TCI state group ID value “0,” a second MAC CE command activating at least one PCI from the second set of PCIs corresponding to/associated with the TCI state group ID value “1,” and so on, and a L_idx-th MAC CE command activating at least one PCI from the L_idx-th set of PCIs corresponding to/associated with the TCI state group ID value “L_idx−1.”

Alternatively, the UE could receive from the network a single MAC CE command activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be first higher layer configured by the network the mapping/association between one or more PCI values and the TCI state group ID values; the UE could then receive from the network one or more bitmaps to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first bitmap with each entry/bit in the first bitmap corresponding to/associated with a distinct entry in the first set of PCIs corresponding to/associated with the TCI state group ID value “0”; if an entry/bit in the first bitmap is set to “1,” the corresponding/associated entry in the first set of PCIs corresponding to/associated with the TCI state group ID value “0” is activated as the PCI corresponding to/associated with the TCI state group ID value “0” for the inter-cell multi-TRP operation.

The UE could also receive from the network a second bitmap with each entry/bit in the second bitmap corresponding to/associated with a distinct entry in the second set of PCIs corresponding to/associated with the TCI state group ID value “1”; if an entry/bit in the second bitmap is set to “1,” the corresponding/associated entry in the second set of PCIs corresponding to/associated with the TCI state group ID value “1” is activated as the PCI corresponding to/associated with the TCI state group ID value “1” for the inter-cell multi-TRP operation. Alternatively, the UE could receive from the network a single bitmap activating at least one PCI from the first set of PCIs corresponding to/associated with the TCI state group ID value “0” and at least one PCI from the second set of PCIs corresponding to/associated with the TCI state group ID value “1.”

For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first bitmap activating at least one PCI from the first set of PCIs corresponding to/associated with the TCI state group ID value “0,” a second bitmap activating at least one PCI from the second set of PCIs corresponding to/associated with the TCI state group ID value “1,” and so on, and a L_idx-th bitmap activating at least one PCI from the L_idx-th set of PCIs corresponding to/associated with the TCI state group ID value “L_idx−1.”

Alternatively, the UE could receive from the network a single bitmap activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be indicated by the network that the TCI state group ID value “0” is associated with the serving cell/TRP (and/or its corresponding PCI). For a TCI state group ID value other than value “0,” e.g., value “1”: for example, the UE could be indicated by the network, e.g., via higher layer RRC signaling and/or MAC CE command and/or dynamic DCI signaling, the exact non-serving (or neighboring) cell/TRP PCI value associated with the TCI state group ID value; for another example, the UE could be indicated by the network that the TCI state group ID value could be associated with the lowest (or the highest) non-serving (or neighboring) cell/TRP PCI value configured for the UE; yet for another example, (i) the UE could be higher layer configured by the network a list/set of PCIs corresponding to/associated with the TCI state group ID value, and (ii) the UE could receive from the network a MAC CE command activating at least one PCI from the higher layer configured list/set of PCIs corresponding to/associated with the TCI state group ID value; yet for another example, (i) the UE could be higher layer configured by the network a list/set of PCIs corresponding to/associated with the TCI state group ID value, and (ii) the UE could receive from the network a bitmap activating at least one PCI from the higher layer configured list/set of PCIs corresponding to/associated with the TCI state group ID value.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values. In this design example, if a beam associated with the i-th PCI is activated, the (i+1)-th, the (i+2)-th, . . . , and the (i+K_idx−1)-th entries in the set/list/pool of PCIs (or equivalently, the (i+1)-th PCI, the (i+2)-th PCI, . . . , and the (i+K_idx−1)-th PCI) along with the corresponding TCI state group ID values could be activated, and/or, the (i−K_idx+1)-th, the (i−K_idx+2)-th, . . . , and the (i−1)-th entries in the set/list/pool of PCIs (or equivalently, the (i−K_idx+1)-th PCI, the (i−K_idx+2)-th PCI, . . . , and the (i−1)-th PCI) along with the corresponding TCI state group ID values could be deactivated.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 4-th PCI (associated with the TCI state group ID value “0”) and the 5-th PCI (associated with the TCI state group ID value “1”) are activated. At the same time, the 1-st PCI (associated with the TCI state group ID value “0”) and the 2-nd PCI (associated with the TCI state group ID value “1”) are deactivated.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values.

In this design example, if a beam associated with the i-th PCI is activated, the (i-floor((K_idx−1)/2))-th, the (i−floor((K_idx−1)/2)+1)-th, . . . , and the (i+ceil((K_idx−1)/2))-th entries in the set/list/pool of PCIs (or equivalently, the (i−floor((K_idx−1)/2))-th PCI, the (i−floor((K_idx−1)/2)+1)-th PCI, . . . , and the (i+ceil((K_idx−1)/2))-th PCI) along with the corresponding TCI state group ID values could be activated, or, the (i-ceil((K_idx−1)/2))-th, the (i−floor((K_idx−1)/2)+1)-th, . . . , and the (i+floor((K_idx−1)/2))-th entries in the set/list/pool of PCIs (or equivalently, the (i-ceil((K_idx−1)/2))-th PCI, the (i−floor((K_idx−1)/2)+1)-th PCI, . . . , and the (i+floor((K_idx−1)/2))-th PCI) along with the corresponding TCI state group ID values could be activated, where floor(x) returns the largest integer that is smaller than or equal to x and ceil(x) returns the smallest integer that is greater than or equal to x. The starting/initial activated cells could be the (i−G)-th, the (i-G+1)-th, . . . , the i-th, . . . , the (i−G+K_idx−1)-th entries in the set/list/pool of PCIs (or equivalently, the (i−G)-th PCI, the (i−G+1)-th PCI, . . . , the i-th PCI, . . . , the (i−G+K_idx−1)-th PCI); their corresponding/associated TCI state group ID values are also activated.

Here, the value of G could be higher layer configured to the UE by the network and/or fixed per RRC configuration. For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 2-nd PCI (associated with the TCI state group ID value “1”) and the 4-th PCI (associated with the TCI state group ID value “0”) are activated.

In addition to Alternative-0, Alternative-1, Alternative-1a, Alternative-1b, Alternative-1c, Alternative-2, Alternative-2a, Alternative-3, Alternative-4, Alternative-4a, Alternative-5, Alternative-6, Alternative-7, Alternative-7a and Alternative-8 based candidate TCI states activation, in one example of Alternative-9, the MAC CE activation command may not include the TCI state group ID value(s)—different from the design example 1.B.1. The UE could identify the TCI state group ID value(s) from the candidate TCI states/TCI state IDs activated by the MAC CE activation command because the TCI state IDs are determined across all N_s>1 lists/pools of TCI states. If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDSCH is transmitted.

In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RSs in all the candidate TCI states activated by the MAC CE activation command are transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RSs in all the candidate TCI states activated by the MAC CE activation command are transmitted.

In addition to Alternative-I, Alternative-Ia, Alternative-II, Alternative-IIa, Alternative-III, Alternative-IV, Alternative-IVa, Alternative-V, Alternative-VI, Alternative-VII, Alternative-VIIa and Alternative-VIII based TCI state indication via DCI, in one example of Alternative-IX, upon receiving the DCI for the PDSCH beam indication, the UE could first identify the TCI state group ID value from the TCI state/TCI state ID value indicated in the DCI because the TCI state IDs are determined across all N_s>1 lists/pools of TCI states. If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDSCH is transmitted.

In addition, the UE could also identify whether the QCL source RS in the indicated TCI state is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS in the indicated TCI state is transmitted.

In this design example, the Alternative-0 based candidate TCI states activation for the PDSCH, wherein one or more candidate TCI states (and therefore, the QCL source RSs indicated therein) and/or the corresponding PDSCH(s) could be transmitted from/associated with either the serving cell/TRP (and/or its PCI value) or the non-serving cell(s)/TRP(s) (or neighboring cell(s)/TRP(s)) (and/or the corresponding PCI value(s)), and/or the Alternative-1 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the CORESETPoolIndex value (if configured) in the MAC CE activation command, and/or the Alternative-2 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the one-bit flag indicator in the MAC CE activation command, and/or the Alternative-3 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the multi-bit indicator in the MAC CE activation command, and/or the Alternative-4 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the PCI value in the MAC CE activation command, and/or the Alternative-5 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the SCI value in the MAC CE activation command, and/or the Alternative-6 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the serving/non-serving (or neighboring) cells/TRPs information indicated in the candidate TCI state(s) in the MAC CE activation command, and/or the Alternative-7 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the TCI state group ID value in the MAC CE activation command, and/or the Alternative-8 based candidate TCI states activation for the PDSCH, wherein the UE could identify whether all the candidate TCI states (and therefore, the QCL source RSs indicated therein) and/or the corresponding PDSCH(s) are transmitted from/associated with either the serving cell/TRP (and/or its PCI value) or a non-serving cell/TRP (or neighboring cell/TRP) (and/or its PCI value) via the association between the TCI state ID value(s) in the MAC CE activation command and the TCI state group ID value(s), could be applied.

In one example, the Alternative-I based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the CORESETPoolIndex value (if configured) in the DCI for the PDSCH beam indication.

In another example, the Alternative-II based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the one-bit flag indicator in the DCI for the PDSCH beam indication.

In yet another example, the Alternative-III based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the multi-bit indicator in the DCI for the PDSCH beam indication.

In yet another example, the Alternative-IV based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the PCI value in the DCI for the PDSCH beam indication.

In yet another example, the Alternative-V based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the association/mapping between the codepoint indices in the DCI(s) for the PDSCH beam indication and the candidate TCI states activated by the MAC CE activation command.

In yet another example, the Alternative-VI based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the serving/non-serving (or neighboring) cells/TRPs information indicated in the TCI state indicated in the DCI for the PDSCH beam indication.

In yet another example, the Alternative-VII based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the TCI state group ID value in the DCI for the PDSCH beam indication.

In yet another example, the Alternative-VIII based TCI state indication for the PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving cell/TRP (or neighboring cell/TRP) (and/or its PCI value) via the association between the TCI state ID value(s) in the DCI for the PDSCH beam indication and the TCI state group ID value(s).

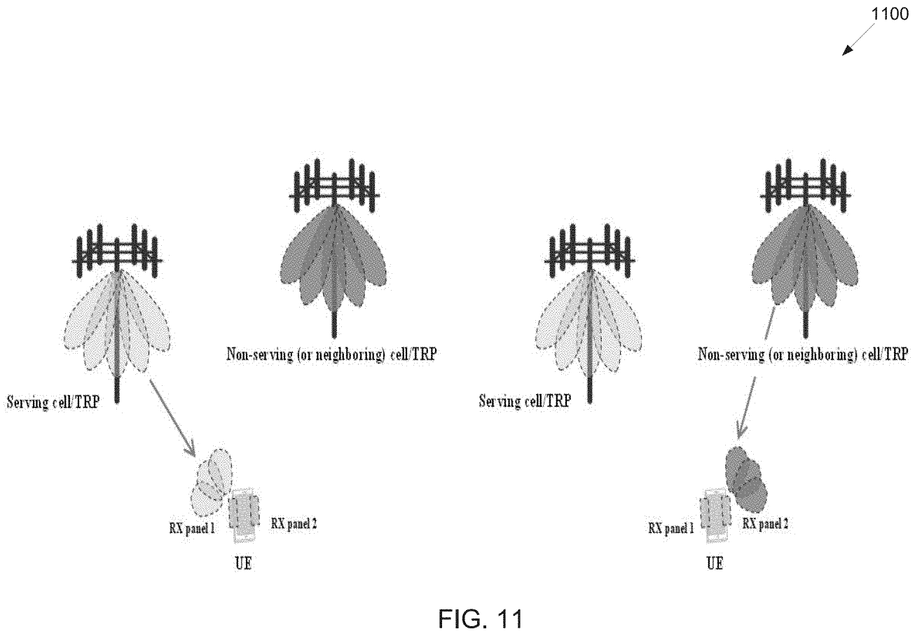

FIG. 11 illustrates an example of inter-cell system 1100 according to embodiments of the present disclosure. An embodiment of the inter-cell system 1100 shown in FIG. 11 is for illustration only.

In an inter-cell system depicted in FIG. 11, wherein different cells/TRPs could have different PCIs and non-serving (or neighboring) cells/TRPs could have different PCIs from that of the serving cell/TRP, a UE could receive from at least one cell/TRP, i.e., either the serving cell/TRP or a non-serving (or neighboring) cell/TRP, various channels/RSs such as a PDCCH and/or a PDSCH at a time (e.g., in a slot) using either a single receive (RX) panel or multiple RX panels.

As shown on the left-hand-side in FIG. 11, for a given time instance (e.g., a slot), the UE could receive from the serving cell/TRP using RX panel 1. For a different time instance (e.g., a different slot) as depicted on the right-hand-side in FIG. 11, the UE could receive from the non-serving cell/TRP (or the neighboring cell/TRP) in the inter-cell system—having a different PCI from that of the serving cell/TRP—using RX panel 2. In this disclosure, a RX panel could correspond to a set of RX antenna elements/ports at the UE, a set of measurement RS resources such as SRS resources, a spatial domain RX filter or etc. Furthermore, a TRP in the inter-cell system can represent a collection of measurement antenna ports, measurement RS resources and/or control resource sets (CORESETs).

For example, a TRP could be associated with one or more of: (1) a plurality of CSI-RS resources; (2) a plurality of CRIs (CSI-RS resource indices/indicators); (3) a measurement RS resource set, for example, a CSI-RS resource set along with its indicator; (4) a plurality of CORESETs associated with a CORESETPoolIndex; and/or (5) a plurality of CORESETs associated with a TRP-specific index/indicator/identity.

The UE could be configured by the network one or more transmission configuration information (TCI) states, which indicate the QCL information/assumptions for one or more RSs/channels such as PDCCHs and/or PDSCHs. The TCI state update/indication for PDCCH and/or PDSCH can also be referred to as beam indication. For instance, for data transmissions on the shared channel (such as the physical downlink shared channel in NR, i.e., PDSCH), the corresponding beam indication procedure under the 3GPP Rel. 15/16 TCI framework can be summarized as follows: a UE can be first higher layer configured by the network (e.g., via high layer RRC signaling) a set/pool of TCI states; the UE could then receive from the network a MAC CE command activating one or more TCI states from the set/pool of RRC configured TCI states; the UE could be indicated by the network via dynamic DCI signaling that one or more of the MAC CE activated TCI states are active for the reception of the PDSCH(s).

The 3GPP Rel. 15/16 TCI framework supports intra-cell operation such that different cells/TRPs in the intra-cell system could share the same physical cell ID (PCI). The 3GPP Rel. 15/16 TCI framework, however, cannot support dynamic switching of the transmission/reception of PDCCH(s)/PDSCH(s) between different cells/TRPs in an inter-cell system, wherein different cells/TRPs could have different PCIs and one or more PCIs could be different from the serving cell/TRP PCI.

The present disclosure considers various design aspects/enhancements for the TCI state/beam indication in an inter-cell system, wherein different cells/TRPs could have different PCIs and one or more PCIs could be from that of the serving cell/TRP. The solutions developed in this disclosure could be used to support the dynamic switching of the transmission/reception of PDCCH(s)/PDSCH(s) between the serving/non-serving (or neighboring) cells/TRPs in the inter-cell system.

The non-serving cell/TRP (or neighboring cell/TRP) for inter-cell operation could have a different PCI from that of the serving cell/TRP.

In one example, the UE could be explicitly indicated by the network, e.g., via higher layer RRC signaling and/or MAC CE command and/or dynamic DCI signaling, the exact PCI value(s) for the non-serving cell(s)/TRP(s) (or neighboring cell(s)/TRP(s)).

In another example, the UE could be first higher layer configured by the network a list/pool/set of neighboring cells' PCIs. The UE could then receive from the network a MAC CE command activating one or more entries in the list/pool/set of neighboring cells' PCIs as the PCI value(s) for the non-serving cell(s)/TRP(s) (or neighboring cell(s)/TRP(s)).

In yet another example, the UE could be first higher layer configured by the network a list/pool/set of neighboring cells' PCIs. The UE could then receive from the network a bitmap with each entry/bit in the bitmap corresponding to/associated with a distinct entry in the list/pool/set of neighboring cells' PCIs. If an entry/bit in the bitmap is set to “1,” the corresponding/associated entry in the list/pool/set of neighboring cells' PCIs is activated as the PCI value for a non-serving cell/TRP (or neighboring cell/TRP). The bitmap could contain at least one “1.”

In yet another example, the UE could be first higher layer configured by the network a list/pool/set of neighboring cells' PCIs. One or more entries in the list/pool/set of neighboring cells' PCIs could be configured as the PCI value(s) for the non-serving cell(s)/TRP(s) (or neighboring cell(s)/TRP(s)) if they are associated with one or more active TCI states for PDSCH/PDCCH.

As described in U.S. patent application Ser. No. 17/584,239 as incorporated by reference herein, a unified TCI framework could indicate/include M≥1 DL TCI states and/or N≥1 UL TCI states, wherein the indicated TCI state could be at least one of: (1) a DL TCI state and/or its corresponding/associated TCI state ID; (2) an UL TCI state and/or its corresponding/associated TCI state ID; (3) a joint DL and UL TCI state and/or its corresponding/associated TCI state ID; and/or (4) separate DL TCI state and UL TCI state and/or their corresponding/associated TCI state ID(s).

There could be various design options/channels to indicate to the UE a beam (i.e., a TCI state) for the transmission/reception of a PDCCH or a PDSCH.

As described in U.S. patent application Ser. No. 17/584,239 as incorporated by reference herein, in one example, a MAC CE could be used to indicate to the UE a beam (i.e., a TCI state and/or a TCI state ID) for the transmission/reception of a PDCCH or a PDSCH and in another example, a DCI could be used to indicate to the UE a beam (i.e., a TCI state and/or a TCI state ID) for the transmission/reception of a PDCCH or a PDSCH: (i) for example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment; (ii) for another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant; and/or (iii) yet for another example, a custom/purpose designed DCI format could be used to indicate to the UE a beam (i.e., a TCI state and/or a TCI state ID) for the transmission/reception of a PDCCH or a PDSCH.

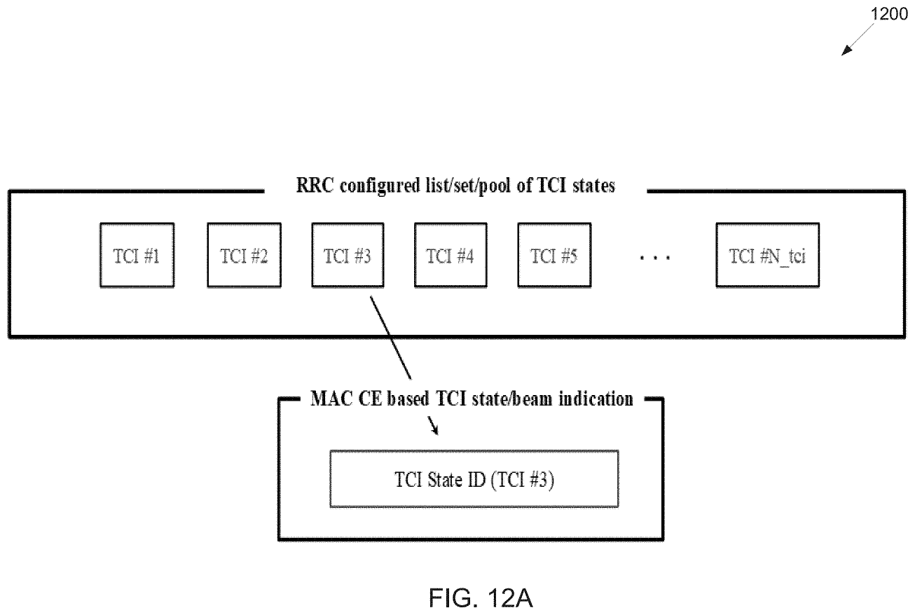

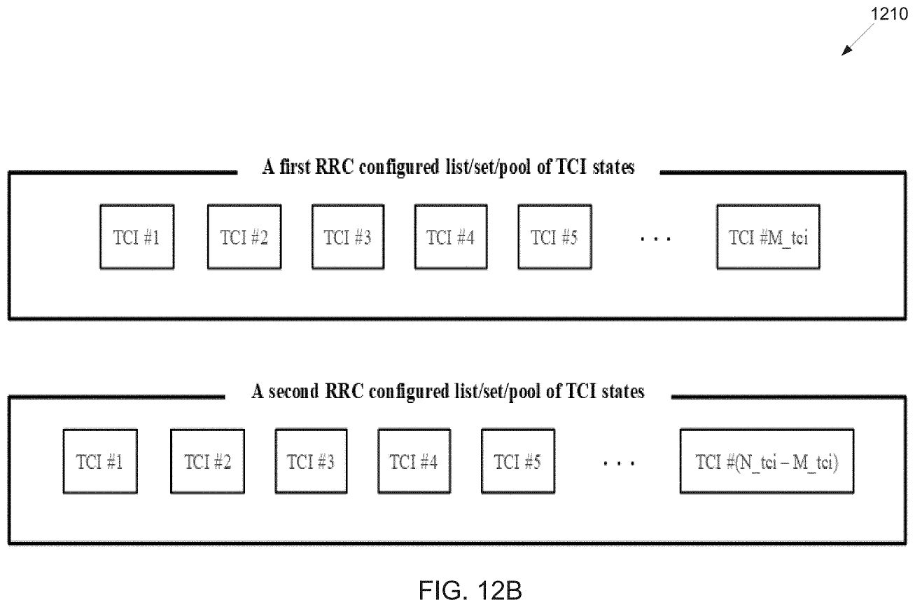

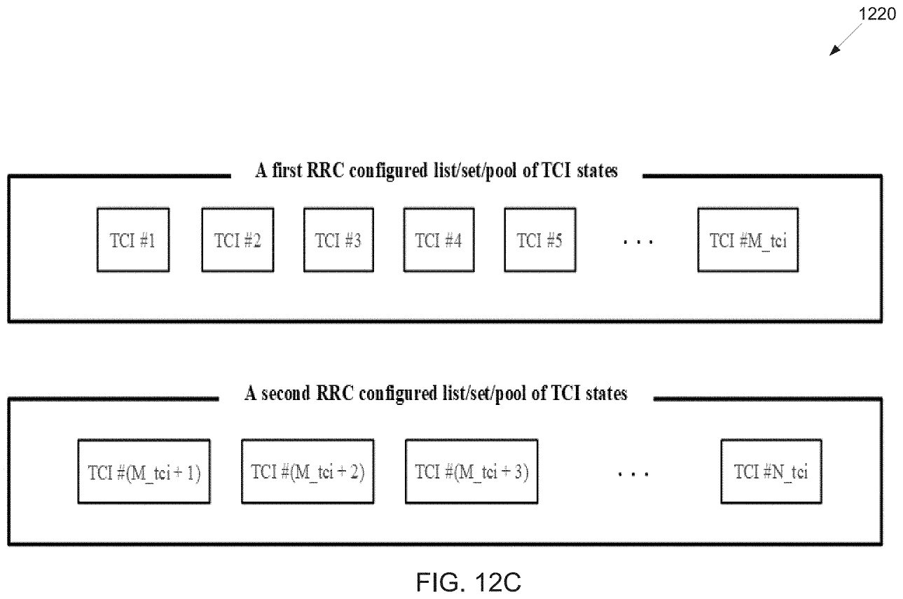

FIG. 12A illustrates an example of MAC CE based TCI state/beam indication 1200 according to embodiments of the present disclosure. An embodiment of the MAC CE based TCI state/beam indication 1200 shown in FIG. 12A is for illustration only.

In one example of design example 1.0A, in FIG. 12A, an example of MAC CE based TCI state/beam indication for the inter-cell beam operation is presented. As illustrated in FIG. 12A, the UE could be first higher layer configured by the network, e.g., via the higher layer RRC signaling, a list/pool of N_tci TCI states. Each TCI state contains at least a QCL source RS associated with either the serving cell/TRP or a non-serving cell/TRP (or neighboring cell/TRP). The UE could then receive from the network one or more MAC CE commands to indicate the beam(s) (i.e., the TCI state(s)) for the transmission/reception of the PDCCH(s) or the PDSCH(s) transmitted from/associated with the serving cell/TRP and/or a non-serving cell/TRP (and/or a neighboring cell/TRP).

For an inter-cell system, the UE could receive from the network a single MAC CE command at a time (e.g., in a slot) for the PDCCH/PDSCH beam indication to enable the dynamic switching of the transmission/reception of the PDCCH(s)/PDSCH(s) between different cells/TRPs, e.g., the serving cell/TRP and one or more non-serving (or neighboring) cells/TRPs having different PCIs from that of the serving cell/TRP. For an inter-cell multi-TRP system, the UE could receive from the network more than one MAC CE commands at a time (e.g., in a slot) to indicate the beams/TCI states for the PDCCHs/PDSCHs simultaneously transmitted from the serving cell/TRP and the non-serving (or neighboring) cell(s)/TRP(s).

The MAC CE for the PDCCH/PDSCH beam indication—for the inter-cell operation —could include at least a TCI state ID. As discussed above, the TCI state corresponding to the TCI state ID could be at least one of: (1) a DL TCI state; (2) an UL TCI state; (3) a joint DL and UL TCI state; and (4) separate DL TCI state and UL TCI state.

In addition, the MAC CE for the inter-cell PDCCH/PDSCH beam indication could include information to indicate/identify the serving/non-serving (or neighboring) cells/TRPs.

In one example of Option-1A, a one-bit flag indicator could be included/indicated in the MAC CE for the inter-cell PDCCH/PDSCH beam indication. If the one-bit flag indicator is present and set to “1,” the corresponding PDCCH/PDSCH could be transmitted from/associated with the serving cell/TRP; in this case, the QCL source RS(s) in the TCI state indicated in the MAC CE could also be associated with/transmitted from the serving cell/TRP. If the one-bit flag indicator is not present or set to “0,” the corresponding PDCCH/PDSCH could be transmitted from/associated with a non-serving cell/TRP (or neighboring cell/TRP) in the inter-cell system; in this case, the QCL source RS(s) in the TCI state indicated in the MAC CE could also be associated with/transmitted from the non-serving cell/TRP (or neighboring cell/TRP). For inter-cell multi-TRP operation, the one-bit flag indicator could correspond to/be configured as the higher layer signaling index—CORESETPoolIndex.

In one example of Option-2A, a multi-bit (more than one bit) indicator could be included/indicated in the MAC CE for the inter-cell PDCCH/PDSCH beam indication to indicate the serving cell/TRP and two or more non-serving cells/TRPs (or neighboring cells/TRPs) in the inter-cell system. The number of bits n_b required for representing the multi-bit indicator could be ceil(log 2(N_nsc+1)), where N_nsc is the total number of non-serving cells/TRPs (or neighboring cells/TRPs) and ceil(x) rounds x up to the next largest integer. In this case, the n_b-bit indicator could correspond to 2\hat{ }(n_b) states, and one of the states (e.g., the first state) could correspond to the serving cell/TRP, and the rest of the states could correspond to the non-serving cells/TRPs (or neighboring cells/TRPs). Alternatively, the number of bits n_b required for representing the multi-bit indicator could be ceil(log 2(N_nsc)).

In this case, the multi-bit indicator only indicates/identifies the non-serving cells/TRPs (or neighboring cells/TRPs); if the multi-bit indicator is not present, the UE may expect that the corresponding PDCCH/PDSCH is transmitted from/associated with the serving cell/TRP; if the multi-bit indicator is not present, the UE could also expect that the QCL source RS(s) in the TCI state indicated in the MAC CE is associated with/transmitted from the serving cell/TRP. The UE could be indicated by the network the association rule(s)/mapping relationship(s) between the states of the multi-bit indicator and the PCI values for the serving/non-serving (or neighboring) cells/TRPs in the inter-cell system; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

In one example of Option-3A, the PCI value(s) could be included/indicated in the MAC CE for the inter-cell PDCCH/PDSCH beam indication. In this design option, one or more PCI values could be used/reserved for representing the serving cell/TRP. The UE could be indicated by the network the association between the PCI value(s) and the serving cell/TRP and/or the association between the PCI value(s) and the non-serving (or neighboring) cell(s)/TRP(s). If the indicated PCI value is associated with the serving cell/TRP, the corresponding PDCCH/PDSCH could be transmitted from/associated with the serving cell/TRP; in this case, the QCL source RS(s) in the TCI state indicated in the MAC CE could also be associated with/transmitted from the serving cell/TRP. If the indicated PCI value is associated with a non-serving cell/TRP (or neighboring cell/TRP), the corresponding PDCCH/PDSCH could be transmitted from/associated with the non-serving cell/TRP (or neighboring cell/TRP) in the inter-cell system; in this case, the QCL source RS(s) in the TCI state indicated in the MAC CE could also be associated with/transmitted from the non-serving cell/TRP (or neighboring cell/TRP).

In one example of Option-4A, the serving cell ID (SCI) value(s) could be included/indicated in the MAC CE for the inter-cell PDCCH/PDSCH beam indication. One or more SCI values in the MAC CE for the inter-cell PDCCH/PDSCH beam indication could be used for representing one or more non-serving cells/TRPs (or neighboring cells/TRPs), and/or, correspond to one or more PCI values for the non-serving cells/TRPs (or neighboring cells/TRPs), in the inter-cell system. The UE could be indicated by the network the exact SCI value(s) used/reserved for representing the non-serving cell(s)/TRP(s) (or neighboring cell(s)/TRP(s)), and/or, the association between the reserved SCI value(s) and the PCI value(s) for the non-serving cell(s)/TRP(s) (or neighboring cell(s)/TRP(s)). If the indicated SCI value is reserved/used for representing a non-serving cell/TRP (or neighboring cell/TRP) and/or corresponds to a non-serving cell/TRP (or neighboring cell/TRP) PCI value, the MAC CE could indicate the beam used for transmitting the PDCCH/PDSCH from the non-serving cell/TRP (or neighboring cell/TRP) in the inter-cell system; in this case, the QCL source RS(s) in the TCI state indicated in the MAC CE could also be associated with/transmitted from the non-serving cell/TRP (or neighboring cell/TRP).

In one example of Option-5A, a TCI state could include information that indicates/identifies the serving/non-serving (or neighboring) cells/TRPs information. For example, a TCI state could include a one-bit flag indicator, which could correspond to/be configured as the higher layer signaling index CORESETPoolIndex in an inter-cell multi-TRP system, to indicate the serving cell/TRP or a non-serving cell/TRP (or neighboring cell/TRP). For another example, a TCI state could include a multi-bit indicator to indicate the serving cell/TRP (and/or its PCI value) and the non-serving (or neighboring) cell(s)/TRPs (and/or the corresponding PCI value(s)). Yet for another example, a TCI state could include the PCI value to indicate the serving/non-serving (or neighboring) cells/TRPs information. Yet for another example, one or more serving cell IDs (SCIs) in a TCI state could be reserved/used to indicate one or more non-serving (or neighboring) cells/TRPs information.

The details about the indication/identification of the serving/non-serving (or neighboring) cells/TRPs information in a TCI state are according to U.S. patent application Ser. No. 17/444,556 as incorporated by reference herein. If the serving cell/TRP information is indicated in the TCI state indicated in the MAC CE for the inter-cell PDCCH/PDSCH beam indication, the corresponding PDCCH/PDSCH could be transmitted from/associated with the serving cell/TRP; in this case, the QCL source RS(s) in the TCI state indicated in the MAC CE for the inter-cell PDCCH/PDSCH beam indication could also be associated with/transmitted from the serving cell/TRP. If the non-serving (or neighboring) cell/TRP information is indicated in the TCI state indicated in the MAC CE for the inter-cell PDCCH/PDSCH beam indication, the corresponding PDCCH/PDSCH could be transmitted from/associated with the non-serving cell/TRP (or neighboring cell/TRP) in the inter-cell system; in this case, the QCL source RS(s) in the TCI state indicated in the MAC CE for the inter-cell PDCCH/PDSCH beam indication could also be associated with/transmitted from the non-serving cell/TRP (or neighboring cell/TRP).

In one example of Option-6A, the MAC CE for the inter-cell PDCCH/PDSCH beam indication could contain/indicate a list/set of M≥1 TCI states/TCI state IDs—selected from the higher layer configured list/set/pool of TCI states—with each TCI state (and therefore, the QCL source RS(s) indicated therein) associated with either the serving cell/TRP or a non-serving (or neighboring) cell/TRP.

In one example, the UE could be explicitly indicated by the network, e.g., via higher layer RRC signaling and/or MAC CE command and/or dynamic DCI signaling, the exact association/mapping between the list/set of M≥1 TCI states/TCI state IDs and the PCI/CORESETPoolIndex values for the serving/non-serving (or neighboring) cells/TRPs in the inter-cell system. For example, the UE could be first configured by the network a list/set of M≥1 PCI/CORESETPoolIndex values for the serving/non-serving (or neighboring) cells/TRPs; the first TCI state/TCI state ID in the list/set of M TCI states/TCI state IDs could be mapped to/associated with the first entry in the list/set of M PCI/CORESETPoolIndex values for the serving/non-serving (or neighboring) cells/TRPs, the second TCI state/TCI state ID in the list/set of M TCI states/TCI state IDs could be mapped to/associated with the second entry in the list/set of M PCI/CORESETPoolIndex values for the serving/non-serving (or neighboring) cells/TRPs, and so on, and the M-th TCI state/TCI state ID in the list/set of M TCI states/TCI state IDs could be mapped to/associated with the M-th entry in the list/set of M PCI/CORESETPoolIndex values for the serving/non-serving (or neighboring) cells/TRPs.

For another example, the UE could be first configured by the network a list/set of M≥1 PCI/CORESETPoolIndex values for the serving/non-serving (or neighboring) cells/TRPs; the lowest (or the highest) TCI state ID value (and/or its corresponding TCI state) in the list/set of M TCI states/TCI state IDs could be mapped to/associated with the first entry in the list/set of M PCI/CORESETPoolIndex values for the serving/non-serving (or neighboring) cells/TRPs, the second lowest (or the second highest) TCI state ID value (and/or its corresponding TCI state) in the list/set of M TCI states/TCI state IDs could be mapped to/associated with the second entry in the list/set of M PCI/CORESETPoolIndex values for the serving/non-serving (or neighboring) cells/TRPs, and so on, and the highest (or the lowest) TCI state ID value (and/or its corresponding TCI state) in the list/set of M TCI states/TCI state IDs could be mapped to/associated with the M-th entry in the list/set of M PCI/CORESETPoolIndex values for the serving/non-serving (or neighboring) cells/TRPs.

In another example, the UE could be implicitly indicated by the network the association/mapping between the list/set of M≥1 TCI states/TCI state IDs and the PCI/CORESETPoolIndex values for the serving/non-serving (or neighboring) cells/TRPs in the inter-cell system. For example, the UE could be indicated by the network that the first TCI state/TCI state ID in the list/set of M TCI states/TCI state IDs could be mapped to/associated with the lowest (or the highest) PCI/CORESETPoolIndex value configured for the UE, the second TCI state/TCI state ID in the list/set of M TCI states/TCI state IDs could be mapped to/associated with the second lowest (or the second highest) PCI/CORESETPoolIndex value configured for the UE, and so on, and the M-th TCI state/TCI state ID in the list/set of M TCI states/TCI state IDs could be mapped to/associated with the highest (or the lowest) PCI/CORESETPoolIndex value configured for the UE.

For another example, the UE could be indicated by the network that the lowest (or the highest) TCI state ID value (and/or its corresponding TCI state) in the list/set of M TCI states/TCI state IDs could be mapped to/associated with the lowest (or the highest) PCI/CORESETPoolIndex value configured for the UE, the second lowest (or the second highest) TCI state ID value (and/or its corresponding TCI state) in the list/set of M TCI states/TCI state IDs could be mapped to/associated with the second lowest (or the second highest) PCI/CORESETPoolIndex value configured for the UE, and so on, and the highest (or the lowest) TCI state ID value (and/or its corresponding TCI state) in the list/set of M TCI states/TCI state IDs could be mapped to/associated with the highest (or the lowest) PCI/CORESETPoolIndex value configured for the UE. Other implicit indication methods of the association/mapping between the list/set of M≥1 TCI states/TCI state IDs and the PCI/CORESETPoolIndex values for the serving/non-serving (or neighboring) cells/TRPs in the inter-cell system are also possible.

In yet another example, the UE could be first higher layer configured by the network the mapping/association between one or more PCI/CORESETPoolIndex values and the list/set of M≥1 TCI states/TCI state IDs; the UE could then receive from the network one or more MAC CE activation commands/bitmaps to activate one or more PCI/CORESETPoolIndex values associated with each entry in the list/set of M TCI states/TCI state IDs.

For example, the UE could be first higher layer configured by the network a first set of PCI/CORESETPoolIndex values corresponding to/associated with the first TCI state/TCI state ID or the lowest/highest TCI state ID value (and/or its corresponding TCI state) in the list/set of M TCI states/TCI state IDs, a second set of PCI/CORESETPoolIndex values corresponding to/associated with the second TCI state/TCI state ID or the second lowest/highest TCI state ID value (and/or its corresponding TCI state) in the list/set of M TCI states/TCI state IDs, and so on, and a M-th set of PCI/CORESETPoolIndex values corresponding to/associated with the M-th TCI state/TCI state ID or the highest/lowest TCI state ID value (and/or its corresponding TCI state) in the list/set of M TCI states/TCI state IDs. The UE could then receive from the network a first MAC CE activation command/bitmap activating at least one PCI/CORESETPoolIndex value from the first set of PCI/CORESETPoolIndex values corresponding to/associated with the first TCI state/TCI state ID or the lowest/highest TCI state ID value (and/or its corresponding TCI state) in the list/set of M TCI states/TCI state IDs, a second MAC CE activation command/bitmap activating at least one PCI/CORESETPoolIndex value from the second set of PCI/CORESETPoolIndex values corresponding to/associated with the second TCI state/TCI state ID or the second lowest/highest TCI state ID value (and/or its corresponding TCI state) in the list/set of M TCI states/TCI state IDs, and so on, and a M-th MAC CE activation command/bitmap activating at least one PCI/CORESETPoolIndex value from the M-th set of PCI/CORESETPoolIndex values corresponding to/associated with the M-th TCI state/TCI state ID or the highest/lowest TCI state ID value (and/or its corresponding TCI state) in the list/set of M TCI states/TCI state IDs.

Alternatively, the UE could receive from the network a single MAC CE activation command/bitmap activating at least one PCI/CORESETPoolIndex value from the first set of PCI/CORESETPoolIndex values corresponding to/associated with the first TCI state/TCI state ID or the lowest/highest TCI state ID value (and/or its corresponding TCI state) in the list/set of M TCI states/TCI state IDs, at least one PCI/CORESETPoolIndex value from the second set of PCI/CORESETPoolIndex values corresponding to/associated with the second TCI state/TCI state ID or the second lowest/highest TCI state ID value (and/or its corresponding TCI state) in the list/set of M TCI states/TCI state IDs, and so on, and at least one PCI/CORESETPoolIndex value from the M-th set of PCI/CORESETPoolIndex values corresponding to/associated with the M-th TCI state/TCI state ID or the highest/lowest TCI state ID value (and/or its corresponding TCI state) in the list/set of M TCI states/TCI state IDs.

In yet another example, the UE could be indicated by the network that the first TCI state/TCI state ID or the lowest/highest TCI state ID value (and/or its corresponding TCI state) in the list/set of M TCI states is associated with the serving cell/TRP (and/or its corresponding PCI/CORESETPoolIndex value). For a given TCI state/TCI state ID in the list/set of M TCI states/TCI state IDs other than the first TCI state/TCI state ID or the lowest/highest TCI state ID value (and/or its corresponding TCI state) in the list/set of TCI states/TCI state IDs: for example, the UE could be indicated by the network, e.g., via higher layer RRC signaling and/or MAC CE command and/or dynamic DCI signaling, the exact non-serving (or neighboring) cell/TRP PCI/CORESETPoolIndex value associated with the TCI state/TCI state ID; for another example, (i) the UE could be higher layer configured by the network a list/set of PCI/CORESETPoolIndex values corresponding to/associated with the TCI state/TCI state ID, and (ii) the UE could receive from the network a MAC CE command activating at least one PCI/CORESETPoolIndex value from the higher layer configured list/set of PCI/CORESETPoolIndex values corresponding to/associated with the TCI state/TCI state ID; yet for another example, (i) the UE could be higher layer configured by the network a list/set of PCI/CORESETPoolIndex values corresponding to/associated with the TCI state/TCI state ID, and (ii) the UE could receive from the network a bitmap activating at least one PCI/CORESETPoolIndex value from the higher layer configured list/set of PCI/CORESETPoolIndex values corresponding to/associated with the TCI state/TCI state ID.

The UE could be indicated by the network which design option(s), selected from/out of Option-1A, Option-2A, Option-3A, Option-4A, Option-5A, and Option-6A described above, is used/implemented; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, the UE could be explicitly indicated by the network, e.g., via higher layer RRC signaling and/or MAC CE command and/or dynamic DCI signaling, the exact design option(s) used/implemented to indicate/identify the serving/non-serving (or neighboring) cells/TRPs in the inter-cell system.

For another example, the UE could receive from the network one or more MAC CE activation commands activating one or more design options used/implemented to indicate/identify the serving/non-serving (or neighboring) cells/TRPs in the inter-cell system.

For yet another example, the UE could receive from the network one or more bitmaps activating one or more design options used/implemented to indicate/identify the serving/non-serving (or neighboring) cells/TRPs in the inter-cell system.

In addition, the design option(s) used/implemented to indicate/identify the serving/non-serving (or neighboring) cells/TRPs in the inter-cell system could be fixed in system specification(s), determined by the network based on UE's capability reporting, and etc. Furthermore, the UE could send to the network their preference(s)/selection(s) regarding the design option(s), e.g., from/out of Option-1A, Option-2A, Option-3A, Option-4A, Option-5A, and Option-6A described above, to use/implement for indicating/identifying the serving/non-serving (or neighboring) cells/TRPs in the inter-cell system.

In one example of design example 1.1A, the UE could be first higher layer configured by the network, e.g., via the higher layer RRC parameter, N_s>1 lists/pools of TCI states with each list/pool of TCI state(s) containing at least one TCI state. Each TCI state contains at least a QCL source RS associated with either the serving cell/TRP or a non-serving cell/TRP (or neighboring cell/TRP). The TCI state indices/IDs and/or the bit-width used for representing the TCI state indices/IDs could be separately determined within each list/pool of TCI states. The UE could then receive from the network one or more MAC CE commands to indicate the beam(s) (i.e., the TCI state(s))—selected from one or more lists/pools of TCI states—for the transmission/reception of the PDCCH(s) or the PDSCH(s) transmitted from/associated with the serving cell/TRP and/or a non-serving cell/TRP (and/or a neighboring cell/TRP).

For an inter-cell system, the UE could receive from the network a single MAC CE command at a time (e.g., in a slot) for the PDCCH/PDSCH beam indication to enable the dynamic switching of the transmission/reception of the PDCCH(s)/PDSCH(s) between different cells/TRPs, e.g., the serving cell/TRP and one or more non-serving (or neighboring) cells/TRPs having different PCIs from that of the serving cell/TRP. For an inter-cell multi-TRP system, the UE could receive from the network more than one MAC CE commands at a time (e.g., in a slot) to indicate the beams/TCI states for the PDCCHs/PDSCHs simultaneously transmitted from the serving cell/TRP and the non-serving (or neighboring) cell(s)/TRP(s).

FIG. 12B illustrates an example of higher layer configured two lists of TCI states 1210 according to embodiments of the present disclosure. An embodiment of the higher layer configured two lists of TCI states 1210 shown in FIG. 12B is for illustration only.

In FIG. 12B, an example of configuring N_s=2 lists/pools of TCI states via the higher layer RRC signaling is presented. A first list/pool of TCI states contains a total of M_tci TCI states, and a second list of TCI states contains a total of (N_tci−M_tci) TCI states. In this example, the TCI state indices/IDs and/or the bit-width used for representing the TCI state indices/IDs are separately determined within each list/pool of TCI states. As shown in FIG. 12B, the TCI states in the first list/pool of TCI states are indexed as #1, #2, . . . , #M_tci or the TCI state IDs in the first list/pool of TCI states are #1, #2, . . . , #M_tci; the TCI states in the second list/pool of TCI states are indexed as #1, #2, . . . , #(N_tci−M_tci) or the TCI state IDs in the second list/pool of TCI states are #1, #2, . . . , #(N_tci−M_tci).

A distinct TCI state group ID could be associated with a list/pool of TCI states configured, e.g., in the higher layer parameter PDSCH-config. For the example shown in FIG. 7B, two TCI state group IDs “0” and “1” could be defined with TCI state group ID “0” associated with the first list/pool of TCI states and TCI state group ID “1” associated with the second list/pool of TCI states. Each TCI state group ID, and therefore, the TCI states in the corresponding higher layer configured list/pool of TCI states could be associated with/mapped to a PCI for either the serving cell/TRP or a non-serving cell/TRP (or neighboring cell/TRP). The UE could be indicated by the network the association between the TCI state group ID values and the PCI values for the serving/non-serving (or neighboring) cells/TRPs.

In one example, the UE could be explicitly indicated by the network, e.g., via higher layer RRC signaling and/or MAC CE command and/or dynamic DCI signaling, the exact association/mapping between the TCI state group ID values and the PCI values for the serving/non-serving (or neighboring) cells/TRPs in the inter-cell system. For example, the UE could be first higher layer configured by the network a list/set of two PCIs for the serving/non-serving (or neighboring) cells/TRPs; the TCI state group ID value “0” could be mapped to/associated with the first entry in the list/set of two PCIs for the serving/non-serving (or neighboring) cells/TRPs, while the TCI state group ID value “1” could be mapped to/associated with the second entry in the list/set of two PCIs for the serving/non-serving (or neighboring) cells/TRPs.

For more than two configured TCI state group ID values (e.g., 0, 1, . . . , L_idx−1 with L_idx>2), the UE could be first higher layer configured by the network a list/set of at least L_idx PCIs for the serving/non-serving (or neighboring) cells/TRPs in the inter-cell system. The UE could then be indicated by the network the association/mapping between the L_idx TCI state group ID values and the PCIs in the higher layer configured list/set of PCIs. Other indication methods, e.g., via higher layer RRC signaling and/or MAC CE command and/or dynamic DCI signaling, of the exact association/mapping between the TCI state group ID values and the PCI values for the serving/non-serving (or neighboring) cells/TRPs in the inter-cell system are also possible.

In another example, the UE could be implicitly indicated by the network the association/mapping between the TCI state group ID values and the PCI values for the serving/non-serving (or neighboring) cells/TRPs in the inter-cell system. For example, the UE could be indicated by the network that the TCI state group ID value “0” could be mapped to/associated with the lowest PCI value configured to the UE, while the TCI state group ID value “1” could be mapped to/associated with the highest PCI value configured to the UE. For more than two configured TCI state group ID values (e.g., 0, 1, . . . , L_idx−1 with L_idx>2), the UE could be indicated by the network that the lowest TCI state group ID value could be mapped to/associated with the lowest PCI value configured for the UE, the second lowest TCI state group ID value could be mapped to/associated with the second lowest PCI value configured for the UE, and so on, and the L_idx-th highest TCI state group ID value could be mapped to/associated with the L_idx-th highest PCI value configured for the UE. Other implicit indication methods of the association/mapping between the TCI state group ID values and the PCI values for the serving/non-serving (or neighboring) cells/TRPs in the inter-cell system are also possible.

In yet another example, the UE could be first higher layer configured by the network the mapping/association between one or more PCI values and the TCI state group ID values; the UE could then receive from the network one or more MAC CE commands to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first MAC CE command activating at least one PCI from the first set of PCIs corresponding to/associated with the TCI state group ID value “0.” The UE could also receive from the network a second MAC CE command activating at least one PCI from the second set of PCIs corresponding to/associated with the TCI state group ID value “1.”

Alternatively, the UE could receive from the network a single MAC CE command activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first MAC CE command activating at least one PCI from the first set of PCIs corresponding to/associated with the TCI state group ID value “0,” a second MAC CE command activating at least one PCI from the second set of PCIs corresponding to/associated with the TCI state group ID value “1,” and so on, and a L_idx-th MAC CE command activating at least one PCI from the L_idx-th set of PCIs corresponding to/associated with the TCI state group ID value “L_idx−1.”

Alternatively, the UE could receive from the network a single MAC CE command activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be first higher layer configured by the network the mapping/association between one or more PCI values and the TCI state group ID values; the UE could then receive from the network one or more bitmaps to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.”

The UE could then receive from the network a first bitmap with each entry/bit in the first bitmap corresponding to/associated with a distinct entry in the first set of PCIs corresponding to/associated with the TCI state group ID value “0”; if an entry/bit in the first bitmap is set to “1,” the corresponding/associated entry in the first set of PCIs corresponding to/associated with the TCI state group ID value “0” is activated as the PCI corresponding to/associated with the TCI state group ID value “0” for the inter-cell operation.

The UE could also receive from the network a second bitmap with each entry/bit in the second bitmap corresponding to/associated with a distinct entry in the second set of PCIs corresponding to/associated with the TCI state group ID value “1”; if an entry/bit in the second bitmap is set to “1,” the corresponding/associated entry in the second set of PCIs corresponding to/associated with the TCI state group ID value “1” is activated as the PCI corresponding to/associated with the TCI state group ID value “1” for the inter-cell operation.

Alternatively, the UE could receive from the network a single bitmap activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.”

The UE could then receive from the network a first bitmap activating at least one PCI from the first set of PCIs corresponding to/associated with the TCI state group ID value “0,” a second bitmap activating at least one PCI from the second set of PCIs corresponding to/associated with the TCI state group ID value “1,” and so on, and a L_idx-th bitmap activating at least one PCI from the L_idx-th set of PCIs corresponding to/associated with the TCI state group ID value “L_idx−1.”

Alternatively, the UE could receive from the network a single bitmap activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be indicated by the network that the TCI state group ID value “0” is associated with the serving cell/TRP (and/or its corresponding PCI). For a TCI state group ID value other than value “0,” e.g., value “1”: for example, the UE could be indicated by the network, e.g., via higher layer RRC signaling and/or MAC CE command and/or dynamic DCI signaling, the exact non-serving (or neighboring) cell/TRP PCI value associated with the TCI state group ID value; for another example, the UE could be indicated by the network that the TCI state group ID value could be associated with the lowest (or the highest) non-serving (or neighboring) cell/TRP PCI value configured for the UE; yet for another example, (i) the UE could be higher layer configured by the network a list/set of PCIs corresponding to/associated with the TCI state group ID value, and (ii) the UE could receive from the network a MAC CE command activating at least one PCI from the higher layer configured list/set of PCIs corresponding to/associated with the TCI state group ID value; yet for another example, (i) the UE could be higher layer configured by the network a list/set of PCIs corresponding to/associated with the TCI state group ID value, and (ii) the UE could receive from the network a bitmap activating at least one PCI from the higher layer configured list/set of PCIs corresponding to/associated with the TCI state group ID value.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values. In this design example, if a beam associated with the i-th PCI is activated, the (i+1)-th, the (i+2)-th, . . . , and the (i+K_idx−1)-th entries in the set/list/pool of PCIs (or equivalently, the (i+1)-th PCI, the (i+2)-th PCI, . . . , and the (i+K_idx−1)-th PCI) along with the corresponding TCI state group ID values could be activated, and/or, the (i−K_idx+1)-th, the (i−K_idx+2)-th, . . . , and the (i−1)-th entries in the set/list/pool of PCIs (or equivalently, the (i−K_idx+1)-th PCI, the (i−K_idx+2)-th PCI, . . . , and the (i−1)-th PCI) along with the corresponding TCI state group ID values could be deactivated.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2.

In this example, if a beam associated with the 3-rd PCI (associated with the TCI state group ID value “2”) is activated, the 4-th PCI (associated with the TCI state group ID value “0”) and the 5-th PCI (associated with the TCI state group ID value “1”) are activated. At the same time, the 1-st PCI (associated with the TCI state group ID value “0”) and the 2-nd PCI (associated with the TCI state group ID value “1”) are deactivated.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values. In this design example, if a beam associated with the i-th PCI is activated, the (i−floor((K_idx−1)/2))-th, the (i−floor((K_idx−1)/2)+1)-th, . . . , and the (i+ceil((K_idx−1)/2))-th entries in the set/list/pool of PCIs (or equivalently, the (i-floor((K_idx−1)/2))-th PCI, the (i−floor((K_idx−1)/2)+1)-th PCI, . . . , and the (i+ceil((K_idx−1)/2))-th PCI) along with the corresponding TCI state group ID values could be activated, or, the (i-ceil((K_idx−1)/2))-th, the (i−floor((K_idx−1)/2)+1)-th, . . . , and the (i+floor((K_idx−1)/2))-th entries in the set/list/pool of PCIs (or equivalently, the (i-ceil((K_idx−1)/2))-th PCI, the (i−floor((K_idx−1)/2)+1)-th PCI, . . . , and the (i+floor((K_idx−1)/2))-th PCI) along with the corresponding TCI state group ID values could be activated, where floor(x) returns the largest integer that is smaller than or equal to x and ceil(x) returns the smallest integer that is greater than or equal to x. The starting/initial activated cells could be the (i−G)-th, the (i−G+1)-th, . . . , the i-th, . . . , the (i−G+K_idx−1)-th entries in the set/list/pool of PCIs (or equivalently, the (i−G)-th PCI, the (i−G+1)-th PCI, . . . , the i-th PCI, . . . , the (i−G+K_idx−1)-th PCI); their corresponding/associated TCI state group ID values are also activated. Here, the value of G could be higher layer configured to the UE by the network and/or fixed per RRC configuration.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 2-nd PCI (associated with the TCI state group ID value “1”) and the 4-th PCI (associated with the TCI state group ID value “0”) are activated.

In this design example, the MAC CE for the PDCCH/PDSCH beam indication—for the inter-cell operation—could include at least a TCI state ID. As discussed above, the corresponding TCI state could be at least one of: (1) a DL TCI state; (2) an UL TCI state; (3) a joint DL and UL TCI state; and/or (4) separate DL TCI state and UL TCI state.

In addition to Option-1A, Option-2A, Option-3A, Option-4A, Option-5A, and Option-6A based MAC CE based inter-cell PDCCH/PDSCH beam indication, in one example of Option-7A, the TCI state group ID value(s) could be included/indicated in the MAC CE for the inter-cell PDCCH/PDSCH beam indication. If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDCCH/PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH/PDSCH is transmitted.

In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RS(s) in the TCI state indicated in the MAC CE is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS(s) in the TCI state indicated in the MAC CE is transmitted.

The UE could be indicated by the network which design option(s), selected from/out of Option-1A, Option-2A, Option-3A, Option-4A, Option-5A, Option-6A, and Option-7A described above, is used/implemented; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, the UE could be explicitly indicated by the network, e.g., via higher layer RRC signaling and/or MAC CE command and/or dynamic DCI signaling, the exact design option(s) used/implemented to indicate/identify the serving/non-serving (or neighboring) cells/TRPs in the inter-cell system.

For another example, the UE could receive from the network one or more MAC CE activation commands activating one or more design options used/implemented to indicate/identify the serving/non-serving (or neighboring) cells/TRPs in the inter-cell system.

For yet another example, the UE could receive from the network one or more bitmaps activating one or more design options used/implemented to indicate/identify the serving/non-serving (or neighboring) cells/TRPs in the inter-cell system.

In addition, the design option(s) used/implemented to indicate/identify the serving/non-serving (or neighboring) cells/TRPs in the inter-cell system could be fixed in system specification(s), determined by the network based on UE's capability reporting, and etc. Furthermore, the UE could send to the network their preference(s)/selection(s) regarding the design option(s), e.g., from/out of Option-1A, Option-2A, Option-3A, Option-4A, Option-5A, Option-6A, and Option-7A described above, to use/implement for indicating/identifying the serving/non-serving (or neighboring) cells/TRPs in the inter-cell system.

In one example of design example 1.2A, the UE could be first higher layer configured by the network, e.g., via the higher layer RRC signaling, N_s>1 lists/pools of TCI states with each list/pool of TCI state(s) containing at least one TCI state. Each TCI state contains at least a QCL source RS associated with either the serving cell/TRP or a non-serving cell/TRP (or neighboring cell/TRP). The TCI state indices/IDs and/or the bit-width used for representing the TCI state indices/IDs could be determined across all N_s lists/pools of TCI states and/or one or more of all N_s lists/pools of TCI states. The UE could then receive from the network one or more MAC CE commands to indicate the beam(s) (i.e., the TCI state(s))—selected from one or more lists/pools of TCI states—for the transmission/reception of the PDCCH(s) or the PDSCH(s) transmitted from/associated with the serving cell/TRP and/or a non-serving cell/TRP (and/or a neighboring cell/TRP).

For an inter-cell system, the UE could receive from the network a single MAC CE command at a time (e.g., in a slot) for the PDCCH/PDSCH beam indication to enable the dynamic switching of the transmission/reception of the PDCCH(s)/PDSCH(s) between different cells/TRPs, e.g., the serving cell/TRP and one or more non-serving (or neighboring) cells/TRPs having different PCIs from that of the serving cell/TRP. For an inter-cell multi-TRP system, the UE could receive from the network more than one MAC CE commands at a time (e.g., in a slot) to indicate the beams/TCI states for the PDCCHs/PDSCHs simultaneously transmitted from the serving cell/TRP and the non-serving (or neighboring) cell(s)/TRP(s).

FIG. 12C illustrates another example of higher layer configured two lists of TCI states 1220 according to embodiments of the present disclosure. An embodiment of the higher layer configured two lists of TCI states 1220 shown in FIG. 12C is for illustration only.

In FIG. 12C, an example of configuring N_s=2 lists/pools of TCI states, e.g., in the higher layer parameter PDSCH-config, is presented. A first list/pool of TCI states contains a total of M_tci TCI states, and a second list of TCI states contains a total of (N_tci−M_tci) TCI states. In this example, the TCI state indices/IDs and/or the bit-width used for representing the TCI state indices/IDs are determined across all N_s=2 lists/pools of TCI states.

As shown in FIG. 12C, the TCI states in the first list/pool of TCI states are indexed as #1, #2, . . . , #M_tci or the TCI state IDs in the first list/pool of TCI states are #1, #2, . . . , #M_tci; the TCI states in the second list/pool of TCI states are indexed as #(M_tci+1), #(M_tci+2), . . . , #N_tci or the TCI state IDs in the second list/pool of TCI states are #(M_tci+1), #(M_tci+2), . . . , #N_tci.

A distinct TCI state group ID could be associated with a list/pool of TCI states configured, e.g., in the higher layer parameter PDSCH-config. For the example shown in FIG. 12C, two TCI state IDs “0” and “1” could be defined with TCI state group ID “0” associated with the first list/pool of TCI states and TCI state group ID “1” associated with the second list/pool of TCI states. Each TCI state group ID, and therefore, the TCI states in the corresponding higher layer configured list/pool of TCI states could be associated with/mapped to a PCI for either the serving cell/TRP or a non-serving cell/TRP (or neighboring cell/TRP). The UE could be indicated by the network the association between the TCI state group ID values and the PCI values for the serving/non-serving (or neighboring) cells/TRPs.

In one example, the UE could be explicitly indicated by the network, e.g., via higher layer RRC signaling and/or MAC CE command and/or dynamic DCI signaling, the exact association/mapping between the TCI state group ID values and the PCI values for the serving/non-serving (or neighboring) cells/TRPs in the inter-cell system. For example, the UE could be first higher layer configured by the network a list/set of two PCIs for the serving/non-serving (or neighboring) cells/TRPs; the TCI state group ID value “0” could be mapped to/associated with the first entry in the list/set of two PCIs for the serving/non-serving (or neighboring) cells/TRPs, while the TCI state group ID value “1” could be mapped to/associated with the second entry in the list/set of two PCIs for the serving/non-serving (or neighboring) cells/TRPs.

For more than two configured TCI state group ID values (e.g., 0, 1, . . . , L_idx−1 with L_idx>2), the UE could be first higher layer configured by the network a list/set of at least L_idx PCIs for the serving/non-serving (or neighboring) cells/TRPs in the inter-cell system. The UE could then be indicated by the network the association/mapping between the L_idx TCI state group ID values and the PCIs in the higher layer configured list/set of PCIs. Other indication methods, e.g., via higher layer RRC signaling and/or MAC CE command and/or dynamic DCI signaling, of the exact association/mapping between the TCI state group ID values and the PCI values for the serving/non-serving (or neighboring) cells/TRPs in the inter-cell system are also possible.

In another example, the UE could be implicitly indicated by the network the association/mapping between the TCI state group ID values and the PCI values for the serving/non-serving (or neighboring) cells/TRPs in the inter-cell system. For example, the UE could be indicated by the network that the TCI state group ID value “0” could be mapped to/associated with the lowest PCI value configured to the UE, while the TCI state group ID value “1” could be mapped to/associated with the highest PCI value configured to the UE. For more than two configured TCI state group ID values (e.g., 0, 1, . . . , L_idx−1 with L_idx>2), the UE could be indicated by the network that the lowest TCI state group ID value could be mapped to/associated with the lowest PCI value configured for the UE, the second lowest TCI state group ID value could be mapped to/associated with the second lowest PCI value configured for the UE, and so on, and the L_idx-th highest TCI state group ID value could be mapped to/associated with the L_idx-th highest PCI value configured for the UE. Other implicit indication methods of the association/mapping between the TCI state group ID values and the PCI values for the serving/non-serving (or neighboring) cells/TRPs in the inter-cell system are also possible.

In yet another example, the UE could be first higher layer configured by the network the mapping/association between one or more PCI values and the TCI state group ID values; the UE could then receive from the network one or more MAC CE commands to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first MAC CE command activating at least one PCI from the first set of PCIs corresponding to/associated with the TCI state group ID value “0.” The UE could also receive from the network a second MAC CE command activating at least one PCI from the second set of PCIs corresponding to/associated with the TCI state group ID value “1.”

Alternatively, the UE could receive from the network a single MAC CE command activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first MAC CE command activating at least one PCI from the first set of PCIs corresponding to/associated with the TCI state group ID value “0,” a second MAC CE command activating at least one PCI from the second set of PCIs corresponding to/associated with the TCI state group ID value “1,” and so on, and a L_idx-th MAC CE command activating at least one PCI from the L_idx-th set of PCIs corresponding to/associated with the TCI state group ID value “L_idx−1.”

Alternatively, the UE could receive from the network a single MAC CE command activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be first higher layer configured by the network the mapping/association between one or more PCI values and the TCI state group ID values; the UE could then receive from the network one or more bitmaps to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first bitmap with each entry/bit in the first bitmap corresponding to/associated with a distinct entry in the first set of PCIs corresponding to/associated with the TCI state group ID value “0”; if an entry/bit in the first bitmap is set to “1,” the corresponding/associated entry in the first set of PCIs corresponding to/associated with the TCI state group ID value “0” is activated as the PCI corresponding to/associated with the TCI state group ID value “0” for the inter-cell operation.

The UE could also receive from the network a second bitmap with each entry/bit in the second bitmap corresponding to/associated with a distinct entry in the second set of PCIs corresponding to/associated with the TCI state group ID value “1”; if an entry/bit in the second bitmap is set to “1,” the corresponding/associated entry in the second set of PCIs corresponding to/associated with the TCI state group ID value “1” is activated as the PCI corresponding to/associated with the TCI state group ID value “1” for the inter-cell operation. Alternatively, the UE could receive from the network a single bitmap activating at least one PCI from the first set of PCIs corresponding to/associated with the TCI state group ID value “0” and at least one PCI from the second set of PCIs corresponding to/associated with the TCI state group ID value “1.”

For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first bitmap activating at least one PCI from the first set of PCIs corresponding to/associated with the TCI state group ID value “0,” a second bitmap activating at least one PCI from the second set of PCIs corresponding to/associated with the TCI state group ID value “1,” and so on, and a L_idx-th bitmap activating at least one PCI from the L_idx-th set of PCIs corresponding to/associated with the TCI state group ID value “L_idx−1.”

Alternatively, the UE could receive from the network a single bitmap activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be indicated by the network that the TCI state group ID value “0” is associated with the serving cell/TRP (and/or its corresponding PCI). For a TCI state group ID value other than value “0,” e.g., value “1”: for example, the UE could be indicated by the network, e.g., via higher layer RRC signaling and/or MAC CE command and/or dynamic DCI signaling, the exact non-serving (or neighboring) cell/TRP PCI value associated with the TCI state group ID value; for another example, the UE could be indicated by the network that the TCI state group ID value could be associated with the lowest (or the highest) non-serving (or neighboring) cell/TRP PCI value configured for the UE; yet for another example, (i) the UE could be higher layer configured by the network a list/set of PCIs corresponding to/associated with the TCI state group ID value, and (ii) the UE could receive from the network a MAC CE command activating at least one PCI from the higher layer configured list/set of PCIs corresponding to/associated with the TCI state group ID value; yet for another example, (i) the UE could be higher layer configured by the network a list/set of PCIs corresponding to/associated with the TCI state group ID value, and (ii) the UE could receive from the network a bitmap activating at least one PCI from the higher layer configured list/set of PCIs corresponding to/associated with the TCI state group ID value.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values.

In this design example, if a beam associated with the i-th PCI is activated, the (i+1)-th, the (i+2)-th, . . . , and the (i+K_idx−1)-th entries in the set/list/pool of PCIs (or equivalently, the (i+1)-th PCI, the (i+2)-th PCI, . . . , and the (i+K_idx−1)-th PCI) along with the corresponding TCI state group ID values could be activated, and/or, the (i−K_idx+1)-th, the (i−K_idx+2)-th, . . . , and the (i−1)-th entries in the set/list/pool of PCIs (or equivalently, the (i−K_idx+1)-th PCI, the (i-K_idx+2)-th PCI, . . . , and the (i−1)-th PCI) along with the corresponding TCI state group ID values could be deactivated.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2.

In this example, if a beam associated with the 3-rd PCI (associated with the TCI state group ID value “2”) is activated, the 4-th PCI (associated with the TCI state group ID value “0”) and the 5-th PCI (associated with the TCI state group ID value “1”) are activated. At the same time, the 1-st PCI (associated with the TCI state group ID value “0”) and the 2-nd PCI (associated with the TCI state group ID value “1”) are deactivated.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values. In this design example, if a beam associated with the i-th PCI is activated, the (i−floor((K_idx−1)/2))-th, the (i−floor((K_idx−1)/2)+1)-th, . . . , and the (i+ceil((K_idx−1)/2))-th entries in the set/list/pool of PCIs (or equivalently, the (i-floor((K_idx−1)/2))-th PCI, the (i−floor((K_idx−1)/2)+1)-th PCI, . . . , and the (i+ceil((K_idx−1)/2))-th PCI) along with the corresponding TCI state group ID values could be activated, or, the (i-ceil((K_idx−1)/2))-th, the (i−floor((K_idx−1)/2)+1)-th, . . . , and the (i+floor((K_idx−1)/2))-th entries in the set/list/pool of PCIs (or equivalently, the (i-ceil((K_idx−1)/2))-th PCI, the (i−floor((K_idx−1)/2)+1)-th PCI, . . . , and the (i+floor((K_idx−1)/2))-th PCI) along with the corresponding TCI state group ID values could be activated, where floor(x) returns the largest integer that is smaller than or equal to x and ceil(x) returns the smallest integer that is greater than or equal to x. The starting/initial activated cells could be the (i−G)-th, the (i−G+1)-th, . . . , the i-th, . . . , the (i−G+K_idx−1)-th entries in the set/list/pool of PCIs (or equivalently, the (i−G)-th PCI, the (i−G+1)-th PCI, . . . , the i-th PCI, . . . , the (i−G+K_idx−1)-th PCI); their corresponding/associated TCI state group ID values are also activated. Here, the value of G could be higher layer configured to the UE by the network and/or fixed per RRC configuration.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 2-nd PCI (associated with the TCI state group ID value “1”) and the 4-th PCI (associated with the TCI state group ID value “0”) are activated.

In this design example, the MAC CE for the PDCCH/PDSCH beam indication—for the inter-cell operation—could include at least a TCI state ID. As discussed above, the TCI state corresponding to the TCI state ID could be at least one of: (1) a DL TCI state; (2) an UL TCI state; (3) a joint DL and UL TCI state; and/or (4) separate DL TCI state and UL TCI state.

In addition to Option-1A, Option-2A, Option-3A, Option-4A, Option-5A, Option-6A, and Option-7A based MAC CE based inter-cell PDCCH/PDSCH beam indication, in one example of Option-8A, the MAC CE for the inter-cell PDCCH/PDSCH beam indication may not include the TCI state group ID value(s)—different from the design example 1.1A. The UE could identify the TCI state group ID value(s) from the TCI state/TCI state ID indicated in the MAC CE for the inter-cell PDCCH/PDSCH beam indication because the TCI state IDs are determined across all N_s>1 lists/pools of TCI states. If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDCCH/PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH/PDSCH is transmitted.

In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RS(s) in the TCI state indicated in the MAC CE is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS(s) in the TCI state indicated in the MAC CE is transmitted.

The UE could be indicated by the network which design option(s), selected from/out of Option-1A, Option-2A, Option-3A, Option-4A, Option-5A, Option-6A, Option-7A, and Option-8A described above, is used/implemented; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, the UE could be explicitly indicated by the network, e.g., via higher layer RRC signaling and/or MAC CE command and/or dynamic DCI signaling, the exact design option(s) used/implemented to indicate/identify the serving/non-serving (or neighboring) cells/TRPs in the inter-cell system.

For another example, the UE could receive from the network one or more MAC CE activation commands activating one or more design options used/implemented to indicate/identify the serving/non-serving (or neighboring) cells/TRPs in the inter-cell system.

For yet another example, the UE could receive from the network one or more bitmaps activating one or more design options used/implemented to indicate/identify the serving/non-serving (or neighboring) cells/TRPs in the inter-cell system.

In addition, the design option(s) used/implemented to indicate/identify the serving/non-serving (or neighboring) cells/TRPs in the inter-cell system could be fixed in system specification(s), determined by the network based on UE's capability reporting, and etc. Furthermore, the UE could send to the network their preference(s)/selection(s) regarding the design option(s), e.g., from/out of Option-1A, Option-2A, Option-3A, Option-4A, Option-5A, Option-6A, Option-7A, and Option-8A described above, to use/implement for indicating/identifying the serving/non-serving (or neighboring) cells/TRPs in the inter-cell system.

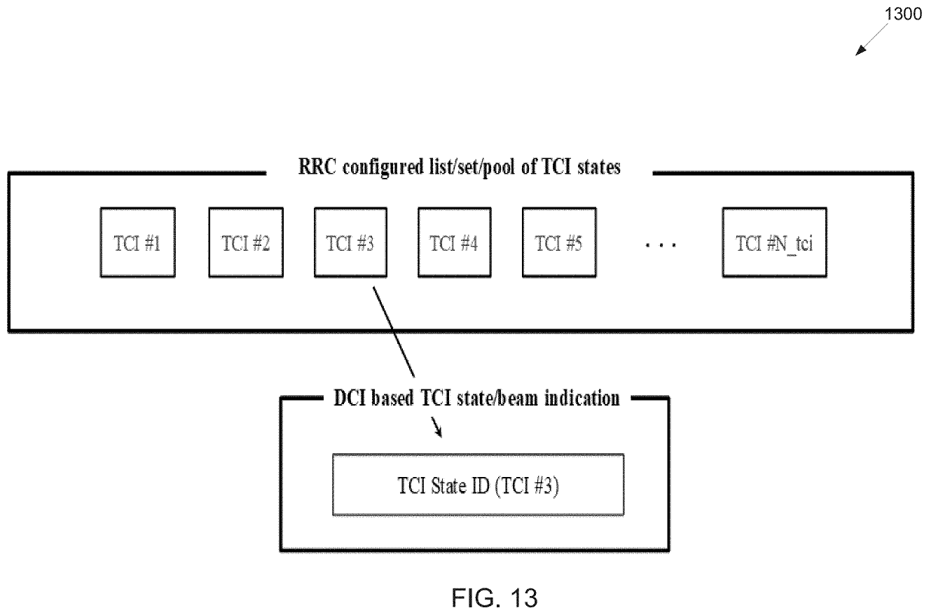

FIG. 13 illustrates an example of DCI based TCI state/beam indication 1300 according to embodiments of the present disclosure. An embodiment of the DCI based TCI state/beam indication 1300 shown in FIG. 13 is for illustration only.

In one example of design example 2.0A, in FIG. 13, an example of DCI based TCI state/beam indication for the inter-cell beam operation is presented. As illustrated in FIG. 13, the UE could be first higher layer configured by the network, e.g., via the higher layer RRC signaling, a list/pool of N_tci TCI states. Each TCI state contains at least a QCL source RS associated with either the serving cell/TRP or a non-serving cell/TRP (or neighboring cell/TRP). The UE could then be indicated by the network one or more DCIs to indicate the beam(s) (i.e., the TCI state(s)) for the transmission/reception of the PDCCH(s) or the PDSCH(s) transmitted from/associated with the serving cell/TRP and/or a non-serving cell/TRP (and/or a neighboring cell/TRP). For an inter-cell system, the UE could receive from the network a single DCI at a time (e.g., in a slot) for the PDCCH/PDSCH beam indication to enable the dynamic switching of the transmission/reception of the PDCCH(s)/PDSCH(s) between different cells/TRPs, e.g., the serving cell/TRP and one or more non-serving (or neighboring) cells/TRPs having different PCIs from that of the serving cell/TRP. For an inter-cell multi-TRP system, the UE could receive from the network more than one DCIs at a time (e.g., in a slot) to indicate the beams/TCI states for the PDCCHs/PDSCHs simultaneously transmitted from the serving cell/TRP and the non-serving (or neighboring) cell(s)/TRP(s).

As described above, a DCI used to indicate to the UE a beam (i.e., a TCI state and/or a TCI state ID) for the transmission/reception of a PDCCH or a PDSCH could be at least one of the following: (1) in one example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment; (2) in another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant; and/or (3) yet in another example, a custom/purpose designed DCI format could be used to indicate to the UE a beam (i.e., a TCI state and/or a TCI state ID) for the transmission/reception of a PDCCH or a PDSCH.

Furthermore, the TCI state indicated in the DCI for the inter-cell PDCCH/PDSCH beam indication could be at least one of: (1) a DL TCI state; (2) an UL TCI state; (3) a joint DL and UL TCI state; and/or (4) separate DL TCI state and UL TCI state.

In addition to including/indicating the TCI state/TCI state ID in the DCI, the DCI for the inter-cell PDCCH/PDSCH beam indication could include information to indicate/identify the serving/non-serving (or neighboring) cells/TRPs.

In one example of Option-IA, a one-bit flag indicator could be included/indicated in the DCI for the inter-cell PDCCH/PDSCH beam indication (from the higher layer configured list/set/pool of TCI state(s)). If the one-bit flag indicator is present and set to “1,” the corresponding PDCCH/PDSCH could be transmitted from/associated with the serving cell/TRP; in this case, the QCL source RS(s) in the TCI state indicated in the DCI could also be associated with/transmitted from the serving cell/TRP. If the one-bit flag indicator is not present or set to “0,” the corresponding PDCCH/PDSCH could be transmitted from/associated with a non-serving cell/TRP (or neighboring cell/TRP) in the inter-cell system; in this case, the QCL source RS(s) in the TCI state indicated in the DCI could also be associated with/transmitted from the non-serving cell/TRP (or neighboring cell/TRP). For inter-cell multi-TRP operation, the one-bit flag indicator could correspond to/be configured as the higher layer signaling index—CORESETPoolIndex.

In one example of Option-IIA, a multi-bit (more than one bit) indicator could be included/indicated in the DCI for the inter-cell PDCCH/PDSCH beam indication (from the higher layer configured list/set/pool of TCI state(s)) to indicate the serving cell/TRP and two or more non-serving cells/TRPs (or neighboring cells/TRPs) in the inter-cell system. The number of bits n_b required for representing the multi-bit indicator could be ceil(log 2(N_nsc+1)), where N_nsc is the total number of non-serving cells/TRPs (or neighboring cells/TRPs) and ceil(x) rounds x up to the next largest integer. In this case, the n_b-bit indicator could correspond to 2\hat{ }(n_b) states, and one of the states (e.g., the first state) could correspond to the serving cell/TRP, and the rest of the states could correspond to the non-serving cells/TRPs (or neighboring cells/TRPs).

Alternatively, the number of bits n_b required for representing the multi-bit indicator could be ceil(log 2(N_nsc)). In this case, the multi-bit indicator only indicates/identifies the non-serving cells/TRPs (or neighboring cells/TRPs); if the multi-bit indicator is not present, the UE may expect that the corresponding PDCCH/PDSCH is transmitted from/associated with the serving cell/TRP; if the multi-bit indicator is not present, the UE could also expect that the QCL source RS(s) in the TCI state indicated in the DCI is associated with/transmitted from the serving cell/TRP.

The UE could be indicated by the network the association rule(s)/mapping relationship(s) between the states of the multi-bit indicator and the PCI values for the serving/non-serving (or neighboring) cells/TRPs in the inter-cell system; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

In one example of Option-IIIA, the PCI value(s) could be included/indicated in the DCI for the inter-cell PDCCH/PDSCH beam indication (from the higher layer configured list/set/pool of TCI state(s)). In this design option, one or more PCI values could be used/reserved for representing the serving cell/TRP. The UE could be indicated by the network the association between the PCI value(s) and the serving cell/TRP and/or the association between the PCI value(s) and the non-serving (or neighboring) cell(s)/TRP(s). If the indicated PCI value is associated with the serving cell/TRP, the corresponding PDCCH/PDSCH could be transmitted from/associated with the serving cell/TRP; in this case, the QCL source RS(s) in the TCI state indicated in the DCI could also be associated with/transmitted from the serving cell/TRP. If the indicated PCI value is associated with a non-serving cell/TRP (or neighboring cell/TRP), the corresponding PDCCH/PDSCH could be transmitted from/associated with the non-serving cell/TRP (or neighboring cell/TRP) in the inter-cell system; in this case, the QCL source RS(s) in the TCI state indicated in the DCI could also be associated with/transmitted from the non-serving cell/TRP (or neighboring cell/TRP).

In one example of Option-IVA, the serving cell ID (SCI) value(s) could be included/indicated in the DCI for the inter-cell PDCCH/PDSCH beam indication (from the higher layer configured list/set/pool of TCI state(s)). One or more SCI values in the DCI for the inter-cell PDCCH/PDSCH beam indication could be used for representing one or more non-serving cells/TRPs (or neighboring cells/TRPs), and/or, correspond to one or more PCI values for the non-serving cells/TRPs (or neighboring cells/TRPs), in the inter-cell system. The UE could be indicated by the network the exact SCI value(s) used/reserved for representing the non-serving cell(s)/TRP(s) (or neighboring cell(s)/TRP(s)), and/or, the association between the reserved SCI value(s) and the PCI value(s) for the non-serving cell(s)/TRP(s) (or neighboring cell(s)/TRP(s)). If the indicated SCI value is reserved/used for representing a non-serving cell/TRP (or neighboring cell/TRP) and/or corresponds to a non-serving cell/TRP (or neighboring cell/TRP) PCI value, the DCI could indicate the beam used for transmitting the PDCCH/PDSCH from the non-serving cell/TRP (or neighboring cell/TRP) in the inter-cell system; in this case, the QCL source RS(s) in the TCI state indicated in the DCI could also be associated with/transmitted from the non-serving cell/TRP (or neighboring cell/TRP).

In one example of Option-VA, a TCI state could include information that indicates/identifies the serving/non-serving (or neighboring) cells/TRPs information. For example, a TCI state could include a one-bit flag indicator, which could correspond to/be configured as the higher layer signaling index CORESETPoolIndex in an inter-cell multi-TRP system, to indicate the serving cell/TRP or a non-serving cell/TRP (or neighboring cell/TRP). For another example, a TCI state could include a multi-bit indicator to indicate the serving cell/TRP (and/or its PCI value) and the non-serving (or neighboring) cell(s)/TRPs (and/or the corresponding PCI value(s)). Yet for another example, a TCI state could include the PCI value to indicate the serving/non-serving (or neighboring) cells/TRPs information. Yet for another example, one or more serving cell IDs (SCIs) in a TCI state could be reserved/used to indicate one or more non-serving (or neighboring) cells/TRPs information. The details about the indication/identification of the serving/non-serving (or neighboring) cells/TRPs information in a TCI state are according to U.S. patent application Ser. No. 17/444,556 as incorporated by reference herein.

If the serving cell/TRP information is indicated in the TCI state indicated in the DCI for the inter-cell PDCCH/PDSCH beam indication (from the higher layer configured list/set/pool of TCI state(s)), the corresponding PDCCH/PDSCH could be transmitted from/associated with the serving cell/TRP; in this case, the QCL source RS(s) in the TCI state indicated in the DCI could also be associated with/transmitted from the serving cell/TRP. If the non-serving (or neighboring) cell/TRP information is indicated in the TCI state indicated in the DCI for the inter-cell PDCCH/PDSCH beam indication (from the higher layer configured list/set/pool of TCI state(s)), the corresponding PDCCH/PDSCH could be transmitted from/associated with the non-serving cell/TRP (or neighboring cell/TRP) in the inter-cell system; in this case, the QCL source RS(s) in the TCI state indicated in the DCI could also be associated with/transmitted from the non-serving cell/TRP (or neighboring cell/TRP).

In one example of Option-VIA, the DCI for the inter-cell PDCCH/PDSCH beam indication (from the higher layer configured list/set/pool of TCI states) could contain/indicate a list/set of M≥1 TCI states/TCI state IDs—selected from the higher layer configured list/set/pool of TCI states—with each TCI state (and therefore, the QCL source RS(s) indicated therein) associated with either the serving cell/TRP or a non-serving (or neighboring) cell/TRP.

In one example, the UE could be explicitly indicated by the network, e.g., via higher layer RRC signaling and/or MAC CE command and/or dynamic DCI signaling, the exact association/mapping between the list/set of M≥1 TCI states/TCI state IDs and the PCI/CORESETPoolIndex values for the serving/non-serving (or neighboring) cells/TRPs in the inter-cell system.

For example, the UE could be first configured by the network a list/set of M≥1 PCI/CORESETPoolIndex values for the serving/non-serving (or neighboring) cells/TRPs; the first TCI state/TCI state ID in the list/set of M TCI states/TCI state IDs could be mapped to/associated with the first entry in the list/set of M PCI/CORESETPoolIndex values for the serving/non-serving (or neighboring) cells/TRPs, the second TCI state/TCI state ID in the list/set of M TCI states/TCI state IDs could be mapped to/associated with the second entry in the list/set of M PCI/CORESETPoolIndex values for the serving/non-serving (or neighboring) cells/TRPs, and so on, and the M-th TCI state/TCI state ID in the list/set of M TCI states/TCI state IDs could be mapped to/associated with the M-th entry in the list/set of M PCI/CORESETPoolIndex values for the serving/non-serving (or neighboring) cells/TRPs.

For another example, the UE could be first configured by the network a list/set of M≥1 PCI/CORESETPoolIndex values for the serving/non-serving (or neighboring) cells/TRPs; the lowest (or the highest) TCI state ID value (and/or its corresponding TCI state) in the list/set of M TCI states/TCI state IDs could be mapped to/associated with the first entry in the list/set of M PCI/CORESETPoolIndex values for the serving/non-serving (or neighboring) cells/TRPs, the second lowest (or the second highest) TCI state ID value (and/or its corresponding TCI state) in the list/set of M TCI states/TCI state IDs could be mapped to/associated with the second entry in the list/set of M PCI/CORESETPoolIndex values for the serving/non-serving (or neighboring) cells/TRPs, and so on, and the highest (or the lowest) TCI state ID value (and/or its corresponding TCI state) in the list/set of M TCI states/TCI state IDs could be mapped to/associated with the M-th entry in the list/set of M PCI/CORESETPoolIndex values for the serving/non-serving (or neighboring) cells/TRPs.

In another example, the UE could be implicitly indicated by the network the association/mapping between the list/set of M≥1 TCI states/TCI state IDs and the PCI/CORESETPoolIndex values for the serving/non-serving (or neighboring) cells/TRPs in the inter-cell system. For example, the UE could be indicated by the network that the first TCI state/TCI state ID in the list/set of M TCI states/TCI state IDs could be mapped to/associated with the lowest (or the highest) PCI/CORESETPoolIndex value configured for the UE, the second TCI state/TCI state ID in the list/set of M TCI states/TCI state IDs could be mapped to/associated with the second lowest (or the second highest) PCI/CORESETPoolIndex value configured for the UE, and so on, and the M-th TCI state/TCI state ID in the list/set of M TCI states/TCI state IDs could be mapped to/associated with the highest (or the lowest) PCI/CORESETPoolIndex value configured for the UE.

For another example, the UE could be indicated by the network that the lowest (or the highest) TCI state ID value (and/or its corresponding TCI state) in the list/set of M TCI states/TCI state IDs could be mapped to/associated with the lowest (or the highest) PCI/CORESETPoolIndex value configured for the UE, the second lowest (or the second highest) TCI state ID value (and/or its corresponding TCI state) in the list/set of M TCI states/TCI state IDs could be mapped to/associated with the second lowest (or the second highest) PCI/CORESETPoolIndex value configured for the UE, and so on, and the highest (or the lowest) TCI state ID value (and/or its corresponding TCI state) in the list/set of M TCI states/TCI state IDs could be mapped to/associated with the highest (or the lowest) PCI/CORESETPoolIndex value configured for the UE.

Other implicit indication methods of the association/mapping between the list/set of M≥1 TCI states/TCI state IDs and the PCI/CORESETPoolIndex values for the serving/non-serving (or neighboring) cells/TRPs in the inter-cell system are also possible.

In yet another example, the UE could be first higher layer configured by the network the mapping/association between one or more PCI/CORESETPoolIndex values and the list/set of M≥1 TCI states/TCI state IDs; the UE could then receive from the network one or more MAC CE activation commands/bitmaps to activate one or more PCI/CORESETPoolIndex values associated with each entry in the list/set of M TCI states/TCI state IDs. For example, the UE could be first higher layer configured by the network a first set of PCI/CORESETPoolIndex values corresponding to/associated with the first TCI state/TCI state ID or the lowest/highest TCI state ID value (and/or its corresponding TCI state) in the list/set of M TCI states/TCI state IDs, a second set of PCI/CORESETPoolIndex values corresponding to/associated with the second TCI state/TCI state ID or the second lowest/highest TCI state ID value (and/or its corresponding TCI state) in the list/set of M TCI states/TCI state IDs, and so on, and a M-th set of PCI/CORESETPoolIndex values corresponding to/associated with the M-th TCI state/TCI state ID or the highest/lowest TCI state ID value (and/or its corresponding TCI state) in the list/set of M TCI states/TCI state IDs.

The UE could then receive from the network a first MAC CE activation command/bitmap activating at least one PCI/CORESETPoolIndex value from the first set of PCI/CORESETPoolIndex values corresponding to/associated with the first TCI state/TCI state ID or the lowest/highest TCI state ID value (and/or its corresponding TCI state) in the list/set of M TCI states/TCI state IDs, a second MAC CE activation command/bitmap activating at least one PCI/CORESETPoolIndex value from the second set of PCI/CORESETPoolIndex values corresponding to/associated with the second TCI state/TCI state ID or the second lowest/highest TCI state ID value (and/or its corresponding TCI state) in the list/set of M TCI states/TCI state IDs, and so on, and a M-th MAC CE activation command/bitmap activating at least one PCI/CORESETPoolIndex value from the M-th set of PCI/CORESETPoolIndex values corresponding to/associated with the M-th TCI state/TCI state ID or the highest/lowest TCI state ID value (and/or its corresponding TCI state) in the list/set of M TCI states/TCI state IDs.

Alternatively, the UE could receive from the network a single MAC CE activation command/bitmap activating at least one PCI/CORESETPoolIndex value from the first set of PCI/CORESETPoolIndex values corresponding to/associated with the first TCI state/TCI state ID or the lowest/highest TCI state ID value (and/or its corresponding TCI state) in the list/set of M TCI states/TCI state IDs, at least one PCI/CORESETPoolIndex value from the second set of PCI/CORESETPoolIndex values corresponding to/associated with the second TCI state/TCI state ID or the second lowest/highest TCI state ID value (and/or its corresponding TCI state) in the list/set of M TCI states/TCI state IDs, and so on, and at least one PCI/CORESETPoolIndex value from the M-th set of PCI/CORESETPoolIndex values corresponding to/associated with the M-th TCI state/TCI state ID or the highest/lowest TCI state ID value (and/or its corresponding TCI state) in the list/set of M TCI states/TCI state IDs.

In yet another example, the UE could be indicated by the network that the first TCI state/TCI state ID or the lowest/highest TCI state ID value (and/or its corresponding TCI state) in the list/set of M TCI states is associated with the serving cell/TRP (and/or its corresponding PCI/CORESETPoolIndex value).

For a given TCI state/TCI state ID in the list/set of M TCI states/TCI state IDs other than the first TCI state/TCI state ID or the lowest/highest TCI state ID value (and/or its corresponding TCI state) in the list/set of TCI states/TCI state IDs: for example, the UE could be indicated by the network, e.g., via higher layer RRC signaling and/or MAC CE command and/or dynamic DCI signaling, the exact non-serving (or neighboring) cell/TRP PCI/CORESETPoolIndex value associated with the TCI state/TCI state ID; for another example, (i) the UE could be higher layer configured by the network a list/set of PCI/CORESETPoolIndex values corresponding to/associated with the TCI state/TCI state ID, and (ii) the UE could receive from the network a MAC CE command activating at least one PCI/CORESETPoolIndex value from the higher layer configured list/set of PCI/CORESETPoolIndex values corresponding to/associated with the TCI state/TCI state ID; yet for another example, (i) the UE could be higher layer configured by the network a list/set of PCI/CORESETPoolIndex values corresponding to/associated with the TCI state/TCI state ID, and (ii) the UE could receive from the network a bitmap activating at least one PCI/CORESETPoolIndex value from the higher layer configured list/set of PCI/CORESETPoolIndex values corresponding to/associated with the TCI state/TCI state ID.

The UE could be indicated by the network which design option(s), selected from/out of Option-IA, Option-IIA, Option-IIIA, Option-IVA, Option-VA, and Option-VIA described above, is used/implemented; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, the UE could be explicitly indicated by the network, e.g., via higher layer RRC signaling and/or MAC CE command and/or dynamic DCI signaling, the exact design option(s) used/implemented to indicate/identify the serving/non-serving (or neighboring) cells/TRPs in the inter-cell system.

For another example, the UE could receive from the network one or more MAC CE activation commands activating one or more design options used/implemented to indicate/identify the serving/non-serving (or neighboring) cells/TRPs in the inter-cell system.

For yet another example, the UE could receive from the network one or more bitmaps activating one or more design options used/implemented to indicate/identify the serving/non-serving (or neighboring) cells/TRPs in the inter-cell system.

In addition, the design option(s) used/implemented to indicate/identify the serving/non-serving (or neighboring) cells/TRPs in the inter-cell system could be fixed in system specification(s), determined by the network based on UE's capability reporting, and etc. Furthermore, the UE could send to the network their preference(s)/selection(s) regarding the design option(s), e.g., from/out of Option-IA, Option-IIA, Option-IIIA, Option-IVA, Option-VA, and Option-VIA described above, to use/implement for indicating/identifying the serving/non-serving (or neighboring) cells/TRPs in the inter-cell system.

In one example of design example 2.1A, the UE could be first higher layer configured by the network, e.g., via the higher layer RRC parameter, N_s>1 lists/pools of TCI states with each list/pool of TCI state(s) containing at least one TCI state. Each TCI state contains at least a QCL source RS associated with either the serving cell/TRP or a non-serving cell/TRP (or neighboring cell/TRP). The TCI state indices/IDs and/or the bit-width used for representing the TCI state indices/IDs could be separately determined within each list/pool of TCI states. The UE could then receive from the network one or more DCIs to indicate the beam(s) (i.e., the TCI state(s))—selected from one or more lists/pools of TCI states—for the transmission/reception of the PDCCH(s) or the PDSCH(s) transmitted from/associated with the serving cell/TRP and/or a non-serving cell/TRP (and/or a neighboring cell/TRP).

For an inter-cell system, the UE could receive from the network a single DCI at a time (e.g., in a slot) for the PDCCH/PDSCH beam indication to enable the dynamic switching of the transmission/reception of the PDCCH(s)/PDSCH(s) between different cells/TRPs, e.g., the serving cell/TRP and one or more non-serving (or neighboring) cells/TRPs having different PCIs from that of the serving cell/TRP. For an inter-cell multi-TRP system, the UE could receive from the network more than one DCIs at a time (e.g., in a slot) to indicate the beams/TCI states for the PDCCHs/PDSCHs simultaneously transmitted from the serving cell/TRP and the non-serving (or neighboring) cell(s)/TRP(s).

In FIG. 12B, an example of configuring N_s=2 lists/pools of TCI states via the higher layer RRC signaling is presented. A first list/pool of TCI states contains a total of M_tci TCI states, and a second list of TCI states contains a total of (N_tci−M_tci) TCI states. In this example, the TCI state indices/IDs and/or the bit-width used for representing the TCI state indices/IDs are separately determined within each list/pool of TCI states. As shown in FIG. 12B, the TCI states in the first list/pool of TCI states are indexed as #1, #2, . . . , #M_tci or the TCI state IDs in the first list/pool of TCI states are #1, #2, . . . , #M_tci; the TCI states in the second list/pool of TCI states are indexed as #1, #2, . . . , #(N_tci−M_tci) or the TCI state IDs in the second list/pool of TCI states are #1, #2, . . . , #(N_tci−M_tci).

A distinct TCI state group ID could be associated with a list/pool of TCI states configured, e.g., in the higher layer parameter PDSCH-config. For the example shown in FIG. 12B, two TCI state group IDs “0” and “1” could be defined with TCI state group ID “0” associated with the first list/pool of TCI states and TCI state group ID “1” associated with the second list/pool of TCI states. Each TCI state group ID, and therefore, the TCI states in the corresponding higher layer configured list/pool of TCI states could be associated with/mapped to a PCI for either the serving cell/TRP or a non-serving cell/TRP (or neighboring cell/TRP). The UE could be indicated by the network the association between the TCI state group ID values and the PCI values for the serving/non-serving (or neighboring) cells/TRPs.

In one example, the UE could be explicitly indicated by the network, e.g., via higher layer RRC signaling and/or MAC CE command and/or dynamic DCI signaling, the exact association/mapping between the TCI state group ID values and the PCI values for the serving/non-serving (or neighboring) cells/TRPs in the inter-cell system. For example, the UE could be first higher layer configured by the network a list/set of two PCIs for the serving/non-serving (or neighboring) cells/TRPs; the TCI state group ID value “0” could be mapped to/associated with the first entry in the list/set of two PCIs for the serving/non-serving (or neighboring) cells/TRPs, while the TCI state group ID value “1” could be mapped to/associated with the second entry in the list/set of two PCIs for the serving/non-serving (or neighboring) cells/TRPs.

For more than two configured TCI state group ID values (e.g., 0, 1, . . . , L_idx−1 with L_idx>2), the UE could be first higher layer configured by the network a list/set of at least L_idx PCIs for the serving/non-serving (or neighboring) cells/TRPs in the inter-cell system. The UE could then be indicated by the network the association/mapping between the L_idx TCI state group ID values and the PCIs in the higher layer configured list/set of PCIs. Other indication methods, e.g., via higher layer RRC signaling and/or MAC CE command and/or dynamic DCI signaling, of the exact association/mapping between the TCI state group ID values and the PCI values for the serving/non-serving (or neighboring) cells/TRPs in the inter-cell system are also possible.

In another example, the UE could be implicitly indicated by the network the association/mapping between the TCI state group ID values and the PCI values for the serving/non-serving (or neighboring) cells/TRPs in the inter-cell system. For example, the UE could be indicated by the network that the TCI state group ID value “0” could be mapped to/associated with the lowest PCI value configured to the UE, while the TCI state group ID value “1” could be mapped to/associated with the highest PCI value configured to the UE. For more than two configured TCI state group ID values (e.g., 0, 1, . . . , L_idx−1 with L_idx>2), the UE could be indicated by the network that the lowest TCI state group ID value could be mapped to/associated with the lowest PCI value configured for the UE, the second lowest TCI state group ID value could be mapped to/associated with the second lowest PCI value configured for the UE, and so on, and the L_idx-th highest TCI state group ID value could be mapped to/associated with the L_idx-th highest PCI value configured for the UE.

Other implicit indication methods of the association/mapping between the TCI state group ID values and the PCI values for the serving/non-serving (or neighboring) cells/TRPs in the inter-cell system are also possible.

In yet another example, the UE could be first higher layer configured by the network the mapping/association between one or more PCI values and the TCI state group ID values; the UE could then receive from the network one or more MAC CE commands to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first MAC CE command activating at least one PCI from the first set of PCIs corresponding to/associated with the TCI state group ID value “0.” The UE could also receive from the network a second MAC CE command activating at least one PCI from the second set of PCIs corresponding to/associated with the TCI state group ID value “1.”

Alternatively, the UE could receive from the network a single MAC CE command activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first MAC CE command activating at least one PCI from the first set of PCIs corresponding to/associated with the TCI state group ID value “0,” a second MAC CE command activating at least one PCI from the second set of PCIs corresponding to/associated with the TCI state group ID value “1,” and so on, and a L_idx-th MAC CE command activating at least one PCI from the L_idx-th set of PCIs corresponding to/associated with the TCI state group ID value “L_idx−1.”

Alternatively, the UE could receive from the network a single MAC CE command activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be first higher layer configured by the network the mapping/association between one or more PCI values and the TCI state group ID values; the UE could then receive from the network one or more bitmaps to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first bitmap with each entry/bit in the first bitmap corresponding to/associated with a distinct entry in the first set of PCIs corresponding to/associated with the TCI state group ID value “0”; if an entry/bit in the first bitmap is set to “1,” the corresponding/associated entry in the first set of PCIs corresponding to/associated with the TCI state group ID value “0” is activated as the PCI corresponding to/associated with the TCI state group ID value “0” for the inter-cell operation.

The UE could also receive from the network a second bitmap with each entry/bit in the second bitmap corresponding to/associated with a distinct entry in the second set of PCIs corresponding to/associated with the TCI state group ID value “1”; if an entry/bit in the second bitmap is set to “1,” the corresponding/associated entry in the second set of PCIs corresponding to/associated with the TCI state group ID value “1” is activated as the PCI corresponding to/associated with the TCI state group ID value “1” for the inter-cell operation.

Alternatively, the UE could receive from the network a single bitmap activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first bitmap activating at least one PCI from the first set of PCIs corresponding to/associated with the TCI state group ID value “0,” a second bitmap activating at least one PCI from the second set of PCIs corresponding to/associated with the TCI state group ID value “1,” and so on, and a L_idx-th bitmap activating at least one PCI from the L_idx-th set of PCIs corresponding to/associated with the TCI state group ID value “L_idx−1.”

Alternatively, the UE could receive from the network a single bitmap activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be indicated by the network that the TCI state group ID value “0” is associated with the serving cell/TRP (and/or its corresponding PCI). For a TCI state group ID value other than value “0,” e.g., value “1”: for example, the UE could be indicated by the network, e.g., via higher layer RRC signaling and/or MAC CE command and/or dynamic DCI signaling, the exact non-serving (or neighboring) cell/TRP PCI value associated with the TCI state group ID value; for another example, the UE could be indicated by the network that the TCI state group ID value could be associated with the lowest (or the highest) non-serving (or neighboring) cell/TRP PCI value configured for the UE; yet for another example, (i) the UE could be higher layer configured by the network a list/set of PCIs corresponding to/associated with the TCI state group ID value, and (ii) the UE could receive from the network a MAC CE command activating at least one PCI from the higher layer configured list/set of PCIs corresponding to/associated with the TCI state group ID value; yet for another example, (i) the UE could be higher layer configured by the network a list/set of PCIs corresponding to/associated with the TCI state group ID value, and (ii) the UE could receive from the network a bitmap activating at least one PCI from the higher layer configured list/set of PCIs corresponding to/associated with the TCI state group ID value.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values. In this design example, if a beam associated with the i-th PCI is activated, the (i+1)-th, the (i+2)-th, . . . , and the (i+K_idx−1)-th entries in the set/list/pool of PCIs (or equivalently, the (i+1)-th PCI, the (i+2)-th PCI, . . . , and the (i+K_idx−1)-th PCI) along with the corresponding TCI state group ID values could be activated, and/or, the (i−K_idx+1)-th, the (i−K_idx+2)-th, . . . , and the (i−1)-th entries in the set/list/pool of PCIs (or equivalently, the (i−K_idx+1)-th PCI, the (i−K_idx+2)-th PCI, . . . , and the (i−1)-th PCI) along with the corresponding TCI state group ID values could be deactivated.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 4-th PCI (associated with the TCI state group ID value “0”) and the 5-th PCI (associated with the TCI state group ID value “1”) are activated. At the same time, the 1-st PCI (associated with the TCI state group ID value “0”) and the 2-nd PCI (associated with the TCI state group ID value “1”) are deactivated.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values. In this design example, if a beam associated with the i-th PCI is activated, the (i−floor((K_idx−1)/2))-th, the (i−floor((K_idx−1)/2)+1)-th, . . . , and the (i+ceil((K_idx−1)/2))-th entries in the set/list/pool of PCIs (or equivalently, the (i-floor((K_idx−1)/2))-th PCI, the (i−floor((K_idx−1)/2)+1)-th PCI, . . . , and the (i+ceil((K_idx−1)/2))-th PCI) along with the corresponding TCI state group ID values could be activated, or, the (i-ceil((K_idx−1)/2))-th, the (i−floor((K_idx−1)/2)+1)-th, . . . , and the (i+floor((K_idx−1)/2))-th entries in the set/list/pool of PCIs (or equivalently, the (i-ceil((K_idx−1)/2))-th PCI, the (i−floor((K_idx−1)/2)+1)-th PCI, . . . , and the (i+floor((K_idx−1)/2))-th PCI) along with the corresponding TCI state group ID values could be activated, where floor(x) returns the largest integer that is smaller than or equal to x and ceil(x) returns the smallest integer that is greater than or equal to x.

The starting/initial activated cells could be the (i−G)-th, the (i−G+1)-th, . . . , the i-th, . . . , the (i−G+K_idx−1)-th entries in the set/list/pool of PCIs (or equivalently, the (i−G)-th PCI, the (i-G+1)-th PCI, . . . , the i-th PCI, . . . , the (i−G+K_idx−1)-th PCI); their corresponding/associated TCI state group ID values are also activated. Here, the value of G could be higher layer configured to the UE by the network and/or fixed per RRC configuration. For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 2-nd PCI (associated with the TCI state group ID value “1”) and the 4-th PCI (associated with the TCI state group ID value “0”) are activated.

As described above, a DCI used to indicate to the UE a beam (i.e., a TCI state and/or a TCI state ID) for the transmission/reception of a PDCCH or a PDSCH could be at least one of the following: (1) in one example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment; (2) in another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant; and/or (3) yet in another example, a custom/purpose designed DCI format could be used to indicate to the UE a beam (i.e., a TCI state and/or a TCI state ID) for the transmission/reception of a PDCCH or a PDSCH.

Furthermore, the TCI state indicated in the DCI for the inter-cell PDCCH/PDSCH beam indication could be at least one of: (1) a DL TCI state; (2) an UL TCI state; (3) a joint DL and UL TCI state; and/or (4) separate DL TCI state and UL TCI state.

In addition to Option-IA, Option-IIA, Option-IIIA, Option-IVA, Option-VA, and Option-VIA based DCI based inter-cell PDCCH/PDSCH beam indication, in one example, Option-VIIA, the TCI state group ID value(s) could be included/indicated in the DCI for the inter-cell PDCCH/PDSCH beam indication (from the higher layer configured list/set/pool of TCI state(s)). If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDCCH/PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH/PDSCH is transmitted.

In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RS(s) in the TCI state indicated in the DCI is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS(s) in the TCI state indicated in the DCI is transmitted.

The UE could be indicated by the network which design option(s), selected from/out of Option-IA, Option-IIA, Option-IIIA, Option-IVA, Option-VA, Option-VIA, and Option-VIIA described above, is used/implemented; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, the UE could be explicitly indicated by the network, e.g., via higher layer RRC signaling and/or MAC CE command and/or dynamic DCI signaling, the exact design option(s) used/implemented to indicate/identify the serving/non-serving (or neighboring) cells/TRPs in the inter-cell system.

For another example, the UE could receive from the network one or more MAC CE activation commands activating one or more design options used/implemented to indicate/identify the serving/non-serving (or neighboring) cells/TRPs in the inter-cell system.

For yet another example, the UE could receive from the network one or more bitmaps activating one or more design options used/implemented to indicate/identify the serving/non-serving (or neighboring) cells/TRPs in the inter-cell system.

In addition, the design option(s) used/implemented to indicate/identify the serving/non-serving (or neighboring) cells/TRPs in the inter-cell system could be fixed in system specification(s), determined by the network based on UE's capability reporting, and etc. Furthermore, the UE could send to the network their preference(s)/selection(s) regarding the design option(s), e.g., from/out of Option-IA, Option-IIA, Option-IIIA, Option-IVA, Option-VA, Option-VIA, and Option-VIIA described above, to use/implement for indicating/identifying the serving/non-serving (or neighboring) cells/TRPs in the inter-cell system.

In one example of design example 2.2A, the UE could be first higher layer configured by the network, e.g., via the higher layer RRC signaling, N_s>1 lists/pools of TCI states with each list/pool of TCI state(s) containing at least one TCI state. Each TCI state contains at least a QCL source RS associated with either the serving cell/TRP or a non-serving cell/TRP (or neighboring cell/TRP). The TCI state indices/IDs and/or the bit-width used for representing the TCI state indices/IDs could be determined across all N_s lists/pools of TCI states and/or one or more of all N_s lists/pools of TCI states. The UE could then receive from the network one or more DCIs to indicate the beam(s) (i.e., the TCI state(s))—selected from one or more lists/pools of TCI states—for the transmission/reception of the PDCCH(s) or the PDSCH(s) transmitted from/associated with the serving cell/TRP and/or a non-serving cell/TRP (and/or a neighboring cell/TRP).

For an inter-cell system, the UE could receive from the network a single DCI at a time (e.g., in a slot) for the PDCCH/PDSCH beam indication to enable the dynamic switching of the transmission/reception of the PDCCH(s)/PDSCH(s) between different cells/TRPs, e.g., the serving cell/TRP and one or more non-serving (or neighboring) cells/TRPs having different PCIs from that of the serving cell/TRP. For an inter-cell multi-TRP system, the UE could receive from the network more than one DCIs at a time (e.g., in a slot) to indicate the beams/TCI states for the PDCCHs/PDSCHs simultaneously transmitted from the serving cell/TRP and the non-serving (or neighboring) cell(s)/TRP(s).

In FIG. 12C, an example of configuring N_s=2 lists/pools of TCI states, e.g., in the higher layer parameter PDSCH-config, is presented. A first list/pool of TCI states contains a total of M_tci TCI states, and a second list of TCI states contains a total of (N_tci−M_tci) TCI states. In this example, the TCI state indices/IDs and/or the bit-width used for representing the TCI state indices/IDs are determined across all N_s=2 lists/pools of TCI states.

As shown in FIG. 12C, the TCI states in the first list/pool of TCI states are indexed as #1, #2, . . . , #M_tci or the TCI state IDs in the first list/pool of TCI states are #1, #2, . . . , #M_tci; the TCI states in the second list/pool of TCI states are indexed as #(M_tci+1), #(M_tci+2), . . . , #N_tci or the TCI state IDs in the second list/pool of TCI states are #(M_tci+1), #(M_tci+2), . . . , #N_tci.

A distinct TCI state group ID could be associated with a list/pool of TCI states configured, e.g., in the higher layer parameter PDSCH-config. For the example shown in FIG. 12C, two TCI state IDs “0” and “1” could be defined with TCI state group ID “0” associated with the first list/pool of TCI states and TCI state group ID “1” associated with the second list/pool of TCI states. Each TCI state group ID, and therefore, the TCI states in the corresponding higher layer configured list/pool of TCI states could be associated with/mapped to a PCI for either the serving cell/TRP or a non-serving cell/TRP (or neighboring cell/TRP). The UE could be indicated by the network the association between the TCI state group ID values and the PCI values for the serving/non-serving (or neighboring) cells/TRPs.

In one example, the UE could be explicitly indicated by the network, e.g., via higher layer RRC signaling and/or MAC CE command and/or dynamic DCI signaling, the exact association/mapping between the TCI state group ID values and the PCI values for the serving/non-serving (or neighboring) cells/TRPs in the inter-cell system. For example, the UE could be first higher layer configured by the network a list/set of two PCIs for the serving/non-serving (or neighboring) cells/TRPs; the TCI state group ID value “0” could be mapped to/associated with the first entry in the list/set of two PCIs for the serving/non-serving (or neighboring) cells/TRPs, while the TCI state group ID value “1” could be mapped to/associated with the second entry in the list/set of two PCIs for the serving/non-serving (or neighboring) cells/TRPs.

For more than two configured TCI state group ID values (e.g., 0, 1, . . . , L_idx−1 with L_idx>2), the UE could be first higher layer configured by the network a list/set of at least L_idx PCIs for the serving/non-serving (or neighboring) cells/TRPs in the inter-cell system. The UE could then be indicated by the network the association/mapping between the L_idx TCI state group ID values and the PCIs in the higher layer configured list/set of PCIs. Other indication methods, e.g., via higher layer RRC signaling and/or MAC CE command and/or dynamic DCI signaling, of the exact association/mapping between the TCI state group ID values and the PCI values for the serving/non-serving (or neighboring) cells/TRPs in the inter-cell system are also possible.

In another example, the UE could be implicitly indicated by the network the association/mapping between the TCI state group ID values and the PCI values for the serving/non-serving (or neighboring) cells/TRPs in the inter-cell system. For example, the UE could be indicated by the network that the TCI state group ID value “0” could be mapped to/associated with the lowest PCI value configured to the UE, while the TCI state group ID value “1” could be mapped to/associated with the highest PCI value configured to the UE. For more than two configured TCI state group ID values (e.g., 0, 1, . . . , L_idx−1 with L_idx>2), the UE could be indicated by the network that the lowest TCI state group ID value could be mapped to/associated with the lowest PCI value configured for the UE, the second lowest TCI state group ID value could be mapped to/associated with the second lowest PCI value configured for the UE, and so on, and the L_idx-th highest TCI state group ID value could be mapped to/associated with the L_idx-th highest PCI value configured for the UE. Other implicit indication methods of the association/mapping between the TCI state group ID values and the PCI values for the serving/non-serving (or neighboring) cells/TRPs in the inter-cell system are also possible.

In yet another example, the UE could be first higher layer configured by the network the mapping/association between one or more PCI values and the TCI state group ID values; the UE could then receive from the network one or more MAC CE commands to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first MAC CE command activating at least one PCI from the first set of PCIs corresponding to/associated with the TCI state group ID value “0.” The UE could also receive from the network a second MAC CE command activating at least one PCI from the second set of PCIs corresponding to/associated with the TCI state group ID value “1.”

Alternatively, the UE could receive from the network a single MAC CE command activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first MAC CE command activating at least one PCI from the first set of PCIs corresponding to/associated with the TCI state group ID value “0,” a second MAC CE command activating at least one PCI from the second set of PCIs corresponding to/associated with the TCI state group ID value “1,” and so on, and a L_idx-th MAC CE command activating at least one PCI from the L_idx-th set of PCIs corresponding to/associated with the TCI state group ID value “L_idx−1.”

Alternatively, the UE could receive from the network a single MAC CE command activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be first higher layer configured by the network the mapping/association between one or more PCI values and the TCI state group ID values; the UE could then receive from the network one or more bitmaps to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first bitmap with each entry/bit in the first bitmap corresponding to/associated with a distinct entry in the first set of PCIs corresponding to/associated with the TCI state group ID value “0”; if an entry/bit in the first bitmap is set to “1,” the corresponding/associated entry in the first set of PCIs corresponding to/associated with the TCI state group ID value “0” is activated as the PCI corresponding to/associated with the TCI state group ID value “0” for the inter-cell operation.

The UE could also receive from the network a second bitmap with each entry/bit in the second bitmap corresponding to/associated with a distinct entry in the second set of PCIs corresponding to/associated with the TCI state group ID value “1”; if an entry/bit in the second bitmap is set to “1,” the corresponding/associated entry in the second set of PCIs corresponding to/associated with the TCI state group ID value “1” is activated as the PCI corresponding to/associated with the TCI state group ID value “1” for the inter-cell operation.

Alternatively, the UE could receive from the network a single bitmap activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first bitmap activating at least one PCI from the first set of PCIs corresponding to/associated with the TCI state group ID value “0,” a second bitmap activating at least one PCI from the second set of PCIs corresponding to/associated with the TCI state group ID value “1,” and so on, and a L_idx-th bitmap activating at least one PCI from the L_idx-th set of PCIs corresponding to/associated with the TCI state group ID value “L_idx−1.”

Alternatively, the UE could receive from the network a single bitmap activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be indicated by the network that the TCI state group ID value “0” is associated with the serving cell/TRP (and/or its corresponding PCI). For a TCI state group ID value other than value “0,” e.g., value “1”: for example, the UE could be indicated by the network, e.g., via higher layer RRC signaling and/or MAC CE command and/or dynamic DCI signaling, the exact non-serving (or neighboring) cell/TRP PCI value associated with the TCI state group ID value; for another example, the UE could be indicated by the network that the TCI state group ID value could be associated with the lowest (or the highest) non-serving (or neighboring) cell/TRP PCI value configured for the UE; yet for another example, (i) the UE could be higher layer configured by the network a list/set of PCIs corresponding to/associated with the TCI state group ID value, and (ii) the UE could receive from the network a MAC CE command activating at least one PCI from the higher layer configured list/set of PCIs corresponding to/associated with the TCI state group ID value; yet for another example, (i) the UE could be higher layer configured by the network a list/set of PCIs corresponding to/associated with the TCI state group ID value, and (ii) the UE could receive from the network a bitmap activating at least one PCI from the higher layer configured list/set of PCIs corresponding to/associated with the TCI state group ID value.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values.

In this design example, if a beam associated with the i-th PCI is activated, the (i+1)-th, the (i+2)-th, . . . , and the (i+K_idx−1)-th entries in the set/list/pool of PCIs (or equivalently, the (i+1)-th PCI, the (i+2)-th PCI, . . . , and the (i+K_idx−1)-th PCI) along with the corresponding TCI state group ID values could be activated, and/or, the (i−K_idx+1)-th, the (i−K_idx+2)-th, . . . , and the (i−1)-th entries in the set/list/pool of PCIs (or equivalently, the (i−K_idx+1)-th PCI, the (i-K_idx+2)-th PCI, . . . , and the (i−1)-th PCI) along with the corresponding TCI state group ID values could be deactivated. For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 4-th PCI (associated with the TCI state group ID value “0”) and the 5-th PCI (associated with the TCI state group ID value “1”) are activated. At the same time, the 1-st PCI (associated with the TCI state group ID value “0”) and the 2-nd PCI (associated with the TCI state group ID value “1”) are deactivated.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values.

In this design example, if a beam associated with the i-th PCI is activated, the (i-floor((K_idx−1)/2))-th, the (i−floor((K_idx−1)/2)+1)-th, . . . , and the (i+ceil((K_idx−1)/2))-th entries in the set/list/pool of PCIs (or equivalently, the (i−floor((K_idx−1)/2))-th PCI, the (i−floor((K_idx−1)/2)+1)-th PCI, . . . , and the (i+ceil((K_idx−1)/2))-th PCI) along with the corresponding TCI state group ID values could be activated, or, the (i-ceil((K_idx−1)/2))-th, the (i−floor((K_idx−1)/2)+1)-th, . . . , and the (i+floor((K_idx−1)/2))-th entries in the set/list/pool of PCIs (or equivalently, the (i-ceil((K_idx−1)/2))-th PCI, the (i−floor((K_idx−1)/2)+1)-th PCI, . . . , and the (i+floor((K_idx−1)/2))-th PCI) along with the corresponding TCI state group ID values could be activated, where floor(x) returns the largest integer that is smaller than or equal to x and ceil(x) returns the smallest integer that is greater than or equal to x. The starting/initial activated cells could be the (i−G)-th, the (i-G+1)-th, . . . , the i-th, . . . , the (i−G+K_idx−1)-th entries in the set/list/pool of PCIs (or equivalently, the (i−G)-th PCI, the (i−G+1)-th PCI, . . . , the i-th PCI, . . . , the (i−G+K_idx−1)-th PCI); their corresponding/associated TCI state group ID values are also activated.

Here, the value of G could be higher layer configured to the UE by the network and/or fixed per RRC configuration. For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 2-nd PCI (associated with the TCI state group ID value “1”) and the 4-th PCI (associated with the TCI state group ID value “0”) are activated.

As described above, a DCI used to indicate to the UE a beam (i.e., a TCI state and/or a TCI state ID) for the transmission/reception of a PDCCH or a PDSCH could be at least one of the following: (1) in one example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment; (2) in another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant; and/or (3) yet in another example, a custom/purpose designed DCI format could be used to indicate to the UE a beam (i.e., a TCI state and/or a TCI state ID) for the transmission/reception of a PDCCH or a PDSCH.

Furthermore, the TCI state indicated in the DCI for the inter-cell PDCCH/PDSCH beam indication could be at least one of: (1) a DL TCI state; (2) an UL TCI state; (3) a joint DL and UL TCI state; and/or (4) separate DL TCI state and UL TCI state.

In addition to Option-IA, Option-IIA, Option-IIIA, Option-IVA, Option-VA, Option-VIA, and Option-VIIA based DCI based inter-cell PDCCH/PDSCH beam indication, in one example of Option-VIIIA, the DCI for the inter-cell PDCCH/PDSCH beam indication (from the higher layer configured list/set/pool of TCI state(s)) may not include the TCI state group ID value(s)—different from the design example 2.1A. The UE could identify the TCI state group ID value(s) from the TCI state/TCI state ID indicated in the DCI for the inter-cell PDCCH/PDSCH beam indication because the TCI state IDs are determined across all N_s>1 lists/pools of TCI states. If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDCCH/PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH/PDSCH is transmitted.

In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RS(s) in the TCI state indicated in the DCI is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS(s) in the TCI state indicated in the DCI is transmitted.

The UE could be indicated by the network which design option(s), selected from/out of Option-IA, Option-IIA, Option-IIIA, Option-IVA, Option-VA, Option-VIA, Option-VIIA, and Option-VIIIA described above, is used/implemented; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, the UE could be explicitly indicated by the network, e.g., via higher layer RRC signaling and/or MAC CE command and/or dynamic DCI signaling, the exact design option(s) used/implemented to indicate/identify the serving/non-serving (or neighboring) cells/TRPs in the inter-cell system.

For another example, the UE could receive from the network one or more MAC CE activation commands activating one or more design options used/implemented to indicate/identify the serving/non-serving (or neighboring) cells/TRPs in the inter-cell system.

For yet another example, the UE could receive from the network one or more bitmaps activating one or more design options used/implemented to indicate/identify the serving/non-serving (or neighboring) cells/TRPs in the inter-cell system.

In addition, the design option(s) used/implemented to indicate/identify the serving/non-serving (or neighboring) cells/TRPs in the inter-cell system could be fixed in system specification(s), determined by the network based on UE's capability reporting, and etc. Furthermore, the UE could send to the network their preference(s)/selection(s) regarding the design option(s), e.g., from/out of Option-IA, Option-IIA, Option-IIIA, Option-IVA, Option-VA, Option-VIA, Option-VIIA, and Option-VIIIA described above, to use/implement for indicating/identifying the serving/non-serving (or neighboring) cells/TRPs in the inter-cell system.

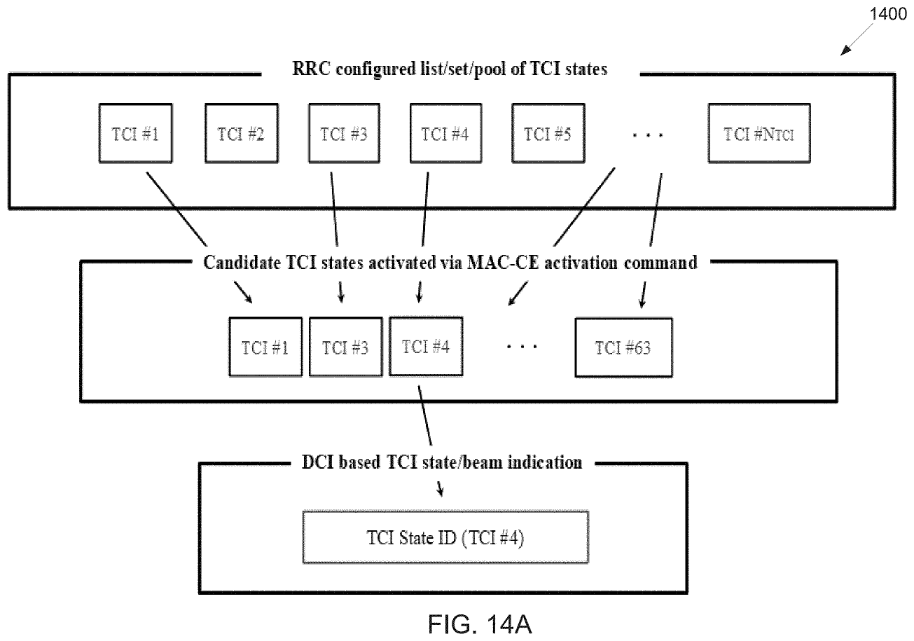

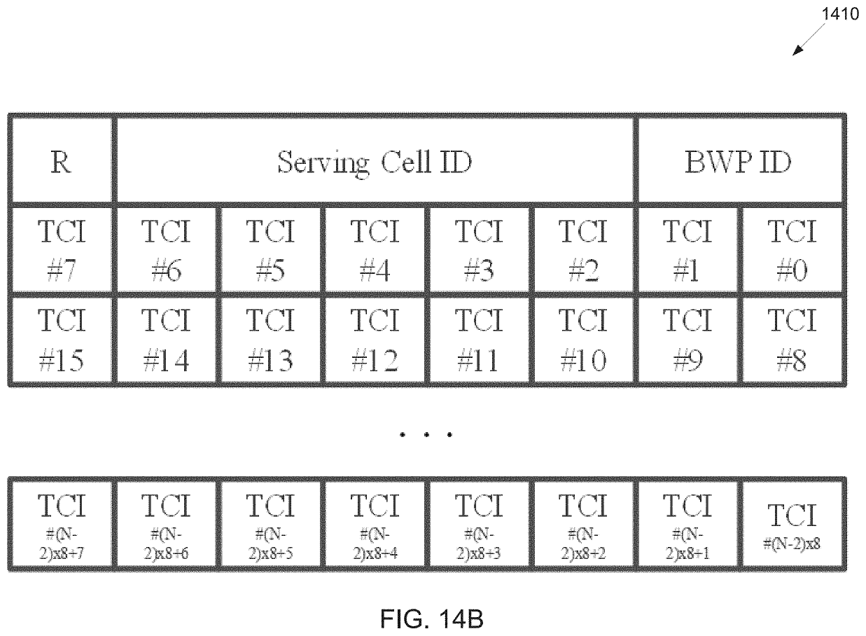

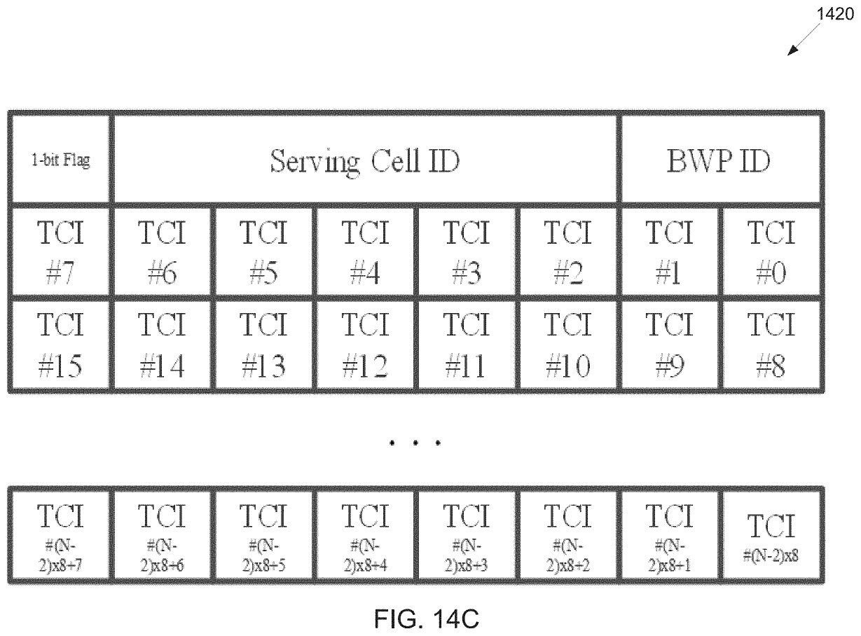

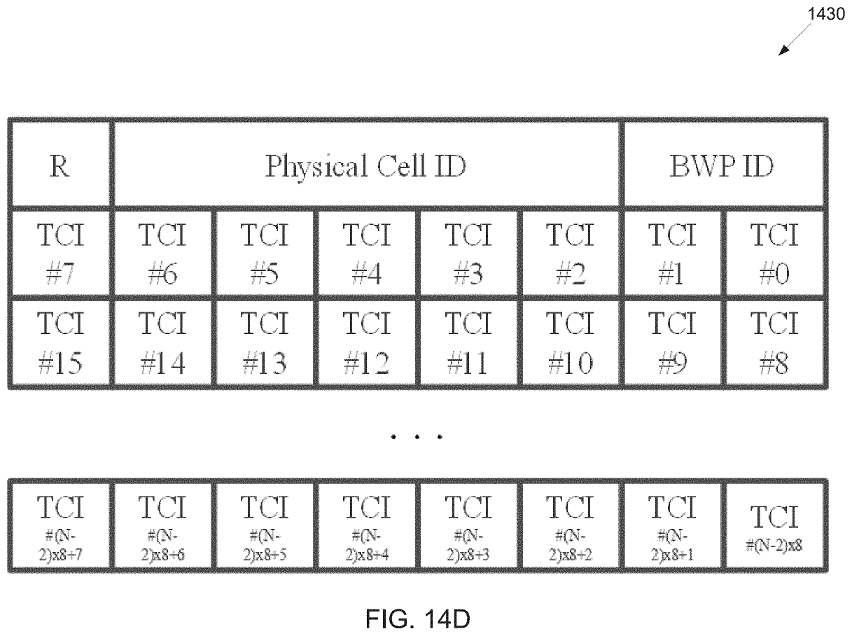

FIG. 14A illustrates another example of DCI based TCI state/beam indication 1400 according to embodiments of the present disclosure. An embodiment of the DCI based TCI state/beam indication 1400 shown in FIG. 14A is for illustration only.

In one example of design example 3.0A, in FIG. 14A, an example of DCI based TCI state/beam indication for the inter-cell beam operation is presented. As shown in FIG. 14A, the UE could be first higher layer configured by the network, e.g., via the higher layer RRC signaling, a list/pool of N_tci TCI states. Each TCI state contains at least a QCL source RS transmitted from/associated with either the serving cell/TRP or a non-serving cell/TRP (or neighboring cell/TRP). The UE could then receive from the network one or more MAC CE activation commands activating one or more TCI states from the higher layer configured list/pool of TCI states, e.g., up to eight TCI states could be activated by a MAC CE activation command as depicted in FIG. 14A, where the QCL source RSs in all the candidate TCI states activated by the MAC CE activation command could be transmitted from/associated with the serving cell/TRP and/or a non-serving cell/TRP (and/or a neighboring cell/TRP).

For an inter-cell system, the UE could receive from the network a single MAC CE activation command at a time (e.g., in a slot) activating one or more TCI states (from the higher layer configured list/set/pool of TCI states) associated with either the serving cell/TRP or the non-serving (or neighboring) cell(s)/TRP(s). For an inter-cell multi-TRP system, the UE could receive from the network more than one MAC CE activation commands at a time (e.g., in a slot) activating two or more TCI states associated with the serving cell/TRP and the non-serving (or neighboring) cell(s)/TRP(s).

The UE could be indicated by the network one or more DCIs to indicate the TCI state(s)/beam(s)—selected from the candidate TCI state(s) activated by the MAC CE activation command(s)—for the transmission/reception of the PDCCH(s) or the PDSCH(s) transmitted from/associated with the serving cell/TRP and/or a non-serving cell/TRP (and/or a neighboring cell/TRP). For an inter-cell system, the UE could receive from the network a single DCI at a time (e.g., in a slot) for the PDCCH/PDSCH beam indication to enable the dynamic switching of the transmission/reception of the PDCCH(s)/PDSCH(s) between different cells/TRPs, e.g., the serving cell/TRP and one or more non-serving (or neighboring) cells/TRPs having different PCIs from that of the serving cell/TRP. For an inter-cell multi-TRP system, the UE could receive from the network more than one DCIs at a time (e.g., in a slot) to indicate the beams/TCI states for the PDCCHs/PDSCHs simultaneously transmitted from the serving cell/TRP and the non-serving (or neighboring) cell(s)/TRP(s).

FIG. 14B illustrates an example of MAC CE activation command for activating/deactivating one or more TCI states 1410 according to embodiments of the present disclosure. An embodiment of the MAC CE activation command for activating/deactivating one or more TCI states 1410 shown in FIG. 14B is for illustration only.

A design example of the MAC CE activation command for activating/deactivating specific TCI states is given in FIG. 14B. As indicated in FIG. 14B, the MAC CE activation command could comprise of a SCI, a BWP ID and a bitmap. Each entry/bit in the bitmap could correspond to a distinct TCI state in the higher layer configured list/pool of TCI states. If an entry/bit in the bitmap is set to “1,” the corresponding/associated TCI state is activated. If an entry/bit in the bitmap is set to “0,” the corresponding/associated TCI state is deactivated. The list of bit positions in the bitmap that are set to “1” s are assigned to a set of codepoints in an increasing order. The TCI field in a DCI (e.g., DCI format 1_1) could indicate the codepoint index, and therefore, the corresponding TCI state for the PDCCH/PDSCH.

There could be various means to identify/indicate serving/non-serving (or neighboring) cells/TRPs information in the MAC CE activation command.

In one example of Alternative-0A, one or more of the candidate TCI states (and therefore, the QCL source RSs indicated therein) activated by the MAC CE activation command and/or the corresponding PDCCH(s)/PDSCH(s) could be transmitted from/associated with either the serving cell/TRP (and/or its PCI value) or one or more non-serving (or neighboring) cells/TRPs (and/or the corresponding PCIs). For the example shown in FIG. 14A, TCI #1 and TCI #3 could be activated by the MAC CE activation command, and they could be associated with the serving cell/TRP and a non-serving cell/TRP (or neighboring cell/TRP), respectively.

In this case, for an inter-cell system, the UE could receive from the network a single MAC CE activation command activating one or more TCI states (and therefore, the QCL source RSs indicated therein) associated with the serving cell/TRP and/or the non-serving (or neighboring) cell(s)/TRP(s). The UE could be indicated by the network a single DCI or separate DCIs to indicate the TCI state(s)/beam(s) for the PDCCH(s)/PDSCH(s) transmitted from the serving cell/TRP and/or the non-serving (or neighboring) cell(s)/TRP(s).

FIG. 14C illustrates another example of MAC CE activation command for activating/deactivating one or more TCI states 1420 according to embodiments of the present disclosure. An embodiment of the MAC CE activation command for activating/deactivating one or more TCI states 1420 shown in FIG. 14C is for illustration only.

In one example of Alternative-1A, a one-bit flag indicator could be included/indicated in the MAC CE activation command. If the one-bit flag indicator is present and set to “1,” the MAC CE activation command could activate one or more candidate TCI states from the higher layer configured list/pool of TCI states, from which at least one TCI state indicated by the DCI could be used for transmitting the PDCCH/PDSCH from the serving cell/TRP; in this case, the QCL source RS(s) in the TCI state(s) activated by the MAC CE activation command could also be associated with/transmitted from the serving cell/TRP. If the one-bit flag indicator is not present or set to “0,” the MAC CE activation command could activate one or more TCI states from the higher layer configured list/pool of TCI states, from which at least one TCI state indicated by the DCI could be used for transmitting the PDCCH/PDSCH from a non-serving cell/TRP (or neighboring cell/TRP) in the inter-cell system; in this case, the QCL source RS(s) in the TCI state(s) activated by the MAC CE activation command could also be associated with/transmitted from the non-serving cell/TRP (or neighboring cell/TRP). One conceptual example of including the one-bit flag indicator in the MAC CE activation command is depicted in FIG. 14C. For inter-cell multi-TRP operation, the one-bit flag indicator could correspond to/be configured as the higher layer signaling index—CORESETPoolIndex.

In one example of Alternative-2A, a multi-bit (more than one bit) indicator could be included in the MAC CE activation command to indicate the serving cell/TRP and two or more non-serving cells/TRPs (or neighboring cells/TRPs) in the inter-cell system. The number of bits n_b required for representing the multi-bit indicator could be ceil(log 2(N_nsc+1)), where N_nsc is the total number of non-serving cells/TRPs (or neighboring cells/TRPs) and ceil(x) rounds x up to the next largest integer. In this case, the n_b-bit indicator could correspond to 2\hat{ }(n_b) states, and one of the states (e.g., the first state) could correspond to the serving cell/TRP, and the rest of the states could correspond to the non-serving cells/TRPs (or neighboring cells/TRPs).

Alternatively, the number of bits n_b required for representing the multi-bit indicator could be ceil(log 2(N_nsc)). In this case, the multi-bit indicator only indicates/identifies the non-serving cells/TRPs (or neighboring cells/TRPs); if the multi-bit indicator is not present, the UE may expect that the MAC CE activation command activates one or more TCI states from the higher layer configured list/pool of TCI states, from which at least one TCI state indicated by the DCI could be used for transmitting the PDCCH/PDSCH from the serving cell/TRP; if the multi-bit indicator is not present, the UE could also expect that the QCL source RS(s) in the TCI state(s) activated by the MAC CE activation command is associated with/transmitted from the serving cell/TRP. The UE could be indicated by the network the association rule(s)/mapping relationship(s) between the states of the multi-bit indicator and the PCI values for the serving/non-serving (or neighboring) cells/TRPs in the inter-cell multi-TRP system; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

FIG. 14D illustrates yet another example of MAC CE activation command for activating/deactivating one or more TCI states 1430 according to embodiments of the present disclosure. An embodiment of the MAC CE activation command for activating/deactivating one or more TCI states 1430 shown in FIG. 14D is for illustration only.

In one example of Alternative-3A, the PCI value(s) could be included/indicated in the MAC CE activation command. The inclusion of the PCI value(s) in the MAC CE activation command could be in addition to the SCI value/field. Alternatively, the MAC CE activation command could contain the PCI value(s) without the SCI value/field.

In FIG. 14D, an example of the MAC CE activation command including the PCI value(s) is presented. In this case, one or more PCI values could be used/reserved for representing the serving cell/TRP. The UE could be indicated by the network the association between the PCI value(s) and the serving cell/TRP and/or the association between the PCI value(s) and the non-serving (or neighboring) cell(s)/TRP(s). If the indicated PCI value is associated with the serving cell/TRP, the MAC CE activation command could activate one or more TCI states from the higher layer configured list/pool of TCI states, from which at least one TCI state indicated by the DCI could be used for transmitting the PDCCH/PDSCH from the serving cell/TRP; in this case, the QCL source RS(s) in the TCI state(s) activated by the MAC CE activation command could also be associated with/transmitted from the serving cell/TRP.

If the indicated PCI value is associated with a non-serving cell/TRP (or neighboring cell/TRP), the MAC CE command could activate one or more TCI states from the higher layer configured list/pool of TCI states, from which at least one TCI state indicated by the DCI could be used for transmitting the PDCCH/PDSCH from the non-serving cell/TRP (or neighboring cell/TRP) in the inter-cell system; in this case, the QCL source RS(s) in the TCI state(s) activated by the MAC CE activation command could also be associated with/transmitted from the non-serving cell/TRP (or neighboring cell/TRP).

In one example of Alternative-4A, one or more SCI values in the MAC CE activation command could be used for representing one or more non-serving cells/TRPs (or neighboring cells/TRPs), and/or, correspond to one or more PCI values for the non-serving cells/TRPs (or neighboring cells/TRPs), in the inter-cell system. The UE could be indicated by the network the exact SCI value(s) used/reserved for representing the non-serving cell(s)/TRP(s) (or neighboring cell(s)/TRP(s)), and/or, the association between the reserved SCI value(s) and the PCI value(s) for the non-serving cell(s)/TRP(s) (or neighboring cell(s)/TRP(s)). If the indicated SCI value is reserved/used for representing a non-serving cell/TRP (or neighboring cell/TRP) and/or corresponds to a non-serving cell/TRP (or neighboring cell/TRP) PCI value, the MAC CE activation command could activate one or more TCI states from the higher layer configured list/pool of TCI states, from which at least one TCI state indicated by the DCI could be used for transmitting the PDCCH/PDSCH from the non-serving cell/TRP (or neighboring cell/TRP) in the inter-cell system; in this case, the QCL source RS(s) in the TCI state(s) activated by the MAC CE activation command could also be associated with/transmitted from the non-serving cell/TRP (or neighboring cell/TRP).

In one example of Alternative-5A, a TCI state could include information that indicates/identifies the serving/non-serving (or neighboring) cells/TRPs information. For example, a TCI state could include a one-bit flag indicator, which could correspond to/be configured as the higher layer signaling index CORESETPoolIndex in an inter-cell multi-TRP system, to indicate the serving cell/TRP or a non-serving cell/TRP (or neighboring cell/TRP). For another example, a TCI state could include a multi-bit indicator to indicate the serving cell/TRP (and/or its PCI value) and the non-serving (or neighboring) cell(s)/TRP(s) (and/or the corresponding PCI value(s)).

For yet another example, a TCI state could include the PCI value to indicate the serving/non-serving (or neighboring) cells/TRPs information. For yet another example, one or more serving cell IDs (SCIs) in a TCI state could be reserved/used to indicate one or more non-serving (or neighboring) cells/TRPs information. The details about the indication/identification of the serving/non-serving (or neighboring) cells/TRPs information in a TCI state are according to U.S. patent application Ser. No. 17/444,556 as incorporated by reference herein. The TCI state(s) indicating the same serving cell/TRP information or the same non-serving (or neighboring) cell(s)/TRP(s) information could be activated by the same MAC CE activation command.

If the serving cell/TRP information is indicated in the activated TCI state(s), the corresponding PDCCH(s)/PDSCH(s) could be transmitted from/associated with the serving cell/TRP; in this case, the QCL source RS(s) in the TCI state(s) activated by the MAC CE activation command could also be associated with/transmitted from the serving cell/TRP. If the non-serving (or neighboring) cell/TRP information is indicated in the activated TCI state(s), the corresponding PDCCH(s)/PDSCH(s) could be transmitted from/associated with the non-serving cell/TRP (or neighboring cell/TRP) in the inter-cell system; in this case, the QCL source RS(s) in the TCI state(s) activated by the MAC CE activation command could also be associated with/transmitted from the non-serving cell/TRP (or neighboring cell/TRP).

The UE could be indicated by the network which design alternative(s), selected from/out of Alternative-1A, Alternative-2A, Alternative-3A, Alternative-4A, and Alternative-5A described above, is used/implemented; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, the UE could be explicitly indicated by the network, e.g., via higher layer RRC signaling and/or MAC CE command and/or dynamic DCI signaling, the exact design alternative(s) used/implemented to indicate/identify the serving/non-serving (or neighboring) cells/TRPs in the inter-cell system.

For another example, the UE could receive from the network one or more MAC CE activation commands activating one or more design alternatives used/implemented to indicate/identify the serving/non-serving (or neighboring) cells/TRPs in the inter-cell system.

For yet another example, the UE could receive from the network one or more bitmaps activating one or more design alternatives used/implemented to indicate/identify the serving/non-serving (or neighboring) cells/TRPs in the inter-cell system.

In addition, the design alternative(s) used/implemented to indicate/identify the serving/non-serving (or neighboring) cells/TRPs in the inter-cell system could be fixed in system specification(s), determined by the network based on UE's capability reporting, and etc. Furthermore, the UE could send to the network their preference(s)/selection(s) regarding the design alternative(s), e.g., from/out of Alternative-1A, Alternative-2A, Alternative-3A, Alternative-4A, and Alternative-5A described above, to use/implement for indicating/identifying the serving/non-serving (or neighboring) cells/TRPs in the inter-cell system.

As described above, a DCI used to indicate to the UE a beam (i.e., a TCI state and/or a TCI state ID) for the transmission/reception of a PDCCH or a PDSCH could be at least one of the following: (1) in one example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment; (2) in another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant; and/or (3) yet in another example, a custom/purpose designed DCI format could be used to indicate to the UE a beam (i.e., a TCI state and/or a TCI state ID) for the transmission/reception of a PDCCH or a PDSCH.

Furthermore, the TCI state indicated in the DCI for the inter-cell PDCCH/PDSCH beam indication could be at least one of: (1) a DL TCI state; (2) an UL TCI state; (3) a joint DL and UL TCI state; and/or (4) separate DL TCI state and UL TCI state.

In addition to including/indicating the TCI state/TCI state ID in the DCI, the DCI for the inter-cell PDCCH/PDSCH beam indication could include information to indicate/identify the serving/non-serving (or neighboring) cells/TRPs.

In one example of Option-AA, a one-bit flag indicator could be included/indicated in the DCI for the inter-cell PDCCH/PDSCH beam indication (from the MAC CE activated TCI state(s)). If the one-bit flag indicator is present and set to “1,” the corresponding PDCCH/PDSCH could be transmitted from/associated with the serving cell/TRP; in this case, the QCL source RS(s) in the TCI state indicated in the DCI could also be associated with/transmitted from the serving cell/TRP. If the one-bit flag indicator is not present or set to “0,” the corresponding PDCCH/PDSCH could be transmitted from/associated with a non-serving cell/TRP (or neighboring cell/TRP) in the inter-cell system; in this case, the QCL source RS(s) in the TCI state indicated in the DCI could also be associated with/transmitted from the non-serving cell/TRP (or neighboring cell/TRP). For inter-cell multi-TRP operation, the one-bit flag indicator could correspond to/be configured as the higher layer signaling index—CORESETPoolIndex.

In one example of Option-BA, a multi-bit (more than one bit) indicator could be included/indicated in the DCI for the inter-cell PDCCH/PDSCH beam indication (from the MAC CE activated TCI state(s)) to indicate the serving cell/TRP and two or more non-serving cells/TRPs (or neighboring cells/TRPs) in the inter-cell system. The number of bits n_b required for representing the multi-bit indicator could be ceil(log 2(N_nsc+1)), where N_nsc is the total number of non-serving cells/TRPs (or neighboring cells/TRPs) and ceil(x) rounds x up to the next largest integer. In this case, the n_b-bit indicator could correspond to 2\hat{ }(n_b) states, and one of the states (e.g., the first state) could correspond to the serving cell/TRP, and the rest of the states could correspond to the non-serving cells/TRPs (or neighboring cells/TRPs).

Alternatively, the number of bits n_b required for representing the multi-bit indicator could be ceil(log 2(N_nsc)). In this case, the multi-bit indicator only indicates/identifies the non-serving cells/TRPs (or neighboring cells/TRPs); if the multi-bit indicator is not present, the UE may expect that the corresponding PDCCH/PDSCH is transmitted from/associated with the serving cell/TRP; if the multi-bit indicator is not present, the UE could also expect that the QCL source RS(s) in the TCI state indicated in the DCI is associated with/transmitted from the serving cell/TRP. The UE could be indicated by the network the association rule(s)/mapping relationship(s) between the states of the multi-bit indicator and the PCI values for the serving/non-serving (or neighboring) cells/TRPs in the inter-cell system; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

In one example of Option-CA, the PCI value(s) could be included/indicated in the DCI for the inter-cell PDCCH/PDSCH beam indication (from the MAC CE activated TCI state(s)). In this design option, one or more PCI values could be used/reserved for representing the serving cell/TRP. The UE could be indicated by the network the association between the PCI value(s) and the serving cell/TRP and/or the association between the PCI value(s) and the non-serving (or neighboring) cell(s)/TRP(s). If the indicated PCI value is associated with the serving cell/TRP, the corresponding PDCCH/PDSCH could be transmitted from/associated with the serving cell/TRP; in this case, the QCL source RS(s) in the TCI state indicated in the DCI could also be associated with/transmitted from the serving cell/TRP. If the indicated PCI value is associated with a non-serving cell/TRP (or neighboring cell/TRP), the corresponding PDCCH/PDSCH could be transmitted from/associated with the non-serving cell/TRP (or neighboring cell/TRP) in the inter-cell system; in this case, the QCL source RS(s) in the TCI state indicated in the DCI could also be associated with/transmitted from the non-serving cell/TRP (or neighboring cell/TRP).

In one example of Option-DA, the serving cell ID (SCI) value(s) could be included/indicated in the DCI for the inter-cell PDCCH/PDSCH beam indication (from the MAC CE activated TCI state(s)). One or more SCI values in the DCI for the inter-cell PDCCH/PDSCH beam indication (from the MAC CE activated TCI state(s)) could be used for representing one or more non-serving cells/TRPs (or neighboring cells/TRPs), and/or, correspond to one or more PCI values for the non-serving cells/TRPs (or neighboring cells/TRPs), in the inter-cell system. The UE could be indicated by the network the exact SCI value(s) used/reserved for representing the non-serving cell(s)/TRP(s) (or neighboring cell(s)/TRP(s)), and/or, the association between the reserved SCI value(s) and the PCI value(s) for the non-serving cell(s)/TRP(s) (or neighboring cell(s)/TRP(s)). If the indicated SCI value is reserved/used for representing a non-serving cell/TRP (or neighboring cell/TRP) and/or corresponds to a non-serving cell/TRP (or neighboring cell/TRP) PCI value, the DCI could indicate the beam used for transmitting the PDCCH/PDSCH from the non-serving cell/TRP (or neighboring cell/TRP) in the inter-cell system; in this case, the QCL source RS(s) in the TCI state indicated in the DCI could also be associated with/transmitted from the non-serving cell/TRP (or neighboring cell/TRP).

In one example of Option-EA, the codepoint indices and/or the bit-width of the codepoint indices in the DCI(s) for the inter-cell PDCCH/PDSCH beam indication (from the MAC CE activated TCI state(s)) could be determined across one or more TCI state(s) activated by one or more MAC CE activation commands. For instance, the UE could receive from the network a first MAC CE command activating 8 TCI states; the QCL source RS in each activated TCI state is transmitted from/associated with the serving cell/TRP and/or each activated TCI state is for a PDCCH/PDSCH transmitted from/associated with the serving cell/TRP. The UE could receive from the network a second MAC CE activation command activating 8 TCI states; the QCL source RS in each activated TCI state is transmitted from/associated with a non-serving cell/TRP (or neighboring cell/TRP) and/or each activated TCI state is for a PDCCH/PDSCH transmitted from/associated with a non-serving cell/TRP (or neighboring cell/TRP).

The UE could then receive from the network a first DCI indicating a TCI state for the PDCCH/PDSCH transmitted from/associated with the serving cell/TRP, where the QCL source RS in the indicated TCI state could also be transmitted from/associated with the serving cell/TRP. The UE could receive from the network a second DCI indicating a TCI state for the PDCCH/PDSCH transmitted from/associated with a non-serving cell/TRP (or neighboring cell/TRP), where the QCL source RS in the indicated TCI state could also be transmitted from/associated with the non-serving cell/TRP (or neighboring cell/TRP).

In this example, the codepoint indices in the first and the second DCIs to indicate the TCI states for the PDCCHs/PDSCHs could be determined across all 16 TCI states activated by the first and the second MAC CE activation commands. The corresponding bit-width of the codepoint indices can then be determined as 4. For instance, the codepoints in the first DCI to indicate the TCI state for the PDCCH/PDSCH transmitted from/associated with the serving cell/TRP could be indexed from 0 to 7, while the codepoints in the second DCI to indicate the TCI state for the PDCCH/PDSCH transmitted from/associated with the non-serving cell/TRP (or neighboring cell/TRP) could be indexed from 8 to 15. The UE could be indicated by the network the mapping between the codepoint indices in the DCI(s) for the inter-cell PDCCH/PDSCH beam indication (from the MAC CE activated TCI state(s)) and the TCI states activated by the MAC CE activation commands. For the example discussed above, if the TCI codepoint index indicated in the DCI is 3, the UE may expect that the corresponding TCI state is for a PDCCH/PDSCH transmitted from/associated with the serving cell/TRP and/or the QCL source RS in the indicated TCI state is transmitted from/associated with the serving cell/TRP.

In one example of Option-FA, a TCI state could include information that indicates/identifies the serving/non-serving (or neighboring) cells/TRPs information. For example, a TCI state could include a one-bit flag indicator, which could correspond to/be configured as the higher layer signaling index CORESETPoolIndex in an inter-cell multi-TRP system, to indicate the serving cell/TRP or a non-serving cell/TRP (or neighboring cell/TRP). For another example, a TCI state could include a multi-bit indicator to indicate the serving cell/TRP (and/or its PCI value) and the non-serving (or neighboring) cell(s)/TRPs (and/or the corresponding PCI value(s)).

Yet for another example, a TCI state could include the PCI value to indicate the serving/non-serving (or neighboring) cells/TRPs information. Yet for another example, one or more serving cell IDs (SCIs) in a TCI state could be reserved/used to indicate one or more non-serving (or neighboring) cells/TRPs information. The details about the indication/identification of the serving/non-serving (or neighboring) cells/TRPs information in a TCI state are according to U.S. patent application Ser. No. 17/444,556 as incorporated by reference herein. If the serving cell/TRP information is indicated in the TCI state indicated in the DCI for the inter-cell PDCCH/PDSCH beam indication (from the MAC CE activated TCI state(s)), the corresponding PDCCH/PDSCH could be transmitted from/associated with the serving cell/TRP; in this case, the QCL source RS(s) in the TCI state indicated in the DCI could also be associated with/transmitted from the serving cell/TRP.

If the non-serving (or neighboring) cell/TRP information is indicated in the TCI state indicated in the DCI for the inter-cell PDCCH/PDSCH beam indication (from the MAC CE activated TCI state(s)), the corresponding PDCCH/PDSCH could be transmitted from/associated with the non-serving cell/TRP (or neighboring cell/TRP) in the inter-cell system; in this case, the QCL source RS(s) in the TCI state indicated in the DCI could also be associated with/transmitted from the non-serving cell/TRP (or neighboring cell/TRP).

In one example of Option-GA, the DCI for the inter-cell PDCCH/PDSCH beam indication (from the MAC CE activated TCI state(s)) could contain/indicate a list/set of M≥1 TCI states/TCI state IDs—selected from the MAC CE activated TCI state(s)—with each TCI state (and therefore, the QCL source RS(s) indicated therein) associated with either the serving cell/TRP or a non-serving (or neighboring) cell/TRP.

In one example, the UE could be explicitly indicated by the network, e.g., via higher layer RRC signaling and/or MAC CE command and/or dynamic DCI signaling, the exact association/mapping between the list/set of M≥1 TCI states/TCI state IDs and the PCI/CORESETPoolIndex values for the serving/non-serving (or neighboring) cells/TRPs in the inter-cell system.

For example, the UE could be first configured by the network a list/set of M≥1 PCI/CORESETPoolIndex values for the serving/non-serving (or neighboring) cells/TRPs; the first TCI state/TCI state ID in the list/set of M TCI states/TCI state IDs could be mapped to/associated with the first entry in the list/set of M PCI/CORESETPoolIndex values for the serving/non-serving (or neighboring) cells/TRPs, the second TCI state/TCI state ID in the list/set of M TCI states/TCI state IDs could be mapped to/associated with the second entry in the list/set of M PCI/CORESETPoolIndex values for the serving/non-serving (or neighboring) cells/TRPs, and so on, and the M-th TCI state/TCI state ID in the list/set of M TCI states/TCI state IDs could be mapped to/associated with the M-th entry in the list/set of M PCI/CORESETPoolIndex values for the serving/non-serving (or neighboring) cells/TRPs.

For another example, the UE could be first configured by the network a list/set of M≥1 PCI/CORESETPoolIndex values for the serving/non-serving (or neighboring) cells/TRPs; the lowest (or the highest) TCI state ID value (and/or its corresponding TCI state) in the list/set of M TCI states/TCI state IDs could be mapped to/associated with the first entry in the list/set of M PCI/CORESETPoolIndex values for the serving/non-serving (or neighboring) cells/TRPs, the second lowest (or the second highest) TCI state ID value (and/or its corresponding TCI state) in the list/set of M TCI states/TCI state IDs could be mapped to/associated with the second entry in the list/set of M PCI/CORESETPoolIndex values for the serving/non-serving (or neighboring) cells/TRPs, and so on, and the highest (or the lowest) TCI state ID value (and/or its corresponding TCI state) in the list/set of M TCI states/TCI state IDs could be mapped to/associated with the M-th entry in the list/set of M PCI/CORESETPoolIndex values for the serving/non-serving (or neighboring) cells/TRPs.

In another example, the UE could be implicitly indicated by the network the association/mapping between the list/set of M≥1 TCI states/TCI state IDs and the PCI/CORESETPoolIndex values for the serving/non-serving (or neighboring) cells/TRPs in the inter-cell system. For example, the UE could be indicated by the network that the first TCI state/TCI state ID in the list/set of M TCI states/TCI state IDs could be mapped to/associated with the lowest (or the highest) PCI/CORESETPoolIndex value configured for the UE, the second TCI state/TCI state ID in the list/set of M TCI states/TCI state IDs could be mapped to/associated with the second lowest (or the second highest) PCI/CORESETPoolIndex value configured for the UE, and so on, and the M-th TCI state/TCI state ID in the list/set of M TCI states/TCI state IDs could be mapped to/associated with the highest (or the lowest) PCI/CORESETPoolIndex value configured for the UE.

For another example, the UE could be indicated by the network that the lowest (or the highest) TCI state ID value (and/or its corresponding TCI state) in the list/set of M TCI states/TCI state IDs could be mapped to/associated with the lowest (or the highest) PCI/CORESETPoolIndex value configured for the UE, the second lowest (or the second highest) TCI state ID value (and/or its corresponding TCI state) in the list/set of M TCI states/TCI state IDs could be mapped to/associated with the second lowest (or the second highest) PCI/CORESETPoolIndex value configured for the UE, and so on, and the highest (or the lowest) TCI state ID value (and/or its corresponding TCI state) in the list/set of M TCI states/TCI state IDs could be mapped to/associated with the highest (or the lowest) PCI/CORESETPoolIndex value configured for the UE. Other implicit indication methods of the association/mapping between the list/set of M≥1 TCI states/TCI state IDs and the PCI/CORESETPoolIndex values for the serving/non-serving (or neighboring) cells/TRPs in the inter-cell system are also possible.

In yet another example, the UE could be first higher layer configured by the network the mapping/association between one or more PCI/CORESETPoolIndex values and the list/set of M≥1 TCI states/TCI state IDs; the UE could then receive from the network one or more MAC CE activation commands/bitmaps to activate one or more PCI/CORESETPoolIndex values associated with each entry in the list/set of M TCI states/TCI state IDs.

For example, the UE could be first higher layer configured by the network a first set of PCI/CORESETPoolIndex values corresponding to/associated with the first TCI state/TCI state ID or the lowest/highest TCI state ID value (and/or its corresponding TCI state) in the list/set of M TCI states/TCI state IDs, a second set of PCI/CORESETPoolIndex values corresponding to/associated with the second TCI state/TCI state ID or the second lowest/highest TCI state ID value (and/or its corresponding TCI state) in the list/set of M TCI states/TCI state IDs, and so on, and a M-th set of PCI/CORESETPoolIndex values corresponding to/associated with the M-th TCI state/TCI state ID or the highest/lowest TCI state ID value (and/or its corresponding TCI state) in the list/set of M TCI states/TCI state IDs.

The UE could then receive from the network a first MAC CE activation command/bitmap activating at least one PCI/CORESETPoolIndex value from the first set of PCI/CORESETPoolIndex values corresponding to/associated with the first TCI state/TCI state ID or the lowest/highest TCI state ID value (and/or its corresponding TCI state) in the list/set of M TCI states/TCI state IDs, a second MAC CE activation command/bitmap activating at least one PCI/CORESETPoolIndex value from the second set of PCI/CORESETPoolIndex values corresponding to/associated with the second TCI state/TCI state ID or the second lowest/highest TCI state ID value (and/or its corresponding TCI state) in the list/set of M TCI states/TCI state IDs, and so on, and a M-th MAC CE activation command/bitmap activating at least one PCI/CORESETPoolIndex value from the M-th set of PCI/CORESETPoolIndex values corresponding to/associated with the M-th TCI state/TCI state ID or the highest/lowest TCI state ID value (and/or its corresponding TCI state) in the list/set of M TCI states/TCI state IDs.

Alternatively, the UE could receive from the network a single MAC CE activation command/bitmap activating at least one PCI/CORESETPoolIndex value from the first set of PCI/CORESETPoolIndex values corresponding to/associated with the first TCI state/TCI state ID or the lowest/highest TCI state ID value (and/or its corresponding TCI state) in the list/set of M TCI states/TCI state IDs, at least one PCI/CORESETPoolIndex value from the second set of PCI/CORESETPoolIndex values corresponding to/associated with the second TCI state/TCI state ID or the second lowest/highest TCI state ID value (and/or its corresponding TCI state) in the list/set of M TCI states/TCI state IDs, and so on, and at least one PCI/CORESETPoolIndex value from the M-th set of PCI/CORESETPoolIndex values corresponding to/associated with the M-th TCI state/TCI state ID or the highest/lowest TCI state ID value (and/or its corresponding TCI state) in the list/set of M TCI states/TCI state IDs.

In yet another example, the UE could be indicated by the network that the first TCI state/TCI state ID or the lowest/highest TCI state ID value (and/or its corresponding TCI state) in the list/set of M TCI states is associated with the serving cell/TRP (and/or its corresponding PCI/CORESETPoolIndex value). For a given TCI state/TCI state ID in the list/set of M TCI states/TCI state IDs other than the first TCI state/TCI state ID or the lowest/highest TCI state ID value (and/or its corresponding TCI state) in the list/set of TCI states/TCI state IDs: for example, the UE could be indicated by the network, e.g., via higher layer RRC signaling and/or MAC CE command and/or dynamic DCI signaling, the exact non-serving (or neighboring) cell/TRP PCI/CORESETPoolIndex value associated with the TCI state/TCI state ID; for another example, (i) the UE could be higher layer configured by the network a list/set of PCI/CORESETPoolIndex values corresponding to/associated with the TCI state/TCI state ID, and (ii) the UE could receive from the network a MAC CE command activating at least one PCI/CORESETPoolIndex value from the higher layer configured list/set of PCI/CORESETPoolIndex values corresponding to/associated with the TCI state/TCI state ID; yet for another example, (i) the UE could be higher layer configured by the network a list/set of PCI/CORESETPoolIndex values corresponding to/associated with the TCI state/TCI state ID, and (ii) the UE could receive from the network a bitmap activating at least one PCI/CORESETPoolIndex value from the higher layer configured list/set of PCI/CORESETPoolIndex values corresponding to/associated with the TCI state/TCI state ID.

The UE could be indicated by the network which design option(s), selected from/out of Option-AA, Option-BA, Option-CA, Option-DA, Option-EA, Option-FA, and Option-GA described above, is used/implemented; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, the UE could be explicitly indicated by the network, e.g., via higher layer RRC signaling and/or MAC CE command and/or dynamic DCI signaling, the exact design option(s) used/implemented to indicate/identify the serving/non-serving (or neighboring) cells/TRPs in the inter-cell system.

For another example, the UE could receive from the network one or more MAC CE activation commands activating one or more design options used/implemented to indicate/identify the serving/non-serving (or neighboring) cells/TRPs in the inter-cell system.

For yet another example, the UE could receive from the network one or more bitmaps activating one or more design options used/implemented to indicate/identify the serving/non-serving (or neighboring) cells/TRPs in the inter-cell system.

In addition, the design option(s) used/implemented to indicate/identify the serving/non-serving (or neighboring) cells/TRPs in the inter-cell system could be fixed in system specification(s), determined by the network based on UE's capability reporting, and etc.

Furthermore, the UE could send to the network their preference(s)/selection(s) regarding the design option(s), e.g., from/out of Option-AA, Option-BA, Option-CA, Option-DA, Option-EA, Option-FA, and Option-GA described above, to use/implement for indicating/identifying the serving/non-serving (or neighboring) cells/TRPs in the inter-cell system.

For Alternative-0A based candidate TCI states activation for the PDCCH/PDSCH, wherein one or more candidate TCI states (and therefore, the QCL source RSs indicated therein) and/or the corresponding PDCCH(s)/PDSCH(s) could be transmitted from/associated with either the serving cell/TRP (and/or its PCI value) or the non-serving (or neighboring) cell(s)/TRP(s) (and/or the corresponding PCI value(s)), Alternative-1A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the one-bit flag indicator in the MAC CE activation command, Alternative-2A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the multi-bit indicator in the MAC CE activation command, Alternative-3A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the PCI value in the MAC CE activation command, Alternative-4A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the SCI value in the MAC CE activation command, and Alternative-5A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the serving/non-serving (or neighboring) cells/TRPs information indicated in the candidate TCI state(s) in the MAC CE activation command.

In one example, the Option-AA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the one-bit flag indicator in the DCI for the inter-cell PDCCH/PDSCH beam indication.

In another example, the Option-BA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the multi-bit indicator in the DCI for the inter-cell PDCCH/PDSCH beam indication.

In yet another example, the Option-CA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the PCI value in the DCI for the inter-cell PDCCH/PDSCH beam indication.

In yet another example, the Option-DA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the SCI value in the DCI for the inter-cell PDCCH/PDSCH beam indication.

In yet another example, the Option-EA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the association/mapping between the codepoint indices in the DCI(s) for the inter-cell PDCCH/PDSCH beam indication and the candidate TCI states activated by the MAC CE activation command.

In yet another example, the Option-FA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the serving/non-serving (or neighboring) cells/TRPs information indicated in the TCI state indicated in the DCI for the inter-cell PDCCH/PDSCH beam indication.

In yet another example, the Option-GA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the association/mapping between the list/set of TCI states/TCI state IDs in the DCI for the inter-cell PDCCH/PDSCH beam indication and the serving/non-serving (or neighboring) cell PCI/CORESETPoolIndex values.

In one example of design example 3.1A, the UE could be first higher layer configured by the network, e.g., via the higher layer RRC signaling, N_s>1 lists/pools of TCI states with each list/pool of TCI state(s) containing at least one TCI state. Each TCI state contains at least a QCL source RS associated with either the serving cell/TRP or a non-serving cell/TRP (or neighboring cell/TRP). The TCI state indices/IDs and/or the bit-width used for representing the TCI state indices/IDs could be separately determined within each list/pool of TCI states.

The UE could then receive from the network one or more MAC CE activation commands activating one or more TCI states from the higher layer configured list(s)/pool(s) of TCI states, e.g., up to eight TCI states could be activated by a MAC CE activation command as depicted in FIG. 14A, where the QCL source RSs in all the candidate TCI states activated by the MAC CE activation command could be transmitted from/associated with the serving cell/TRP and/or a non-serving cell/TRP (and/or a neighboring cell/TRP). For an inter-cell system, the UE could receive from the network a single MAC CE activation command at a time (e.g., in a slot) activating one or more TCI states (from the higher layer configured list(s)/set(s)/pool(s) of TCI states) associated with either the serving cell/TRP or the non-serving (or neighboring) cell(s)/TRP(s).

For an inter-cell multi-TRP system, the UE could receive from the network more than one MAC CE activation commands at a time (e.g., in a slot) activating two or more TCI states associated with the serving cell/TRP and the non-serving (or neighboring) cell(s)/TRP(s). The UE could be indicated by the network one or more DCIs to indicate the TCI state(s)/beam(s)—selected from the candidate TCI state(s) activated by the MAC CE activation command(s)—for the transmission/reception of the PDCCH(s) or the PDSCH(s) transmitted from/associated with the serving cell/TRP and/or a non-serving cell/TRP (and/or a neighboring cell/TRP).

For an inter-cell system, the UE could receive from the network a single DCI at a time (e.g., in a slot) for the PDCCH/PDSCH beam indication to enable the dynamic switching of the transmission/reception of the PDCCH(s)/PDSCH(s) between different cells/TRPs, e.g., the serving cell/TRP and one or more non-serving (or neighboring) cells/TRPs having different PCIs from that of the serving cell/TRP. For an inter-cell multi-TRP system, the UE could receive from the network more than one DCIs at a time (e.g., in a slot) to indicate the beams/TCI states for the PDCCHs/PDSCHs simultaneously transmitted from the serving cell/TRP and the non-serving (or neighboring) cell(s)/TRP(s).

In FIG. 12B, an example of configuring N_s=2 lists/pools of TCI states via the higher layer RRC signaling is presented. A first list/pool of TCI states contains a total of M_tci TCI states, and a second list of TCI states contains a total of (N_tci−M_tci) TCI states. In this example, the TCI state indices/IDs and/or the bit-width used for representing the TCI state indices/IDs are separately determined within each list/pool of TCI states. As shown in FIG. 12B, the TCI states in the first list/pool of TCI states are indexed as #1, #2, . . . , #M_tci or the TCI state IDs in the first list/pool of TCI states are #1, #2, . . . , #M_tci; the TCI states in the second list/pool of TCI states are indexed as #1, #2, . . . , #(N_tci−M_tci) or the TCI state IDs in the second list/pool of TCI states are #1, #2, . . . , #(N_tci−M_tci).

A distinct TCI state group ID could be associated with a list/pool of TCI states configured, e.g., in the higher layer parameter PDSCH-config. For the example shown in FIG. 12B, two TCI state group IDs “0” and “1” could be defined with TCI state group ID “0” associated with the first list/pool of TCI states and TCI state group ID “1” associated with the second list/pool of TCI states. Each TCI state group ID, and therefore, the TCI states in the corresponding higher layer configured list/pool of TCI states could be associated with/mapped to a PCI for either the serving cell/TRP or a non-serving cell/TRP (or neighboring cell/TRP). The UE could be indicated by the network the association between the TCI state group ID values and the PCI values for the serving/non-serving (or neighboring) cells/TRPs.

In one example, the UE could be explicitly indicated by the network, e.g., via higher layer RRC signaling and/or MAC CE command and/or dynamic DCI signaling, the exact association/mapping between the TCI state group ID values and the PCI values for the serving/non-serving (or neighboring) cells/TRPs in the inter-cell system. For example, the UE could be first higher layer configured by the network a list/set of two PCIs for the serving/non-serving (or neighboring) cells/TRPs; the TCI state group ID value “0” could be mapped to/associated with the first entry in the list/set of two PCIs for the serving/non-serving (or neighboring) cells/TRPs, while the TCI state group ID value “1” could be mapped to/associated with the second entry in the list/set of two PCIs for the serving/non-serving (or neighboring) cells/TRPs.

For more than two configured TCI state group ID values (e.g., 0, 1, . . . , L_idx−1 with L_idx>2), the UE could be first higher layer configured by the network a list/set of at least L_idx PCIs for the serving/non-serving (or neighboring) cells/TRPs in the inter-cell system. The UE could then be indicated by the network the association/mapping between the L_idx TCI state group ID values and the PCIs in the higher layer configured list/set of PCIs. Other indication methods, e.g., via higher layer RRC signaling and/or MAC CE command and/or dynamic DCI signaling, of the exact association/mapping between the TCI state group ID values and the PCI values for the serving/non-serving (or neighboring) cells/TRPs in the inter-cell system are also possible.

In another example, the UE could be implicitly indicated by the network the association/mapping between the TCI state group ID values and the PCI values for the serving/non-serving (or neighboring) cells/TRPs in the inter-cell system. For example, the UE could be indicated by the network that the TCI state group ID value “0” could be mapped to/associated with the lowest PCI value configured to the UE, while the TCI state group ID value “1” could be mapped to/associated with the highest PCI value configured to the UE. For more than two configured TCI state group ID values (e.g., 0, 1, . . . , L_idx−1 with L_idx>2), the UE could be indicated by the network that the lowest TCI state group ID value could be mapped to/associated with the lowest PCI value configured for the UE, the second lowest TCI state group ID value could be mapped to/associated with the second lowest PCI value configured for the UE, and so on, and the L_idx-th highest TCI state group ID value could be mapped to/associated with the L_idx-th highest PCI value configured for the UE. Other implicit indication methods of the association/mapping between the TCI state group ID values and the PCI values for the serving/non-serving (or neighboring) cells/TRPs in the inter-cell system are also possible.

In yet another example, the UE could be first higher layer configured by the network the mapping/association between one or more PCI values and the TCI state group ID values; the UE could then receive from the network one or more MAC CE commands to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first MAC CE command activating at least one PCI from the first set of PCIs corresponding to/associated with the TCI state group ID value “0.” The UE could also receive from the network a second MAC CE command activating at least one PCI from the second set of PCIs corresponding to/associated with the TCI state group ID value “1.”

Alternatively, the UE could receive from the network a single MAC CE command activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first MAC CE command activating at least one PCI from the first set of PCIs corresponding to/associated with the TCI state group ID value “0,” a second MAC CE command activating at least one PCI from the second set of PCIs corresponding to/associated with the TCI state group ID value “1,” and so on, and a L_idx-th MAC CE command activating at least one PCI from the L_idx-th set of PCIs corresponding to/associated with the TCI state group ID value “L_idx−1.”

Alternatively, the UE could receive from the network a single MAC CE command activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be first higher layer configured by the network the mapping/association between one or more PCI values and the TCI state group ID values; the UE could then receive from the network one or more bitmaps to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first bitmap with each entry/bit in the first bitmap corresponding to/associated with a distinct entry in the first set of PCIs corresponding to/associated with the TCI state group ID value “0”; if an entry/bit in the first bitmap is set to “1,” the corresponding/associated entry in the first set of PCIs corresponding to/associated with the TCI state group ID value “0” is activated as the PCI corresponding to/associated with the TCI state group ID value “0” for the inter-cell operation.

The UE could also receive from the network a second bitmap with each entry/bit in the second bitmap corresponding to/associated with a distinct entry in the second set of PCIs corresponding to/associated with the TCI state group ID value “1”; if an entry/bit in the second bitmap is set to “1,” the corresponding/associated entry in the second set of PCIs corresponding to/associated with the TCI state group ID value “1” is activated as the PCI corresponding to/associated with the TCI state group ID value “1” for the inter-cell operation.

Alternatively, the UE could receive from the network a single bitmap activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.”

The UE could then receive from the network a first bitmap activating at least one PCI from the first set of PCIs corresponding to/associated with the TCI state group ID value “0,” a second bitmap activating at least one PCI from the second set of PCIs corresponding to/associated with the TCI state group ID value “1,” and so on, and a L_idx-th bitmap activating at least one PCI from the L_idx-th set of PCIs corresponding to/associated with the TCI state group ID value “L_idx−1.”

Alternatively, the UE could receive from the network a single bitmap activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be indicated by the network that the TCI state group ID value “0” is associated with the serving cell/TRP (and/or its corresponding PCI). For a TCI state group ID value other than value “0,” e.g., value “1”: for example, the UE could be indicated by the network, e.g., via higher layer RRC signaling and/or MAC CE command and/or dynamic DCI signaling, the exact non-serving (or neighboring) cell/TRP PCI value associated with the TCI state group ID value; for another example, the UE could be indicated by the network that the TCI state group ID value could be associated with the lowest (or the highest) non-serving (or neighboring) cell/TRP PCI value configured for the UE; yet for another example, (i) the UE could be higher layer configured by the network a list/set of PCIs corresponding to/associated with the TCI state group ID value, and (ii) the UE could receive from the network a MAC CE command activating at least one PCI from the higher layer configured list/set of PCIs corresponding to/associated with the TCI state group ID value; yet for another example, (i) the UE could be higher layer configured by the network a list/set of PCIs corresponding to/associated with the TCI state group ID value, and (ii) the UE could receive from the network a bitmap activating at least one PCI from the higher layer configured list/set of PCIs corresponding to/associated with the TCI state group ID value.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values.

In this design example, if a beam associated with the i-th PCI is activated, the (i+1)-th, the (i+2)-th, . . . , and the (i+K_idx−1)-th entries in the set/list/pool of PCIs (or equivalently, the (i+1)-th PCI, the (i+2)-th PCI, . . . , and the (i+K_idx−1)-th PCI) along with the corresponding TCI state group ID values could be activated, and/or, the (i−K_idx+1)-th, the (i−K_idx+2)-th, . . . , and the (i−1)-th entries in the set/list/pool of PCIs (or equivalently, the (i−K_idx+1)-th PCI, the (i-K_idx+2)-th PCI, . . . , and the (i−1)-th PCI) along with the corresponding TCI state group ID values could be deactivated.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2.

In this example, if a beam associated with the 3-rd PCI (associated with the TCI state group ID value “2”) is activated, the 4-th PCI (associated with the TCI state group ID value “0”) and the 5-th PCI (associated with the TCI state group ID value “1”) are activated. At the same time, the 1-st PCI (associated with the TCI state group ID value “0”) and the 2-nd PCI (associated with the TCI state group ID value “1”) are deactivated.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values. In this design example, if a beam associated with the i-th PCI is activated, the (i−floor((K_idx−1)/2))-th, the (i−floor((K_idx−1)/2)+1)-th, . . . , and the (i+ceil((K_idx−1)/2))-th entries in the set/list/pool of PCIs (or equivalently, the (i-floor((K_idx−1)/2))-th PCI, the (i−floor((K_idx−1)/2)+1)-th PCI, . . . , and the (i+ceil((K_idx−1)/2))-th PCI) along with the corresponding TCI state group ID values could be activated, or, the (i-ceil((K_idx−1)/2))-th, the (i−floor((K_idx−1)/2)+1)-th, . . . , and the (i+floor((K_idx−1)/2))-th entries in the set/list/pool of PCIs (or equivalently, the (i-ceil((K_idx−1)/2))-th PCI, the (i−floor((K_idx−1)/2)+1)-th PCI, . . . , and the (i+floor((K_idx−1)/2))-th PCI) along with the corresponding TCI state group ID values could be activated, where floor(x) returns the largest integer that is smaller than or equal to x and ceil(x) returns the smallest integer that is greater than or equal to x.

The starting/initial activated cells could be the (i−G)-th, the (i−G+1)-th, . . . , the i-th, . . . , the (i−G+K_idx−1)-th entries in the set/list/pool of PCIs (or equivalently, the (i−G)-th PCI, the (i-G+1)-th PCI, . . . , the i-th PCI, . . . , the (i−G+K_idx−1)-th PCI); their corresponding/associated TCI state group ID values are also activated. Here, the value of G could be higher layer configured to the UE by the network and/or fixed per RRC configuration. For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 2-nd PCI (associated with the TCI state group ID value “1”) and the 4-th PCI (associated with the TCI state group ID value “0”) are activated.

In addition to Alternative-0A, Alternative-1A, Alternative-2A, Alternative-3A, Alternative-4A, and Alternative-5A based candidate TCI states activation for the PDCCH/PDSCH, in one example of Alternative-6A, the TCI state group ID value(s) could be included/indicated in the MAC CE activation command. If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDCCH/PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH/PDSCH is transmitted.

In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RSs in all the candidate TCI states activated by the MAC CE activation command are transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RSs in all the candidate TCI states activated by the MAC CE activation command are transmitted.

The UE could be indicated by the network which design alternative(s), selected from/out of Alternative-1A, Alternative-2A, Alternative-3A, Alternative-4A, Alternative-5A, and Alternative-6A described above, is used/implemented; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, the UE could be explicitly indicated by the network, e.g., via higher layer RRC signaling and/or MAC CE command and/or dynamic DCI signaling, the exact design alternative(s) used/implemented to indicate/identify the serving/non-serving (or neighboring) cells/TRPs in the inter-cell system.

For another example, the UE could receive from the network one or more MAC CE activation commands activating one or more design alternatives used/implemented to indicate/identify the serving/non-serving (or neighboring) cells/TRPs in the inter-cell system.

For yet another example, the UE could receive from the network one or more bitmaps activating one or more design alternatives used/implemented to indicate/identify the serving/non-serving (or neighboring) cells/TRPs in the inter-cell system.

In addition, the design alternative(s) used/implemented to indicate/identify the serving/non-serving (or neighboring) cells/TRPs in the inter-cell system could be fixed in system specification(s), determined by the network based on UE's capability reporting, and etc. Furthermore, the UE could send to the network their preference(s)/selection(s) regarding the design alternative(s), e.g., from/out of Alternative-1A, Alternative-2A, Alternative-3A, Alternative-4A, Alternative-5A, and Alternative-6A described above, to use/implement for indicating/identifying the serving/non-serving (or neighboring) cells/TRPs in the inter-cell system.

As described above, a DCI used to indicate to the UE a beam (i.e., a TCI state and/or a TCI state ID) for the transmission/reception of a PDCCH or a PDSCH could be at least one of the following: (1) in one example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment; (2) in another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant; and/or (3) yet in another example, a custom/purpose designed DCI format could be used to indicate to the UE a beam (i.e., a TCI state and/or a TCI state ID) for the transmission/reception of a PDCCH or a PDSCH.

Furthermore, the TCI state indicated in the DCI for the inter-cell PDCCH/PDSCH beam indication could be at least one of: (1) a DL TCI state; (2) an UL TCI state; (3) a joint DL and UL TCI state; and/or (4) separate DL TCI state and UL TCI state.

In addition to Option-AA, Option-BA, Option-CA, Option-DA, Option-EA, Option-FA, and Option-GA based TCI state indication for the PDCCH/PDSCH, in one example of Option-HA, the TCI state group ID value(s) could be included/indicated in the DCI for the inter-cell PDCCH/PDSCH beam indication (from the MAC CE activated TCI state(s)). If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDCCH/PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH/PDSCH is transmitted.

In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RS(s) in the TCI state indicated in the DCI for the inter-cell PDCCH/PDSCH beam indication (from the MAC CE activated TCI state(s)) is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS(s) in the TCI state indicated in the DCI for the inter-cell PDCCH/PDSCH beam indication (from the MAC CE activated TCI state(s)) is transmitted.

The UE could be indicated by the network which design option(s), selected from/out of Option-AA, Option-BA, Option-CA, Option-DA, Option-EA, Option-FA, Option-GA, and Option-HA described above, is used/implemented; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, the UE could be explicitly indicated by the network, e.g., via higher layer RRC signaling and/or MAC CE command and/or dynamic DCI signaling, the exact design option(s) used/implemented to indicate/identify the serving/non-serving (or neighboring) cells/TRPs in the inter-cell system.

For another example, the UE could receive from the network one or more MAC CE activation commands activating one or more design options used/implemented to indicate/identify the serving/non-serving (or neighboring) cells/TRPs in the inter-cell system.

For yet another example, the UE could receive from the network one or more bitmaps activating one or more design options used/implemented to indicate/identify the serving/non-serving (or neighboring) cells/TRPs in the inter-cell system.

In addition, the design option(s) used/implemented to indicate/identify the serving/non-serving (or neighboring) cells/TRPs in the inter-cell system could be fixed in system specification(s), determined by the network based on UE's capability reporting, and etc. Furthermore, the UE could send to the network their preference(s)/selection(s) regarding the design option(s), e.g., from/out of Option-AA, Option-BA, Option-CA, Option-DA, Option-EA, Option-FA, Option-GA, and Option-HA described above, to use/implement for indicating/identifying the serving/non-serving (or neighboring) cells/TRPs in the inter-cell system.

In this design example, the Alternative-0 based candidate TCI states activation for the PDCCH/PDSCH, wherein one or more candidate TCI states (and therefore, the QCL source RSs indicated therein) and/or the corresponding PDCCH(s)/PDSCH(s) could be transmitted from/associated with either the serving cell/TRP (and/or its PCI value) or the non-serving (or neighboring) cell(s)/TRP(s) (and/or the corresponding PCI value(s)), and/or the Alternative-1A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the one-bit flag indicator in the MAC CE activation command, and/or the Alternative-2A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the multi-bit indicator in the MAC CE activation command, and/or the Alternative-3A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the PCI value in the MAC CE activation command, and/or the Alternative-4A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the SCI value in the MAC CE activation command, and/or the Alternative-5A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the serving/non-serving (or neighboring) cells/TRPs information indicated in the candidate TCI state(s) in the MAC CE activation command, and/or the Alternative-6A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the TCI state group ID value in the MAC CE activation command, could be applied.

In one example, the Option-AA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the one-bit flag indicator in the DCI for the inter-cell PDCCH/PDSCH beam indication.

In another example, the Option-BA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the multi-bit indicator in the DCI for the inter-cell PDCCH/PDSCH beam indication.

In yet another example, the Option-CA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the PCI value in the DCI for the inter-cell PDCCH/PDSCH beam indication.

In yet another example, the Option-DA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the SCI value in the DCI for the inter-cell PDCCH/PDSCH beam indication.

In yet another example, the Option-EA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the association/mapping between the codepoint indices in the DCI(s) for the inter-cell PDCCH/PDSCH beam indication and the candidate TCI states activated by the MAC CE activation command.

In yet another example, the Option-FA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the serving/non-serving (or neighboring) cells/TRPs information indicated in the TCI state indicated in the DCI for the inter-cell PDCCH/PDSCH beam indication.

In yet another example, the Option-GA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the association/mapping between the list/set of TCI states/TCI state IDs in the DCI for the inter-cell PDCCH/PDSCH beam indication and the serving/non-serving (or neighboring) cell PCI/CORESETPoolIndex values.

In yet another example, the Option-HA based TCI state indication for the PDCCH/PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving (or neighboring) cell/TRP (and/or its PCI value) via the TCI state group ID value in the DCI for the inter-cell PDCCH/PDSCH beam indication.

In one example of design example 3.2A, the UE could be first higher layer configured by the network, e.g., via the higher layer RRC signaling, N_s>1 lists/pools of TCI states with each list/pool of TCI state(s) containing at least one TCI state. Each TCI state contains at least a QCL source RS associated with either the serving cell/TRP or a non-serving cell/TRP (or neighboring cell/TRP). The TCI state indices/IDs and/or the bit-width used for representing the TCI state indices/IDs could be determined across all N_s lists/pools of TCI states and/or one or more of all N_s lists/pools of TCI states.

The UE could then receive from the network one or more MAC CE activation commands activating one or more TCI states from the higher layer configured list(s)/pool(s) of TCI states, e.g., up to eight TCI states could be activated by a MAC CE activation command as depicted in FIG. 14A, where the QCL source RSs in all the candidate TCI states activated by the MAC CE activation command could be transmitted from/associated with the serving cell/TRP and/or a non-serving cell/TRP (and/or a neighboring cell/TRP). For an inter-cell system, the UE could receive from the network a single MAC CE activation command at a time (e.g., in a slot) activating one or more TCI states (from the higher layer configured list(s)/set(s)/pool(s) of TCI states) associated with either the serving cell/TRP or the non-serving (or neighboring) cell(s)/TRP(s).

For an inter-cell multi-TRP system, the UE could receive from the network more than one MAC CE activation commands at a time (e.g., in a slot) activating two or more TCI states associated with the serving cell/TRP and the non-serving (or neighboring) cell(s)/TRP(s). The UE could be indicated by the network one or more DCIs to indicate the TCI state(s)/beam(s)—selected from the candidate TCI state(s) activated by the MAC CE activation command(s)—for the transmission/reception of the PDCCH(s) or the PDSCH(s) transmitted from/associated with the serving cell/TRP and/or a non-serving cell/TRP (and/or a neighboring cell/TRP).

For an inter-cell system, the UE could receive from the network a single DCI at a time (e.g., in a slot) for the PDCCH/PDSCH beam indication to enable the dynamic switching of the transmission/reception of the PDCCH(s)/PDSCH(s) between different cells/TRPs, e.g., the serving cell/TRP and one or more non-serving (or neighboring) cells/TRPs having different PCIs from that of the serving cell/TRP. For an inter-cell multi-TRP system, the UE could receive from the network more than one DCIs at a time (e.g., in a slot) to indicate the beams/TCI states for the PDCCHs/PDSCHs simultaneously transmitted from the serving cell/TRP and the non-serving (or neighboring) cell(s)/TRP(s).

In FIG. 12C, an example of configuring N_s=2 lists/pools of TCI states, e.g., in the higher layer parameter PDSCH-config, is presented. A first list/pool of TCI states contains a total of M_tci TCI states, and a second list of TCI states contains a total of (N_tci−M_tci) TCI states. In this example, the TCI state indices/IDs and/or the bit-width used for representing the TCI state indices/IDs are determined across all N_s=2 lists/pools of TCI states. As shown in FIG. 12C, the TCI states in the first list/pool of TCI states are indexed as #1, #2, . . . , #M_tci or the TCI state IDs in the first list/pool of TCI states are #1, #2, . . . , #M_tci; the TCI states in the second list/pool of TCI states are indexed as #(M_tci+1), #(M_tci+2), . . . , #N_tci or the TCI state IDs in the second list/pool of TCI states are #(M_tci+1), #(M_tci+2), . . . , #N_tci.

A distinct TCI state group ID could be associated with a list/pool of TCI states configured, e.g., in the higher layer parameter PDSCH-config. For the example shown in FIG. 12C, two TCI state IDs “0” and “1” could be defined with TCI state group ID “0” associated with the first list/pool of TCI states and TCI state group ID “1” associated with the second list/pool of TCI states. Each TCI state group ID, and therefore, the TCI states in the corresponding higher layer configured list/pool of TCI states could be associated with/mapped to a PCI for either the serving cell/TRP or a non-serving cell/TRP (or neighboring cell/TRP). The UE could be indicated by the network the association between the TCI state group ID values and the PCI values for the serving/non-serving (or neighboring) cells/TRPs.

In one example, the UE could be explicitly indicated by the network, e.g., via higher layer RRC signaling and/or MAC CE command and/or dynamic DCI signaling, the exact association/mapping between the TCI state group ID values and the PCI values for the serving/non-serving (or neighboring) cells/TRPs in the inter-cell system. For example, the UE could be first higher layer configured by the network a list/set of two PCIs for the serving/non-serving (or neighboring) cells/TRPs; the TCI state group ID value “0” could be mapped to/associated with the first entry in the list/set of two PCIs for the serving/non-serving (or neighboring) cells/TRPs, while the TCI state group ID value “1” could be mapped to/associated with the second entry in the list/set of two PCIs for the serving/non-serving (or neighboring) cells/TRPs. For more than two configured TCI state group ID values (e.g., 0, 1, . . . , L_idx−1 with L_idx>2), the UE could be first higher layer configured by the network a list/set of at least L_idx PCIs for the serving/non-serving (or neighboring) cells/TRPs in the inter-cell system.

The UE could then be indicated by the network the association/mapping between the L_idx TCI state group ID values and the PCIs in the higher layer configured list/set of PCIs. Other indication methods, e.g., via higher layer RRC signaling and/or MAC CE command and/or dynamic DCI signaling, of the exact association/mapping between the TCI state group ID values and the PCI values for the serving/non-serving (or neighboring) cells/TRPs in the inter-cell system are also possible.

In another example, the UE could be implicitly indicated by the network the association/mapping between the TCI state group ID values and the PCI values for the serving/non-serving (or neighboring) cells/TRPs in the inter-cell system. For example, the UE could be indicated by the network that the TCI state group ID value “0” could be mapped to/associated with the lowest PCI value configured to the UE, while the TCI state group ID value “1” could be mapped to/associated with the highest PCI value configured to the UE.

For more than two configured TCI state group ID values (e.g., 0, 1, . . . , L_idx−1 with L_idx>2), the UE could be indicated by the network that the lowest TCI state group ID value could be mapped to/associated with the lowest PCI value configured for the UE, the second lowest TCI state group ID value could be mapped to/associated with the second lowest PCI value configured for the UE, and so on, and the L_idx-th highest TCI state group ID value could be mapped to/associated with the L_idx-th highest PCI value configured for the UE. Other implicit indication methods of the association/mapping between the TCI state group ID values and the PCI values for the serving/non-serving (or neighboring) cells/TRPs in the inter-cell system are also possible.

In yet another example, the UE could be first higher layer configured by the network the mapping/association between one or more PCI values and the TCI state group ID values; the UE could then receive from the network one or more MAC CE commands to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.” The UE could then receive from the network a first MAC CE command activating at least one PCI from the first set of PCIs corresponding to/associated with the TCI state group ID value “0.” The UE could also receive from the network a second MAC CE command activating at least one PCI from the second set of PCIs corresponding to/associated with the TCI state group ID value “1.”

Alternatively, the UE could receive from the network a single MAC CE command activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.” The UE could then receive from the network a first MAC CE command activating at least one PCI from the first set of PCIs corresponding to/associated with the TCI state group ID value “0,” a second MAC CE command activating at least one PCI from the second set of PCIs corresponding to/associated with the TCI state group ID value “1,” and so on, and a L_idx-th MAC CE command activating at least one PCI from the L_idx-th set of PCIs corresponding to/associated with the TCI state group ID value “L_idx−1.”

Alternatively, the UE could receive from the network a single MAC CE command activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be first higher layer configured by the network the mapping/association between one or more PCI values and the TCI state group ID values; the UE could then receive from the network one or more bitmaps to activate one or more PCIs associated with different TCI state group ID values. For example, the UE could be first higher layer configured by the network a first set of PCIs corresponding to/associated with the TCI state group ID value “0,” and a second set of PCIs corresponding to/associated with the TCI state group ID value “1.”

The UE could then receive from the network a first bitmap with each entry/bit in the first bitmap corresponding to/associated with a distinct entry in the first set of PCIs corresponding to/associated with the TCI state group ID value “0”; if an entry/bit in the first bitmap is set to “1,” the corresponding/associated entry in the first set of PCIs corresponding to/associated with the TCI state group ID value “0” is activated as the PCI corresponding to/associated with the TCI state group ID value “0” for the inter-cell operation. The UE could also receive from the network a second bitmap with each entry/bit in the second bitmap corresponding to/associated with a distinct entry in the second set of PCIs corresponding to/associated with the TCI state group ID value “1”; if an entry/bit in the second bitmap is set to “1,” the corresponding/associated entry in the second set of PCIs corresponding to/associated with the TCI state group ID value “1” is activated as the PCI corresponding to/associated with the TCI state group ID value “1” for the inter-cell operation.

Alternatively, the UE could receive from the network a single bitmap activating at least one PCI from the first set of PCIs corresponding to/associated with the TCI state group ID value “0” and at least one PCI from the second set of PCIs corresponding to/associated with the TCI state group ID value “1.” For more than two configured TCI state group ID values (e.g., 0, 1, . . . , L_idx−1 with L_idx>2), the UE could be first higher layer configured by the network a first set of PCIs corresponding to/associated with the TCI state group ID value “0,” a second set of PCIs corresponding to/associated with the TCI state group ID value “1,” and so on, and a L_idx-th set of PCIs corresponding to/associated with the TCI state group ID value “L_idx−1.”

The UE could then receive from the network a first bitmap activating at least one PCI from the first set of PCIs corresponding to/associated with the TCI state group ID value “0,” a second bitmap activating at least one PCI from the second set of PCIs corresponding to/associated with the TCI state group ID value “1,” and so on, and a L_idx-th bitmap activating at least one PCI from the L_idx-th set of PCIs corresponding to/associated with the TCI state group ID value “L_idx−1.”

Alternatively, the UE could receive from the network a single bitmap activating at least one PCI from the first set of PCIs corresponding to/associated with the TCI state group ID value “0,” at least one PCI from the second set of PCIs corresponding to/associated with the TCI state group ID value “1,” and so on, and at least one PCI from the L_idx-th set of PCIs corresponding to/associated with the TCI state group ID value “L_idx−1.”

In yet another example, the UE could be indicated by the network that the TCI state group ID value “0” is associated with the serving cell/TRP (and/or its corresponding PCI). For a TCI state group ID value other than value “0,” e.g., value “1”: for example, the UE could be indicated by the network, e.g., via higher layer RRC signaling and/or MAC CE command and/or dynamic DCI signaling, the exact non-serving (or neighboring) cell/TRP PCI value associated with the TCI state group ID value; for another example, the UE could be indicated by the network that the TCI state group ID value could be associated with the lowest (or the highest) non-serving (or neighboring) cell/TRP PCI value configured for the UE; yet for another example, (i) the UE could be higher layer configured by the network a list/set of PCIs corresponding to/associated with the TCI state group ID value, and (ii) the UE could receive from the network a MAC CE command activating at least one PCI from the higher layer configured list/set of PCIs corresponding to/associated with the TCI state group ID value; yet for another example, (i) the UE could be higher layer configured by the network a list/set of PCIs corresponding to/associated with the TCI state group ID value, and (ii) the UE could receive from the network a bitmap activating at least one PCI from the higher layer configured list/set of PCIs corresponding to/associated with the TCI state group ID value.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values.

In this design example, if a beam associated with the i-th PCI is activated, the (i+1)-th, the (i+2)-th, . . . , and the (i+K_idx−1)-th entries in the set/list/pool of PCIs (or equivalently, the (i+1)-th PCI, the (i+2)-th PCI, . . . , and the (i+K_idx−1)-th PCI) along with the corresponding TCI state group ID values could be activated, and/or, the (i−K_idx+1)-th, the (i−K_idx+2)-th, . . . , and the (i−1)-th entries in the set/list/pool of PCIs (or equivalently, the (i−K_idx+1)-th PCI, the (i-K_idx+2)-th PCI, . . . , and the (i−1)-th PCI) along with the corresponding TCI state group ID values could be deactivated. For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2.

In this example, if a beam associated with the 3-rd PCI (associated with the TCI state group ID value “2”) is activated, the 4-th PCI (associated with the TCI state group ID value “0”) and the 5-th PCI (associated with the TCI state group ID value “1”) are activated. At the same time, the 1-st PCI (associated with the TCI state group ID value “0”) and the 2-nd PCI (associated with the TCI state group ID value “1”) are deactivated.

In yet another example, the UE could be first higher layer configured (e.g., via the higher layer RRC signaling) a set/list/pool of serving/non-serving (or neighboring) cells/TRPs PCIs. The UE could be indicated by the network that the i-th entry in the set/list/pool of PCIs (or equivalently, the i-th PCI), is associated with the TCI state group ID value mod(i−1, K_idx), where mod(x, y) calculates the remainder of the Euclidean division of x by y, and K_idx represents the total number of configured TCI state group ID values.

In this design example, if a beam associated with the i-th PCI is activated, the (i-floor((K_idx−1)/2))-th, the (i−floor((K_idx−1)/2)+1)-th, . . . , and the (i+ceil((K_idx−1)/2))-th entries in the set/list/pool of PCIs (or equivalently, the (i−floor((K_idx−1)/2))-th PCI, the (i−floor((K_idx−1)/2)+1)-th PCI, . . . , and the (i+ceil((K_idx−1)/2))-th PCI) along with the corresponding TCI state group ID values could be activated, or, the (i-ceil((K_idx−1)/2))-th, the (i−floor((K_idx−1)/2)+1)-th, . . . , and the (i+floor((K_idx−1)/2))-th entries in the set/list/pool of PCIs (or equivalently, the (i-ceil((K_idx−1)/2))-th PCI, the (i−floor((K_idx−1)/2)+1)-th PCI, . . . , and the (i+floor((K_idx−1)/2))-th PCI) along with the corresponding TCI state group ID values could be activated, where floor(x) returns the largest integer that is smaller than or equal to x and ceil(x) returns the smallest integer that is greater than or equal to x.

The starting/initial activated cells could be the (i−G)-th, the (i−G+1)-th, . . . , the i-th, . . . , the (i−G+K_idx−1)-th entries in the set/list/pool of PCIs (or equivalently, the (i−G)-th PCI, the (i-G+1)-th PCI, . . . , the i-th PCI, . . . , the (i−G+K_idx−1)-th PCI); their corresponding/associated TCI state group ID values are also activated. Here, the value of G could be higher layer configured to the UE by the network and/or fixed per RRC configuration.

For instance, for K_idx=3 TCI state group ID values 0, 1 and 2, the 1-st entry, the 2-nd entry and the 3-rd entry in the set/list/pool of PCIs (or equivalently, the 1-st PCI, the 2-nd PCI and the 3-rd PCI) are associated with TCI state group ID values 0, 1 and 2, the 4-th entry, the 5-th entry and the 6-th entry in the set/list/pool of PCIs (or equivalently, the 4-th PCI, the 5-th PCI and the 6-th PCI) are associated with TCI state group ID values 0, 1 and 2, and the 7-th entry, the 8-th entry and the 9-th entry in the set/list/pool of PCIs (or equivalently, the 7-th PCI, the 8-th PCI and the 9-th PCI) are associated with TCI state group ID values 0, 1 and 2. In this example, if a beam associated with the 3-rd PCI (associated with the TCI state group ID value “2”) is activated, the 2-nd PCI (associated with the TCI state group ID value “1”) and the 4-th PCI (associated with the TCI state group ID value “0”) are activated.

In addition to Alternative-0A, Alternative-1A, Alternative-2A, Alternative-3A, Alternative-4A, Alternative-5A, and Alternative-6A based candidate TCI states activation for the PDCCH/PDSCH, in one example of Alternative-7A, the MAC CE activation command may not include the TCI state group ID value(s)—different from the design example 3.1A. The UE could identify the TCI state group ID value(s) from the candidate TCI states/TCI state IDs activated by the MAC CE activation command because the TCI state IDs are determined across all N_s>1 lists/pools of TCI states.

If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDCCH/PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH/PDSCH is transmitted.

In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RSs in all the candidate TCI states activated by the MAC CE activation command are transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RSs in all the candidate TCI states activated by the MAC CE activation command are transmitted.

As described above, a DCI used to indicate to the UE a beam (i.e., a TCI state and/or a TCI state ID) for the transmission/reception of a PDCCH or a PDSCH could be at least one of the following: (1) in one example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment; (2) in another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant; and/or (3) yet in another example, a custom/purpose designed DCI format could be used to indicate to the UE a beam (i.e., a TCI state and/or a TCI state ID) for the transmission/reception of a PDCCH or a PDSCH.

Furthermore, the TCI state indicated in the DCI for the inter-cell PDCCH/PDSCH beam indication could be at least one of: (1) a DL TCI state; (2) an UL TCI state; (3) a joint DL and UL TCI state; and/or (4) separate DL TCI state and UL TCI state.

In addition to Option-AA, Option-BA, Option-CA, Option-DA, Option-EA, Option-FA, Option-GA, and Option-HA based TCI state indication for the PDCCH/PDSCH, in one example of Option-IA, the DCI for the inter-cell PDCCH/PDSCH beam indication (from the MAC CE activated TCI state(s)) may not include the TCI state group ID value(s)—different from the design example 3.1A.

The UE could identify the TCI state group ID value(s) from the TCI state/TCI state ID indicated in the DCI for the inter-cell PDCCH/PDSCH beam indication because the TCI state IDs are determined across all N_s>1 lists/pools of TCI states. If the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could further identify whether the corresponding PDCCH/PDSCH is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the PDCCH/PDSCH is transmitted.

In addition, if the UE has been configured/indicated by the network the association between the TCI state group ID values and the serving/non-serving (or neighboring) cells/TRPs, and/or, the association between the TCI state group ID values and the exact PCI values for the serving/non-serving (or neighboring) cells/TRPs, the UE could identify whether the QCL source RS(s) in the TCI state indicated in the DCI is transmitted from/associated with the serving cell/TRP or a non-serving cell/TRP (or neighboring cell/TRP), and/or, the exact PCI value for either the serving cell/TRP or the non-serving cell/TRP (or neighboring cell/TRP), from which the QCL source RS(s) in the TCI state indicated in the DCI is transmitted.

The UE could be indicated by the network which design option(s), selected from/out of Option-AA, Option-BA, Option-CA, Option-DA, Option-EA, Option-FA, Option-GA, Option-HA, and Option-IA described above, is used/implemented; this indication could be via higher layer (RRC) or/and MAC CE or/and DCI based signaling or/and any combination of at least two of RRC, MAC CE and DCI based signaling; this indication could be via a separate (dedicated) parameter or joint with another parameter.

For example, the UE could be explicitly indicated by the network, e.g., via higher layer RRC signaling and/or MAC CE command and/or dynamic DCI signaling, the exact design option(s) used/implemented to indicate/identify the serving/non-serving (or neighboring) cells/TRPs in the inter-cell system.

For another example, the UE could receive from the network one or more MAC CE activation commands activating one or more design options used/implemented to indicate/identify the serving/non-serving (or neighboring) cells/TRPs in the inter-cell system.

For yet another example, the UE could receive from the network one or more bitmaps activating one or more design options used/implemented to indicate/identify the serving/non-serving (or neighboring) cells/TRPs in the inter-cell system.

In addition, the design option(s) used/implemented to indicate/identify the serving/non-serving (or neighboring) cells/TRPs in the inter-cell system could be fixed in system specification(s), determined by the network based on UE's capability reporting, and etc. Furthermore, the UE could send to the network their preference(s)/selection(s) regarding the design option(s), e.g., from/out of Option-AA, Option-BA, Option-CA, Option-DA, Option-EA, Option-FA, Option-GA, Option-HA, and Option-IA described above, to use/implement for indicating/identifying the serving/non-serving (or neighboring) cells/TRPs in the inter-cell system.

In this design example, the Alternative-0 based candidate TCI states activation for the PDCCH/PDSCH, wherein one or more candidate TCI states (and therefore, the QCL source RSs indicated therein) and/or the corresponding PDCCH(s)/PDSCH(s) could be transmitted from/associated with either the serving cell/TRP (and/or its PCI value) or the non-serving (or neighboring) cell(s)/TRP(s) (and/or the corresponding PCI value(s)), and/or the Alternative-1A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the one-bit flag indicator in the MAC CE activation command, and/or the Alternative-2A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the multi-bit indicator in the MAC CE activation command, and/or the Alternative-3A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the PCI value in the MAC CE activation command, and/or the Alternative-4A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the SCI value in the MAC CE activation command, and/or the Alternative-5A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the serving/non-serving (or neighboring) cells/TRPs information indicated in the candidate TCI state(s) in the MAC CE activation command, and/or the Alternative-6A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the TCI state group ID value in the MAC CE activation command, and/or the Alternative-7A based candidate TCI states activation for the PDCCH/PDSCH, wherein the UE could identify whether all the candidate TCI states (and therefore, the QCL source RSs indicated therein) and/or the corresponding PDCCH(s)/PDSCH(s) are transmitted from/associated with either the serving cell/TRP (and/or its PCI value) or a non-serving (or neighboring) cell/TRP (and/or its PCI value) via the association between the TCI state ID value(s) in the MAC CE activation command and the TCI state group ID value(s), could be applied.

In one example, the Option-AA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the one-bit flag indicator in the DCI for the inter-cell PDCCH/PDSCH beam indication.

In another example, the Option-BA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the multi-bit indicator in the DCI for the inter-cell PDCCH/PDSCH beam indication.

In yet another example, the Option-CA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the PCI value in the DCI for the inter-cell PDCCH/PDSCH beam indication.

In yet another example, the Option-DA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the SCI value in the DCI for the inter-cell PDCCH/PDSCH beam indication.

In yet another example, the Option-EA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the association/mapping between the codepoint indices in the DCI(s) for the inter-cell PDCCH/PDSCH beam indication and the candidate TCI states activated by the MAC CE activation command.

In yet another example, the Option-FA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the serving/non-serving (or neighboring) cells/TRPs information indicated in the TCI state indicated in the DCI for the inter-cell PDCCH/PDSCH beam indication.

In yet another example, the Option-GA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the association/mapping between the list/set of TCI states/TCI state IDs in the DCI for the inter-cell PDCCH/PDSCH beam indication and the serving/non-serving (or neighboring) cell PCI/CORESETPoolIndex values.

In yet another example, the Option-HA based TCI state indication for the PDCCH/PDSCH could be applied, wherein the UE could identify whether the indicated TCI state (and therefore, the QCL source RS indicated therein) and/or the corresponding PDSCH are transmitted from/associated with either the serving cell/TRP (and/or its PCI value) or a non-serving (or neighboring) cell/TRP (and/or its PCI value) via the TCI state group ID value in the DCI for the inter-cell PDCCH/PDSCH beam indication.

In yet another example, the Option-IA based TCI state indication for the PDCCH/PDSCH could be applied, wherein the UE could identify whether the indicated TCI state (and therefore, the QCL source RS indicated therein) and/or the corresponding PDCCH/PDSCH are transmitted from/associated with either the serving cell/TRP (and/or its PCI value) or a non-serving (or neighboring) cell/TRP (and/or its PCI value) via the association between the TCI state ID value(s) in the DCI for the inter-cell PDCCH/PDSCH beam indication and the TCI state group ID value(s).

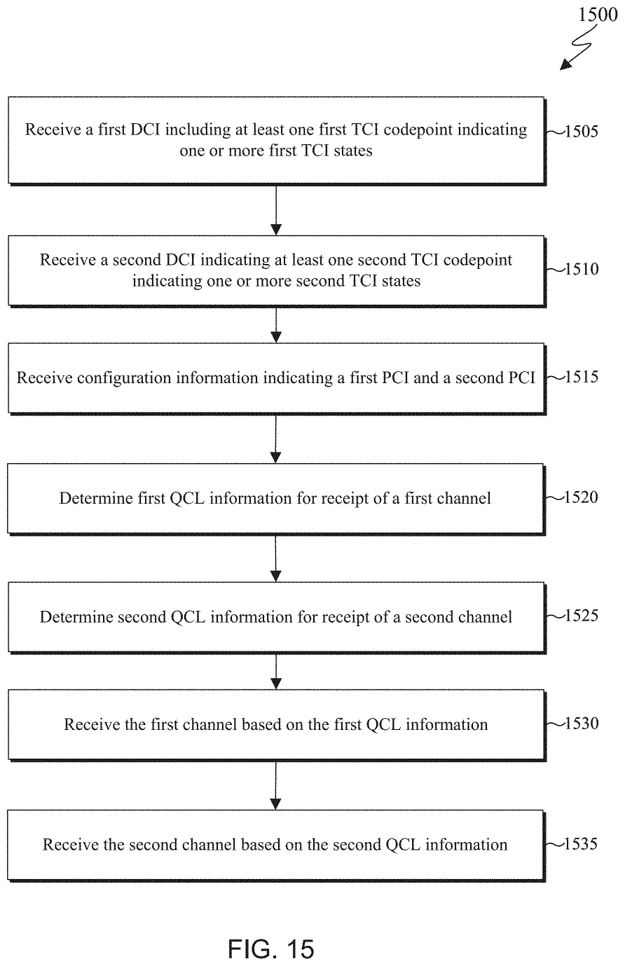

FIG. 15 illustrates an example method 1500 for beam indication for an inter-cell operation in a wireless communication system according to embodiments of the present disclosure. The steps of the method 1500 of FIG. 15 can be performed by any of the UEs 111-119 of FIG. 1, such as the UE 116 of FIG. 3, and an analogous method may be performed by a BS such as BS 101-103 in FIG. 1. The method 1500 is for illustration only and other embodiments can be used without departing from the scope of the present disclosure.

The method begins with the UE receiving a first DCI including at least one first TCI codepoint indicating one or more first TCI states (step 1505). For example, in step 1505, the first DCI is received in a CORESET associated with a first CORESET pool index. The UE then receives a second DCI indicating at least one second TCI codepoint indicating one or more second TCI states (step 1510). For example, in step 1510, the second DCI is received in a CORESET associated with a second CORESET pool index.

In some embodiments, the UE may also receive, via higher layer RRC signaling, a first list of TCI states associated with a first entity ID; receive, via higher layer RRC signaling, a second list of TCI states associated with a second entity ID; receive a first MAC CE command associated with the first entity ID; and receive a second MAC CE command associated with the second entity ID. The first MAC CE command indicates one or more TCI states from the first list and maps the indicated one or more TCI states to one or more of the one or more first TCI codepoints indicated by the first DCI. The second MAC CE command indicates one or more TCI states from the second list and maps the indicated one or more TCI states to one or more of the one or more second TCI codepoints indicated by the second DCI. Here, the first or second entity ID may correspond to at least one of: (1) a PCI, (2) a CORESET pool index, or (3) a PCI index pointing to an entry in a list of PCIs that are higher layer configured to the UE.

In some embodiments, the UE may receive a third DCI including at least one third TCI codepoint indicating one or more third TCI states, where the third DCI is received in a CORESET associated with the first or second CORESET pool index; receive, via higher layer RRC signaling, a first list of TCI states associated with a first entity ID; receive, via higher layer RRC signaling, a second list of TCI states associated with a second entity ID; and receive a medium access control MAC CE command. The MAC CE command indicates at least one first TCI state from the first list and at least one second TCI state from the second list and maps the indicated at least one first TCI state and at least one second TCI state to one or more of the one or more third TCI codepoints indicated by the third DCI. The first or second entity ID corresponds to at least one of: (1) a PCI, (2) a CORESET pool index or (3) a PCI index pointing to an entry in a list of PCIs that are higher layer configured to the UE.

The UE then receives configuration information indicating a first PCI and a second PCI (step 1515). For example, the DCI format for the first or second DCIs is 1_1 or 1_2. The one or more first and second TCI states corresponds to one of a joint DL and UL TCI state, a separate DL TCI state, or a separate UL TCI state. The first PCI is associated with the first CORESET pool index. The second PCI is associated with the second CORESET pool index. The first PCI or the second PCI corresponds to serving cell PCI provided in higher layer parameter ServingCellConfigCommon.

The UE then determines first QCL information for receipt of a first channel (step 1520). For example, in step 1520, the determination may be based on the one or more first TCI states indicated by the first DCI and the first channel a first PDCCH, PDSCH, or CSI-RS. The UE then determines second QCL information for receipt of a second channel (step 1525). For example, in step 1525, the determination may be based on the one or more second TCI states indicated by the second DCI and the second channel a second PDCCH, PDSCH, or CSI-RS.

In some embodiments, according to the first QCL information, a DM-RS of the first PDCCH, a DM-RS of the first PDSCH, or the first CSI-RS associated is QCL'ed with a set of RSs in the one or more first TCI states indicated by the first DCI. According to the second QCL information, a DM-RS of the second PDCCH, a DM-RS of the second PDSCH, or the second CSI-RS is QCL'ed with a set of RSs in the one or more second TCI states indicated by the second DCI.

In one example, the first PDCCH, PDSCH, or CSI-RS may be associated with the first CORESET pool index or the first PCI, and the second PDCCH, PDSCH, or CSI-RS is associated with the second CORESET pool index or the second PCI. In another example, the first PDCCH, PDSCH, or CSI-RS may be associated with the second CORESET pool index or the second PCI, and the second PDCCH, PDSCH, or CSI-RS is associated with the first CORESET pool index or the first PCI.

Thereafter, the UE receives the first channel based on the first QCL information (step 1530) and receives the second channel based on the second QCL information (step 1535). In some embodiments, the UE may receive a third DCI including at least one third TCI codepoint indicating a first TCI state and a second TCI state, where the third DCI is received in a CORESET associated with the first or second CORESET pool index; determine, based on the first TCI state indicated by the third DCI, third QCL information for receipt of the first PDCCH, PDSCH, or CSI-RS; and determine, based on the second TCI state indicated by the third DCI, fourth QCL information for receipt of the second PDCCH, PDSCH, or CSI-RS. In some embodiments, according to the third QCL information, a DM-RS of the first PDCCH, a DM-RS of the first PDSCH, or the first CSI-RS associated is QCL'ed with a set of RSs in the first TCI state indicated by the third DCI; and according to the fourth QCL information, a DM-RS of the second PDCCH, a DM-RS of the second PDSCH, or the second CSI-RS is QCL'ed with a set of RSs in the second TCI state indicated by the third DCI.

The above flowchart illustrates example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a first downlink control information (DCI) including at least one first transmission configuration indicator (TCI) codepoint indicating one or more first TCI states, wherein the first DCI is received in a control resource set (CORESET) associated with a first CORESET pool index;
receive a second DCI indicating at least one second TCI codepoint indicating one or more second TCI states, wherein the second DCI is received in a CORESET associated with a second CORESET pool index; and
receive configuration information indicating a first physical cell identity (PCI) and a second PCI; and
a processor operably coupled to the transceiver, the processor configured to:
determine, based on the one or more first TCI states indicated by the first DCI, first quasi co-location (QCL) information for receipt of a first physical downlink control channel (PDCCH), physical downlink shared channel (PDSCH), or channel state information reference signal (CSI-RS); and
determine, based on the one or more second TCI states indicated by the second DCI, second QCL information for receipt of a second PDCCH, PDSCH, or CSI-RS,
the transceiver is further configured to:
receive the first PDCCH, PDSCH, or CSI-RS based on the first QCL information; and
receive the second PDCCH, PDSCH, or CSI-RS based on the second QCL information.

2. The UE of claim 1, wherein:
a DCI format for the first or second DCIs is 1_1 or 1_2,
the one or more first and second TCI states corresponds to one of a joint downlink (DL) and uplink (UL) TCI state, a separate DL TCI state, or a separate UL TCI state,
the first PCI is associated with the first CORESET pool index,
the second PCI is associated with the second CORESET pool index, and
the first PCI or the second PCI corresponds to serving cell PCI provided in higher layer parameter ServingCellConfigCommon.

3. The UE of claim 1, wherein:
the first PDCCH, PDSCH, or CSI-RS is associated with the first CORESET pool index or the first PCI, and the second PDCCH, PDSCH, or CSI-RS is associated with the second CORESET pool index or the second PCI; or
the first PDCCH, PDSCH, or CSI-RS is associated with the second CORESET pool index or the second PCI, and the second PDCCH, PDSCH, or CSI-RS is associated with the first CORESET pool index or the first PCI.

4. The UE of claim 1, wherein:
according to the first QCL information, a demodulation RS (DM-RS) of the first PDCCH, a DM-RS of the first PDSCH, or the first CSI-RS associated is quasi co-located (QCL'ed) with a set of RSs in the one or more first TCI states indicated by the first DCI; and
according to the second QCL information, a DM-RS of the second PDCCH, a DM-RS of the second PDSCH, or the second CSI-RS is QCL'ed with a set of RSs in the one or more second TCI states indicated by the second DCI.

5. The UE of claim 1, wherein:
the transceiver is further configured to receive a third DCI including at least one third TCI codepoint indicating a first TCI state and a second TCI state, wherein the third DCI is received in a CORESET associated with the first or second CORESET pool index; and
the processor is further configured to:
determine, based on the first TCI state indicated by the third DCI, third QCL information for receipt of the first PDCCH, PDSCH, or CSI-RS; and
determine, based on the second TCI state indicated by the third DCI, fourth QCL information for receipt of the second PDCCH, PDSCH, or CSI-RS.

6. The UE of claim 5, wherein
according to the third QCL information, a demodulation RS (DM-RS) of the first PDCCH, a DM-RS of the first PDSCH, or the first CSI-RS associated is QCL'ed with a set of RSs in the first TCI state indicated by the third DCI; and
according to the fourth QCL information, a DM-RS of the second PDCCH, a DM-RS of the second PDSCH, or the second CSI-RS is QCL'ed with a set of RSs in the second TCI state indicated by the third DCI.

7. The UE of claim 1, wherein the transceiver is further configured to:
receive, via higher layer radio resource control (RRC) signaling, a first list of TCI states associated with a first entity identifier (ID);
receive, via higher layer RRC signaling, a second list of TCI states associated with a second entity ID;
receive a first medium access control (MAC) control element (CE) command associated with the first entity ID; and
receive a second MAC CE command associated with the second entity ID,
wherein the first MAC CE command indicates one or more TCI states from the first list and maps the indicated one or more TCI states to one or more of the one or more first TCI codepoints indicated by the first DCI,
wherein the second MAC CE command indicates one or more TCI states from the second list and maps the indicated one or more TCI states to one or more of the one or more second TCI codepoints indicated by the second DCI, and
wherein the first or second entity ID corresponds to at least one of: (1) a PCI, (2) a CORESET pool index, or (3) a PCI index pointing to an entry in a list of PCIs that are higher layer configured to the UE.

8. The UE of claim 1, wherein the transceiver is further configured to:
receive a third DCI including at least one third TCI codepoint indicating one or more third TCI states, wherein the third DCI is received in a CORESET associated with the first or second CORESET pool index;
receive, via higher layer radio resource control (RRC) signaling, a first list of TCI states associated with a first entity identifier (ID);
receive, via higher layer RRC signaling, a second list of TCI states associated with a second entity ID; and
receive a medium access control (MAC) control element (CE) command,
wherein the MAC CE command indicates at least one first TCI state from the first list and at least one second TCI state from the second list and maps the indicated at least one first TCI state and at least one second TCI state to one or more of the one or more third TCI codepoints indicated by the third DCI, and
wherein the first or second entity ID corresponds to at least one of: (1) a PCI, (2) a CORESET pool index or (3) a PCI index pointing to an entry in a list of PCIs that are higher layer configured to the UE.

9. A base station (BS), comprising:
a transceiver configured to:
transmit a first downlink control information (DCI) including at least one first transmission configuration indicator (TCI) codepoint indicating one or more first TCI states, wherein the first DCI is transmitted in a control resource set (CORESET) associated with a first CORESET pool index and wherein the one or more first TCI states indicate first quasi co-location (QCL) information for a first physical downlink control channel (PDCCH), physical downlink shared channel (PDSCH), or channel state information reference signal (CSI-RS);
transmit a second DCI indicating at least one second TCI codepoint indicating one or more second TCI states, wherein the second DCI is transmitted in a CORESET associated with a second CORESET pool index and wherein the one or more second TCI states indicate second QCL information for a second PDCCH, PDSCH, or CSI-RS;
transmit configuration information indicating a first physical cell identity (PCI) and a second PCI;
transmit the first PDCCH, PDSCH, or CSI-RS; and
transmit the second PDCCH, PDSCH, or CSI-RS.

10. The BS of claim 9, wherein:
a DCI format for the first or second DCIs is 1_1 or 1_2,
the one or more first and second TCI states corresponds to one of a joint downlink (DL) and uplink (UL) TCI state, a separate DL TCI state, or a separate UL TCI state,
the first PCI is associated with the first CORESET pool index,
the second PCI is associated with the second CORESET pool index, and
the first PCI or the second PCI corresponds to serving cell PCI provided in higher layer parameter ServingCellConfigCommon.

11. The BS of claim 9, wherein:
the first PDCCH, PDSCH, or CSI-RS is associated with the first CORESET pool index or the first PCI, and the second PDCCH, PDSCH, or CSI-RS is associated with the second CORESET pool index or the second PCI; or
the first PDCCH, PDSCH, or CSI-RS is associated with the second CORESET pool index or the second PCI, and the second PDCCH, PDSCH, or CSI-RS is associated with the first CORESET pool index or the first PCI.

12. The BS of claim 9, wherein:
according to the first QCL information, a demodulation RS (DM-RS) of the first PDCCH, a DM-RS of the first PDSCH, or the first CSI-RS associated is quasi co-located (QCL'ed) with a set of RSs in the one or more first TCI states indicated by the first DCI; and
according to the second QCL information, a DM-RS of the second PDCCH, a DM-RS of the second PDSCH, or the second CSI-RS is QCL'ed with a set of RSs in the one or more second TCI states indicated by the second DCI.

13. The BS of claim 9, wherein:
the transceiver is further configured to transmit a third DCI including at least one third TCI codepoint indicating a first TCI state and a second TCI state,
the third DCI is transmitted in a CORESET associated with the first or second CORESET pool index,
the first TCI state indicates third QCL information for the first PDCCH, PDSCH, or CSI-RS; and
the second TCI state indicates fourth QCL information for the second PDCCH, PDSCH, or CSI-RS.

14. The BS of claim 13, wherein
according to the third QCL information, a demodulation RS (DM-RS) of the first PDCCH, a DM-RS of the first PDSCH, or the first CSI-RS associated is QCL'ed with a set of RSs in the first TCI state indicated by the third DCI; and
according to the fourth QCL information, a DM-RS of the second PDCCH, a DM-RS of the second PDSCH, or the second CSI-RS is QCL'ed with a set of RSs in the second TCI state indicated by the third DCI.

15. The BS of claim 9, wherein the transceiver is further configured to:
transmit, via higher layer radio resource control (RRC) signaling, a first list of TCI states associated with a first entity identifier (ID);
transmit, via higher layer RRC signaling, a second list of TCI states associated with a second entity ID;
transmit a first medium access control (MAC) control element (CE) command associated with the first entity ID; and
transmit a second MAC CE command associated with the second entity ID,
wherein the first MAC CE command indicates one or more TCI states from the first list and maps the indicated one or more TCI states to one or more of the one or more first TCI codepoints indicated by the first DCI,
wherein the second MAC CE command indicates one or more TCI states from the second list and maps the indicated one or more TCI states to one or more of the one or more second TCI codepoints indicated by the second DCI, and
wherein the first or second entity ID corresponds to at least one of: (1) a PCI, (2) a CORESET pool index, or (3) a PCI index pointing to an entry in a list of PCIs that are higher layer configured.

16. The BS of claim 9, wherein the transceiver is further configured to:
transmit a third DCI including at least one third TCI codepoint indicating one or more third TCI states, wherein the third DCI is transmitted in a CORESET associated with the first or second CORESET pool index;
transmit, via higher layer radio resource control (RRC) signaling, a first list of TCI states associated with a first entity identifier (ID);
transmit, via higher layer RRC signaling, a second list of TCI states associated with a second entity ID; and
transmit a medium access control (MAC) control element (CE) command,
wherein the MAC CE command indicates at least one first TCI state from the first list and at least one second TCI state from the second list and maps the indicated at least one first TCI state and at least one second TCI state to one or more of the one or more third TCI codepoints indicated by the third DCI, and
wherein the first or second entity ID corresponds to at least one of: (1) a PCI, (2) a CORESET pool index or (3) a PCI index pointing to an entry in a list of PCIs that are higher layer configured.

17. A method for operating user equipment (UE), the method comprising:
receiving a first downlink control information (DCI) including at least one first transmission configuration indicator (TCI) codepoint indicating one or more first TCI states, wherein the first DCI is received in a control resource set (CORESET) associated with a first CORESET pool index;
receiving a second DCI indicating at least one second TCI codepoint indicating one or more second TCI states, wherein the second DCI is received in a CORESET associated with a second CORESET pool index;
receiving configuration information indicating a first physical cell identity (PCI) and a second PCI;
determining, based on the one or more first TCI states indicated by the first DCI, first quasi co-location (QCL) information for receipt of a first physical downlink control channel (PDCCH), physical downlink shared channel (PDSCH), or channel state information reference signal (CSI-RS);
determining, based on the one or more second TCI states indicated by the second DCI, second QCL information for receipt of a second PDCCH, PDSCH, or CSI-RS;
receiving the first PDCCH, PDSCH, or CSI-RS based on the first QCL information; and
receiving the second PDCCH, PDSCH, or CSI-RS based on the second QCL information.

18. The method of claim 16, wherein:
a DCI format for the first or second DCIs is 1_1 or 1_2,
the one or more first and second TCI states corresponds to one of a joint downlink (DL) and uplink (UL) TCI state, a separate DL TCI state, or a separate UL TCI state,
the first PCI is associated with the first CORESET pool index,
the second PCI is associated with the second CORESET pool index, and
the first PCI or the second PCI corresponds to serving cell PCI provided in higher layer parameter ServingCellConfigCommon.

19. The method of claim 16, wherein:
the first PDCCH, PDSCH, or CSI-RS is associated with the first CORESET pool index or the first PCI, and the second PDCCH, PDSCH, or CSI-RS is associated with the second CORESET pool index or the second PCI; or
the first PDCCH, PDSCH, or CSI-RS is associated with the second CORESET pool index or the second PCI, and the second PDCCH, PDSCH, or CSI-RS is associated with the first CORESET pool index or the first PCI.

20. The method of claim 16, wherein:
according to the first QCL information, a demodulation RS (DM-RS) of the first PDCCH, a DM-RS of the first PDSCH, or the first CSI-RS associated is quasi co-located (QCL'ed) with a set of RSs in the one or more first TCI states indicated by the first DCI; and
according to the second QCL information, a DM-RS of the second PDCCH, a DM-RS of the second PDSCH, or the second CSI-RS is QCL'ed with a set of RSs in the one or more second TCI states indicated by the second DCI.
